(19) United States
(12) Patent Application Publication
(10) Pub. No.: US 2023/0289440 A1
(43) Pub. Date: Sep. 14, 2023

(54) DATA PROCESSING TERMINALS AND RELATED METHODS IN LOCK, INTERMEDIATE, AND UNLOCK MODES

(71) Applicants: Jaelark JUNG, Goyang-si (KR); Jaekyu LEE, Gunpo-si (KR); Youngtack SHIM, Seoul (KR)

(72) Inventors: Jaelark JUNG, Goyang-si (KR); Jaekyu LEE, Gunpo-si (KR); Youngtack SHIM, Seoul (KR)

(21) Appl. No.: 18/199,233

(22) Filed: May 18, 2023

Related U.S. Application Data
(63) Continuation-in-part of application No. 16/323,861, filed on Feb. 7, 2019.
(60) Provisional application No. 62/379,599, filed on Aug. 25, 2016.

(51) Int. Cl. G06F 21/55; G06F 1/16; G06F 21/56; G06F 21/31

(52) U.S. Cl. CPC G06F 21/554; G06F 1/1641; G06F 21/561; G06F 21/31; G06F 2221/034

(57) ABSTRACT

The disclosure relates to various data processing terminals capable of operating in different modes each of which is granted with different authorities to access hardware or software elements of the terminals. More particularly, a terminal includes a lock system operating in a lock mode and a main system operating in an unlock mode, and erases an entire or a selected portion of results obtained by running operations in the lock mode, when a terminal switches from a lock mode to an unlock mode with greater access authority. Because potentially malicious computer codes which may be impregnated into such results are erased before switching to an unlock mode, the terminal enhances an integrity and a security of a terminal, and improves privacy of a user by preventing loss or unintended disclosure of private data stored in a terminal.

### CROSS-REFERENCE TO RELATED APPLICATIONS

This disclosure claims priority from the U.S. patent application Ser. No. 16/323,861 filed on Feb. 7, 2019, which is a national stage of International Application No. PCT/KR2017/009220 filed on Aug. 23, 2017, which claims the priority from U.S. Provisional patent application Ser. No. 62/379,599 filed on Aug. 25, 2016. Each of the above applications are incorporated herein by reference in its entirety. In case of any discrepancy between this disclosure and the above applications, it is noted that this disclosure prevails over the above applications. It is also noted that, in case of omittance, the contents which were provided in the above applications but not included in this disclosure are deemed to be not incorporated into this disclosure and that such contents are not parts of this disclosure, unless otherwise specifically incorporated herein by reference (e.g., by referring to the line numbers and column numbers of the above applications).

### FIELD OF DISCLOSED DATA PROCESSING TERMINALS AND THEIR METHODS

This disclosure relates to various data processing terminals which may operate in at least one hierarchy which may in turn defines therein multiple modes of operation, where such terminals grant users with different access authorities in each of such modes. Upon receiving proper user inputs (or sub-inputs), the terminals may allow a user to switch from a current mode to a new mode, where the current mode may include a powered-off state (i.e., a terminal is not communicable and its display unit is therefore turned off), an off-state (i.e., a terminal is communicable and, therefore, a powered-on state, but its display unit is turned off), and at least one of such modes as, e.g., a powered-on state (i.e., a terminal is communicable and its display unit may be turned on or off) and an on-state in which a terminal is communicable and its display unit is turned on, which are defined in the hierarchy, and where a new mode may include the powered-off state, the off-state, the on-state, and one of other modes also defined in the hierarchy. This disclosure also relates to various units and their hardware or software elements of such terminals capable of allowing or denying a user to switch from a current mode to a new mode. This disclosure further relates to various configurations of such units and their hardware and software elements to enable and to embody such mode switching.

This disclosure also relates to various methods of providing such data processing terminals which can operate in different modes of operation, various methods of operating such terminals in such modes, various methods of switching from a current mode to a new mode, and various methods of granting a user with one of multiple access authorities such that a user may switch to a new mode from a current mode or that a user may drive a certain hardware or software element in a certain mode.

This disclosure also provides various methods of setting up various hierarchies each of which defines different modes of operation therein, various methods of arranging such modes of operation in a hierarchy, and various methods of assigning identical, similar, different or comparable access authorities to each of such modes. This disclosure also provides various methods of granting (or denying) a user to switch to a certain mode from a current mode, or to switch from one mode to another in a certain sequence in a certain hierarchy, various methods of granting (or denying) an access to a certain hardware or software element of a terminal based on the access authorities assigned to each of such modes, various methods of establishing various hierarchies of multiple modes, or the like.

Based thereupon, this disclosure provides various data processing terminals capable of providing a user with enhanced security, improved integrity, or heightened privacy by including therein at least one main system and at least one lock (or intermediate) system. A main system may generally include various hardware and software elements with which a user can run various unlock operations in an unlock mode, while a lock (or intermediate) system may generally include at least one hardware element or software element which may be physically or operationally isolated or blocked from the main system. Therefore, any result obtained by driving the hardware or software element of a lock (or intermediate) system in a lock (or intermediate) mode may not adversely affect the hardware or software element of a main system in a lock (or intermediate) mode. Because of such physical or operational isolation, a terminal may allow a user to run almost any operation he wants in a lock (or intermediate) mode using a lock (or intermediate) system, without having to risk any security, integrity or privacy of a main system.

To this end, this disclosure provides various data processing terminals which may include at least two of such mains, intermediate, and lock systems, various configurations of various units or their hardware or software elements of at least two of such systems, various methods of physically or operationally isolating a lock (or intermediate) system from a main system (or vice versa), or various configurations for completely (or partially) isolating a lock (or intermediate) system from a main system (or vice versa). This disclosure also discloses various methods of ensuring physical or operational isolation between such main and lock (or intermediate) systems, various methods of erasing (or semi-erasing) potentially risky or undesirable results which may reside in a lock (or intermediate) system before, during, or after a user may switch from a lock (or intermediate) mode to an unlock mode, or the like.

Further exemplary aspects, embodiments, and examples of various data processing terminals and their related methods are disclosed below along with appended figures.

### BACKGROUND

As prior art data processing devices (such as, e.g., smart-phones, mobile phones, tablet computers, personal digital assistants, web pads, or the like) are equipped with top-notch processors (powerful than ever) and memories of ever-increasing capacities, users get more and more dependent thereupon and addicted thereto. In addition, prior art data processing devices are generally equipped with communication capabilities so that users may replace not only their telephones but also their desk-top computers or laptop computers with such devices. Therefore, it is not surprising to see more users store and carry their most precious and private data in such portable data processing devices, with the hope of fully enjoying various conveniences offered by such devices.

Commensurate with the advent of hardware and software technologies which are associated with mobile communication, more hackers are tempted to plant malicious viruses into seemingly benign software apps (i.e., applications) or contents, and to massively circulate them in the web, hoping that unwary users would allow the malicious viruses to be impregnated into main systems of the users' data processing devices. Once being impregnated, the viruses would allow the hackers to access and steal personal or financially valuable data of the users.

Therefore, whenever a user may access and download such malicious applications or contents to the device without comprehending risks associated therewith, the user incurs damages such as, e.g., an exposure or a loss of precious financial data stored in the main system of the device, an accidental revelation of their most private and embarrassing data, or a mal-functioning device, all caused by malicious viruses migrated into the main system of their devices. Some hackers go even further to impregnate ransomware and block the users from accessing data stored in their own devices, until the victims pay money to the hackers.

Even conservative or wary users are encountered with such situations frequently. For example, the user may be asked (or required) to access unfamiliar websites and to download software applications or contents from the web. Of course, the best policy is to not do so. However, the users may have to do so, particularly when they do not have any other choices, when they are in an emergency or in a rush, or the like.

Such security concerns usually hinder the conservative or wary users from fully utilizing their data processing devices. For example, when a user visits a new website and finds attractive contents, he or she hesitates to open a new application or to download contents therefrom, due to the fear that their precious data stored in their devices may fall into the hands of the hackers.

Users of such data processing devices have other reasons to protect their main systems of the devices, for the main system (e.g., its main memory unit) typically contains the users' most personal data which the users do not want to disclose to others or do not want to share with others. Of course, conventional authentication programs may prevent such from happening to some extent. However, the users are often forced to use their devices in an open environment, while risking disclosure of whatever contents may be kept in the main memory unit of their main systems.

A user may also resort to currently available vaccine programs to confirm whether a downloaded application or content may include any malicious viruses. However, many viruses are designed to escape from the vaccine programs. Even when the users may find out that the downloaded application contains damaging viruses, it is usually too late to take any remedial actions, for it is usually only after such viruses have successfully migrated into the main systems of their devices.

In other words, whatever advanced security means may be developed and incorporated into such a device to protect a user, hackers are almost always able to come up with a new tool or an advanced algorithm which can effectively neutralize the security means. As a matter of fact, considering that almost everything in a data processing device operates in a digital domain, it is no wonder to realize that hackers can do almost everything they want to accomplish, given enough time to catch up. It is, accordingly, important to realize that the best or optimal policy for the users to protect their own data stored in their data processing devices may be to [1] not access suspicious websites, [2] not download any such malicious applications or contents into the device, or the like. Of course, this policy usually does not help, for there is no fool-proof protocol to find out in advance which websites are suspicious or which contents include such viruses.

As discussed above, there is an impending need for a data processing terminal to provide a user with enhanced security, improved integrity, and heightened privacy. Of course, the enhanced security, improved integrity, and heightened privacy should not compromise the user convenience which a terminal is intended to provide. A user may find it most convenient when a data processing terminal can provide enhanced security, improved integrity, and heightened privacy, when a terminal can do so without requiring a user to provide many separate user inputs, without consuming a long period of time, or without sacrificing seamless operations of the terminal.

### SUMMARY

Various data processing terminals of this disclosure aim to provide their users with the enhanced security, the improved integrity, and the better data protection, while maintaining or improving a convenience of seamless capabilities by employing at least “four features” which may be “independent” of each other or which may be “interdependent” on each other, depending upon configurational or operational characteristics of a terminal or upon such characteristics of various hardware or software elements of a main, intermediate or lock system of a terminal.

The first of such features is to provide a user with “at least two different modes” of operation each of which is granted with different access authority to drive a hardware or software element of a main, intermediate or lock system. As a result, a user may operate a terminal in one mode (e.g., an unlock mode) when a user processes reliable data, but may operate a terminal in another mode (e.g., a lock or intermediate mode) when a user processes unreliable data. The second of such features is the “physical isolation” or “operational isolation” of [1] a main system from a lock (or intermediate) system of a terminal or [2] the lock system from the intermediate system of the terminal.

The third of such features is the “erase (or semi-erase) operation” with which a terminal can erase all (or some) results obtained by running various lock (or intermediate) operations with a lock (or intermediate) system in a lock (or intermediate) mode before such results may affect any hardware or software element of a main system of a terminal. To this end, a terminal may run an erase (or semi-erase) operation in one of various timings as will be defined below. Finally, the fourth of such features is the inclusion of a “mode-switching input unit” with which a user may conveniently switch from one mode to another mode, simply by providing a terminal with a single user input which includes at least one mode-switching (user) sub-input, and without having to turn off a display unit of a terminal and then to turn it on again.

Various objectives, advantages, and benefits of various data processing terminals of this disclosure as well as related methods of providing and using such terminals will be described below, starting with definitions of terms and phrases to be used throughout this disclosure.

### 1. Definitions

As described above, various data processing terminals of this disclosure may operate in multiple different (or sometimes identical or similar) modes of operation, each of which is granted by the terminals with different (or sometimes identical or similar access authorities). In addition, such terminals may allow their users to switch from a current mode to a new mode, while providing the users with the enhanced security, improved integrity, and heightened privacy.

It is appreciated throughout this disclosure that various numerals disposed between square brackets “[” and “]” such as, e.g., [1] or [2], mean that they are alternatives. Accordingly, “examples of such a system include [1] a lock system, [2] an intermediate system, or the like” means that the device may be the lock system, the intermediate system, the lock and intermediate systems, or its (or their) equivalents.

### 1-1. Accessible Hardware or Software Elements

Each data processing terminal is equipped with multiple hardware elements and multiple software elements therein. Among those elements, when a terminal may allow a user to neither directly drive nor directly modify a certain hardware or software element for operational or security reasons, this element is to be referred to as a “non-accessible” hardware or software element within the scope of this disclosure. A microprocessor, a wireless transmitter, a wireless receiver, a firmware, and a kernel are typical examples of such non-accessible hardware or software elements. In addition, a software element which is stored not in an accessible user space of a terminal but in a protected kernel space of a terminal is another example of the non-accessible elements.

When a manufacturer of a terminal allows a user to directly drive a certain hardware or software element with a user input, however, this element is referred to as an “accessible” hardware or software element of a terminal. For example, an input unit, a memory unit, a software application (to be abbreviated as an “app” hereinafter), or an O/S with which a user can run various operations are typical examples of the accessible software or hardware elements. In addition, when a terminal provides a user with various user interfaces (e.g., a graphical user interface, a text-based interface, or another user interface), the hardware or software element which can be driven by a user by manipulating such user interfaces may be referred to as the accessible hardware or software element.

In this regard, when a data processing terminal grants a user with a certain access authority in a certain mode of operation, the user may [1] access all accessible hardware or software elements, or [2] access not all but only some of the accessible hardware or software elements. In each of the above [1] and [2], the terminal may also grant the user [3] to drive an entire “portion” of a certain accessible hardware or software element, or [4] to drive not the entire portion but only a restricted “portion” of a certain accessible hardware or software element. In the case of [4] of this paragraph, a user may drive the certain accessible hardware or software element in a restricted “extent” such that the user may drive only some but not all portions of the element or may drive the element not with all available options but only with restricted “options.”

Accordingly, a terminal may grant a user to switch from a current mode to a new mode upon receiving a proper user input. The terminal may then grant the user [1] to “access” at least one accessible hardware or software element, [2] to “drive” the element, [3] to “run” a certain operation by driving such an element, [4] to “perform” a certain function by driving the element, or the like, based on the access authority which the terminal grants to the user in the new mode. In contrary, a terminal may deny a user [5] from switching from a current mode to a new mode, e.g., when the terminal does not authorize a user input. In this case, [5-1] the user may get stuck in the current mode or [5-2] the terminal may switch to the off-state or the powered-off state. In the case of [5-1], the terminal may keep allowing the user to drive those hardware or software elements which are accessible in the current mode but may continue to block the user from driving other hardware or software elements which may only be accessible in the new mode.

It is appreciated that a user can “access” or “drive” at least one accessible hardware or software element only when a terminal grants the user with proper access authorities in a certain mode but that, even in such a mode, the user cannot access or drive non-accessible hardware or software elements. In this regard, when a terminal or user is said to access or to drive a certain hardware or software element, it is presumed that the hardware or software element is an “accessible” hardware or software element, unless otherwise specified. It is further appreciated that “to ‘drive’ an element” is [1] to be synonymous with “to ‘drive’ at least one accessible hardware or software element” or [2] to collectively include “to ‘drive’ at least one accessible hardware element” and/or “to ‘execute’ at least one accessible software element” hereinafter.

### 1-2. Main System Vs. Lock System

A data processing terminal of this disclosure includes at least one main system and at least one lock system. In addition, a terminal may also include at least one optional intermediate system. In general, a terminal grants the greatest (or most) access authority to a user driving a main system in an unlock mode, while granting the least access authority to a user who drives a lock system in a lock mode. A terminal may optionally grant an intermediate access authority to a user who drives the intermediate system in an intermediate mode, where the intermediate access authority is less than that of the main system but greater than that of the lock system.

As used herein, a “main system” refers to a system which a user uses to operate a data processing terminal in an unlock mode (of operation) which a terminal actually defines in a certain hierarchy. A main system may typically be a system which a user uses to operate a terminal in an “unlock mode” as will be described below. In this context, a main system is the system which is granted by the terminal the greatest access authority in a certain hierarchy.

The main system includes at least one (main) accessible hardware element and/or at least one (main) accessible software element.

A terminal grants the greatest (or most) access authority when a user uses a main system in an unlock mode, thereby allowing a user to drive the greatest number (or all) of the accessible hardware elements of a main system and/or the greatest number (or all) of the accessible software elements of a main system. In this regard, a “main system” may be synonymous with an “unlock system” in this disclosure, unless otherwise specified. In addition, a main system or an unlock system operates in an unlock mode which is actually defined in a certain hierarchy by a terminal, and actually granted with the most access authority in the hierarchy by the terminal.

In contrary, a “lock system” refers to another system which a user uses to operate a data processing terminal in a lock mode (of operation) which a terminal actually defines in a certain hierarchy. The lock system generally corresponds to a system which a user uses to operate a terminal in a “lock mode” as will be defined below. In this context, a lock system is a system which is granted with the least access authority in a certain hierarchy in which the lock mode is defined. A terminal may provide a lock system with at least one (lock) hardware or software element of its own, or may not provide any of such elements. A terminal may (or may not) allow a lock system to drive at least one accessible (main) hardware or software element of a main system.

A lock system may be “physically” or “operationally” “isolated, blocked or separated” from a main system for various security, integrity or privacy reasons as will be described below. It is appreciated that such “physical or operational” “isolation, blocking or separation” is to be abbreviated as “isolation” or “blocking” for simplicity of illustration.

Therefore and in one case, when a user drives a lock system in a lock mode, a terminal may not grant a user with any access authority to various accessible elements of a main system through such isolation or blocking. Therefore, a user may neither access nor drive any accessible hardware or software element of a main system in a lock mode. Because a user cannot recruit any accessible hardware or software element of a main system in a lock mode, a lock system itself may preferably include at least one (lock) hardware or software element of its own which is accessible in the lock mode such that a user may access and drive such an element of a lock system and may run various (lock) operations in a lock mode. In this respect, a lock system is deemed to have the least access authority to the accessible hardware or software elements of a main system.

In another case, when a user drives a lock system in a lock mode, a terminal may grant the user with the minimum access authority to a main system such that, e.g., a user can only drive a minimum number of such accessible (main) hardware or software elements of a main system, while operating a lock system in a lock mode. Although a terminal may allow a user to recruit (e.g., access or drive) at least one accessible hardware or software element of a main system in a lock mode, a terminal may completely (or partly) prevent a user (or lock system) [1] from storing any result(s) which is obtained by running lock operations in a lock mode into a main system or [2] from modifying any element of a main system in a lock mode through such isolation or blocking. As a result, the terminal may prevent (or at least minimize) a main system from being adversely affected or degraded by such result(s) or by a lock system. In this case, because a user can recruit only a minimum number of the accessible (main) hardware or software element of a main system in a lock mode, a lock system may [1] include at least one (lock) hardware or software element of its own to run various lock operations, or [2] not include any accessible element therein, while relying on a main system to run such lock operations. In this respect, this lock system may be deemed to have some (but not all) access authority to those accessible hardware or software elements of a main system.

In yet another case, when a user drives a lock system in a lock mode, a terminal may rather grant a user with a full access authority to a main system such that, e.g., a user can drive all accessible hardware or software elements of a main system while operating a lock system in a lock mode. However, a terminal may completely (or partly) prevent a user (or a lock system) [1] from storing any result obtained by running lock operations in a lock mode into a main system or [2] from modifying any element of a main system in a lock mode through such isolation or blocking. As a result, a terminal may still prevent (or at least minimize) a main system from being adversely affected or degraded by such result(s) or by a lock system as well. In this case, even though a user can recruit all accessible hardware or software elements of a main system while operating a lock system in a lock mode, the lock system may [1] still include at least one (lock) hardware or software element of its own, or [2] not include any element of its own, while completely depending upon a main system to run such lock operations in a lock mode. In this respect, this lock system may be deemed similar or (almost) identical to a main system.

### 1-3. Access Authority

As used herein, an “access authority” refers to an authority which a terminal grants (or assigns) to a user who operates a terminal by driving a certain system in a certain mode of operation. More particularly, an “access authority” refers to an authority which a terminal grants to a user to access a certain number of such accessible hardware or software elements of a main, intermediate or lock system. For example, a terminal may grant a user to access all, only some, or none of such accessible elements of a main system. When a terminal grants a user with access authority to a certain accessible hardware or software element of a main system, it is noted that a user can [1] “drive” the element, [2] “run” a certain operation by driving the element, or [3] “perform” a certain function by running the operation. It is noted that, depending upon the nature of such access authority, a user may have the access authority to drive an element of a main system [1] by operating a main system in an unlock mode or [2] by operating a lock (or intermediate) system in a lock (or intermediate) mode. When this disclosure refers to access authority to a hardware or software element of a lock system, such access authority will be referred to as the access authority to access the element [1] by a lock (or intermediate) system in a lock (or intermediate) mode or [2] by a main system in an unlock mode.

Therefore, unless otherwise specified, “access authority” of this disclosure refers to the access authority [1] to “access” at least one of the accessible hardware and/or software elements of a main system while operating a main system in an unlock mode or while operating a lock (or intermediate) system in a lock (or intermediate) mode, [2] to “drive” the hardware or software element while operating such a system in such a mode, [3] to “run” at least one operation by driving the element while operating one of such systems in such a mode, or [4] to “perform” a certain function by running such an operation while operating one of such systems in such a mode. Only when the disclosure mentions access authority to at least one hardware or software elements of a lock system, such access authority refers to the access authority [1] to access at least one of such accessible lock (or intermediate) elements while operating a lock (or intermediate) system in a lock (or intermediate) mode or while operating a main system in an unlock mode, [2] to drive the elements while operating one of such systems in such a mode, [3] to run at least one operation while operating one of such systems in such a mode, or [4] to perform a certain function by running at least one operation while operating one of such systems in such a mode.

### 1-4. Modes (of Operation) and Access Authorities

As used herein, a “mode (of operation)” or simply a “mode” refers to an operational state of a data processing terminal, where a user can access a certain number of accessible hardware or software elements of a main, intermediate or main system of a terminal. A terminal allows a user [1] to “advance” to a new mode from its “powered-off state” (i.e., when a terminal is powered off and is not communicable and, accordingly, its display unit is or has been turned off), [2] to “advance” to a new mode from its “off-state” (i.e., when a terminal is powered on and communicable, but its display unit is or has been turned off), [3] to “switch” from a current mode to a new mode while in an “on-state” (i.e., when a terminal is powered on and communicable, and its display unit is or has been turned on), [4] to “advance” to its off-state from one mode (e.g., the on-state), or [5] to “advance” to its powered-off state from one mode (e.g., the powered-on state), in response to a suitable user input provided to an input unit of a terminal by a user. For simplicity of illustration, to “switch modes (of operation)” or “mode switching” collectively refers to any of the above [1] to [5] hereinafter.

Further details of “1-4. Modes (of Operation) and Access Authorities” are identical to the following portions of U.S. patent application Ser. No. 16/323,861 (will be abbreviated as the “'861 application” hereinafter) such as, e.g., FIGS. 1A to 1D and the text from [0065] on page 5 through [0114] on page 10, where these portions are incorporated herein in their entirety by reference.

### 1-5. Types of Hierarchies

As defined above, a “mode (of operation)” or simply a “mode” refers to an operational state of a data processing terminal, where a user can access a certain number of accessible hardware or software elements of a main system of a terminal. In this context, a “hierarchy (of operation)” or simply a “hierarchy” means a set of at least two modes which a terminal actually defines (e.g., along a line of an access authority or on a domain of an access authority) and to each of which a terminal grants preset access authority to accessible hardware and/or software elements of a main system of the terminal.

For example, a terminal (or a user) may define [1] at least one unlock mode and at least one lock more in a 1^{st} hierarchy, [2] at least two unlock modes with no lock mode in a 2^{nd} hierarchy, [3] at least two lock modes with no unlock mode in a 3^{rd} hierarchy, [4] at least one unlock mode, at least one intermediate mode, and at least one lock mode in a 4^{th} hierarchy, or the like. It is appreciated that at least two unlock modes may be granted with the identical or at least substantially similar access authorities and, accordingly, that such modes as well as their access authorities are completely overlapping each other. To the contrary, at least two unlock modes may be granted with the partly overlapping or non-overlapping access authorities. The same applies to at least two lock modes or at least two intermediate modes as well.

Once a terminal (or a user) sets up a certain hierarchy and defines certain modes in the hierarchy, a terminal may [1] advance to a certain mode defined in a hierarchy from a powered-off state or an off-state of a terminal, [2] switch to a new mode defined in a hierarchy from a current mode also defined in the hierarchy, or [3] to advance to a powered-off state or an off-state from a current mode. To this end, a terminal (or a user) may set up various hierarchies based on the needs, and may actually define various modes in each of such hierarchies. Following examples explain various types of such hierarchies.

Further details of “1-5. Types of Hierarchies” are identical to the following portions of the '861 application such as, e.g., FIG. 2, and the text from [0119] on page 10 through [0157] on page 14, where these portions are incorporated herein in their entirety by reference.

### 1-6. Deleting Vs. Erasing

Whenever a terminal (more particularly, its CPU unit or its O/S) drives various elements, a terminal may tend to leave various data, files, or folders behind. As used herein, “result” or “results” mean data, files, or folders which are left behind after (or while) driving a lock (or intermediate) system in a lock (or intermediate) mode.

That is, such “result” or “results” may also mean such data, files, folders, texts, images, contents, computer codes, or the like, which a user (or a terminal) may obtain by [1] driving a lock (or intermediate) system in a lock (or intermediate) mode, [2] executing a lock (or intermediate) hardware (or software) element in a lock or (intermediate) mode, [3] executing a lock (or intermediate) application (or to be simply abbreviated as an “app”) in a lock or (intermediate) mode, or the like.

Unless otherwise specified, such “result” or “results” may not include those “outcomes” which are obtained [1] by driving a main system in an unlock mode, [2] by executing a main hardware (or software) element in an unlock, [3] by executing a main app in an unlock, or the like, unless otherwise specified. It is appreciated that, such “outcomes” may mean various data, files, folders, texts, images, contents, or computer codes which are obtained by the above [1], [2] or [3] of this paragraph.

As used herein, “delete” refers to operations of “removing direct pointers” to certain data sectors in which any results (which are desired to be deleted) reside or are stored. It is appreciated, however, that such results may be usually represented residually, even after such “deleting,” through data remanence. In addition, such results may be recovered by others even after a simple “deleting” operation. In other words, when a terminal runs lock operations by a lock system in a lock mode, some results are obtained and reside in the lock system. Therefore, even when a terminal switches from the lock mode to an unlock mode after deleting such results from the lock system, some results may be still left behind in a terminal. When malicious viruses are included in such results, such viruses may then be able to penetrate or migrate into a main system while a user operates a terminal in an unlock mode, and may adversely affect the main system.

As used in this disclosure, a “malicious virus” or “malicious viruses” collectively refers to all types of software which is designed to cause disruption to the prior art data processing device or the data processing terminal of this disclosure by, e.g., [1] gaining unauthorized access to user's data stored in the device or terminal, [2] gaining unauthorized access to a hardware or software element of the device or terminal, [3] leaking the user's data stored in the device or terminal to a 3^{rd} party without user's authorization, [4] depriving the user's access to such data or such a device or terminal, [5] interfering with the security of the device or terminal, or the like.

Examples of such “malicious viruses” may include, e.g., (computer) viruses, (computer) worms, Trojan horses, ransomware, adware, rogue software, wiper, keyloggers, spyware, (http) cookies, other computer malware, or the like. Other malicious (or benign) computer codes (or software element) may be designated as such “malicious viruses” by [1] a manufacturer of such a device or terminal, [2] a provider of an O/S or [3] a user.

Accordingly, a simple deleting operation may not be enough to prevent a main system of a terminal (or various accessible hardware or software elements of the main system) from being contaminated or adversely affected by such results which are obtained by running lock (or intermediate) operations with a lock (or intermediate) system in a lock (or intermediate) mode and which may reside in the lock (or intermediate) system even after such deleting.

In contrary, “erase” as used herein refers to operations of “purging such results” from a memory unit(s), while leaving such memory unit(s) operable. That is, an “erase operation” or “erasure” not only deletes such direct pointers but also purges remnant results which may be residing or stored in a memory unit (or sector). Thus, the erased (or purged) results cannot be generally recovered by others. In addition, even when such results can be recovered by a skillful artisan, the process is extremely difficult. Thus, an “erase operation” or “erasure” may be typically required in order to achieve enhanced security of a data processing terminal, which is one of various objectives of the terminals of this disclosure.

A terminal may run an erase (or semi-erase) operation in various occasions. In one occasion, the terminal may run such erasure or semi-erasure when a user detects such malicious viruses in such results, in at least one lock software (or hardware) elements, in one lock app, in at least a portion of a lock system, or the like.

In another occasion, the terminal may run such erasure or semi-erasure when a user may find that [1] a lock system does not function properly or as expected, [2] at least one lock software, lock hardware element or lock app does not run lock operations properly or as expected, [3] at least one lock software, lock hardware element or lock app does not perform functions properly or as expected, or the like.

In another occasion, a terminal may run such erasure or semi-erasure when the terminal may discover such viruses by executing various anti-virus software element or app. The terminal may run an anti-virus operation when [1] the terminal finds a malfunction of such elements or apps, [2] a user runs a certain number of lock operations, where that certain number exceeds a preset number, [3] a user obtains such “results” a size of which exceeds a preset size, [4] a certain period of time has elapsed after the most recent erasure (or semi-erasure), [5] data stored in a lock memory unit may exceed a certain size, or the like.

Regardless of whether or not such malicious viruses are present (or included in) a lock system or whether or not a terminal may run an anti-virus operation, the terminal may run an erasure or semi-erasure in one of [2], [3], [4] or [5] of the preceding paragraph.

It is noted that various data processing terminals of this disclosure may allow a user to erase all or some of such results (e.g., text, images, files, folders, or computer codes) which may be obtained by running lock (or intermediate) operations by driving a lock (or intermediate) system in a lock (or intermediate) mode. As will be explained in detail below, a lock system may include at least one lock memory unit in which a lock system may temporarily or permanently store such results. For this reason, various lock (or intermediate) memory units (or sectors) of this disclosure may mean such memory units (or sectors) which may reside in a lock (or intermediate) system. However, the lock (or intermediate) memory units (or sectors) may also refer to those memory units (or sectors) which reside in a main system but which may be recruited by a lock (or intermediate) system in a mode other than an unlock mode such as, e.g., the lock (or intermediate) mode.

In contrary to such “erase” and as used herein, “semi-erase” is defined as an operation of “purging some but not all results” which are obtained by running lock (or intermediate) operations with a lock (or intermediate) system in a lock (or intermediate) mode and which may be stored or reside in a lock (or intermediate) memory unit(s).

Because a semi-erase operation may erase at least a portion but not an entire portion of the results, at least some results may then be stored in a lock (or intermediate) memory unit (or sector), while leaving the lock (or intermediate) memory unit (or sector) operable. That is, a “semi-erase operation” or “semi-erasure” purges only a portion of such results (including their remnant information) obtained by running lock (or intermediate) operations with a lock (or intermediate) system in a lock (or intermediate) mode, while leaving the rest of the results intact in such lock (or intermediate) memory unit(s), with or without an active storing operation.

It is appreciated that a terminal (more precisely, its main, intermediate, or lock system) may run such erasure or semi-erasure over various hardware elements of a main, intermediate, or lock system. For example, such a terminal may run such erasure (or semi-erasure) over a main memory unit of a main system, an intermediate memory unit of an intermediate system, or a lock memory unit of a lock system. A terminal may also run such erasure (or semi-erasure) over a “temporary memory sector” of a main, intermediate, or lock system, where examples of the temporary memory sector may include, but not be limited to, [1] a data buffer of the main, intermediate or lock system, [2] a cache thereof, [3] a clipboard thereof, or [4] a recycle bin thereof.

As used herein, “erased results” refers to those results which are erased by a terminal when a terminal allows a user [1] to switch from a lock mode (or a current mode which may not be a lock mode) to a new mode which may be an intermediate or unlock mode, or [2] to switch from an on-state of a terminal to an off-state thereof. Such erased results collectively refer to [1] erased texts, [2] erased images, [3] erased files, [4] erased folders, [5] erased software applications, [6] other erased results which are obtained by running a lock (or intermediate) operation with a lock (or intermediate) system in a lock (or intermediate) mode, and which reside (or have been residing) in a lock (or intermediate) system, or the like.

It is appreciated that, when this disclosure includes a clause “prevent a main system from the erased results,” it does not connote that a terminal protects a main system from the results after having erased such results. Rather, it means that the terminal protects a main system by erasing such results and that a terminal may not have been able to protect a main system from such results unless a terminal has erased such erased results. By the same token, “to-be-erased result(s)” are synonymous with the “erased results,” except that the former is used to refer to those result(s) which may be currently mixed with “to-be-stored result(s)” or “to-not-be erased result(s)” but which are to be erased later.

As used herein, “stored results” refers to those results which are not erased by a terminal but stored therein, e.g., in a lock, intermediate or main system. Thus, the “stored results” corresponds to a difference between all of such results obtained by running lock (or intermediate) operations in a lock (or intermediate) mode and the erased results, where such stored results may be stored permanently or temporarily. By the same token, “to-be-stored results” are synonymous with the “stored results,” except that the former is used to refer to those results which are currently mixed with “to-be-erased results” but which are to be stored later, either actively in response to a user input or passively without any user input.

Instead of such erasure or semi-erasure, a terminal may “format” or “reformat” a certain hardware element or may even “initialize” such an element. A terminal may run the formatting or initialization operations in certain cases such as, e.g., [1] when a certain period has passed since the last formatting or initialization, [2] when a terminal may detect, in its memory unit or its temporary memory sector, suspicious data, computer codes, or files which may include such malicious viruses, [3] when a terminal may detect a malfunctioning hardware or software element which may be caused by such viruses, or the like.

Because such formatting or initialization may be viewed as special cases of such erasure (or semi-erasure), a terminal may also run such formatting or initialization operations in one of various erasure timings which will be described below. In addition, similar to the erasure and semi-erasure, a terminal may [1] “completely” format or initialize a certain hardware element or [2] “partly” format or initialize such an element.

As a terminal formats or initializes a certain hardware element, all software elements which had been loaded onto the element may also be removed. Therefore, upon formatting or initializing a lock system, a terminal may manipulate which data or computer codes in a lock system are to be removed.

In one case, a terminal may remove only those data which have been stored or residing in a lock memory unit or a temporary lock memory sector by a partial formatting or partial initialization, while excluding a lock O/S or lock (software) applications from such removal. To this end, a terminal may [1] store a lock O/S, a lock software application (or “app”), or others in safe space such as, e.g., a lock BIOS (i.e., a basic input output system) or another memory space which is to be excluded from such partial formatting or partial initialization, [2] designate certain memory sectors which are to be formatted or initialized by a terminal, while excluding other sectors from such partial formatting or partial initialization.

Because a lock system still includes a viable lock O/S or a lock software application therein, the terminal may be able to operate in a lock mode immediately after such partial formatting or partial initialization. It is appreciated that a terminal may also remove a lock O/S or a lock software app when the terminal detects the malicious viruses in such O/S or app.

In another case, a terminal may remove all data or computer codes which have been stored or residing in a lock memory unit or a temporary lock memory sector by a (complete) formatting or a (complete) initialization. Thus, a terminal even removes a lock O/S and lock (software) apps such as, e.g., a lock viewer. Because a lock system does not include a viable lock O/S or lock software applications therein, the terminal may not operate anymore in a lock mode, immediately after such (complete) formatting or (complete) initialization. As a result, a terminal may have to reload a lock O/S or a necessary lock (software) application into a lock system.

In another case, when a lock system does not include a lock O/S but does include a lock app, a lock system may not drive the lock app by itself, and may have to rely on a main CPU unit (or main O/S) to drive the lock app.

When a terminal partly formats or partly initializes a lock system, a main system may then drive the lock app immediately after such formatting or initialization with its main CPU unit (or main O/S). However, when a terminal completely formats or initializes a lock system, a main system may have to reload the lock app onto a lock system, and may help a lock system run lock operations. When a lock system includes a lock app as well as a driver capable of driving the lock app, this case is similar to the above lock system with a lock CPU unit and, therefore, further details are omitted herein.

The terminal may “reload” (or load) a lock software application (to be abbreviated as a “lock app” hereinafter) or a lock O/S in several different modes after removing a lock app or a lock O/S by initialization, formatting or other removing methods such as deleting or erasing, where the lock app or lock O/S which is to be removed from a lock system is such an app or O/S [1] which is detected to be actually contaminated by the malicious viruses or [2] which may be suspected to be contaminated by such viruses.

Because the lock app or the lock O/S can be removed or reloaded (or loaded) by the same or similar manner, following exemplary modes preferentially refer to reloading (or loading) of a lock app only, while reloading (or loading) of a lock O/S may be accomplished by the same or similar manner. Therefore, details of reloading (or loading) the lock O/S are omitted,

In the first mode, the terminal may reload (or load) an entire portion of a certain main app ioto a lock system and use the reloaded (or loaded) app as a “reloaded lock app” of a lock system.

In a 1^{st} example of the first mode, a terminal may reload (or load) a certain main app onto a lock system and use the reloaded (or loaded) app as a “reloaded lock app” of a lock system. Thus, a reloaded (or loaded) lock app of a lock system may be identical to a main app of a main system such that a number of operations (or functions) which can be run (or performed) by a reloaded (or loaded) lock app is identical to a number of operations (or functions) which can be run (or performed) by a main app. Thus, when a terminal includes a single lock system and a single main system, the terminal after such reloading (or loading) may include two identical apps one of which is the lock app, while the other is the main app.

In a 2^{nd} example of the first mode, a terminal may similarly reload (or load) a certain main app onto a lock system and use the reloaded (or loaded) app as a “reloaded lock app” of a lock system, while restricting a number of operations (or functions) which can be run (or performed) by a “reloaded lock app” to be less than a number of operations (or functions) which can be run (or performed) by a main app.

A terminal can embody this arrangement by providing restricted options to a reloaded (or loaded) lock app, while not restricting any option of a main app. Therefore, when a terminal includes a single lock system and a single main system, the terminal may include a lock app A_{L} and a main app A_{M}, where A_{L} can be regarded as a subset of A_{M} in a qualitative sense.

In the second mode, a terminal may reload (or load) at least a portion but not an entire portion of a certain main app onto a lock system, and then use the reloaded (or loaded) app as a “reloaded lock app” of a lock system. Therefore, a number of operations (or functions) which can be run (or performed) by a reloaded (or loaded) lock app may be less than a number of operations (or functions) which can be run (or performed) by a main app. This case is similar to the 2^{nd} example of the first mode and, thus, further details are omitted herein.

In the third mode, a terminal may include a reference app (or O/S) which may be stored in a certain location of a terminal, but where [1] the certain location is inside the terminal but not inside a main system or [2] the reference lap may not be the main app (or main O/S) operated by a main system. Examples of such certain locations include [1] a BIOS, [2[a main memory unit, [3] a main memory sector, or the like.

The terminal may reload (or load) at least a portion of the certain app (or O/S) onto a lock system, and then use the reloaded (or loaded) app (or O/S) as a “reloaded lock app (or reloaded lock O/S)” of a lock system. In this mode, a number of operations (or functions) which can be run (or performed) by a reloaded (or loaded) lock app (or lock O/S) may be equal to or less than a number of operations (or functions) which can be run (or performed) by the reference app (or O/S) stored in a lock mode, an unlock mode or another mode.

In an example where a terminal may include a single lock system (which includes a lock app A_{L}) and a single main system (which includes a main app A_{M}), an app A may be stored in one of the certain locations of the main system as exemplified in the preceding paragraph.

In a 1^{st} example of the third mode, a lock app A_{L} and a main app A_{M} may be identical to each other when [1] the same (i.e., either an entire portion of the or only a portion of the) app A is downloaded to a lock system and to a main system and the reloaded (or loaded) apps may serve respectively as A_{L} and A_{M}, [2] an entire portion of A_{M} is downloaded into a lock system without restricting any option and the reloaded (or loaded) app serves as A_{M}, or the like.

In a 2^{nd} example of the third mode, a lock app A_{L} may be regarded as a subset of a main app A_{M} when [1] an entire portion of an app A is downloaded to a main system and the reloaded (or loaded) app serves as A_{M}, whereas only a portion of the app A is downloaded to a lock system and the reloaded (or loaded) app serves A_{L}, [2] an entire portion of an app A is downloaded to a main system and a lock system and the reloaded (or loaded) apps respectively serve as A_{M} and A_{L}, where options of the lock app A_{L} are restricted, or [3] only a portion of a main app A_{M} is downloaded to a lock system and the reloaded (or loaded) app serves A_{L}.

In a 3^{rd} example of the third mode, A_{L} is not a subset of A_{M} but A_{L} may be different from A_{M} when [1] at least a portion of an app A is downloaded into a lock system and the reloaded (or loaded) app serves as A_{L}, where A_{L} can run (or perform) at least one operation (or function) which a main app A_{M} cannot run (or perform), [2] different portions of an app A may be downloaded into a main and lock system and the reloaded (or loaded) apps respectively serve as A_{M} and A_{L}, where A_{L} can run (or perform) at least one operation (or function) which a main app A_{M} cannot run (or perform), or the like.

In the fourth mode, a terminal may load an entire portion or only a portion of an app which is stored not in a terminal but in an external source (such as, e.g., an add-on device, a portable device, another terminal, a website, a cloud, or another host), and then use the reloaded (or loaded) app as a “reloaded lock app” of a lock system. The terminal may access such an app in an external source via an internet or other networks. The terminal may also manipulate the number of operations (or functions) which can be run (or performed) by the reloaded lock app.

When a terminal of this fourth mode includes a single lock system and a single main system, and an app A is stored in the remote location, the terminal may include a lock app A_{L} and a main app A_{M}, where [1] A_{L} and A_{M} may be identical to each other, [2] A_{L} may be regarded as a subset of A_{M}, or [3] A_{L} is not a subset of A_{M} and A_{L} and A_{M} may be different from each other, due to the reasons which are identical or similar to those of the third mode.

A terminal may reload (or load) such an app (or O/S) in various “reloading timings” and use the reloaded (or loaded) app (or O/S) as a lock app (or O/S), where examples of such reloading (or loading) timings may include, e.g., [1] after removing or erasing an old lock app (or O/S) from a lock system, [2] concurrently with removing or erasing an old lock app (or O/S) from a lock system by overwriting the old lock app (or O/S) with a main app, [3] after formatting or initializing a lock system, or the like.

### 1-7. Display Unit and Display Surface

A data processing terminal includes at least one (main) display unit which in turn defines at least one “displace surface” for displaying a “static image (e.g., a picture)” or a “dynamic image (e.g., a video clip)” thereon, where the image may be in black-and-white, in color, or a combination thereof. Therefore, a display unit displays on a display surface static images of, e.g., one or more [1] characters, [2] words, [3] texts, [4] drawings, [5] pictures or [6] other static images of objects or persons. A display unit may also display dynamic images of, e.g., [1] video games, [2] video clips, or [3] dynamic images of characters, words, texts, drawings, cartoons, objects or persons, or the like.

A terminal may store such static or dynamic images therein and display such images one by one, may receive such images from an external source such as, e.g., an add-on device, a portable device, another terminal, a website, a cloud or the like. A terminal may display such images [1] only after acquiring them, [2] concurrently with acquiring them, or the like. It is appreciated that a “display surface” refers to a “portion” of a display unit which is a hardware element of a main, intermediate or lock system of a terminal. Because a user may drive a display unit to display such static or dynamic images, a display unit may be deemed as one of the accessible hardware element of a main, intermediate or lock system as well.

A single display surface may define a single “segment” where the display surface then becomes identical to the display segment. However, when a display surface defines “multiple segments” thereon, a display unit may be able to display different static or dynamic images on different segments concurrently or sequentially.

Similarly, a terminal may include multiple display units, where such display units may have the same shapes, sizes, or functions. Alternatively, such display units may have different shapes, sizes or functions, and may be implemented in different locations of a terminal.

In the latter example of the preceding paragraph, one display unit may be used as a “major display unit” which may be provided on one side of a terminal, while another display unit may serve as a “minor display unit” or a supplemental display unit which may be provided on a different side of the terminal. It then follows that each of multiple display units may include display surfaces of which shapes and sizes may be identical (or similar) to each other or different from each other.

When a terminal is provided as a foldable device which can be folded or opened in a linear or curved path (to be collectively referred to as a “curvilinear path” hereinafter), one display unit may be exposed to a user when the terminal is folded (or unfolded), while another display unit may be exposed to the user when the terminal is unfolded (or folded).

As will be explained below, various notice units of this disclosure may serve as one of multiple display units, where such notice units may have the same, similar or different capability of displaying the static or dynamic images in black-and-white, in color, in a certain resolution, or the like. Because a notice unit serves to provide a visual notice signals to a user, the notice unit may [1] be smaller than a display unit, [2] display simple static or dynamic images than a display unit, or the like. When desirable, a single display unit may use a portion of its display surface as a notice unit as well.

When a terminal includes multiple display units, the terminal may drive each of such multiple display units [1] concurrently, [2] sequentially, [3] temporarily independent of each other, [4] according to an order in which a user provides user inputs, or the like.

For example, a terminal may [1] turn on a 1^{st} display unit whenever a 2^{nd} display unit is turned on, [2] turn off a 1^{st} display unit whenever a 2^{nd} display unit is turned on, [3] turn on or off at least two display units in a certain sequence, [4] turn on or off each display unit independently, [5] turn on (or turn off) a certain display unit when a terminal receives a certain user input, [6] turn on (or off) a certain display unit when a terminal receives a user input through a certain input unit, or the like. As will be explained in the following Section, a terminal may recruit a display unit to constantly display routine data such as, e.g., a time, date, or the like. A terminal may recruit [1] the same software elements to drive each of multiple display units, or [2] different software elements to drive each of such display units.

In contrary to such examples where a terminal includes at least one display unit, a terminal may not include any display units therein. Such a terminal may instead be configured to be releasably coupled to an external display device which is a separate device from the terminal.

With this arrangement, a terminal of this disclosure may be provided in a more compact shape or size. Of course, a terminal which includes at least one display unit may also be configured to operationally couple with an external display device to supplement a display unit of a main system of a terminal.

### 1-8. Screen

As used herein, a “screen” refers to an image which a terminal displays on a “display surface” of a display unit. The screen may [1] be in a black-and-white mode or in a color mode, [2] be in a 2-D mode or a 3-D mode, or [3] provide a 2-D image, a 3-D image, a hologram image, or the like. It is appreciated that the screen may be static (i.e., not changing over time) or dynamic (i.e., changing over time). In this context, a screen may include a single “window” or multiple windows in each of which a user may run different (software) elements or app of a main, intermediate or lock system of a terminal.

When or after a display unit is turned on (i.e., a terminal is in its on-state), a screen is displayed on a display surface of a display unit, and a user may be able to see the screen.

Accordingly, a screen may be an image of whatever is displayed on the display surface, and such a screen may include [1] one or more static images of characters, words, texts, drawings, pictures or static images of objects or persons, [2] dynamic images of a video game, or [3] dynamic images such as, e.g., video clips or other dynamic images of objects or persons.

The screen may include at least one advertisement, a content, a warning, an instruction, or other images. A screen may also include an “unlock (or home) screen” which is displayed in an unlock mode, a “lock screen” which is displayed in a lock mode, and an “intermediate screen” which is displayed in an intermediate mode.

As used herein, a display unit which displays only images related to “routine data” is deemed to be “turned off” and to be in an “off-state” within the scope of this disclosure. By the same token, when a terminal includes a major display unit and a minor display unit and when the major display unit is turned off but the minor display unit displays only routine data, such display units are deemed to be turned off, and to be in its off-state within the scope of this disclosure. In addition, when a terminal incorporates a single display unit which includes a major section and a minor section therein, a display unit is deemed to be turned off when a major section is turned off but a minor section displays only routine data.

In general, the routine data refer to those obtainable without running an operation in response to a user input. Such routine data may typically relate to various information about a date, a time, a clock, a stopwatch, a battery charge, a temperature, a weather, a wireless connection, an armed alarm, an arrival of a new email or message, an incoming call, a notice of an upcoming event, or the like. In addition, when a terminal may display routine data or other information on a display unit while keeping “at least 80% of the pixels” of such a display unit turned off, this display unit may be deemed to be turned off and to be in an off-state within the scope of this disclosure.

### 1-9. Concurrent and Sequential

As used herein, “concurrence” is synonymous with “simultaneity,” and refers to an occurrence, a happening, or an existence of multiple operations (or steps) at the same time.

Similarly, “concurrent” or “concurrently” is synonymous with “simultaneous” or “simultaneously.” Thus, a user is deemed to provide multiple user inputs concurrently when such user inputs are provided to one or more input units at the same time.

Accordingly, when a user provides multiple user inputs concurrently, the user is deemed to provide the user inputs in such a way that there exists at least one common clock cycle of a processor of the terminal in which the user provides such multiple user inputs. That is, such multiple user inputs overlap each other in at least one common clock cycle, and such multiple user inputs are not completely separated by any temporal gap therebetween.

Similarly, a terminal is deemed to run multiple operations (or their steps) concurrently, when the operations (or steps) are run at the same time. Accordingly, when a terminal runs multiple operations (or steps) concurrently, the terminal is deemed to run such operations (or steps) in such a way that there exists at least one common clock cycle of a processor of a terminal in which the terminal runs both of such operations (or steps). That is, such multiple operations (or steps) overlap each other in at least one common clock cycle, and such multiple operations (or steps) are not completely separated by any temporal gap therebetween.

Other details of “1-9. Concurrent and Sequential” are identical to the following portions of the '861 application such as, e.g., FIG. 3, and the text from [0192] on page 17 through [0197] on page 17, where these portions are to be incorporated herein in their entirety by reference.

### 1-10. User Input

As used herein, a “user input” refers to an input which is provided to at least one input unit of a terminal by a user who directly or indirectly manipulates at least one portion of the input unit. A user may provide the user input with his or her body part(s) or with a non-user object such as a stylus, a pen, or the like. For simplicity of illustration, when “a user provides” a user input to at least one input unit of a terminal, it collectively refers that a user may [1] use “at least one body part of the user,” [2] use “at least one non-user object which an input unit” can recognize, [3] allow a terminal to obtain biometric information of a user, [4] allow a terminal to obtain electromagnetic waves or acoustic waves related to user, or the like.

In one example, a user may “directly manipulate” at least a portion of an input unit of a data processing terminal. In one case, a user may directly provide a user input by “moving” at least one movable portion of the input unit or by “touching or contacting” at least a portion of the input unit [1] with a user body part, [2] a non-user object, or the like.

In the case of such moving, a user may move the movable portion for a preset period (of time) or for another period of his choice. In the case of such contacting, a user may [1] maintain a contact between the portion of the input unit and a user body part (or a non-user object) for a preset period of time, or [2] maintain a contact while moving the body part or non-user object and, therefore, changing a position of such a contact.

In another example, a user may “indirectly provide” a user input by “providing waves” to an input unit of a data processing terminal, without having to directly manipulate a portion of the input unit. In one case, a user may emit to the input unit [1] electromagnetic waves which carry information related to a user input such as, e.g., an image of a user, wave characteristics (e.g., amplitudes, frequencies, phase angles, or phase lags) or other information, or [2] acoustic waves which carry information related to a user input such as, e.g., a user voice, a sound generated by a user body part, or the like. Therefore, when an input unit acquires an image of a user for authenticating a face, an iris, or a retina, such an image is deemed as a user input. Similarly, when an input unit acquires a voice of a user for voice authentication, the voice is deemed as a user input.

As used herein, a “user input” includes “at least one (user) sub-input” therein. When a user supplies a user input to an input unit, an input unit may “receive” a user input, and a sensor of the input unit may “acquire” a (user) sub-input from a user input. Therefore, when a user input includes only one (user) sub-input therein, the user input corresponds to the (user) sub-input.

Conversely, when a user input includes therein multiple (user) sub-inputs, a single input unit or multiple input units receive the user input, while a single sensor or multiple sensors (of a single or multiple input units) acquire the (user) sub-inputs therefrom. For simplicity of illustration, a “user input” and a “(user) sub-input” are collectively referred to as the user input throughout this disclosure, unless otherwise specified. In addition, a “(user) sub-input” may be abbreviated as a “sub-input.”

Depending on configurational and operational characteristics of an input unit, a user may provide various types of user inputs. A user may provide some of such user inputs by his or her direct manipulation of the input unit, whereas a user may provide others of such user inputs not by such direct manipulation of the input unit but by indirectly providing various user inputs to the input unit.

It is appreciated that a data processing terminal of this disclosure may have a configuration which may allow a user to [1] fold or unfold at least a portion (i.e., a foldable portion) of itself (or its display unit) within a preset range of angles about a folding axis (to be referred to as a “foldable configuration”), [2] unroll or roll at least a portion (i.e., a rollable portion) of a display surface of a display unit up to a preset length, width or distance along an unrolling or rolling axis (to be referred to as a “rollable configuration”) in an unrolling or rolling direction, or [3] a combination of [1] and [2] of this paragraph.

As will be described below, a terminal with the foldable configuration (i.e., a foldable terminal) may include a display unit (to be referred to as a “target display unit”) which can be folded and unfolded respectively between its “folded state” and its “unfolded state.”

Thus, when the terminal is in the folded state, a user [1] cannot see an entire portion (or at least a majority) of a display surface of the target display unit, [2] cannot manipulate the target display unit, or the like. When the terminal is in the unfolded state, a user [1] can see an entire portion (or at least a majority) of a display surface of the target display unit, [2] can manipulate the target display unit, or the like. A foldable terminal may include a target display unit and a non-target display unit, where the target display unit may have a lengths or a height which may vary between the closed state and open state and which may be different from that of the non-target display unit.

A terminal with the rollable configuration (i.e., a rollable terminal) may also include the “target display unit” which can be rolled and unrolled respectively between a “rolled state” and an “unrolled state.”

Thus, when the terminal is in the rolled state, a user [1] cannot see an entire portion of a display surface of the target display unit, [2] cannot manipulate the target display unit, or the like. When the terminal is in the unrolled state, the user [1] can see an entire portion of a display surface of the target display unit, [2] can manipulate the target display unit, or the like.

A rollable terminal may include a target display unit and a non-target display unit, where the target display unit may have a length or a height which may vary between the rolled state and unrolled state, and which may be different from that of the non-target display unit.

For simplicity of illustration, the foldable configuration and rollable configuration are collectively referred to as an “adjustable configuration” hereinafter. In addition, the folded state of a foldable terminal and the rolled state of a rollable terminal are to be collectively as a “closed state,” whereas the unfolded state of a foldable terminal and the unrolled state of a rollable terminal are to be collectively as a “open state” hereinafter. In addition, the foldable portion of a foldable terminal and the rollable portion of a rollable terminal are to be collectively as an “adjustable portion” hereinafter.

A user input of this disclosure may be classified based upon its type or nature. A “1^{st} type user input” relates to a “mechanical user input” which is provided to at least a portion of an input unit by directly manipulating the portion. Examples of the 1^{st} type user input may include, but not limited to, [1] “moving” (e.g., [1-1] pressing, pushing or pulling with or without a resulting displacement, [1-2] translating or sliding, [1-3] rotating or pivoting, or [1-4] otherwise varying a position or orientation of) at least a portion of the input unit, or [2]“touching (or contacting)” at least a portion of the input unit with or without a resulting displacement, or [3] a combination of the above [1] and [2].

Examples of the 1^{st} type user input may include “mechanical biometric information” of a user, where examples of such 1^{st} type user input may include, but not limited to, [1] a blood pressure or a heart rate which is measured in a certain position of the user, [2] a blood flow rate measured in that position, [3] other information related to cardiovascular function, [4] a breathing rate in rest or during exercise, [5] a respiratory air flow rate, [6] other information as to respiratory function, or [7] other biometric information related to skeletal or muscular body parts. As defined above, such mechanical user inputs include therein at least one mechanical (user) sub-input.

The 1^{st} type user input further relates to a “static feature” or a “dynamic feature” of the mechanical user input. Examples of this 1^{st} type user input may include, but not limited to, [1] a force associated with a movement or a contact of at least a portion of an input unit (a scalar or a vector), [2] a velocity of the movement (a scalar or a vector), [3] an acceleration of such a movement (a scalar or a vector), [4] a displacement of the portion due to the movement (a scalar or a vector), [5] a direction of the force, velocity, acceleration or movement, [6] a direction of the contact, [7] a duration of the above [1] to [6], [8] a number of applications of the above [1] to [6], [9] a temporal overlap or gap between such forces, velocities, accelerations, displacements, directions, or the like.

Examples of this 1^{st} type user input may also include a “mechanical property” of [1] a user body part or [2] a non-user object which is used to provide the 1^{st} type user input to the portion of the input unit, where examples of such 1^{st} type user input may also include various mechanical properties such as, e.g., [1] an elasticity, [2] a roughness, [3] various moduli, or the like. An amplitude or a frequency of a force exerted onto a sensor of an input unit is an example of this 1^{st} type user input.

In the adjustable configuration, the 1^{st} type user input may also include, but not limited to, [1] folding or unfolding a foldable portion of a terminal, [2] rolling or unrolling a rollable portion, [3] moving or touching a hard button or a soft button which may initiate such folding, unfolding, rolling or unrolling, [4] static or dynamic features as to such folding, unfolding, rolling or unrolling, or the like.

A “2^{nd} type user input” relates to an “electrical user input” which is an “electrical signal” provided to at least a portion of an input unit capable of receiving the 2^{nd} type user input and acquiring an electrical (user) sub-input therefrom. For example, a user may use [1] a certain pen, a wearable device, or a portable devices to generate and to provide a certain direct current (DC) or alternating current (AC) electrical signal to the input unit, or [2] another terminal to generate and to provide the electrical signal. A user may also provide “electrical biometric information” of his body part as the 2^{nd} type user input, where examples of such user inputs may include, e.g., [1] an electrocardiogram (ECG), [2] an electromyogram (EMG), [3] an electroencephalogram (EEG), or [4] any other electrical signals measured in a certain position of the body.

The 2^{nd} type user input may further relate to a “static feature” or a “dynamic feature” of the electrical user input. Examples of this 2^{nd} type user input may include, but not limited to, [1] an electrical current or voltage, [2] its magnitude, [3] its phase angle, [4] its phase lag, [5] its frequency, [6] its wave-length, or [7] its flux (a scalar or a vector).

The 2^{nd} type user input may also include an “electrical property” of a user body part or a non-user object which is used to provide the 2^{nd} type user input to a proper portion of the input unit, where examples of the 2^{nd} type user input may include various electrical properties such as, e.g., [1] resistivity of the body part or object, [2] its conductivity, [3] its capacitance, [4] its permittivity, [5] its dielectric property, [6] its thermoelectricity, or the like, where such properties may be measured in a constant electric field or magnetic field or where such properties or their changes may be measured in a varying electric or magnetic field. A fingerprint of a user that is monitored by a capacitive sensor of a capacitive input unit is an example of this 2^{nd} type user input.

A “3^{rd} type user input” relates to a “magnetic user input” which is a “magnetic signal” provided to at least a portion of an input unit capable of receiving the 3^{rd} type user input and acquiring a magnetic (user) sub-input therefrom. For example, a user may use a certain pen, a wearable device as explained above, or other portable devices to generate and provide a certain direct current (DC) or alternating current (AC) magnetic signal to the input unit, may use another terminal for generating and providing the magnetic signal, or the like. A user may also provide various “magnetic biometric information” of his or her body part as the 3^{rd} type user input, where the 3^{rd} type user inputs may similarly include, e.g., a magnetocardiogram (MCG), a magnetomyogram (MMG), a magnetoencephalogram (MEG), or any other magnetic signals measured in a certain position of the body.

The 3^{rd} type user input may also relate to a “static feature” or a “dynamic feature” of the magnetic user input. Examples of this 3^{rd} type user input may include a magnitude of its magnetic B-field or H-field, its direction, a number of magnetic poles therein, its phase angle or phase lag, its frequency, its wave-length, its flux (a scalar or a vector), or the like. The 3^{rd} type user input may also include a “magnetic property” of a user body part or a non-user object which is employed to provide the 3^{rd} type magnetic user input to the portion of the input unit, where the 3^{rd} type user input may include various magnetic properties such as, e.g., a magnetic polarity, a magnetic permeability, a magnetic susceptibility, or the like, where such properties may be measured in a constant electric or magnetic field or where such properties or changes in such properties may be measured in a varying electric or magnetic field.

A “4^{th} type user input” relates to an “electromagnetic user input” which is “electromagnetic waves” emitted to at least a portion of an input unit capable of receiving the 4^{th} type user input and acquiring an electromagnetic (user) sub-input included therein. For example, a user may use a certain pen, a wearable device (e.g., a watch, a ring, a necklace, a bracelet, a lens, or glasses), or other portable devices to emit such electromagnetic waves to the input unit, may use another data processing terminal to emit such waves, or the like. In addition, the user may provide an “image of a body part” such as a face, an iris, a retina or another body part, or an “image of a non-user object” to the input unit, where such images may be provided to the input unit in a range of the visible electromagnetic waves, UV rays, IR rays, or other electromagnetic waves of specific frequency ranges. It is appreciated that the 4^{th} type user input provided as such images may include still images, video clips, or a combination thereof, and that the 4^{th} type user input may correspond to as an “optical user input” as well, particularly when such 4^{th} type user inputs employ visible light rays.

The 4^{th} type user input may also relate to a “static feature” or a “dynamic feature” of the electromagnetic user input. Examples of this 4^{th} type user input may include a magnitude of such waves, their phase angle, their phase lag, their wave-length, their frequency, their flux (a scalar or a vector), or the like. When the 4^{th} type user input relates to the above images, examples of this 4^{th} type user input may include a color (e.g., its hue, value, and intensity) of such images, their contrast, their sizes, contents included in such images, arrangement of such images, orientation of such images, or the like. As defined above, this 4^{th} type electromagnetic user input includes therein at least one electromagnetic (user) sub-input.

A “5^{th} type user input” relates to an “acoustic user input” which is “acoustic waves” emitted to at least a portion of an input unit capable of receiving the 5^{th} type user input and acquiring an acoustic (user) sub-input included therein. For example, a user may use a certain pen, a wearable device (e.g., a watch, a band, a ring, a necklace, a bracelet, an earring, a lens, a nail, a glove, a helmet, a hat, a belt, a goggle, glasses, or a shoe), or other devices portably worn by a user and to emit such acoustic waves to the input unit, or may use another data processing terminal to emit such waves. In addition, the user may provide the input unit with his or her “voice” or a “body sound” using his or her body parts such as, e.g., clapping, finger snaps, or the like. The user may also provide a “non-user sound” to the input unit, where such sounds may be provided to the input unit in a range of audible sound waves, ultrasonic waves or other acoustic waves of specific frequency ranges.

The 5^{th} type user input may also relate to a “static feature” or a “dynamic feature” of the acoustic user input. Examples of this 5^{th} type user input may include a magnitude of such waves, their phase angle, their phase lag, their wave-length, their frequency, their flux (a scalar or a vector), or the like. When the 5^{th} type user input relates to the above voice or body sound, examples of this 5^{th} type user input may include a duration, a tone, an envelope, a location of a source thereof, or the like. As defined above, this 5^{th} type acoustic user input includes therein at least one acoustic (user) sub-input.

In addition to the above, the user input may also include temporal changes of any the above user inputs such as, e.g., a change in a movement pattern over time, a temporal change in an intensity of force exerted to the input unit over time, or the like. The user input may further include spatial changes of the above user inputs such as, e.g., a change in positions of contact between the user's body part and an input unit, a change in distribution of force applied to a certain area of an input unit, or the like.

### 1-11. Single User Input

Like the definition of “concurrent” provided in Section 1-9, a “single concurrent effort” is [1] synonymous with a “single simultaneous effort” and [2] abbreviated as a “single effort,” unless otherwise specified. Accordingly, a “single effort” or a “single concurrent effort” includes [1] one effort exercised by a user, or [2] multiple (identical or different) efforts exercised by a user at the same time. That is, for multiple efforts to be concurrent, there exists at least one common clock cycle of a processor of a terminal in which a user exercises such multiple efforts and, therefore, such multiple efforts overlap each other in at least one common clock cycle. When a user exercises more than two efforts, concurrency of such efforts may be determined based on the definition of concurrency as provided in Section 1-9, and as exemplified in FIG. 3.

Unless otherwise specified, a “user input” is synonymous with a “single user input” throughout this disclosure. Accordingly, a “user input” or a “single user input” means an input which a user provides to at least a portion of at least one input unit of a data processing terminal, when a user provides at least one of the 1^{st}, 2^{nd} 3rd 4^{th} and 5^{th} type user inputs to the portion of the input unit by exercising a “single effort” through the direct manipulation, indirect manipulation or other manipulations of at least a portion of the input unit as explained in Section 1-10. That is, when a user provides multiple user inputs concurrently by exercising a single effort, such user inputs are deemed as a single user input. In contrary, when a user exercises multiple efforts to provide multiple user inputs not concurrently (i.e., sequentially), such user inputs do not qualify as a single user input.

Therefore, a single 1^{st} type user input and a single 3^{rd} user input qualifies as a (single) user input provided to an input unit by a (single) concurrent effort by a user. In addition, two 1^{st} type user inputs qualify as a (single) user input when a user provides both user inputs by a (single) concurrent effort, three 5^{th} type user inputs qualify as a (single) user input when a user provides such three user inputs by a (single) concurrent effort, and one 1^{st} type user input and three 4^{th} type user inputs can also qualify as a (single) user input as far as a user provides such four user inputs by a (single) concurrent effort.

Put in different contexts, a user may press a 1^{st} input unit with his finger and move his finger over the 1^{st} input unit. If the user moves his finger while maintaining such pressing (e.g., without detaching the finger from the input unit), such pressing and moving qualify as a single (concurrent) effort by the user, for the user exercises such pressing and moving over at least one common clock cycle of a processor of a terminal. However, when there exists a temporal gap between such pressing and moving (e.g., pressing, detaching, and then moving), such pressing and moving may not quality as the single (concurrent) effort, unless the temporal gap is less than 0.5, 0.3, 0.1, or 0.05 second, which will be explained in greater below in conjunction with a definition of “multiple quick efforts” which is to be provided in Section 1-12.

In another example, a user may touch a 2^{nd} input unit and provide an image of his face to a 3^{rd} input unit (e.g., by staring at a camera). When the user provides the image while maintaining the touching, such touching and providing qualify as a single (concurrent) effort as far as there exists at least one common clock cycle in which the user exercises such touching and providing at the same time. In other words, such touching and providing are a single concurrent effort, for there is no temporal gap between such touching and providing.

In another example, a user may press a 1^{st} input unit with a 1^{st} finger and touch a 4^{th} input unit with a 2^{nd} finger. Such pressing and touching can also qualify as a single (concurrent) effort by the user, as far as there exists at least one common clock cycle in which the user performs such pressing and touching, or as far as there is no temporal gap between such pressing and touching.

Other details of “1-11. Single User Input” are identical to the following portions of the '861 Application such as, e.g., FIG. 4, and the text from [0223] on page 20 through [0229] on page 21, where these portions are to be incorporated herein in their entirety by reference.

### 1-12. Multiple Quick Efforts

As defined in Section 1-11, a “user input” or a “single user input” means an input which a user provides to at least one input unit of a terminal by exercising a “single effort.” However, a user may repeat an identical “quick effort” more than once to provide a certain user input, where examples of such repeated efforts may include quick double clicks, double taps, triple clicks, triple taps, or the like. By definition, such multiple clicks or taps are separated from each other by temporal gaps and, therefore, such quick clicks or quick taps may not qualify as a single user input.

In reality, however, a user may repeat such multiple quick clicks (or taps) to provide a terminal with a single preset user input, and a terminal may recognize such “multiple quick efforts” as a single preset user input such that, e.g., a terminal runs a 1^{st} operation upon receiving a user input such as a single tap, but runs a 2^{nd} operation upon receiving a different user input such as double taps. In such cases, the “multiple quick efforts” are deemed to qualify as a “user input” or a “single user input” when a user repeats such efforts quickly, within a certain period of time such as 1.0, 0.5, or 0.3 second. In addition, when a terminal may recognize a single user input when a user repeats such multiple efforts within 1.5, 2.0, 3.0 seconds, such multiple quick efforts are also deemed as a user input or a single user input, depending upon a control setting.

In contrary to such multiple quick clicks or taps which are repetitions of the same effort, multiple quick efforts may include different efforts exercised by a user, usually by using different body parts, by using different non-user objects, by applying different user inputs concurrently or sequentially to different input units, or the like. For example, a user may manipulate a portion of a 1^{st} input unit once (e.g., a button), while speaking to a 2^{nd} input unit (e.g., a microphone) concurrently. Such touching and speaking can qualify as a single user input, as far as the touching and speaking overlap in at least one common clock cycle.

Even when a user touches the portion of the 1^{st} input unit and then speaks to the 2^{nd} input unit after a certain period (i.e., not any common clock cycle but a temporal gap), such touching and speaking can also qualify as a single user input when the terminal recognizes such touching and speaking as a single user input or when the gap is less than 1.0, 0.7, 0.5, or 0.3 second.

In another example, a user may press a portion of a 3^{rd} input unit (e.g., a touchscreen) once with a finger or stylus, while staring at a 4^{th} input unit (e.g., a camera) concurrently. Such pressing and staring can qualify as a single user input as well. Even when a user presses the portion of the 3^{rd} input unit and then stares at the 4^{th} input unit after a certain period (i.e., a temporal gap), such pressing and staring may still qualify as a single user input when the terminal recognizes such pressing and staring as a single user input or when the gap is less than 1.0, 0.7, 0.5, or 0.3 second.

In yet another example, a user may exercise multiple efforts by repeating the same effort, while manipulating a static or dynamic feature of such efforts. Examples of such features may include, but not limited to, a length of the efforts, an extent (or strength) of the efforts, a direction thereof, a temporal gap between two sequential efforts, a temporal overlap along two successive efforts, a number of the efforts, a sequence of the efforts, or the like.

Therefore, while pressing a portion of an input unit, a user may press such a portion harder, may shift a direction of pressing, may repeat pressing without detaching a finger therefrom, or the like, thereby providing different and unique quick actions which a terminal may recognize as a different and unique single user input.

### 1-13. (User) Sub-Inputs

As used herein, a “(user) sub-input” or simply a “sub-input” is an element of a user input which causes an input unit to generate a “control signal.” Therefore, a “(user) sub-input” or a “sub-input” is defined as a basic element of a user input. To acquire such (user) sub-inputs, an input unit includes at least one sensing element (i.e., a sensor), where configurational or operational characteristics of such a sensor may depend upon a nature of a (user) sub-input to monitor. Accordingly, when a 1^{st} input unit is to receive a mechanical, 1^{st} type user input, the 1^{st} input unit may preferably include a mechanical sensor capable of acquiring a mechanical (user) sub-input included in the user input. Alternatively, when a 2^{nd} input unit is to receive acoustic, 5^{th} type user input, the 2^{nd} input unit may preferably include an acoustic sensor capable of acquiring an acoustic (user) sub-input included in the user input. A user input of this disclosure may include therein at least one of multiple (user) sub-inputs such as [1] a mode-switching (user) sub-input (UI_{SWI}), [2] an activation (user) sub-input (UI_{ACT}), [3] an authentication (user) sub-input (UI_{THEN}), or [4] an auxiliary (user) sub-input (UI_{Aux}). In this context, when an input unit “receives a user input,” it is presumed that a proper sensor (or a sensing element) of the input unit “acquires at least one (user) sub-input” from the user input.

More particularly, when a user provides a user input to advance to one mode from an off-state of a terminal or to switch from a current mode to a new mode, it is deemed that the user input includes UI_{SWI} and may optionally include at least one of other (user) sub-inputs such as UI_{ACT}, UI_{THEN}, and UI_{AUX}. Therefore, upon receiving a user input including UI_{SWI}, a terminal acquires UI_{SWI} therefrom, and runs a mode-switching operation in order to switch to at least one mode which is selected from a set of multiple modes (of operation) which are included in a certain hierarchy and each of which is actually defined by a terminal. As will be described below, however, a terminal may switch modes in response to a user input which does not include any UI_{SWI} as well, e.g., when such mode switching is conditioned upon other operations such as, an authentication operation, an activation operation, or the like.

It is appreciated that a user may preferably include a certain number of (user) sub-inputs in a single user input. In response to receiving such a user input or in response to acquiring such (user) sub-inputs, a terminal may run various operations. Therefore, a 1^{st} number of such (user) sub-inputs included in the user input is typically equal to a 2^{nd} number of operations which are to be run by a terminal in response to the user input.

It is appreciated, however, that the above 1^{st} number may not necessarily be the same as the above 2^{nd} number in some cases. In one case, a terminal may automatically run (or start to run) an authentication operation upon (or in response to) acquiring UI_{SWI}. In another case, a terminal may turn on (or start to turn on) a display unit in response (or upon) acquiring UI_{SWI}. In such cases, the 1^{st} number is less than the 2^{nd} number.

To the contrary, the 1^{st} number may be greater than the 2^{nd} number. In one case, a terminal may acquire UI_{ACT}, UI_{THEN}, and UI_{SWI} from a single user input, and then may turn on a display unit and switch to a certain mode only when a user passes the user authenticating. When a user fails the user authenticating, a terminal may stay in an off-state or in a current mode, without running any other operation. In this case, a terminal ends up running only one operation, despite acquiring three (user) sub-inputs.

It then follows that the above 1^{st} number may be equal to, greater than or less than the above 2^{nd} number. In addition, it then also follows that, even when the 1^{st} number is equal to the 2^{nd} number, the operations run by a terminal may not correspond to each of such (user) sub-inputs provided to a single or multiple input units.

### 1-13-1. Activation (User) Sub-Input (UI_{ACT})

A 1^{st} of various exemplary (user) sub-inputs is an “activation (user) sub-input (UI_{ACT})” which may be referred to as an “activation sub-input (UI_{ACT})” or simply UI_{ACT}, all of which “activate” a terminal by causing the terminal to run an activation (or turning-on) operation and by causing the terminal to turn on its display unit in response to (receiving) the user input or to (acquiring) UI_{ACT}. For simplicity of illustration, an input unit for receiving UI_{SWI} is to be referred to as an “activation input unit” hereinafter, while a sensor of the activation input unit is to be referred to as an “activation sensor” hereinafter.

When a terminal includes multiple display units, UI_{ACT} may cause a terminal to turn on at least one or all display units. Because a terminal executes (or starts to execute) at least one unexecuted (or remaining) step of an operation of turning on a display unit once acquiring UI_{ACT}, the terminal (more particularly, its CPU unit, its O/S, or its software application) may neither run an activation operation nor turn on a display unit without UI_{ACT}.

An activation input unit may use any conventional activation sensor which can generate a control signal which in turn can be recognized by a terminal as UI_{ACT} and which can cause a terminal to run an activation operation. Accordingly, the activation input unit may operate mechanically, electrically, optically or magnetically, while generating a mechanical, electrical, optical or magnetic control signal with its activation sensor in response to a user input including UI_{ACT}. It is appreciated that a terminal does not always require UI_{ACT} to run an activation operation and to turn on a display unit, for an activation operation may be conditioned upon other operations. For example, a terminal may turn on a display unit whenever a user passes user authentication, regardless of whether or not an input unit has received a user input including UI_{ACT}.

A user may provide UI_{ACT} in various timings (i.e., an activation timing or a turning-on timing) such as, e.g., [1] concurrently with acquiring one of UI_{SWI}, UI_{THEN}, and UI_{AUX}, [2] when providing a single user input (e.g., by manipulating [2-1] a single input unit or [2-2] multiple input units concurrently), [3] when providing multiple non-concurrent user inputs (e.g., by sequentially manipulating [3-1] multiple input units or [3-2] different portions of an input unit), or the like. A user may concurrently provide UI_{ACT} along with at least one of UI_{SWI}, UI_{ACT} or UI_{ACT}, e.g., by concurrently manipulating [1] a single input unit, [2] multiple input units, or [3] at least two parts of a single input unit.

### 1-13-2. Authentication (User) Sub-Input (UI_{THEN})

A 2^{nd} exemplary (user) sub-input is an “authentication (user) sub-input (UI_{THEN})” which may be referred to as an “authentication sub-input (UI_{THEN})” or simply UI_{THEN}, all of which “authenticate” a user by causing a terminal to run at least one authentication operation in response to [1] (receiving) a user input or [2] (acquiring) UI_{THEN}. For simplicity of illustration, an input unit for receiving UI_{THEN} is to be referred to as an “authentication input unit” hereinafter, while a sensor of the authentication input unit is to be referred to as an “authentication sensor” hereinafter.

When a terminal includes multiple input units assigned to user authentication, UI_{THEN} may cause a terminal to drive at least one (or all) of such input units. Because the terminal executes (or starts to execute) at least one unexecuted (or remaining) step of an authentication operation once acquiring UI_{THEN}, the terminal (i.e., its CPU unit, O/S, or software application) may not run any authentication operation without UI_{THEN}.

An authentication input unit may employ any conventional authentication sensor which can generate a control signal which in turn can be recognized by a terminal as UI_{THEN} and which can cause a terminal to run at least one authentication operation. Accordingly, the authentication input unit may operate mechanically, electrically, optically or magnetically, while generating various mechanical, electrical, optical or magnetic control signals with its authentication sensor in response to a user input including UI_{THEN}.

It is appreciated that a terminal does not always require UI_{THEN} to run an authentication operation, particularly when an authentication operation is conditioned upon other operations.

For example, even when a terminal does not receive a user input including UI_{THEN} therein, the terminal may run an authentication operation and authenticate a current user, [1]whenever a terminal is to switch modes in response to acquiring UI_{SWI}, [2] whenever a user attempts to switch to a new mode granted with more access authority than a current mode, [3] following a preset execution sequence of an O/S or a software app, or the like.

A terminal may use various user-related or user-irrelevant information as UI_{THEN}. For example, UI_{THEN} may be, may correspond to, or may accompany at least one of following “biometric information” of a user such as, e.g., [1] an image of a body part (e.g., a fingerprint, a hand, a palm, a wrist, an iris, a retina, an eye, an ear, a nose, a face, another body part, blood vessels, a distribution pattern of such vessels, a blood flow rate, a blood flow pattern, or the like), [2] electrical (including resistive, conductive, or capacitive) signals representing or related to biometric information of a user, [3] optical or magnetic signals representing or related to biometric information of a user, [4] a user sound (including a voice, a finger snap, or a clap) or other sounds related to such biometric information, or [5] physiological features (e.g., body temperature, blood pressure, an ECG, a heart rate, other cardiovascular features, a breathing rate, breathing sound, other respiratory features, gastrointestinal features such as a movement of stomach or intestines, an EMG, an EEG, or other skeletal or muscular features). In addition, UI_{THEN} may be, may correspond to, or may accompany at least one of the following “dynamic biometric information” of a user such as, e.g., [1] a displacement or a movement of a body part, [2] a velocity thereof, [3] an acceleration, [4] its position in a 2-D plane or in a 3-D space, [5] a gesture of a body part, or the like.

A terminal may use non-biometric information as UI_{THEN} as well. For example, UI_{THEN} may be, may correspond to, or may accompany information regarding a password or a pass code, a non-user image, a non-user sound, a non-user light, non-user acoustic or electromagnetic waves, or the like. A terminal may also use its own static or dynamic feature as UI_{THEN}. For example, a terminal may monitor a displacement or a movement of its part, its velocity or an acceleration, its position, a number of movements, a sequence of the movements, a duration of the movements, its orientation (e.g., facing up or down, tilted at an angle, or the like), or any other related information, and use such features as UI_{THEN}, and authenticate a user based thereon. As far as there exists mutual agreement between a terminal and a user, any information may be recruited as UI_{THEN}.

A user may provide UI_{THEN} through various manipulations such as, e.g., [1] by manipulating a single portion of an authentication input unit, [2] by manipulating multiple portions of a single authentication input unit, or [3] by manipulating at least two portions of at least two authentication input units, where such manipulating in [2] or [3] may be concurrent, sequential or a combination thereof.

A user may provide UI_{THEN} in one of various authenticating timings such as, e.g., concurrently with [1] providing either UI_{SWI} or UI_{ACT}, [2] providing both of UI_{SWI} and UI_{ACT}, [3] providing all of such UI_{SWI}, UI_{ACT}, and UI_{AUX}, or the like. To this end, a user may [1] include multiple sub-inputs in a single user input and provide that user input to a single input unit, [2] include multiple sub-inputs in multiple user inputs and provide the user inputs to a single input unit either concurrently or sequentially, [3] include multiple sub-inputs in multiple user inputs and provide them to multiple input units either concurrently or sequentially, or the like.

A user may exercise an “active single effort” by performing a voluntary action to provide UI_{THEN} to an input unit, where examples of such voluntary actions may include [1] swiping a finger over an authentication input unit or pressing such an input unit with a finger to provide UI_{THEN} about a fingerprint, [2] staring at a camera to provide UI_{THEN} about an image of an iris, a retina, or a face, [3] talking to a microphone to provide UI_{THEN} about a user's voice, or the like. A user may exercise “multiple active quick efforts” by performing multiple voluntary actions to provide UI_{THEN} as well.

In the alternative, a terminal may acquire at least one UI_{THEN} on its own without necessarily requiring a user to take an active action. Accordingly, a terminal may take an image of a body part of a user, may obtain a user voice, or may record environmental sounds, and then acquire UI_{THEN} from the image, voice, or sounds, regardless of whether or not [1] a user voluntarily presses a sensor or stares at a camera, [2] a user speaks only to a terminal, without talking to a 3^{rd} person on the other line, or the like. In such cases, a user may be deemed to exercise a “passive single effort” by performing an involuntary action to provide UI_{THEN} to an input unit.

Once an input unit of a terminal receives a (single) user input from a user, a sensor of the input unit acquires UI_{THEN} therefrom. In response thereto, a terminal (i.e., its processor, its O/S or its software app) may then start to execute program codes of an authentication application, and determines whether or not a current user may pass the user authenticating.

In particular, a terminal may (1) execute “comparing steps” of the authentication application by comparing UI_{THEN} with biometric information of a user which is pre-stored in the terminal, and (2) execute “determining steps” of the authentication application by determining whether a current user passes (i.e., a “pass”) or fails (i.e., a “fail”) the user authenticating. A terminal may run an authentication operation in one of various authenticating timings such as, e.g., [1] upon or (immediately) after acquiring an user input which includes UI_{THEN}, [2] upon or (immediately) after acquiring UI_{THEN}, [3] after acquiring a user input which includes UI_{THEN} but before [3-1] receiving another user input or [3-2] acquiring another (user) sub-input, [4] after acquiring UI_{THEN} but before [4-1] receiving another user input or [4-2] acquiring another (user) sub-input, [5] before, during or after switching to a new mode which is granted with [5-1] more access authorities (e.g., from a lock mode to an unlock mode) or [5-2] comparable access authorities (e.g., from a 1^{st} unlock mode to a 2^{nd} unlock mode) or [6] during or after turning a display unit.

### 1-13-3. Mode-Switching (User) Sub-Input (UI_{SWI})

A 3^{rd} exemplary (user) sub-input is a “mode-switching (user) sub-input (UI_{SWI})” which may also be referred to as a “mode-switching sub-input (UI_{SWI})” or simply UI_{SWI}, all of which “switch” a mode of operation by causing a terminal [1] to advance to one mode from an off-state or a powered-off state, or [2] to switch from a current mode to a new mode in response [1] to (receiving) a user input or [2] to (acquiring) UI_{SWI}, where a terminal may switch modes in one of various “mode-switching timings” as will be explained below. Because a terminal may execute (or start to execute) at least one unexecuted (or remaining) step of a mode-switching operation once acquiring UI_{SWI}, a terminal (more particularly, its processor, its O/S, or its software application) may not run any mode-switching operation without UI_{SWI}.

It is appreciated that an input unit for receiving UI_{SWI} is referred to as a “mode-switching input unit” hereinafter, while a sensor of the mode-switching input unit is to be referred to as a “mode-switching sensor” hereinafter. In addition and as defined in Section 1-4, to “switch modes” or “mode switching” collectively refers to any of the following mode switching such as, e.g., [1] to “advance” to a certain mode from its “powered-off state,” [2] to “advance” to a certain mode from its “off-state,” [3] to “switch” from a current mode to a new mode while in an “on-state” (i.e., when a terminal is communicable and not completely powered off, and its display unit is or has been turned on), [4] to “advance” to an off-state from one mode (i.e., in the on-state), or [5] to “advance” to a powered-off state from one mode (i.e., in the on-state).

A terminal selects a new mode based on UI_{SWI} by referring to a “matching list” which matches each of multiple mode-switching (user) sub-inputs (multiple UI_{SWI}'s) with each of multiple modes of operation which have been defined in a certain hierarchy by a user (or a terminal). Because multiple UI_{SWI}'s and multiple modes (defined in a certain hierarchy) are already listed in the matching list, a step of selecting a new mode from UI_{SWI} may be simply a step of locating a correct entry (i.e., one of multiple pre-defined modes which corresponds to the acquired UI_{SWI}) from a matching list based on another entry (i.e., one of UI_{SWI}'s provided by a user). Accordingly, the step of selecting a correct entry from the matching list may be different from determining steps which are involved in a user authentication operation where a terminal compares UI_{THEN} with a pre-stored authentication information, for UI_{THEN} provided by a user may not be correct, or for UI_{THEN} provided by a user may not match pre-existing information stored in a terminal.

Further details of “1-13. Mode-Switching (User) Sub-Input (UI_{SWI})” are identical to the following portions of the '861 application such as, e.g., FIG. 4, and the text from [0262] on page 23 through [0273] on page 25, where these portions are incorporated herein in their entirety by reference.

It is appreciated that each of such types of the user inputs exemplified in Section 1-13 can include one, two or three of such (user) sub-inputs UI_{SWI}, UI_{THEN}, and UI_{ACT}, and that each of such (user) sub-inputs UI_{SWI}, UI_{THEN}, and UI_{ACT} may be included in at least two of multiple user inputs.

A terminal or a user may also manipulate a setting so that a certain user input received by a certain input unit may be interpreted to carry UI_{SWI} in a 1^{st} setting, whereas the same user input received by the same input unit may be interpreted to carry UI_{THEN} in a 2^{nd} setting.

### 1-14. Input Units

As used herein, an “input unit” refers to a hardware element of a terminal. For example, an input unit receives at least one of the above 1^{st} to 5^{th} type user inputs. A terminal may recruit any prior art mechanical, electrical, magnetic, and/or optical device as an input unit, as far as the device can [1] receive at least one of the above user inputs, or [2] include at least one prior art sensor capable of acquiring at least one (user) sub-input which is included in that user input received by the input unit.

When a certain input unit is designated to receive UI_{ACT}, the input unit is referred to as an “activation input unit” which includes at least one “activation sensor” therein. When a certain input unit is designated to receive UI_{THEN}, the input unit is referred to as an “authentication input unit” which includes at least one “authentication sensor” therein. Similarly, when a certain input unit is designated to receive UI_{SWI}, the input unit is referred to as an “mode-switching input unit” which includes at least one “mode-switching sensor” therein. A terminal may also include an additional input unit which can receive a user input which includes therein another (user) sub-input for running operations other than the above authenticating, activation, or mode-switching operations. Such an input unit is referred to as an “auxiliary input unit” which includes therein at least one “auxiliary sensor” capable of acquiring an “auxiliary (user) sub-input (UI_{Aux}).”

Further details of “1-14. Input Units” are identical to the following portions of the '861 Application such as, e.g., the text from [0277] on page 25 through [0282] on page 25, where these portion is incorporated herein in their entirety by reference.

### 1-15. (Software) Application

As used herein, a “software element” of a main system of a terminal collectively refers to [1] a man O/S), or [2] a main (software) application, and the software element is synonymous with an “accessible software element.” A software element typically means a set of computer instructions or programs.

As used herein, a “(software) application,” an “application” or “app” may refer to one of software elements of a terminal, and also means a set of computer instructions or programs designed [1] to run a certain operation, or [2] to perform a specific function. It is appreciated that an app is driven by a CPU unit, an O/S, or another application, and that driving an app leads to running a certain operation or performing a specific function. It is also appreciated that driving an app may accompany driving at least one hardware element as well.

As used herein, an “app” is deemed to not include an “O/S” and, therefore, to be different from the O/S. A manufacturer or a distributor of a terminal may implement at least one (software) application into a terminal before sale. Alternatively, a user may download at least one app to a terminal after purchase. An O/S or an already-implemented app may download a new “app” from other sources such as, e.g., an external memory device, a website, or the like.

An app may provide a user with various options such that the user may select different options in driving the app to run different operations or to perform different functions.

Therefore, when a terminal grants a user with access authority to drive a certain app, a terminal may also allow a user to use all available options or to use only certain selected options, depending upon a mode in which a user operates a terminal, access authority granted thereto, or the like.

### 1-16. Run an Operation

It is a terminal (1) which “drives” various hardware or software elements of a main, intermediate or lock system, and (2) which “runs” various operations using a main, intermediate or lock system. In particular, driving an O/S, at least one (software) app, or a CPU unit of a terminal leads to running various operations. For illustration purposes, “an O/S, a (software) application (i.e., an app) or a CPU (unit) of a terminal” may be referred to as a “terminal” in this disclosure. Therefore, a terminal may run an operation by driving at least one portion of its CPU, O/S, or app. For illustration purposes, a phrase “run an operation” is deemed to be synonymous with “run at least one operation” or “run at least one pre-determined operation.”

To “run an operation” may typically include at least one of multiple steps such as, e.g., at least one step of [1] retrieving data which have been pre-stored in a terminal, [2] retrieving a system setting or a user preference related to running an operation, [3] preparing at least one hardware or software element ready to run an operation (e.g., erasing a volatile or non-volatile memory unit, erasing at least a portion of results obtained by running lock operations, getting electrical power supply ready, or the like), [4] supplying electrical power to a hardware element, [5] driving the element (e.g., manipulating a hardware element or executing computer instructions of a software element to perform a function), [6] storing data obtained from driving the element, [7] storing, utilizing, or erasing results obtained from such driving, or the like.

To this end, a terminal may employ one or more arrangements such that, e.g., a terminal [1] may retrieve data (or results) from a memory unit of a main, intermediate or lock system, [2] may clear a memory unit of a main, intermediate or lock system before driving a hardware or software element, [3] may supply electrical power to at least one hardware element, thereby rendering the element ready to run an operation, [4] may drive at least one software element by [4-1] executing a set of computer instructions or [4-2] dividing such instructions to two or more sections and executing such sections sequentially, concurrently or in a combination thereof, or the like. Regardless of the above differences, an “operation” may be deemed to “have been on hold” or to “be on hold” as far as a terminal may not proceed to execute any unexecuted or remaining steps of a computer instructions or (software) app which are required to “run” a certain operation.

Once receiving a user input or in response to the user input, a terminal may drive (or start to drive) at least one hardware or software element, and may run (or start to run) at least one operation. Alternatively, a terminal may drive at least one 1^{st} hardware or software element in response to receiving a 1^{st} user input, and may then run a 2^{nd} operation automatically (or on its own), even without receiving a 2^{nd} user input to run the 2^{nd} operation, where an example may include a terminal which drives a 2^{nd} element and runs a 2^{nd} operation upon obtaining a certain outcome from running a 1^{st} operation with a 1^{st} element. This arrangement is referred to as driving a 2^{nd} element and running a 2^{nd} operation “conditioned upon” driving a 1^{st} element and running a 1^{st} operation.

In this disclosure, a terminal may drive a hardware or software element [1] upon receiving (or in response to) a user input or [2] in response to (or upon) acquiring at least one (user) sub-input. For example, a terminal may “run an activation operation” in response to acquiring UI_{ACT}, may “run an authentication operation” in response to acquiring UI_{THEN}, or may “run a mode-switching operation” in response to acquiring UI_{SWI}.

Because a single user input may include more than one (user) sub-input, a terminal may drive multiple elements, and may run multiple operations upon receiving a single user input, where such multiple elements or operations may be identical to or different from each other.

### 1-17. Mode-Switching Operation in a Single Screen

As used herein, to “run at least one mode-switching operation” or simply to “run a mode-switching operation” is synonymous with [1] “switching modes,” [2] “mode switching,” or [3] simply “switching.” As described above, such “mode switching” is an operation which causes a terminal to switch from a current mode to a new mode, where a terminal defines such modes in a hierarchy and, therefore where the current mode or new mode may include [1] each and every mode defined in the hierarchy, [2] an off-state, [3] a powered-off state, or the like.

It is appreciated that an on-state is also implicitly included in the current or new mode, for any lock mode, any intermediate mode, and any unlock mode are in the on-state. In addition, a powered-on state is also implicitly included in the current or new mode, for any lock mode, any intermediate mode, and any unlock mode are in the powered-on state.

A “mode switching” or running a mode-switching operation may include multiple steps therein. For example, a mode switching may include the steps of, e.g., [1] starting to run a mode-switching operation, [2] selecting at least one new mode from a matching list of multiple pre-defined modes defined in a certain hierarchy based upon UI_{SWI}, [3] taking an action when UI_{SWI} does not match any of multiple modes listed in the matching list, [4] switching from a current mode to a new mode, or [5] completing to run a mode-switching operation.

In general, a terminal may run various mode-switching operations in various ways. For simplicity of illustration, various mode-switching operations may be classified based on many factors such as, e.g., whether a terminal [1] is (or has been) in a powered-off state or in a powered-on state before mode switching, [2] is (or has been) in an off-state or in an on-state before mode switching, [3] runs an authentication operation in conjunction with (e.g., before, concurrently or after) such mode switching, or the like.

In one example, when a terminal in its off-state receives a user input including UI_{SWI}, a terminal advances to a new mode based upon UI_{SWI}, where the new mode is selected from a matching list, and where the matching list may match each of multiple modes defined in a certain hierarchy with each of multiple UI_{SWI}'s acquired by a terminal. As used herein, such mode of switching to a new mode is to be referred to as a “1^{st} type switching modes” or “1^{st} type mode switching” hereinafter.

When a terminal employs a user authentication, a terminal may advance to different modes depending upon an outcome from such authentication. In one case, a terminal may advance to an unlock mode and display an unlock (or home) screen when a user passes the user authenticating. When a user fails the authentication, a terminal may [1] advance to a lock mode (or a different default mode) and display a lock screen (or a default screen), or [2] remain in the off-state, without displaying any screen on a display unit.

In this case, a terminal may first acquire UI_{THEN} from a user input, runs an authenticating operation, and then acquire UI_{SWI} only when a user passes such authentication. Alternatively, a terminal may acquire UI_{THEN} and UI_{SWI} concurrently, regardless of whether or not a user may pass the authenticating.

In another case, a terminal in an on-state may receive a user input including UI_{SWI}. A terminal may then switch from a current mode to a new mode by, e.g., selecting the new mode from the matching list based upon UI_{SWI}. As used herein, such mode switching of switching to a new mode from a current mode is to be referred to as a “2^{nd} type switching modes” or “2^{nd} type mode switching” hereinafter.

When a terminal employs a user authentication, a terminal may switch to a new mode depending upon an outcome from such user authenticating. In one case, a terminal may switch to an unlock mode and display an unlock (or home) screen when a user passes the user authenticating.

When a user fails such authenticating, however, a terminal may [1] switch to a lock (or different default) mode and display a lock (or different default) screen, [2] remain in the lock mode wile displaying a lock screen when a current mode is a lock mode, or [3] switch to an off-state by turning off its display unit.

Alternatively, a terminal may first acquire UI_{THEN} from a user input, and may then acquire UI_{SWI} only when a user passes such authenticating. In the alternative, a terminal may acquire UI_{THEN} and UI_{SWI} concurrently, regardless of whether or not a user may pass the authenticating.

### 1-18. Mode-Switching Operation in Multiple Windows

Various mode-switching operations of the preceding Section typically relate to a terminal which drives a single display unit and which displays a single screen or window thereon.

Accordingly, such a terminal allows a user to run operations in one mode at a time, regardless of how many modes a terminal may define in a certain hierarchy. As a result, whenever a user switches to a first mode from a second mode, a user in the second mode cannot run any operation which may only be accessible in the first mode anymore. However, when a terminal allows the user to use multiple windows on a single display unit or multiple display units concurrently, the terminal may allow a user to use options which may be different from those in the preceding Section 1-17.

In one example, a terminal may allow a user to use at least two windows such that a user may use a 1^{st} window to run operations in a lock (or intermediate) mode, whereas a user may use a 2^{nd} window for running the same or different operations in an unlock mode. A terminal operating in this arrangement may allow a user to switch modes in any manner as described above and below, so that a user may switch from one window (which is designated to operate in one mode) to another screen (which is designated to operate in a different mode) by providing UI_{SWI} to a mode-switching input unit. Alternatively, a user may manually select a desired mode by moving a cursor in a non-touch-type display unit, or by moving a body part with respect to a display unit such as a prior art touchscreen and pressing or touching a certain window of his choice.

Accordingly, a user may run various operations in either window by switching from one to the other, just like a user hops from one window to another of a computer with a mouse. This arrangement may provide a user with enhanced security and improved integrity of a main system of a terminal, by entirely or partially isolating a lock (or intermediate) system of a terminal from its main system, thereby preventing any results residing in a lock (or intermediate) system from contaminating or deteriorating a main system. However, this arrangement may not be able to preserve privacy of data in a main system, for a lucky unauthorized user who sneaks into a lock (or intermediate) system may see whatever is displayed on another screen driven by a main system.

Accordingly, a terminal may run an erase (or semi-erase) operation in various erasure timings. In one case, a terminal runs such erasure or semi-erasure whenever a user switches from a 1^{st} window (operating in a 1^{st} mode granted with less access authority) to a 2^{nd} window (operating in a 2^{nd} mode with more access authority) but not vice versa. In the alternative, a terminal may run the erasure (or semi-erasure) whenever a user may switch modes, regardless of those access authorities granted to a current mode or a new mode. In addition, a terminal may run such erasure or semi-erasure, only if a user terminates to operate in a lock (or intermediate) mode and closes the window designated thereto. A terminal may instead request or ask a user to confirm such erasure or semi-erasure.

Synchronization of such erasure (or semi-erasure) with other operations is feasible, as far as such arrangements may be easy to implement into a terminal or as far as a user may easily run such an erasure or semi-erasure.

It is appreciated that a terminal with multiple windows may employ user authenticating when a user may switch from one window to another. More particularly, when a terminal switches from a lock (or intermediate) mode to an unlock mode, a terminal may run an authentication operation to confirm whether a current user may have access authority to advance to the unlock mode.

A terminal may also allow a user to temporarily minimize at least one window on a display unit while operating a terminal, where such a window [1] may be designated to a lock (or intermediate) mode, or [2] may be selected by a user to run various lock (or intermediate) operations in a lock (or intermediate) mode. In this arrangement, a terminal may run such erasure or semi-erasure in one of various erasure timings.

A user may minimize one of such windows to run various lock (or intermediate) operation for many reasons. For example, when a user minimizes a window in a lock (or intermediate) mode with an intention to resume operation again in a lock (or intermediate) mode, a terminal may not run such erasure (or semi-erasure). When a user attempts to maximize the window, a terminal may require an additional user authentication. Alternatively, a terminal may require a user to store to-be-stored results before such minimization, particularly when the user intends to use such to-be-stored results in the following session.

It is appreciated that the above arrangements for synchronizing the erasure (or semi-erasure) with switching the windows may be applied to a window which may be designated to an unlock mode. In other words, although a user who operates a terminal in an unlock mode has already been authenticated as an authorized user, the synchronization between such window switching and such erasure (or semi-erasure) may provide a user with further enhanced security and improved integrity of a main system of a terminal, along with even heightened privacy of data stored in a main system.

In a different example where a terminal may include multiple display units, the terminal may employ various configurational or operational features of the case in which a terminal includes a display unit which displays multiple windows thereon, e.g., by treating each display unit of the terminal of this example as each window of the above examples.

Accordingly, further details of this example are to be omitted.

### 1-19. Authentication Operation

As used herein, to “run at least one authentication operation” or simply to “run an authentication operation” is synonymous with “user authenticating” or “authenticating” hereinafter. As also used herein, an “authentication operation” refers to an operation with which a terminal checks or determines whether or not [1] a current user is an authorized user, [2] a current user has an access authority to drive a certain hardware or software element of a main, intermediate or lock system of a terminal, [3] a current user can run a certain operation, [4] a current user can use certain options while driving a certain hardware or software element, or the like. To this end, a terminal compares acquired UI_{THEN} of a current user with authentication information which is already stored in the terminal (i.e., a pre-stored UI_{THEN}).

To “run an authentication operation” may typically include therein at least one of multiple steps such as, e.g., at least one step of [1] getting an authentication input unit and its authentication sensor ready, [2] receiving a user input provided to the input unit, [3] acquiring UI_{THEN} from the user input using the authentication sensor, [4] “comparing” acquired UI_{THEN} with a pre-stored UI_{THEN} or other authentication information [5] “determining” whether a user may pass (i.e., a “pass”) or fail (i.e., a “fail”) the user authenticating, or [6] terminating an authentication operation. When desirable, such “authenticating” may include at least one step of temporarily or permanently “storing (to-be-stored) results” involved in the above steps [1] to [6] in an available memory unit (or sector).

For example, a terminal may store [1] the acquired UI_{THEN}, [2] differences between the acquired UI_{THEN} and pre-stored UI_{THEN}, or [3] an outcome such as the “pass” or the “fail,” where such [1] to [3] may be in the form of texts, files, or folders, and where such [1] to [3] may be included in the “results” defined above.

A terminal may run a single authentication operation or multiple different authentication operations concurrently or sequentially. In the latter case, the terminal may include at least two authentication sensors to run at least two of a fingerprint authentication operation, a face authentication operation, a hand (or palm) authentication operation, an iris (or retina) authentication operation, a voice authentication operation, an authentication operation based on a pattern of a blood vessel(s) or other physiological features, or the like.

A terminal may employ different arrangements to run authentication operations such that, e.g., a terminal renders (or starts to render) [1] at least one authentication sensor ready when a terminal turns (or starts to turn) on a display unit, or [2] an authentication sensor ready while a display unit remains turned off. A terminal may render an authentication sensor ready upon (or in response to) acquiring UI_{THEN} or other (user) sub-inputs.

Alternatively, a terminal may render an authentication sensor ready only after acquiring UI_{THEN}. A terminal may then use UI_{THEN} for user authenticating or may extract other information for authenticating from the user input.

Regardless of differences in detailed arrangements, however, an “authentication operation” is deemed to be on hold (or to have been on hold) [1] until a terminal receives a user input, [2] until a terminal acquires UI_{THEN}, [3] until a terminal acquires other (user) sub-inputs, or [4] as far as a display unit remains turned off.

That is, at least one unexecuted (or remaining) step of an authentication operation may not be executed [1] until a terminal receives a user input or acquires UI_{THEN} (or other sub-inputs), or [2] while a display unit remains turned off. Therefore, until a terminal acquires UI_{THEN} (or other sub-inputs) or while a display unit remains turned off, an authentication operation may be deemed to be on hold.

Once acquiring UI_{THEN}, a terminal executes (or starts to execute) at least one unexecuted (or remaining) step of an authentication operation so that a terminal may run at least one authentication operation which has been on hold. As a result, execution of such steps may lead to performing at least one specific function assigned to the authentication operation.

Various biometric or non-biometric information may be used as UI_{THEN}. Examples of such biometric information which may be used as UI_{THEN} may include an image of a body part (e.g., a fingerprint, a hand, a palm, a wrist, an iris, a retina, an eye, an ear, a nose, a face, other body parts, blood vessels, or their distribution pattern) which may be captured by various image acquisition units of a terminal such as, e.g., a camera or a scanner. Further examples of such biometric information may include electric or magnetic features related to the body part, where a pattern of electrical conductance of a body part is one example, and where further details thereof have been described above.

Other examples of the biometric information may include, e.g., a sound (including a voice of a user or that of a non-user), various physiological features of a user (or a non-user) such as, e.g., cardiovascular features (an average blood pressure, a blood pressure measured at a certain location, or a heart rate), respiratory features (a breathing rate, or a breathing sound), gastrointestinal features (a movement of stomach or intestines, or the like), other physiological features of a user, or a user's other physiological conditions. A terminal may also incorporate various conventional sensors to monitor the above biometric information such as, e.g., a pressure sensor, a thermometer, or a flow rate sensor.

Other examples of biometric information may also include user's dynamic biometric information such as, e.g., a displacement (or a movement of) a body part, a velocity thereof, its acceleration, its position in a 2-D plane or a 3-D space, a gesture, or the like. In addition, other conventional non-biometric information may be used for authenticating a current user, where examples of such non-biometric information may include, but not limited to, a password, a pass code, a pass gesture, a movement pattern, or the like.

### 1-20. Activation Operation

As used herein, an “activation operation” means an operation to switch (or to start to switch) a terminal from an off-state to an on-state. Therefore, an “activation operation” also means an operation to switch (or to start to switch) a display unit from an off-state to an on-state, and is synonymous with [1] an “operation of turning on a display unit” while (or when) a display unit is (or has been) turned off, or [2] an “operation of switching a display unit from an off-state to an on-state.”

By the same token and as used herein, to “run an activation operation” is synonymous with to “run an operation of turning on a display unit” while (or when) a display unit is (or has been) turned off. Thus, to run an activation operation is synonymous with “turning on a display unit” or simply “turning on.”

An “activation operation” or “turning on a display unit” may include one or more of multiple steps such as, e.g., at least one step of [1] acquiring an activation (user) sub-input (UI_{ACT}) or other (user) sub-inputs when desirable, [2] closing an electrical switch of a display unit or otherwise rendering the display unit ready to be turned on, [3] supplying an electric current to a display unit, [4] selecting a screen to be displayed on a display unit when a display unit is turned on from an off-state, [5] displaying a new screen on a display unit or replacing (or overlaying) a current screen with a new screen when a terminal may switch modes, or the like. A terminal may employ different arrangements for such “turning on” such as, e.g., a terminal may [1] render a screen ready while a display unit is turned off such that a display unit displays a pre-selected screen concurrently with being turned on, [2] select a certain screen to be displayed on a display unit only after acquiring UI_{ACT}, [3] receive a screen to be displayed from an external device or an external source (such as, e.g., an add-on device, a portable device, another terminal, a website or a cloud), or [4] display one screen from multiple pre-selected screen randomly or in a certain order.

Regardless of such differences in detailed arrangements, however, an “activation operation” is deemed to be on hold (or to have been on hold) while (or as far as) a display unit remains (or is) turned off. That is, one or multiple unexecuted (or remaining) steps of an “activation operation” have not been executed while (or as long as) a display unit is or remains turned off. Therefore, while a display unit is in its off-state (i.e., remains turned off), an “activation operation” and a “turning on” is deemed to be on hold.

A terminal may synchronize “timings” between such turning on and other operations to be run by the terminal. Such timings related to turning on a display unit are referred to as “turning-on timings” hereinafter. Examples of such turning-on timings may include running an activation operation [1] “concurrently with” receiving a user input including UI_{ACT} therein, [2]“concurrently with” receiving another user input which does not include UI_{ACT} therein, [3]“immediately after” receiving the user input of [1] or [2], [4] after receiving the user input of [1] or [2] but “before” a user provides another user input, [5] concurrently with running an authentication operation (e.g., upon determining whether a user passes such authenticating), [6] immediately after running an authentication operation, or the like.

It is noted throughout this disclosure that an event E₂ “immediately after” an event E₁ means that E₁ happens and then ends first and that, thereafter, E₂ start to happen within 0.5, 0.3, 0.2, 0.1 or 0.05 sec. As a result, a user may feel that there exists a very short temporal gap between the end of E₁ and a start of E₂, but that E₁ and E₂ happens consecutively but almost at the same time.

### 1-21. Types of Switching Modes

When a user desires to switch from a current mode (or an off-state) to a new mode, a terminal may enable a user to do so in different ways. That is, a terminal may mandate a user to switch to a certain new mode one after another only along various modes defined in a hierarchy in which a terminal operates. To the contrary, a terminal may allow a user to switch to any mode defined a hierarchy by jumping around such modes depending upon UI_{SWI}.

As used herein, a “series switching” means an arrangement in which a terminal switches from a current mode to a new mode which corresponds to a mode neighboring the current mode in a hierarchy. In this arrangement, a terminal switches modes whenever it receives a user input or whenever it acquires UI_{SWI}. Conversely and as used herein, a “selective switching” refers to an arrangement where a terminal may switch to a new mode which may not necessarily be a neighboring mode of a current mode in a hierarchy, either in a forward direction or in a backward direction. In this selective switching, a terminal switches modes not only upon acquiring UI_{SWI} but also depending on which UI_{SWI} a user provides.

Further details of “1-21. Types of Switching Modes” are identical to the following portions of the '861 application such as, e.g., FIG. 4, and the text from [0329] on page 29 through [0338] on page 31, where these portions are incorporated herein in their entirety by reference.

### 2. Objectives

Objectives to be achieved by various data processing terminals of this disclosure are summarized below. It is appreciated that following objectives are exemplary only and, therefore, not intended to confine any application or scope of such terminals. It is also appreciated that various features of the data processing terminals, their units, and their hardware or software elements in this Section 2 are focused upon protecting a main system of a terminal from those results obtained by running lock operations by a lock system in a lock mode. It is to be understood [1] that a main system of a terminal may also be protected from various results obtained by running intermediate operations by an intermediate system in an intermediate mode, [2] that an intermediate system of a terminal may also be protected from various results obtained by running lock operations by a lock system in a lock mode, or the like.

### 2-1. Running a Lock Operation with a Lock System in a Lock Mode

A first objective and one exemplary aspect of a data processing terminal and related methods of this disclosure are to restrict a user from driving all (or some) accessible hardware or software elements of a main system when a user operates a terminal in a lock mode. Therefore, a user who is operating a terminal in a lock mode may be prevented from [1] driving at least one hardware or software element of a main system, [2] driving that hardware or software element with full options even after successful accessing and driving, or the like.

To this end, at least a portion of a main system may be physically or operationally isolated from a lock system. In addition, a terminal may prevent a user who operates a terminal in a lock mode from driving all (or at least some) hardware or software element of a main system.

Due to such isolation or prevention, the “results” which are obtained by running an operation with a lock system in a lock mode may not be able to adversely affect a main system of the same terminal.

For simplicity of illustration, to “run at least one operation with a lock system (and, therefore, in a lock mode)” is referred to as to [1] “run at least one lock operation,” [2] “run a lock operation,” [3] “run lock operations,” or the like. To “run at least one operation with an intermediate system (and, therefore, in an intermediate mode)” is abbreviated as to [1] “run at least one intermediate operation,” [2] “run an intermediate operation,” or [3] “run intermediate operations” hereinafter.

In one exemplary embodiment of this first objective, a terminal may allow a user to switch from a current mode to a new mode [1] directly based on UI_{SWI}, [2] indirectly according to a user input such as, e.g., based upon an outcome obtained from running an authentication operation which in turn uses UI_{THEN}, [3] based upon a setting of a terminal selected by a user or a terminal, or the like.

In another exemplary embodiment of this first objective, a user may run an operation with a lock system in a lock mode (i.e., run a lock operation), while not driving all (or some) hardware or software elements of a main system of the terminal. More particularly, a terminal may prevent a user from storing unauthorized or unreliable results into a main system (e.g., into a main memory unit) [1] while a user runs a lock operation in a lock mode, [2] as far as a user operates a terminal in a lock mode, [3] before a terminal switches to a new mode granted with greater access authority, or the like.

A terminal may prevent a user from accessing or retrieving data from a main system (e.g., from a main memory unit), or may prevent a user from altering any unit of a main system [1] while a user runs a lock operation in a lock mode, [2] as far as a user operates a terminal in a lock mode, [3] before a terminal switches to a new mode granted with greater access authority, or the like.

As described above, a lock system may be physically or operationally isolated from a main system of a terminal. Therefore, a terminal may enhance the security of its main system, e.g., by preventing [1] any unauthorized alteration of a main system while a user runs lock operations by a lock system in a lock mode, [2] such alteration of the above even after a terminal switches to an unlock mode, unless a terminal runs such erasure (or semi-erasure), or [3] hacking of a main system.

As a result, a terminal may improve the integrity of a main system by preventing [1] modification or alteration of a main system during or after a user runs lock operations, [2] modification or alteration of a main system even after a terminal switches to an unlock mode, unless a terminal runs such erasure (or semi-erasure), or the like. A terminal may also preserve the privacy, e.g., by protecting [1] personal data stored in a main memory unit of a main system from being accessed without any authorization by unauthorized users in a lock mode, [2] unauthorized data retrieval from a main system during (or after) a user runs lock operations, or the like.

In addition, because any results obtained by running lock operations may neither drive nor modify a main system in a lock mode, a user may run lock operations, [1] without being concerned about degrading the security or integrity of a main system, or [2] without worrying about any contamination of a main system by the malicious viruses. Due to the foregoing reasons, a user may also comfortably access any unknown or unreliable website, may download any contents therefrom, or may permanently or temporarily store such results in a lock memory unit of a lock system, while preventing the malicious viruses which may be included in the results obtained by running the lock operations in the lock mode from accessing or degrading the main system.

A terminal may include a single or multiple lock systems to run lock operations in a lock mode. When a terminal includes multiple lock systems, the terminal may grant the same or different access authorities to at least two (or all) of such systems. All or at least two of the lock systems may be physically or operationally isolated from at least a portion of a main system such that [1] a lock system may not adversely affect (e.g., modify or alter) a main system, or [2] any results obtained by running lock operations in a lock mode may not adversely affect a main system.

As far as the security, integrity, or privacy of a main system is not adversely affected, a terminal may allow a user driving a lock system in a lock mode to access data stored in a main system, but may prevent a user from altering, modifying or otherwise changing any unit, element or data of a main system.

Due to such advantages, multiple users may share a single terminal in various ways. For example, those users may operate a terminal in a common lock, intermediate, or unlock mode. A terminal may instead provide each user with at least one of his or her own lock, intermediate, or main system. More particularly, a terminal may [1] prevent each user from driving a system of another user, [2] prevent each user from switching to a certain mode of another user, or [3] prevent any result obtained by running lock operations by a 1^{st} user from adversely affecting any system of another user. Accordingly, the terminal may maintain the security, integrity, or privacy of [1] a main system of each user or [2] a common main system of a terminal.

### 2-2. Erasing Those Results in a Lock Mode

A second objective and another exemplary aspect of a data processing terminal and related methods of this disclosure are to enable a user to erase all or some results obtained by running lock operations by driving a lock system in a lock mode.

In one exemplary embodiment of this second objective, a terminal may “run an erase operation” to erase all (or some) results obtained by running a lock operation with a lock system in a lock mode. Instead, a terminal may “run a semi-erase operation” in order to erase not all but only a selected portion of such results obtained by running lock operations.

Further details of running such erasure (or semi-erasure) have been provided in Section 1-6 and, therefore, are omitted herein.

In another exemplary embodiment of this second objective, a terminal may “synchronize” the erasure (or the semi-erasure) with various “timings,” particularly when (or after) a user may switch from a current mode to a new mode. For example, a terminal may run such erasure (or semi-erasure) when it may switch from a mode which is granted with less access authority to a mode granted with greater access authority (or vice versa). Alternatively, a terminal may run such erasure (or semi-erasure) whenever a terminal may switch modes.

A terminal may run the erasure (or semi-erasure) when a terminal switches from an “off-state” to an “on-state” (or vice versa). These arrangements may ensure that the results obtained by running operations with a 1^{st} system (e.g., a lock or intermediate system) in a 1^{st} mode may not be automatically transferred to a 2^{nd} mode or may not become accessible by a 2^{nd} system (e.g., an intermediate system or a main system) in the 2^{nd} mode and that such results may not adversely affect a hardware element or software element of a main (or intermediate) system of a terminal.

As used herein, “erasure timings” may refer to those timings or instances in which a terminal runs an erasure operation or a semi-erasure operation. Such erasure timings may be defined based upon various features.

In a 1^{st} case, such “erasure timings” may be defined in a relation to a presence or absence of such malicious viruses in a terminal. Examples of such erasure timings may include [1] when a terminal may detect such viruses [1-1] in such “results,” [1-2] in a lock system, [1-3] in a lock hardware element, [1-4] in a lock software element or [1-5] in a lock app, [2] when a terminal may find [2-1] suspicious results. [2-2] suspicious lock app, [2-3] suspicious lock software element, [2-4] suspicious lock hardware element, [2-5] suspicious lock system, or the like.

In a 2^{nd} case, such erasure timings may be defined in a relation to those timings of other operations run by a terminal, In particular, the erasure timings may be synchronized with the “timings” of various mode-switching operations.

Examples of such erasure timings may include running an erase (or semi-erase) operation [1] after obtaining such results in a lock (or intermediate) mode but before switching to a new mode, [2] “concurrently with” the mode switching (e.g., at least one step of an erase or semi-erase operation overlaps with at least one step of a mode-switching operation in a common clock cycle), [3] “immediately after” the mode switching, where the term “immediately after” has been provided above, [4] after such mode switching but “before” a user provides another user input, or the like.

In a 3^{rd} case, such erasure timings may be defined in a relation to those timings of various operations which are run by a main, intermediate or lock system, where examples of such erasure timings may include running an erasure or semi-erasure [1] before running an authentication operation, [2] concurrently with running an authentication operation (e.g., before, upon or after determining whether a current user passes or fails a user authenticating), [3] after running an authentication operation, [4] before turning on or turning off a display unit, [5] concurrently with such turning on (or off), [6] after such turning on (or off), [7] before powering off (or on) a terminal, [8] concurrently with such powering off (or on), [9] after such powering off (or on), [10] concurrently with receiving a user input related to running such erasure (or semi-erasure), [11] after receiving the user input of [10]. or the like.

In a 3^{rd} case, such erasure timings may be defined in a relation to those timings of running lock operations in a lock mode. For example, such erasure timings may include instances such as [1] when a certain period has elapsed after a previous erasure (or semi-erasure), [2] when a user has been running lock operations for a period longer than a preset period, [3] when a user has been running different lock operations more than a preset number, [4] when a size of such “result” or “results” has exceeded a preset size,

Accordingly, various terminals of this disclosure may provide a user with seamless features and consequent user convenience. As a result, a user may ensure that any results which may be permanently or temporarily stored or residing in a lock system (e.g., a lock memory unit or sector) may not adversely affect any element or unit of a main system. In addition, a user may conveniently erase a trace of operations which he has run using a lock system in a lock mode.

A terminal may run such erasure (or semi-erasure) in various ways when viewed in the level of clock cycles. In a 1st example, a terminal may run a “real-time erasure (or semi-erasure),” where a terminal may run the erasure (or semi-erasure) before, concurrently with or after a user runs a next or different operation, thereby erasing (or semi-erasing) data after data, file after file, folder after folder as the user runs the next, different operation.

In the 2^{nd} example, a terminal may run an “interim erasure (or semi-erasure),” where a terminal may run such erasure (or semi-erasure) [1] at every preset interval set by a terminal, [2] at every interval selected by a user, or [3] at every instance when such results obtained by running such lock operations exceed a certain size, or the like.

In a 3^{rd} example, a terminal may run an “ex post erasure (or semi-erasure)” in which a terminal may run such erasure (or semi-erasure) once a user finishes running lock operations in a lock mode. A terminal may detect that A user finishes running a lock operation when a user provides a user input, e.g., [1] which includes UI_{SWI}, [2] which is for turning off a display unit, [3] which is for powering off a terminal, [4] which is for running such erasure (or semi-erasure), or the like.

When a portion of such results resides in a lock (or intermediate) system of a terminal in its power-off state and when a user powers on the terminal, the terminal may run such erasure (or semi-erasure) concurrently with of after the terminal is powered on, with or without receiving any user input for running such erasure (or semi-erasure). Similarly, when a portion of the results resides in a lock (or intermediate) system of a terminal in its off-state and when a user turns on a display unit, a terminal may run the erasure (or semi-erasure) concurrently with of after the terminal is powered on.

In another exemplary embodiment of this second objective, a terminal may run an erasure (or semi-erasure) to erase all (or some) results obtained by running operations in various modes. In a 1^{st} example, a lock system may run such erasure (or semi-erasure) in a lock mode. That is, a lock system may start to run such erasure (or semi-erasure) in a lock mode, where the erasure (or semi-erasure) may be completed either before, concurrently with or after switching to a new mode such as an intermediate mode or an unlock mode.

In a 2^{nd} example, an intermediate system may run such erasure (or semi-erasure) in an intermediate mode so that an intermediate system may start to run such erasure (or semi-erasure) in an intermediate mode, where such erasure (or semi-erasure) may also be completed either before, concurrently with or after a terminal may switch to a new mode such as an unlock mode.

In a 3^{rd} example, a main system may run such erasure (or semi-erasure) in an unlock mode.

In other words, a main system may start to run such erasure (or semi-erasure) in the unlock mode, where such erasure (or semi-erasure) may be completed concurrently with or after switching to a new mode such as an intermediate mode or a lock mode. When desirable, a lock (or intermediate) system may start and complete such erasure (or semi-erasure) in the unlock mode.

In the 1^{st} and 2^{nd} examples of this embodiment of the preceding paragraphs, a terminal may run the erasure (or semi-erasure) when the terminal may switch modes from one mode granted with less access authority to another mode granted with greater access authority.

Thus, these arrangements may ensure the enhanced security and improved integrity of a main system of a terminal, while also strengthening the protection of valuable data stored in a main system.

To the contrary, in the 3^{rd} example of this embodiment, a terminal runs such erasure (or semi-erasure) even when a terminal switches from a current mode granted with greater access authority to a new mode with less access authority. It is, however, appreciated that a terminal running such a mode-switching operation may be in a low risk even without running any erasure (or semi-erasure), for potential threats to a main system which operate in an unlock more may be deemed minimal at best.

However, when the user runs such erasure (or semi-erasure) in such mode switching of the 3^{rd} example, a user can effectively remove at least a portion of or an entire portion of such results obtained by running the unlock operations in the unlock mode. As a result, a user may effectively prevent a 3^{rd} person from finding out any trace regarding [1] which unlock operations a user has run in the past (or unlock mode), [2] which websites a user has visited in the past (or unlock mode), [3] which contents a user has downloaded from external sources in the past (or unlock mode), [4] what kind of communication a user has exchanged in the past (or unlock mode), or the like. In this context, whenever a user is concerned about privacy of his data stored or residing either in a lock, intermediate or main system, a terminal may then be configured to run such erasure (or semi-erasure) whenever a terminal switches modes.

During the semi-erasure, a terminal may select a certain portion of such results as designated by a user. Then, the terminal may run a semi-erase operation, while not erasing that certain portion of such results, while erasing other portions of such results. Accordingly, once the semi-erase operation is completed, that certain portion of such results still resides in a lock system, while other portions of such results do not reside in the lock system anymore.

During the semi-erasure, a terminal may alternatively select a certain portion of the results, where a user may designate that certain portion by providing a certain user input. Thereafter, a terminal may not erase a certain part of the certain portion of such results, while erasing all other parts of the certain portion of such results. A terminal may select that certain part based on that certain user input or another user input.

In another alternative, a terminal may select the certain portion of such results based on an outcome of running an anti-virus operation. For example, upon receiving a user input for running a semi-erase operation, a terminal may run an anti-virus operation, anti-malware operation, anti-spyware operation, or the like. By scanning such results, the terminal may detect a certain portion of such results which may be infected by malicious viruses.

The terminal may then erase the infected portion of such results, while not erasing the remaining portions of such results. In the alternative, a terminal may scan a certain portion of such results, scan such a portion of such results, and erase an infected part of such a portion, while not erasing the remaining parts of such a portion.

### 2-3. Saving Those Results in a Lock Mode

A third objective and another exemplary aspect of a data processing terminal and related methods thereof are to provide a terminal with which a user may run a saving operation for saving at least a portion or an entire portion of such results which are obtained by running lock operations with a lock system in a lock mode, while ensuring that such stored results may not [1] adversely affect a main (or intermediate) system or [2] interfere with running unlock operations in an unlock mode by a main system.

In one exemplary embodiment of this third objective, a lock system may include a lock memory unit. In addition, a lock system may run a saving operation and may temporarily or permanently store at least a portion of such results (obtained by running lock operations with the lock system in a lock mode) in the lock memory unit. More particularly, a lock memory unit may be physically or operationally isolated from a main memory (or another) unit of a main system.

As a result, a terminal can protect a main memory (or another) unit of a main system from any malicious virus which may be stored in the lock system and which may potentially contaminate or spoil a main (or intermediate) system. In other words, by physically or operationally isolating a lock memory unit or an entire lock system from a main system, a terminal may enable a user to fully utilize a lock system as well as a main system, while minimizing contamination or destruction of a main system by such viruses which may reside in such results.

In another exemplary embodiment of this third objective, a lock system may not include any lock memory unit, but a terminal may allow a lock system to recruit at least a portion of a main memory unit of a main system, and run a saving operation, thereby temporarily (or permanently) storing at least a portion of the results obtained by running lock operations with a lock system in a lock mode.

In this case, a terminal may also physically or operationally isolate the portion of a main memory unit recruited by the lock system from other portions of the main memory unit in such a way that a terminal may prevent such other portions of the main memory unit from being contaminated by results stored or residing in the recruited portion of the main memory unit. In this context, that portion of a main memory unit recruited by a lock system may be regarded as a unit of the lock system, not a unit of the main system.

In the above embodiment of the preceding paragraph, a terminal may run an erase (or semi-erase) operation in the recruited portion of the main memory unit in one of such erasure timings, thereby erasing all (or some) of such results stored or residing in the recruited portion of the main memory unit. Accordingly, the terminal may ensure that any viruses or malicious programs included in such results may be eventually erased and may not contaminate the main system of the terminal.

In either embodiment of this Section 2-3, a terminal may also allow a user to store at least some of such results residing in a lock system, and then to access such results while a user operates a main system in an unlock mode. In this case, a terminal may ensure that those results may neither access nor alter any unit of the main (or intermediary) system, or that the results may not be stored in a main (or intermediate) system. The terminal may also allow a user to retrieve at least a portion of such results in an unlock mode and to store such a portion of such results in a main memory unit of a main system. In this case, a terminal may check whether the to-be-stored results may not contain any malicious virus therein.

In the saving operation, a terminal may select a certain portion of such results as designated by a user. Then, the terminal may run a saving operation, and may save that certain portion in a lock (or main) system. As a result, once the saving operation is completed, that certain portion of such results will still reside in a lock (or main) system. All other portions of such results may still reside in the lock (or main) system when the terminal does not run any erase operation. Or all other portions of the results may not reside in the lock (or main) system when the terminal completes an erase operation.

In the saving operation, a terminal may alternatively select a certain portion of the results, where a user may designate that certain portion by providing a certain user input. The terminal may then run a saving operation and save a certain part of the certain portion of such results, where all other parts of the certain portion of such results may [1] still reside in a lock (or main) system when the terminal does not run any erase operation, or [2] not reside in a lock (or main) system when the terminal runs a erase operation.

Alternatively, a terminal may select the certain portion of such results based on an outcome of running an anti-virus operation. For example, upon receiving a user input for running a saving operation, a terminal may run an anti-virus operation, anti-malware operation, anti-spyware operation, or the like. By scanning such results, the terminal may detect a certain portion of such results which may be infected by malicious viruses.

The terminal may then erase the infected portion of such results, while saving the remaining portions of such results. In the alternative, a terminal may scan a certain portion of such results, scan such a portion of such results, and erase an infected part of such a portion, while saving the remaining parts of such a portion.

### 2-4. Implementing Lock and Main Systems into a Terminal

A fourth objective and another exemplary aspect of a data processing terminal and its related methods are to provide a data processing terminal capable of running various operations using various hardware or software elements provided in various configurations, thereby fulfilling various objectives of this disclosure. To this end, a terminal may include at least one main system and at least one lock system, where (at least a portion or an entire portion of) a lock system may be physically or operationally isolated from (at least a portion or an entire portion of) a main system. When a terminal includes at least one intermediate system, a lock system may also be physically or operationally isolated from (at least a portion or an entire portion of) an intermediate (or main) system. It is noted that features related to a lock system operating in a lock mode in the following embodiments of this Section 2-4 may be similarly incorporated to an intermediate system operating in an intermediate mode.

In a 1^{st} exemplary embodiment of this fourth objective, a data processing terminal includes at least one main system and at least one lock system. The main system may include at least one main CPU unit, at least one main memory unit, at least one main input unit, and at least one main output unit, along with other optional main units as commonly found in other prior art data processing devices.

The lock system may include at least one lock application (i.e., a lock app and, e.g., a prior art file viewer), at least one optional lock memory unit, at least one optional lock CPU unit, and an optional lock hardware or software element such as, e.g., a lock display unit or other lock apps. It is noted in this embodiment that each element of a lock system is “operationally isolated” from at least one or all elements of a main system in such a wat that a terminal does not allow a lock system to drive any element of a main system in a lock mode or in an unlock mode. It is also noted in this embodiment that at least one or all elements of a lock system may be “physically isolated” from at least one or all elements of a main system so that a terminal disposes at least one or all elements of a lock system not physically adjacent to at least one or all elements of a main system.

In one case, a data processing terminal may include at least one main system and at least one lock system in various configurations. In one case, a lock system may be implemented independently of a main system, i.e., “completely isolated” from all units or all elements of a main system, either physically or operationally. As a result, when a lock system includes a lock hardware or software element, that lock element may be physically or operationally isolated from all units or all elements of a main system completely, whereby the terminal may completely prevent [1] any results stored or residing in a lock system from adversely affecting any unit or any element of a main system, or [2] any lock unit or lock element from adversely affecting any unit or any element of a main system.

In another case, a lock system may only be “partly isolated” from all units or elements of a main system, either physically or operationally. Thus, when a lock system includes a lock hardware or software element, that lock element [1] may be physically or operationally isolated from at least one but not from all units (or elements) of a main system, or [2] may not be isolated from all units (or elements) of a main system but may be isolated from at least one unit (or element) of a main system. Accordingly, a terminal may prevent some results stored or residing in the isolated unit of a lock system from adversely affecting any unit of a main system.

In a 2^{nd} exemplary embodiment of this fourth objective, an exemplary data processing terminal may include at least one main system and at least one lock system, each of which is similar to that of the 1^{st} embodiment of this fourth objective. In addition, each lock element of a lock system is “physically isolated” (i.e., positioned in different locations) from all elements of a main system. But a lock system is not completely operationally isolated from a main system such that [1] a terminal may allow a lock system to drive at least one element of a main system or that [2] a lock system may recruit at least one but not all elements of a main system in a lock mode.

In this context, this lock system is referred to as “operationally partly interacting” with at least one (but not all) element of a main system. In contrary, when a lock system may recruit all elements of a main system in a lock mode, this lock system is to be referred to as “operationally completely interacting” with a main system.

In this embodiment, a lock system may be physically isolated from a main system so that a lock system is disposed in a location which is not adjacent to all elements of a main system.

In one case, a lock system may recruit at least one but not all portions of a main memory unit, and temporarily (or permanently) store all (or some) results obtained by running lock operations in a lock mode. Thereafter, a lock system may retrieve the stored results from the recruited portion of a main memory unit. In another case, a lock system may recruit at least one but not all portions of a main CPU unit, and run lock operations with the recruited portion of a main CPU unit in a lock mode. In yet another case, a lock system may recruit at least a portion but not all portions of a main display unit and display therein various results obtained by running lock operations in a lock mode.

It is appreciated in such cases that, even though a lock system may recruit some elements of a main system, a terminal may still prevent a lock system [1] from erasing any data which have been already stored in a main memory unit, [2] from changing configurations of any main unit of a main system, or the like. Accordingly, a terminal may enhance the security, improve integrity, and heighten privacy of the main system of a terminal.

In a 3^{rd} exemplary embodiment of this fourth objective, an exemplary data processing terminal may include at least one main system and at least one lock system, each of which is similar to that of the 1^{st} embodiment of this fourth objective. However, each element or unit of a lock system is “completely operationally isolated” from (i.e., not interacting with) each element or unit of a main system. Therefore, such a lock system may not be able to recruit any element of a main system, as far as a user operates a terminal in a lock mode.

However, at least one element of a lock system [1] may be disposed adjacent to at least one element of a main system either laterally or vertically, or [2] may form a unitary article with at least one element of a main system. Accordingly, although a lock system is (completely or partly) operationally isolated from a main system, such a lock system is referred to as “physically interacting” with at least one (but not all) element of a main system.

In this embodiment, a lock system is operationally isolated from a main system in such a way that a lock system does not recruit any element of a main system at all. In one case, a lock memory unit of a lock system may be disposed next to a main memory unit of a main system. A lock memory unit and a main memory unit may also form a unitary article.

However, a lock system may not drive any portion of a main memory unit, or a main system may not drive any portion of a lock memory unit. In another case, a lock CPU unit of a lock system may be disposed next to a main CPU unit of a main system. A lock CPU unit may even form a unitary article with a main CPU unit. However, a lock system may not drive any portion of a main CPU unit, or a main system may not drive any portion of a lock CPU unit.

In a 4^{th} exemplary embodiment of this fourth objective, an exemplary data processing terminal may include at least one main system and at least one lock system, each of which is similar to that of the 1^{st} embodiment. But a main system is “operationally interacting” with at least one element of a lock system such that a main system may drive the interacting portion of a lock system while a user operates a terminal in an unlock mode, [1] whether or not a lock system is “operationally interacting” with at least one element of a main system and, thus, whether or not a lock system may drive the interacting portion of a main system in a lock mode, or [2] whether or not a lock system is “operationally isolated” with all elements of a main system and, therefore, whether or not a lock system may drive any element of a main system in a lock mode. In this case, a lock system may be “physically isolated” from a main system or “physically interacting” with at least one element of the main system.

As described above, a terminal may grant different access authorities to the lock and main systems in the lock and unlock modes. Thus and in a 5^{th} exemplary embodiment of this fourth objective, a terminal may entirely restrict a lock system from driving any hardware or software element of a main system in a lock mode. In the alternative, a terminal may grant a lock system to drive only a certain hardware or software element of a main system in a lock (or intermediate) mode.

Thus, by manipulating a degree of physical or operational isolation between a main system and a lock system, a user may easily run a lock operation [1] with a lock system only in a lock mode, [2] with a lock system in both of the lock and unlock modes, [3] with a main system in an unlock mode along with [1] or [2], or the like. It is noted, however, that a terminal may prevent or at least minimize an accident that a lock system may adversely affect a main system or that the lock and main systems may get mixed up in running operations in the lock or unlock mode so that some results obtained by running lock operations in a lock mode may adversely degrade the security, integrity, or privacy of a main system.

The existence of a lock system may generally require a terminal to incorporate at least one extra hardware or software element of the lock system, and to define an extra space to fit the extra element inside the terminal. However, costs and efforts associated with the extra element and extra space may well be surpassed by, e.g., improved versatility in seamless operations, enhanced security or integrity, a minimized risk of hacking by an unauthorized person, or improved privacy of personal data stored in a terminal. Alternatively, by configuring at least a portion of a main CPU unit or a main O/S to serve as a part of a lock system while providing physical or operational isolation between such lock and main systems, a terminal may provide a user with the above advantages, while obviating the need for an extra hardware or software element.

### 2-5. Implementing a Single System for Both of Lock and Unlock Modes

A fifth objective and another exemplary aspect of a data processing terminal and related methods thereof are to provide a data processing terminal which includes a single system which may serve as both a main system and a lock system and, therefore, which can operate in both lock and unlock modes. That is, a terminal includes a single system which can operate as a main system in an unlock mode, and as a lock system in a lock mode.

Accordingly, this system may be viewed [1] as a single main system operating in an unlock mode, while also serving as a lock system when operating in a lock mode or [2] as a single lock system operating in a lock mode, while also serving as a main system when operating in an unlock mode. For illustration purposes, following explanations are based upon the above view [1]. It is noted, however, that various features of the following embodiments of this Section 2-5 may also be applicable to a terminal based on the above view [2]. In general, various embodiments of this fifth object may be embodied into the terminals of the 3^{rd} Configuration as will be described in greater detail below.

In one exemplary embodiment of this fifth objective, a terminal includes only a single system. In a lock mode, a terminal operates the system as a lock system which may drive certain hardware and software elements of a terminal, but which may be prevented [1] from driving other hardware or software elements of a terminal, [2] from altering such other elements, [3] from erasing data stored in such other elements, [4] from modifying or altering configuration or operational sequence of such other elements, [5] from storing results obtained from running lock operations in a lock mode into such other elements, [6] from updating or rearranging such other elements, or [7] from transmitting data stored in such other elements to a lock system, to another terminal, or to a 3^{rd} party. In addition, a terminal may also operate the single system as a main system in an unlock mode, while driving such other elements of a terminal. This single system may also operate in multiple lock or unlock modes, may run such “erasure” or “semi-erasure” when a terminal may switch from a lock mode to another lock or unlock mode (or vice versa when desirable), or when a terminal receives a certain user input.

That is, the above system may be regarded as a pool of multiple hardware and software elements, where a terminal assigns some elements to a lock system, while assigning the rest of such elements to a main system. To obtain the enhanced security, improved integrity, and better protection of data stored therein, such elements recruited by the system in a lock mode may be completely isolated from such other elements recruited by the system in an unlock mode, either physically or operationally. Alternatively, such elements recruited by a system may be partly isolated from such other elements recruited by the system.

In another exemplary embodiment of this fifth objective, a terminal similarly includes only a single system. In a lock mode, a terminal operates the system as a lock system which may drive certain hardware and software elements of a terminal, but which may be prevented from driving other remaining elements or from running some operations as exemplified in [1] to [7] of the above embodiment. In addition, a terminal may also operate the single system as a main system in an unlock mode, while driving such other elements of a terminal. The only difference between the terminals of the previous and present embodiment is that the latter terminal may allow at least one hardware or software element to be driven by both of a lock system and a main system.

In this context, this system may be regarded as a pool of multiple hardware and software elements, where a terminal may (1) assign a 1^{st} group of elements to a lock system, (2) assign a 2^{nd} group of elements to a main system, and then (3) assign a 3^{rd} group of elements to both of a lock system and a main system. To achieve the enhanced security, improved integrity, and better protection of data stored therein, the 1^{st} group of elements may be completely isolated from the 2^{nd} group of elements, either physically or operationally. At the same time, a terminal may also allow the 3^{rd} group of elements [1] to run the same operations in both of a lock mode and an unlock mode, [2] to run more operations in an unlock mode than in a lock mode, [3] to access and use the same data in both modes, [4] to access more data in an unlock mode than a lock mode, or the like.

Because such systems of this embodiment may operate as a main system as well as a lock system, it may be typically easier to construct a terminal, e.g., by granting different access authorities to a lock system and a main system, by displaying different graphical user interfaces (GUIs) on a lock screen and an unlock screen, or the like.

Because at least one hardware or software element can be used as a lock element as well as a main element, a terminal may not need to include multiple redundant elements or units in each of the lock and main systems. As a result, the terminal may be constructed as a more compact article. In addition, by isolating a group of elements (or units) recruited as a lock system from another group of elements (or units) recruited as a main system, this terminal may also enhance security, prevent hacking, improve integrity, or preserve privacy thereof. Moreover, this terminal may provide operational flexibility to a user who may set different access authorities to different modes, while incorporating only a single system therein.

### 2-6. Multiple Modes and Their Access Authorities

A sixth objective and another exemplary aspect of a data processing terminal and related methods thereof are to provide a terminal which operates in at least one lock mode and in at least one unlock mode, along with at least one optional intermediate mode such as, e.g., a semi-lock mode, a less-lock mode, a semi-unlock mode, or a less-unlock mode, and which assigns various access authorities to each of such modes.

As defined above, an “access authority” refers to an authority [1] to “access” a certain number (including zero) of accessible hardware or software elements of a main system of a terminal, unless otherwise specified that such elements belong to a lock (or intermediate) system, [2] to “drive” such an element, [3] to “run” a certain operation by driving such an element, or [4] to “perform” a certain function [4-1] by driving such an element or [4-2] by running such an operation. It is appreciated that features related to a lock system operating in a lock mode in the following embodiments of this Section may also apply to other features related to an intermediate system operating in an intermediate mode.

Further details of “2-6. Multiple Modes and Their Access Authorities” are identical to the following portions of the '861 application such as, e.g., FIG. 4, and the text from [0392] on page 36 through [0411] on page 38, where these portions are incorporated herein in their entirety by reference.

### 2-7. Easy Shifting Between Different Modes or States

A seventh objective and another exemplary aspect of a data processing terminal and related methods thereof are to provide a terminal with a hardware or software element with which a user can easily switch modes such as, e.g., switching [1] from a powered-off state to a certain mode of operation defined in a certain hierarchy, [2] from a powered-on state but an off-state to the certain mode of operation, [3] from a current mode to a new mode both of which are defined in the hierarchy, [4] from the certain mode to an off-state, or [5] from the current mode to a powered-off state. As a result, a user does not have to turn off a display unit and then turn it on to switch from a current mode to a new mode, or to authenticate himself or herself to switch modes, or the like.

Further details of such “2-7. Easy Shifting between Different Modes or States” are identical to the following portions of the '861 application such as, e.g., the text from [0414] on page 38 through [0422] on page 39, where these portions are incorporated herein in their entirety by reference.

### 2-8. Use Applications

An eighth objective and another exemplary aspect of this disclosure are to fabricate a data processing terminal which may include at least one of various features related to such mode switching and which may operate in one of various sequences or arrangements such that the terminal may enhance such security, prevent such hacking, improve such integrity, or preserve such privacy which have been described above. Various data processing terminals of this disclosure are generally fabricated as portable terminals in such a way that a user may carry such terminals with himself, like prior art smartphones, handphones or tablets.

In the first exemplary embodiment of this eighth objective, a data processing terminal of this disclosure may be readily fabricated according to this disclosure and based upon various teaching provided herein.

In the second exemplary embodiment of this eighth objective, a data processing terminal of this disclosure can also be fabricated by modifying at least one hardware or software element of a prior art data processing device based on this disclosure or based on various teachings thereof, thereby converting the prior art data processing device into the data processing terminal of this disclosure.

Therefore, the data processing terminal of this disclosure may be fabricated by modifying various prior art data processing devices or data managing devices such as, e.g., [1] a prior art desk top data processor, [2] a prior art device including that processor, [3] a prior art mobile data processor, [4] a prior art device including that processor, or [5] other prior art devices which can run various data processing operations such as, e.g., [5-1] data storing, [5-2] data editing or rearranging, [5-3] data storing, [5-4] data cleaning or erasing, [5-5] reception or transmission of such data, or the like. It then follows that various data processing terminals of this disclosure may also be fabricated in shapes, sizes, or designs which may be similar or identical to those of such prior art devices described in this paragraph.

In the third exemplary embodiment of this eighth objective, such features related to various mode switching, authenticating or turning on each combined with erasure (or semi-erasure) described in this disclosure may be implemented into various prior art computers such as, e.g., [1] desk top computers, [2] lap-top computers, [3] mobile pads, [4] computers of various sizes or capacities which are incorporated into various electrical devices such as, e.g., [4-1] vehicles, [4-2] robots, or the like, each of which can run various data processing operations examples of which have been described in the preceding paragraph. Thus, a data processing terminal of this disclosure may be fabricated in a shape, a size, or a design which may be similar or identical to those of various prior art devices which are described in this paragraph.

In the fourth exemplary embodiment of this eighth objective, such features related to various mode switching, authenticating or turning on each combined with erasure (or semi-erasure) exemplified in this disclosure may be implemented into various prior art wireless communication devices. Thus, various data processing terminal of this disclosure may be fabricated in a shape, a size, or a design which is similar or identical to [1] prior art smart-phones, [2] prior art mobile-phones, [3] prior art mobile pads, [4] prior art personal digital assistants, [5] prior art web pads, [6] other prior art wireless communication devices, or [7] other prior art data processing devices.

In the fifth exemplary embodiment of this eighth objective, the data processing terminals of this disclosure may include various prior art features which are related to, e.g., an internet of things (IoT), big data, artificial intelligence (AI), or the like.

In the 1^{st} example, a data processing terminal of this disclosure may include at least one hardware element or software element which can connect to an IoT network, or to an electrical device which is a part of the IoT network, thereby monitoring or manipulating an operation of the IoT network or an operation of the electric device. When desirable, a terminal may couple with an electrical device in the IoT network and then manipulate the electric device based on the mode switching of a terminal.

Conversely, an electrical device which is in the IoT network may couple with a terminal of this disclosure and render the terminal switch modes [1] when the device may start or end a certain operation, [2] when the device detects a certain event (e.g., fire, emergency, or other preset events), or the like. The terminal may also utilize the IoT-related features for various applications in which prior art IoT's are currently employed.

A terminal may also check whether a IoT network, any device connected to the IoT network, a lock system or any lock element (or unit) includes any malicious virus, whether a terminal has to remove a software element infected with the malicious virus from the network, device, lock system or lock element (or unit) and reload a corresponding software element thereinto, or the like.

In the 2^{nd} example, a data processing terminal of this disclosure may include at least one hardware or software elements which can connect to a big data repository, thereby storing data therein or retrieving data therefrom. In addition, such a terminal may incorporate a prior art algorithm or computer codes with which the terminal may analyze the big data and utilize such in conjunction with various operations of the terminal. For example, a terminal may condition the mode switching upon an outcome obtained by analyzing the big data, or such a terminal may manipulate the data stored in the big data repository based on the mode switching.

In the 3^{rd} example, a data processing terminal of this disclosure may include at least one hardware element or software element which incorporates or collaborates with various conventional intelligent agents, thereby analyzing usages of a terminal, user preferences, user habits, and environment with such agents, and assist a terminal or a user. Accordingly, the intelligent agents may provide a terminal (or a user) with reasoning, knowledge, planning, or natural language processing, as have been performed by prior art intelligent agents such as, e.g., artificial intelligence (AI).

For example, such a terminal may employ the prior art intelligent agent for various purposes such as, e.g., controlling a hardware or software element of the terminal, performing self-diagnosis of a main system or a lock system of such a terminal, repairing any defects of such systems, diagnosing physical or operational isolation between a lock system and a main system, or the like.

A terminal may also employ the prior art intelligent agent to assist a user in various ways such as, e.g., keeping track of [1] various operations which a user ran, [2] various functions which a user performed, [3] sequence of various modes in which a user operated a terminal, or the like. Based thereupon, the prior art intelligent agent may suggest a user which operation to run, which function to perform, whether the user should stay in a current mode, to which mode the user may switch, whether a lock system or its units (or elements) includes malicious virus, whether a terminal has to remove a current lock element (or lock system) and reload a corresponding lock element (or system) or the like.

More particularly, a terminal may switch modes with a guidance from the intelligent agent. In the 1^{st} example, the intelligent agent may require a terminal to switch from a current mode to a new mode based upon user actions, e.g., [1] when an outcome obtained from running lock (or unlock) operations by a user in a lock (or unlock) mode may favor such mode switching, [2] when user statistics may reveal that a user tends to switch modes at a certain instance or under a preset circumstance, or [3] when a user preference may mandate such mode switching.

In the 2^{nd} example, the intelligent agent may require a terminal to switch from a current mode to a new mode based upon external circumstances or events, e.g., [1] when an emergency occurs or a preset event happens, [2] when a chance of an emergency or a preset event increases over a preset threshold, [3] when a preset appointment is upcoming, [4] when a certain call, message, or email is received, or the like. The terminal may also utilize those intelligent agent-related features for various applications in which prior art intelligent agents are currently employed.

In the sixth exemplary embodiment of this eighth objective, a user may apply various features of this disclosure not only to a mobile data processing terminal as described heretofore and hereinafter, but also to [1] a non-mobile data processing terminal (or equipment) or [2] a non-portable data processing terminal (or equipment). For example, a non-mobile terminal (e.g., prior art desktop computers or other data processing devices) may incorporate various features of this disclosure such that security of the computer or devices, integrity thereof, or protection of data stored therein may be enhanced. In another example, various transportation vehicle (such as, e.g., an automobile, a train, a motor bicycle, a bicycle, an airplane, or a helicopter) or various drones may incorporate various features of this disclosure in such a way that operation of such vehicles or drones may be better protected and, at the same time, prevent unauthorized users from using such vehicles or drones for undesirable purposes.

In the seventh exemplary embodiment of this eighth objective, a data processing terminal of this disclosure may have an adjustable configuration such as, e.g., a foldable configuration, a rollable configuration, or the like. A terminal with a fordable configuration (i.e., a foldable terminal) may include at least one foldable portion which can be unfolded or folded, respectably, in an unfolded state and a folded state, thereby exposing a different number of display units to a user in those states.

In contrary, a terminal with a rollable configuration (i.e., a rollable terminal) may include at least one rollable portion on a display surface of a display unit which can be unrolled (thus, exposed to a user) and rolled (thus, not exposed to a user), respectively, in an unrolled state and a rolled state, thereby providing a user with the display surfaces with varying shapes or sizes.

Further details of such data processing terminals which are fabricated in the foldable configuration or rollable configuration are described below in Section 8 (or 5^{th} Configuration) of this disclosure.

In the eighth exemplary embodiment of this eighth objective, a data processing terminal of this disclosure may be applied to or used with various prior art systems related to, e.g., a virtual reality (VR), an augmented reality (AR), a mixed reality (MR), an extended reality (XR), a substitutional reality (SR). More particularly, various features exemplified for the VR hereinafter may be applied to the AR, MR, XR or SR, unless otherwise specified. For example, when the VR includes a VR system, the VR system may also be applied to the AR, MR, XR or SR such that the AR may include an AR system, an MR may include an MR system, an XR may include an XR system, or the SR may include a SR system.

In this disclosure, the VR is provided to a user by a VR system which may generate realistic images, sounds, and optionally other sensations all of which may simulate a physical presence of a user in a “virtual world” (to be referred to as “VW” hereinafter). Therefore, a user using a VR system may look around a VW, move around in the VW, and interact with virtual features or items provided in the VW.

In order to generate realistic images, sounds or other sensations which may simulate the physical presence of a user in a VW, a VR system may use [1] a head-mounted display such as, e.g., a headset or a goggle, or [2] a multi-projected environment such as, e.g., a specially designed space with multiple large screens. A VR system may provide to a user or receive therefrom auditory and video feedback signals, but may allow other types of sensory or force feedback through haptic technology.

For simplicity of illustration, a head-mount display, multi-projected environment or other hardware elements for embodying the realistic images, sounds and other sensations which may simulate physical presence of a user in a VW (i.e., a virtual world) are to be collectively referred to as a “HMD” or a “head-mount display” hereinafter.

It is noted that a VR system may include at least one additional sensor to obtain a signal from a movement of a body part (e.g., a finger, hand, wrist, arm, shoulder, neck, head, upper body, hip, lower limb, leg, or toe) of a user. It is also noted that a VR system may include at least one actuator to deliver at least one feedback signal which is generated by the VR system and which is delivered to at least one of such body parts of the user.

Such sensors or actuators may be incorporated into a HMD and, thus, a user may put the HMD around his head. Instead, such sensors or actuators may not be incorporated into the HMD and, therefore, may not be worn by a user around his head. Rather, such sensors or actuators may be incorporated into other peripherals which may be coupled to or worn around another body part of the user. For simplicity of illustration, however, such sensors or actuators which are not incorporated into a HMD will be collectively referred to as a part of a HMD or simply as the HMD, unless otherwise specified.

In general, a server (or a VW server), a HMD (or a VW HMD), or one of various data processing terminals of this disclosure may include at least one (VW) hardware element or at least one (VW) software element which [1] can couple with or [2] can be connected to each other.

Examples of such VW hardware elements may include [1] a VW server or its equivalent capable of providing a background or contents of various VW episodes to a user, [2] a HMD, [3] a terminal, or [4] various hardware elements of such a terminal.

Examples of such VW software elements may include [1] an O/S, a computer program or computer codes each of which is capable of providing a VW to a user, or [2] at least one app which may be run by the O/S, program or codes.

In the 1^{st} example of this eighth exemplary embodiment, a VR system may be installed into a data processing terminal of this disclosure. A user may then operate a lock, intermediate or main system in the VR. For example, a user may enter the VW with his or her terminal and may run various operations in various episodes, where examples of such episodes may include, e.g., playing games, watching contents, connecting with other people, gathering information, visiting places, doing shopping or making transactions. Each game, people connection, information gathering, visiting, shopping or transaction may include more than one episode.

While running such operations in each episode, the user creates various “results” which may include malicious viruses capable of threatening the security or integrity of the terminal, allowing hackers to access and to steal (or degrade) precious data stored in the terminal, or the like. A terminal of this disclosure may enhance its security and integrity and preserve data of a user stored therein in the VW as well.

For example, when a user is not sure about the safety or integrity of a certain episode (e.g., a presence or an absence of malicious viruses), a terminal may allow a user to create such “results” in a lock mode by, e.g., [1] running a lock operation in that VW episode in a lock mode, [2] by visiting various sources of contents provided in that VW episode in the lock mode, [3] downloading data, texts, files, folders, contents, images or computer codes from their sources provided in that VW episode in the lock mode, [4] arranging or processing such data, texts, files, folders, contents, images or computer codes of that VW episode in the lock mode, or the like.

A terminal may not allow the user or such results from accessing certain hardware or software elements of a main system) of the terminal in the lock mode, e.g., by employing various physical or operational isolations as described throughout this disclosure.

When a user may switch from one episode to another episode or may switch from the lock mode to an unlock (or intermediate) mode, the terminal may run an erase (or semi-erase) operation on such results in one of various erasure timings described in this disclosure.

Accordingly, a user may obviate even a remote possibility that the malicious viruses included in such results may access or degrade those certain hardware or software elements of a main system of a terminal.

A user may still use a HMD to fully enjoy the VW. To this end, the HMD may be coupled to a terminal. A user may then enter the VW, and run various operations in various episodes in a lock mode such as, e.g., playing games, connecting with other people, gathering information, doing shopping or making transactions, while creating results by operating a lock system in a lock mode, where the lock system may be incorporated into a HMD or a terminal. When A user may switch from one episode to another episode or may switch from the lock mode to an unlock (or intermediate) mode, the terminal may run an erase (or semi-erase) operation on such results in one of various erasure timings as described in this disclosure.

It is noted that a lock, intermediate or main system of the VR system (e.g., a terminal, a server or a HMD) may be implemented into various devices. For example, at least one of such a lock, intermediate or main system may be installed into [1] a terminal, [2] a HMD, [3] a server, [4] at least two of [1], [2], and [3], or [5] all of [1], [2], and [3]. When desirable, multiple lock, intermediate or main systems which are granted with identical or different access authorities may be installed in one of the above [1] to p5[so that a terminal may include one lock system, while one of the (VW) HMD and (VW) server may include another lock system.

In the 2^{nd} example of this eighth exemplary embodiment, a VR may be is provided by an external VW server, and a user uses a HMD to enjoy the VW, where the server and the user respectively correspond to a server and a client of a prior art client-server network.

Similar to a lock system and a main system of various data processing terminals described above, a VW server may assign a user (i.e., a client) two different sectors in a VW account of the user, where the 1^{st} sector and the 2^{nd} sector may respectively operate like a lock system and a main system. Thus, the 1^{st} sector may include at least one lock hardware or software lock element, and the 2^{nd} sector may include at least one main hardware or software element. In this context, the 1^{st} sector may be referred to as the lock sector operating in a lock mode, while the 2^{nd} sector may be referred to the main sector operating in an unlock mode. When desirable, the VW server may assign an additional sector which may operate like an intermediate system.

A user may enter the VW while wearing a HMD, and run various operations in various episodes while operating the lock sector. When a user switches from one episode to another episode or may switch from the lock sector to an main sector, the terminal may run an erase (or semi-erase) operation on such results in one of various erasure timings. Therefore, a user may obviate a remote possibility that the malicious viruses included in such results may access or degrade those hardware or software elements in the main sector of the user's account provided by the server.

In the 3^{rd} example of this eighth exemplary embodiment, a VR may be provided by an external VW server, and a user uses a HMD to enjoy the VW, just like the 2^{nd} example of this eighth embodiment. However, a VR system may not provide all of the 1^{st} and 2^{nd} sectors of the 2^{nd} example to the server.

Therefore, the lock sector may be provided in the HMD, while the main sector may be provided in the server. Or the lock sector may be provided in the server, while the main sector may be provided in the HMD. Or the lock sector as well as the main sector may be provided in the HMD.

In the 4^{th} example of this eighth exemplary embodiment, a VR may be provided by an external server, and a user uses a HMD to enjoy the VW, just like the 2^{nd} example of this eighth embodiment. However, a VR system may provide at least one of the 1^{st} and 2^{nd} sectors to one of various terminals of this disclosure.

Thus, one of the lock and main sectors may be provided in the server, while the other of such sectors may be provided in the terminal. Or one of the lock and main sectors may be provided in the HMD, while the other of such sectors may be provided in the terminal.

In the 5^{th} example of this eighth exemplary embodiment, regardless of whether or not a VR may be provided by an external VW server, the “results” may be generated only in one of various terminals of this disclosure. To this end, the terminal is preferably capable of transmitting or receiving data to and from [1] a VW server, [2] a VW HMD, or the like.

Because a terminal includes a lock system and a main system and such results may be temporarily residing or stored in the lock system, a terminal may run an erasure (or semi-erasure) operation when a user switches [1] from one VW episode to another VW episode or [2] from a lock mode to an unlock (or intermediate) mode, thereby preventing the malicious viruses hidden or residing in such results from adversely affecting the main system of the terminal.

Further details of such data processing terminals which may be applied to or used with various prior art features related to the VR are described below in Section 9 (or 6^{th} Configuration) of this disclosure.

### 2-9. User Applications

A ninth objective and another exemplary aspect of a data processing terminal and related methods thereof are to grant certain access authorities to multiple modes of operation defined in a certain hierarchy, to incorporate such into a terminal, and to enable a single user or multiple users to utilize multiple modes with a single terminal. To this end, a terminal may include multiple systems each of which may operate in each of multiple modes defined in a certain hierarchy. As a result, a single user or multiple users may enjoy versatility or flexibility in using such a terminal by operating at least two different systems in one or at least two of different modes.

Further details of “2-9. User Applications” are identical to the following portions of the '861 Application such as, e.g., the text from [0437] on page 40 to [0445] on page 41, where these portions are incorporated herein in their entirety by reference.

### 2-10. User Advantages

A tenth objective and another exemplary aspect of a data processing terminals and its related methods are to offer a user with enhanced security, improved privacy, and better protection of data stored therein.

In a 1^{st} exemplary embodiment of this tenth objective, a terminal may provide a user with various hierarchies each of which defines multiple modes of operation thereon. A terminal may grant each mode with identical, similar, comparable, or different access authorities. A terminal may erase an entire (or only selected) portions of results obtained by running various operations in a lock (or unlock) mode in response to mode switching in various erasure timings. In addition, the terminal may run such erasure (or semi-erasure) when a terminal may switch from a mode with less access authority [1] to another mode with greater access authority, [2] to another mode with comparable or non-overlapping access authority, or the like.

Therefore, a terminal operating in a new mode may be secured from potential attacks from malicious programs which may have been downloaded and impregnated into such results obtained in a previous mode, whether the previous mode is granted with less access authority than a new mode (or vice versa). As a result, a user may enjoy operating a terminal in each of multiple modes defined in a hierarchy by completely (or partly) isolating each mode from the rest of multiple modes in the hierarchy, without having to worry about potential contamination or spoiling of a terminal therefrom. As a result, a user can enjoy enhanced security, improved privacy, and heightened privacy.

In a 2^{nd} exemplary embodiment of this tenth objective, a lock system of a terminal of this disclosure may stay inside the terminal [1] in a powered-off state, [2] in an off state, [3] even when a terminal may operate a main system in an unlock mode, or the like. A lock app (or software element) may similarly stay inside the terminal [1] in a powered-off state, [2] in an off state, [3] even when a terminal may operate a main system in an unlock mode, or the like.

Of course, when a terminal finds that a certain lock app (or element) is contaminated by malicious viruses, the terminal may remove such an app (or element) from a lock system, and may reload a new version of such an app (or element) into the lock system. Or the terminal may remove the entire lock system, and reload a new version of the lock system thereinto.

Except such periods for removing and reloading, a lock app (or element) or a lock system always stays in the terminal [1] in a powered-off state, [2] in an off state, or [3] when a terminal may operate a main system in an unlock mode.

Even when multiple users (e.g., A and B) share a terminal, when each of A and B has his own account, and when A's (or B's) account includes A's (or B's) own lock system and A's (or B's) main system, A's and B's lock apps (or elements) stay in the terminal (except for such periods for removing and reloading) [1] in a powered-off state, [2] in an off state, or [3] when a terminal operate a main system in an unlock mode. Therefore, when A operates A's lock app in A's lock mode, B's lock app still stays in B's lock system and in the terminal.

Therefore, a user can readily [1] operate the lock system, [2] drive the lock app (or element) [3] run various lock operations in a lock mode, or the like, without having to reload (or load) a proper app (or element) into the lock system and drive such a lock app, whenever a user may drive the lock system and to run lock operations.

In a 3^{rd} exemplary embodiment of this tenth objective, a terminal of this disclosure may isolate a main system from a lock system by physically or operationally isolate the main system from the lock system. In addition, a terminal may run an erase (or semi-erase) operations on such “results” which are obtained by running lock operations in a lock mode.

By running such erasure (or semi-erasure), a terminal can erase malicious viruses which may be included in such results, thereby enhancing the security of a main system or an entire terminal.

Similar to the above 3^{rd} embodiment, a terminal of the 4^{th} exemplary embodiment of this tenth objective of this disclosure may also isolate a main system from a lock system by physically or operationally isolate the main system from the lock system. A terminal may run an erase (or semi-erase) operations on such “results” as well. Because a terminal can erase spyware, spy-codes, malicious computer codes or cookies (e.g., http cookies) which [1] may be included in such results or [2] may contaminate at least one lock element of the lock system, the terminal can also maintain privacy of user's activities.

Further details of “2-10. User Advantages” are identical to the following portions of the '861 application such as, e.g., the text from [0450] on page 41 to [0456] on page 42, where these portions are incorporated herein in their entirety by reference.

### 2-11. Modifying or Improving Prior Art Data Processing Devices

Various data processing terminals, their units, and their hardware or software elements of this disclosure may operate in different modes of operation which have been disclosed in various prior art documents. Examples of such prior art includes U.S. Pat. No. 8,782,775 entitled “Embedded authentication systems in an electronic device” and assigned to Apple (specifically referring to, but not limited to, FIG. 3 and FIG. 5C, Col. 7; Lines 27-39, Col. 8; Line 15-Col. 9; Line 17), U.S. Pat. Application Publication No. 2012/0009896 entitled “Above-lock camera access” and assigned to Microsoft Corp. (specifically referring to, but not limited to, FIGS. 3A-3B, FIGS. 4A-4B, Para. [70]-[72], Para. [75]-[76]), U.S. Pat. No. 8,943,580 entitled “Embedded authentication systems in an electronic device” and assigned to Apple, Inc. (specifically referring to, but not limited to, FIGS. 3 and 5C, Col. 7; Line 27-39, Col. 8; Line 15-Col. 9; Line 17), or the like.

It is appreciated, however, that various terminals of this disclosure may grant the prior art modes of operation of the above paragraph with access authorities which are different from those as disclosed in such prior art. In addition, various terminals of this disclosure may include such prior art modes of the preceding paragraph in a new hierarchy which may also be different from those disclosed in such prior art. Various terminals of this disclosure may further combine such prior art modes with other modes which are disclosed heretofore and hereinafter.

### 3. Additional Objectives

This disclosure relates to various data processing terminals each of which may operate in multiple modes of operations one at a time. More particularly, each terminal of this disclosure may erase an entire (or a selected) portion of results which are obtained by running various lock (or intermediate) operations by operating a lock (or intermediate) system in a lock (or intermediate) mode, where such results may be stored or reside in a lock (or intermediate) system in a lock (or intermediate) mode.

Thus, even when a user runs various lock (or intermediate) operations with a lock (or intermediate) system in a corresponding mode while accessing unreliable websites, connecting to suspicious links, or downloading files or contents impregnated with malicious viruses therefrom, a terminal can erase an entire (or selected) portion of such results in various erasure timings. As a result, when a terminal may switch to an unlock mode, such malicious viruses have already been erased and, therefore, cannot adversely affect a main system of a terminal.

In addition to such erasure or semi-erasure, various terminals of this disclosure may physically or operationally isolate a main (or lock) system from a lock (or main) system either completely or partly. As a result, even when malicious viruses successfully land onto a lock system, such viruses may not migrate into a main system due to such physical or operational isolation.

Accordingly, various terminals of this disclosure can protect themselves against a risk posed by questionable websites, potentially detrimental downloaded contents, and viruses embedded in such contents or links. At the same time, a terminal enables a user to enjoy seamless operations, while switching from one mode to another without making a user worry about contaminating or damaging his or her terminal from his or her activities in a restricted mode.

In a 1^{st} exemplary objective of this disclosure, a method is provided for operating a data processing terminal in a lock mode and in an unlock mode. The terminal includes a lock system, a main system, and a display unit. The lock system includes a first number of lock elements one of which is a first lock element capable of performing a first function, while the main system includes a second number of main elements one of which is a first main element which can perform the first function, where the second number may be greater than, equal to, or less than said first number. The terminal drives the lock system in the lock mode, but drives the main system in the unlock mode.

The method may include the steps of providing a first access authority to a user for driving the lock elements of the lock system in the lock mode; providing a second access authority to the user for driving the main elements of the main system in the unlock mode; displaying a lock screen on the display unit in said the mode; displaying a graphical user interface of the first lock element on the lock screen in the lock mode; allowing the user's accessing an external source with the first lock element in the lock mode when the terminal receives from the user a first user input provided to the graphical user interface, where the external source includes at least one content infected by a malicious virus; allowing the user's downloading from the external source a first result including the content through the accessing in the lock mode, while blocking the first result from accessing the main system in the lock mode; receiving from the user a second user input for switching from the lock mode to the unlock mode; and erasing a certain portion of the first result at an erasure timing related to one of the receiving said second user input and the switching to the unlock mode, wherein the certain portion of the first result includes the content, whereby the terminal prevents the infected content included in the first result from infecting the first main element of the main system in the lock mode, even when the first lock element is infected by the content in the lock mode.

In a 1^{st} example of the 1^{st} exemplary objective, the first lock element is an application (or app) for performing the first function, and the first main element is another application for performing the first function.

In a 2^{nd} example of the 1^{st} exemplary objective, such erasure timing is one of a first timing which is after the receiving the second user input but before the switching; a second timing which may be concurrent with the switching; a third timing which may be immediately after the switching; and a fourth timing which is after the switching but before receiving from the user a third user input, where the receiving the third user input is after the receiving the second user input.

In a 3^{rd} example of the 1^{st} exemplary objective, the method includes the steps of: authenticating the user based upon at least a portion of the second user input; performing the switching when the user passes the authenticating; and not performing the switching when the user fails to pass the authenticating, where such a terminal may perform the user authenticating using at least one of a fingerprint of the user, the user's iris, the user's retina, the user's voice, the said user's face.

In a 4^{th} example of the 1^{st} exemplary objective, such not performing of the 3^{rd} example may include one of the steps of: remaining in the lock mode after the user fails the authenticating; turning off the display unit after the user fails the authenticating; and performing the erasing after the user fails the authenticating.

In a 5^{th} example of the 1^{st} exemplary objective, the first lock element is one of a web browser application, an email application, a messenger application, an internet-of-things application, and an ad viewer application.

In a 6^{th} example of the 1^{st} exemplary objective, the content of the 6^{th} example is a text, a file, a folder, or data, where the downloading includes at least one of the steps of: allowing the user to access an internet-of-things network by driving the internet-of-things application and download the content through the internet-of-things network; allowing the user to access a website by driving the web browser application and download the content from the website; and allowing the user to download the content by driving one of the ad viewer application, the messenger application, and the email application.

In an 7^{th} example of the 1^{st} exemplary objective, such downloading may include the step of acquiring the first result by performing one of displaying a file, displaying an image, and accessing a website.

In a 8^{th} example of the 1^{st} exemplary objective, such erasing may include one of the steps of: erasing only the content, while not erasing the rest of the first result; erasing the certain portion which includes the content but not erasing remaining portions of the first result; and erasing an entire portion of the first result, including the certain portion which in turn includes the content.

In a 9^{th} example of the 1^{st} exemplary objective, the terminal may receive a fourth user input from the user, where such erasing includes one of the steps of: identifying a portion of the first result which is designated by the fourth user input as the certain portion, and erasing the identified portion; and identifying a portion of the first result which is designated by the fourth user input as a portion which is different from the certain portion, and erasing the first result except the identified portion.

In a 10^{th} example of the 1^{st} exemplary objective, the method also includes the steps of: erasing the certain portion of the first result while saving the rest of the first result in the lock system; and allowing the user to access the rest of the first result in the unlock mode after the switching to the unlock mode.

In a 2^{nd} exemplary objective of this disclosure, a data processing terminal operates in a lock mode and in an unlock mode, and includes a display unit, a lock system, and a main system. The terminal operates the lock system in the lock mode, and the lock system displays a lock screen on the display unit in the lock mode. The main system which the terminal operates in the unlock mode displays a home screen on the display unit in the unlock mode. The lock system includes a first number of lock elements one of which is a first lock element which is a web browser application capable of accessing an external source including at least one content infected by a malicious virus. The main system includes a second number of main elements one of which is a first main element which is a web browser application capable of accessing said external source, where the second number may be greater than, equal to, or less than the first number.

Upon receiving a first user input from a user in an off-state in which the display unit is turned off but the terminal is powered on, the terminal turns on the display unit, switches to the lock mode, displays the lock screen on the display unit, and displays a first graphical user interface of the first lock element on the lock screen.

Upon receiving from the user a second user input provided to the first graphical user interface, the terminal allows the user to access the external source with the first lock element, and to download a first result which includes the infected content, while blocking the content from accessing the first main element in said lock mode.

After generating the first result in the unlock mode, upon receiving from the user a third user input for switching from the lock mode to the unlock mode, the terminal erases a certain portion of the first result at a mode-switching timing related to one of a first timing of receiving the third user input and a second timing of switching from said lock mode to the unlock mode, whereby the terminal can prevent the infected content from infecting the first main element of the main system in the lock mode, even when the first lock element is infected by the content in the lock mode.

In a 1^{st} example of the 2^{nd} exemplary objective, the mode-switching timing may be one of a first timing which is before erasing the certain portion, a second timing which is concurrent with the erasing, and a third timing which is after the erasing.

In a 2^{nd} example of the 2^{nd} exemplary objective, the lock system includes the first lock element and a second lock element, and the terminal displays on the lock screen the first graphical user interface of the first lock element as well as a second graphical user interface of the second lock element.

In a 3^{rd} example of the 2^{nd} exemplary objective, the first result is one of data, a file, a folder, and a content.

In a 4^{th} example of the 2^{nd} exemplary objective, the terminal runs one of initialization and formatting of the lock system in at least one of multiple circumstances so that the terminal removes the first lock element from the lock system and then reloads the first lock element to the lock system, where such circumstances include a first circumstance in which a certain period has passed since one of previous initialization and formatting, and a second circumstance in which the terminal detects the content infected by the virus in one of the first result, the lock elements, and the lock system.

In a 5^{th} example of the 2^{nd} exemplary objective, the first result may include at least one of: first information related to an address of a website accessed by the web browser application; second information which is related to the website; and third information downloaded from the website.

In a 6^{th} example of the 2^{nd} exemplary objective, the certain portion is an entire portion of the first result.

In a 7^{th} example of the 2^{nd} exemplary objective, the certain portion is not an entire portion of the first result so that the terminal erases the certain portion but does not erase the rest of the first result in the lock system.

In an 8^{th} example of the 2^{nd} exemplary objective, the terminal also includes a lock memory unit which stores the rest of the first result. The terminal allows the user to access the lock memory unit in at least one of the lock mode and the unlock mode.

In a 9^{th} example of the 2^{nd} exemplary objective, the lock memory unit includes at least one of a data buffer, a cache, a clipboard, a recycle bin, a non-volatile memory element, and a volatile memory element.

In a 10^{th} example of the 2^{nd} exemplary objective, the terminal runs an authentication operation in response to at least a portion of the third user input. The terminal switches to the unlock mode when the user passes the authentication operation but does not switch to the unlock mode if the user fails the authentication operation.

In a 11^{th} example of the 2^{nd} exemplary objective, the third user input may include an information related to at least one of a fingerprint of the user, the user's iris, the user's retina, the user's voice, and the user's face.

In a 3^{rd} exemplary objective of this disclosure, a data processing terminal operates in a lock mode and in an unlock mode, and includes a display unit; a lock system, and a main system. The lock system which the terminal operates in the lock mode but not in the unlock mode displays a lock screen on the display unit in the lock mode. The terminal operates the main system in the unlock mode but not in the lock mode. The lock system is loaded with a first number of lock applications one of which is a first lock application, where the first lock application is a web browser application capable of accessing an external source. The main system is loaded with a second number of main applications one of which is a first main application which is the web browser application, where the second number may be greater than, equal to, or less than the first number.

Upon receiving from a user a first user input while the terminal may be in an off-state in which the terminal is powered on but the display unit is turned off, the terminal turns on the display unit, displays the lock screen on the display unit, and displays on the lock screen a graphical user interface of the first lock application. Upon receiving from the user a second user input which is applied to the graphical user interface of the first lock application in the lock mode, the terminal allows the user to access the external source using the first lock application, and to download a first result from the external source, while blocking the first result from accessing the main system in said lock mode.

After downloading the first result and upon receiving from the user a third user input in the lock mode, the terminal switches from the lock mode to the unlock mode at a mode-switching timing. The terminal erases at least a portion of the first result at an erasure timing which is one of a first timing which is before switching to the unlock mode, a second timing which is concurrent with switching to the unlock mode, a third timing which is immediately after switching to the unlock mode, and a fourth timing which is upon receiving an additional user input from the user. Thus, the terminal is capable of preventing the at least a portion of the first result from infecting the first main element with a malicious virus in the lock mode as well as in the unlock mode, even if the first lock element is infected by the virus in the lock mode.

In a 4^{th} exemplary objective of this disclosure, a data processing terminal operates in a lock mode and in an unlock mode, and includes a display unit; a lock system, and a main system. The lock system is operated by the terminal in said lock mode but not in said unlock mode, and the lock system displays a lock screen on the display unit in the lock mode. The main system is operated by the terminal in the unlock mode but not in the lock mode. The lock system is loaded with a first number of lock applications which include a first lock application which is a web browser application, while the main system is loaded with a second number of unlock applications which include a first main application which is the web browser application, where the second number may be greater than, equal to, or less than the first number.

The lock system displays a graphical user interface of the first lock application on the lock screen in the lock mode. Upon receiving a first user input which is provided to the graphical user interface of the first lock application by the user in the lock mode, the terminal drives the first lock application, allows the user to access an external source which includes a content which is infected by a malicious virus, and generates a first result related to the external source while preventing the first result from accessing the main system in the lock mode.

After generating the first result and upon receiving a second user input from the user in the lock mode, the terminal switches from the lock mode to the unlock mode. The terminal erases at least a portion of the first result at an erasure timing which is one of a first timing which is before switching to the unlock mode, a second timing which is concurrent with switching to the unlock mode, a third timing which is immediately after switching to the unlock mode, and a fourth timing which is upon receiving an additional user input from the user. The first lock app remains loaded in the lock system after the terminal switches to the unlock mode. The terminal erases the first lock application from the lock system when one of the terminal and the user finds the first lock application infected by said malicious virus.

After erasing the infected first lock application, the terminal reloads (or loads) at least a portion of the first main application into the lock system, and drive the reloaded application as a new first lock application. Therefore, the terminal can prevent the at least a portion of the first result from infecting the first main application from being infected by the virus, even when the first lock element is infected by the virus in the lock mode.

In a 5^{th} exemplary objective of this disclosure, a data processing terminal operates in a lock mode and in an unlock mode, and includes a display unit; a lock system, and a main system. The lock system is operated by the terminal in the lock mode, and displays a lock screen on the display unit in the lock mode. The main system is operated by the terminal in the unlock mode, and displays a home screen on the display unit in the unlock mode. The lock system includes a first number of lock applications, where one of such applications is a first lock application. The main system is loaded with a second number of main applications, where one of such applications is a first main application. The second number may be greater than, equal to, or less than the first number.

The first lock application is capable of performing a first function in the lock mode but not in the unlock mode, while the first main application is also capable of performing the first function in the unlock mode but not in the lock mode. The lock system displays a graphical user interface of the first lock application on the lock screen in the lock mode. Upon receiving a first user input which is provided to the graphical user interface of the first lock application by a user in the lock mode, the terminal drives the first lock application, allows the first lock application to access an external source which includes a content infected by a malicious virus, and allows the first lock application to generate a first result which may be related to accessing the external source, while preventing the first result from accessing the main system in the lock mode.

After generating the first result and upon receiving a second user input from the user in the lock mode, the terminal switches from the lock mode to the unlock mode. The terminal erases a first portion which is infected by the virus from the first result while saving a second portion of the first result one of before, concurrently with, and after switching to the unlock mode, where the first lock application remains loaded in the lock system even after the terminal switches to the unlock mode. The terminal erases the first lock application from the lock system when one of the terminal and the user finds that the first lock application is infected by the malicious virus.

After erasing the infected first lock application, the terminal reloads at least a portion of said the main application into the lock system, and uses the reloaded application as a new first lock application. Thus, the terminal can prevent the first portion of the first result from infecting the first main application with the virus, even when the first lock application is infected by the virus in the lock mode.

In a 6^{th} exemplary objective of this disclosure, a data processing terminal operates in a lock mode and in an unlock mode, and includes a display unit; a lock system, and a main system. The lock system is operated by the terminal in the lock mode but not in the unlock mode, and displays a lock screen on the display unit in the lock mode. The main system is operated by the terminal in the unlock mode but not in the lock mode, and displays a home screen on the display unit in the unlock mode.

The lock system is loaded with a first number of lock applications which include a first lock application which may be, e.g., a web browser application, an email application, a messenger application, an internet-of-things application, or an ad viewer application. The main system is similarly loaded with a second number of unlock applications which includes a first main application which may be the web browser application, the internet-of-things application, the messenger application, the email application, the ad view application, or the like. The second number may be greater than, equal to, or less than the first number.

The lock system displays a graphical user interface of the first lock application on the lock screen in the lock mode, while the main system displays a graphical user interface of the first main application on the home screen in the unlock mode. The first lock application is capable of performing a certain function in response to a third user input provided by the user to the graphical user interface of the first lock application in the lock mode, while the first main application is also capable of performing the certain function in response to a fourth user input provided by the user to the graphical user interface of the first main application in the unlock mode.

Upon receiving a first user input from the user, the terminal drives the first lock application, allows the first lock application to access an external source which includes a content infected by a malicious virus, and generates a first result which is related to performing the certain function while preventing the first result from accessing the main system in the lock mode.

After generating the first result and upon receiving a second user input from the user in the lock mode, the terminal switches from the lock mode to the unlock mode. The terminal erases a first portion which is infected by the virus from the first result while saving a second portion of the first result at an erasure timing which is one of a first timing which may be before switching to the unlock mode, a second timing which is concurrent with switching to the unlock mode, a third timing which may be immediately after switching to the unlock mode, and a fourth timing which is upon receiving an additional user input from the user. The first lock application may remain loaded in the lock system after the terminal switches to the unlock mode.

The terminal may erase the first lock application from the lock system when the terminal or the user finds that the first lock application is infected by the malicious virus. After erasing the infected first lock application, the terminal reloads (or loads) at least a portion of the first main application onto the lock system, and drive a reloaded application as a new first lock application. Thus, the terminal can prevent the first portion of the first result from infecting the first main application with the virus, even when the first lock application is infected by the virus in the lock mode.

In a 7^{th} exemplary objective of this disclosure, a data processing terminal operates in a lock mode and in an unlock mode, and includes a display unit; a lock system, and a main system. The lock system is operated by the terminal in the lock mode, and displays a lock screen on the display unit in the lock mode; while the main system is operated in the unlock mode, and displays a home screen on the display unit in the unlock mode.

The lock system may include a first number of lock elements one of which is a lock web browser application which can perform a first function of accessing an external source including at least one content infected by a malicious virus, while the main system includes a second number of main elements one of which is a main web browser application capable of performing the first function of accessing said external source, where the second number is greater than the first number.

Upon receiving a first user input from a user in an off-state where the display unit is turned off but where the terminal is powered on, the terminal may turn on the display unit, switch to the lock mode, display the lock screen on the display unit, and display a first graphical user interface of the lock web browser application on the lock screen.

Upon receiving from the user a second user input provided to the first graphical user interface, the terminal allows the user to access the external source with the lock web browser application, and to download a first result which includes the infected content, while preventing the infected content from accessing or modifying the main system in the lock mode.

Upon receiving from the user a third user input in the lock mode after generating the first result, the terminal switches to the unlock mode while erasing a certain portion of the first result at a mode-switching timing related to one of a first timing of receiving the third user input and a second timing of switching from the lock mode to the unlock mode. Therefore, the terminal can prevent the infected content from infecting the main web browser application of the main system in the lock mode, even when the lock web browser application is infected by the malicious virus in the lock mode.

In a 1^{st} example of the 7^{th} exemplary objective, the mode-switching timing may be one of a third timing which is after receiving the second user input but before switching to the unlock mode, a fourth timing which is concurrent with the switching, and a fifth timing which is after the switching.

In a 2^{nd} example of the 7^{th} exemplary objective, the lock system may include a lock web browser application and a second lock element. The terminal displays on the lock screen the first graphical user interface of the lock web browser application and a second graphical user interface of the second lock element.

In a 3^{rd} example of the 7^{th} exemplary objective, the first result is one of data, a file, a folder, and a content.

In a 4^{th} example of the 7^{th} exemplary objective, the terminal removes the lock web browser application from the lock system when the system detects the infected content in the lock system.

In a 5^{th} example of the 7^{th} exemplary objective, after said terminal removes the lock web browser application from the lock system, the terminal may allow said user to reload at least a portion of the main web browser application onto the lock system, and drive the reloaded application as the lock web browser application.

In a 6^{th} example of the 7^{th} exemplary objective, the terminal runs an initialization operation or a formatting operation of the lock system in at least one of multiple circumstances so that the terminal removes the lock web browser application from the lock system and reloads (or loads) the lock web browser application to said lock system, where such circumstances include a first circumstance in which a certain period has passed since one of previous initialization and previous formatting, and a second circumstance in which the terminal detects said content infected by the virus in one of the first result, the lock web browser application, and the lock system.

In a 7^{th} example of the 7^{th} exemplary objective, the first result includes at least one of first information related to an address of a website accessed by the lock web browser application; second information related to the website, and third information which is downloaded from the website.

In an 8^{th} example of the 7^{th} exemplary objective, where the certain portion may be an entire portion of such first result or the certain portion is not an entire portion of such first result such that the terminal erases the certain portion but does not erase the rest of the first result.

In a 9^{th} example of the 7^{th} exemplary objective, the terminal also includes a lock memory unit which may be one of a data buffer, a cache, a clipboard, a recycle bin, a non-volatile memory element, a volatile memory element, or the like.

In a 10^{th} example of the 7^{th} exemplary objective, the terminal may allow the user to access said the memory unit in the lock mode or in the unlock mode.

In a 11^{th} example of the 7^{th} exemplary objective, the terminal runs an authentication operation in response to at least a portion of said third user input, where the third user input includes an information related to at least one of a fingerprint of the user, the user's iris, the user's retina, the user's voice, and the user's face.

In a 12^{th} example of the 7^{th} exemplary objective, the terminal may switch to the unlock mode when the user passes the authentication operation, but the terminal may not switch to the unlock mode but remains in the lock mode when the user fails the authentication operation.

In an 8^{th} exemplary objective of this disclosure, a data processing terminal operates in a lock mode and in an unlock mode, and includes a display unit; a lock system, and a main system. The lock system is operated by the terminal in the lock mode, and displays a lock screen on the display unit in the lock mode, while the main system is operated by the terminal in the unlock mode, and displays a home screen on the display unit in the unlock mode. The lock system includes a lock web browser application capable of performing a first function of accessing an external source which may include at least one content infected by malicious viruses. The main system includes a main web browser application capable of performing the first function of accessing the external source, and also includes at least one additional application which is not the main web browser application and which is not included in the lock system. The terminal displays a first graphical user interface of the lock web browser application on the lock screen in the lock mode. When the terminal receives from a user a first user input which is provided to the first graphical user interface, the terminal allows the user to access said external source with the lock web browser application, and to download a first result which may include the infected content, while preventing the infected content from accessing the main system in the lock mode. Upon receiving from the user a second user input in the lock mode after generating the first result, the terminal performs switching from the lock mode to the unlock mode and erasing a certain portion of the first result from the lock system. Therefore, the terminal can prevent the infected content from infecting the main web browser application of the main system in the lock mode, even when the lock web browser application is infected by the malicious virus in the lock mode.

In a 1^{st} example of the 8^{th} exemplary objective, the terminal prevents the lock web browser application from accessing the main system in said lock mode, or prevents the lock system from accessing the main system in the lock mode.

In a 2^{nd} example of the 8^{th} exemplary objective, the terminal performs one of [1] the erasing and, thereafter, the switching, [2] the erasing and the switching simultaneously; [3] the switching and, thereafter, the erasing, or the like.

In a 3^{rd} example of the 8^{th} exemplary objective, the main web browser application is capable of performing not only the first function but also a second function, while the lock web browser application is capable of performing the first function but not the second function.

In a 4^{th} example of the 8^{th} exemplary objective, the main web browser application can perform not only the first function but also a second number of additional functions, whereas the lock web browser application can perform not only the first function but also a third number of additional functions, where the second number is not less than the third number.

In a 5^{th} example of the 8^{th} exemplary objective, the terminal removes the lock web browser application from the lock system when the system detects the infected content in the lock system. After the terminal removes the lock web browser application from the lock system, the terminal allows the user to reload the lock web browser application onto said lock system.

In a 6^{th} example of the 8^{th} exemplary objective, the terminal runs one of initialization and formatting of the lock system in at least one of multiple circumstances such that the terminal removes the lock web browser application from the lock system and then reloads the lock web browser application to the lock system, where such circumstances include a first circumstance in which a certain period has passed since one of previous initialization and previous formatting, and a second circumstance in which the terminal detects the content infected by the virus in one of the first result, the lock web browser application, and the lock system.

In a 7^{th} example of the 8^{th} exemplary objective, the first result is one of data, a file, a folder, and a content, or the first result includes at least one of first information which is related to an address of a website accessed by the lock web browser application, second information which is related to the website; and third information which is downloaded from the website.

In an 8^{th} example of the 8^{th} exemplary objective, the certain portion is [1] an entire portion of the first result, or [2] not an entire portion of the first result, so that the terminal erases the certain portion but does not erase the rest of the first result.

In a 9^{th} example of the 8^{th} exemplary objective, the terminal may include a lock memory unit which includes at least one of a data buffer, a cache, a clipboard, a recycle bin, a non-volatile memory element, a volatile memory element, or the like. The lock system stores at least a portion of the rest of the first result in the lock memory unit.

In a 10^{th} example of the 8^{th} exemplary objective, the terminal allows the user to access the lock memory unit in the lock mode or in the unlock mode.

In an 11^{th} example of the 8^{th} exemplary objective, the terminal runs an authentication operation in response to at least a portion of the third user input, where the third user input includes an information related to at least one of a fingerprint of the user, the user's iris, the user's retina, the user's voice, and the user's face.

In a 12^{th} example of the 8^{th} exemplary objective, the terminal switches to the unlock mode when the user passes said authentication operation. But the terminal does not switch to the unlock mode but remains in the lock mode when the user fails the authentication operation.

In a 9^{th} exemplary objective of this disclosure, a data processing terminal operates in a lock mode and in an unlock mode, and includes a display unit; a lock system, and a main system. The lock system is operated by the terminal in the lock mode, and displays a lock screen on the display unit in the lock mode; while the main system is operated by the terminal in the unlock mode, and displays a home screen on the display unit in the unlock mode. The lock system includes a lock element which can perform a first function of accessing an external source including at least one content infected by a malicious virus, while the main system includes a main element which can perform the first function of accessing the external source.

When the lock element is a lock web browser app, a lock internet-of-things app, a lock advertisement viewer app, a lock messenger app, or a lock email app, the main element may be one of a corresponding main web browser app, a main internet-of-things app, a main advertisement viewer app, a main messenger app, and a main email app, respectively. The terminal displays a first graphical user interface of said lock element on said lock screen in the lock mode.

When the terminal receives from a user a first user input provided to the first graphical user interface, the terminal allows the user to access the external source with the lock element, and to download a first result which includes the infected content, while preventing the infected content from accessing the main system in the lock mode. Upon receiving from the user a second user input in the lock mode after generating the first result, the terminal performs switching from the lock mode to the unlock mode and erasing a certain portion of the first result from the lock system. Therefore, the terminal can prevent the infected content from infecting the main element of the main system in the lock mode, even when the lock element is infected by the malicious virus in the lock mode.

In a 1^{st} example of the 9^{th} exemplary objective, the terminal prevents the lock element or lock system from accessing the main system in the lock mode or In a 2^{nd} example of the 9^{th} exemplary objective, the terminal may perform [1] the erasing and, thereafter, the switching, [2] the erasing and the switching simultaneously; or [3] the switching and, thereafter, the erasing.

In a 3^{rd} example of the 9^{th} exemplary objective, the main element is capable of performing not only the first function but also a second function, while the lock element is capable of performing the first function but not the second function. Alternatively, the main element is capable of performing not only the first function but also a second number of additional functions, while the lock element is capable of performing not only the first function but also a third number of additional functions, where the second number is not less than the third number.

In a 4^{th} example of the 9^{th} exemplary objective, the terminal removes the lock element from the lock system when the system detects the infected content in the lock system. After the terminal removes the lock element from the lock system, the terminal may allow the user to reload a corresponding new element onto the lock system.

In a 5^{th} example of the 9^{th} exemplary objective, the terminal runs one of initialization and formatting of the lock system in at least one of multiple circumstances so that the terminal removes the lock element from the lock system and reloads a new element into the lock system to replace the removed lock element, where such circumstances include a first circumstance in which a certain period has passed since one of previous initialization and previous formatting, and a second circumstance in which the terminal detects the content infected by the virus in one of the first result, the lock element, and the lock system.

In a 6^{th} example of the 9^{th} exemplary objective, the first result is one of data, a file, a folder, and a content. In the alternative, the first result includes at least one of first information which is related to an address of the external source accessed by the lock element; and second information downloaded from the external source.

In a 7^{th} example of 9^{th} exemplary objective, the certain portion may be an entire portion of the first result or may not be an entire portion of the first result such that the terminal erases the certain portion but does not erase the rest of the first result.

In a 10^{th} exemplary objective of this disclosure, a method is provided for operating a data processing terminal which includes a display unit, a lock system, and a main system, while protecting the main system from the lock system, where the terminal operates the main system in an unlock mode, but operates the lock system in a lock mode. The method may include the steps of: including in the lock system a lock web browser app which is capable of performing a first function of accessing an external source including multiple contents, where the contents include at least one infected content which is infected by a malicious virus and at least one non-infected content which is not infected by the virus; including in the main system a main web browser app which is capable of performing the first function and further including in the main system at least one second app which is not the main web browser app and which is not included in the lock system; displaying a lock screen on the display unit in the lock mode; displaying a first graphical user interface of the lock web browser app on the lock screen; upon receiving a first user input which is provided to the first graphical user interface by a user, allowing the user to access the external source with the lock web browser app, and also allowing the user to download from the external source a first result which includes at least one of the contents, while preventing the first result from accessing the main web browser app in the lock mode; and upon receiving from the user a second user input in the lock mode after generating the first result, erasing a certain portion of the first result from the lock system, switching from the lock mode to the unlock mode, and displaying a home screen on the display unit in said the mode, whereby minimizing or preventing the first result from infecting the main web browser app of the main system in the lock mode, even if the first result includes the infected content.

In a 1^{st} example of the 10^{th} exemplary objective, the method may include the step of, upon receiving a zeroth user input from a user in an off-state in which the display unit is turned off but the terminal is powered on, turning on the display unit, displaying the lock screen on the display unit, and displaying the first graphical user interface of the lock web browser app on the lock screen.

In a 2^{nd} example of the 10^{th} exemplary objective, the method includes the steps of: including in the lock system the lock web browser app and a second lock app which is different from the lock web browser app; and displaying on the lock screen the first graphical user interface and a second graphical user interface of the second lock app.

In a 3^{rd} example of the 10^{th} exemplary objective, the method includes the steps of: allowing the lock web browser app to perform the first function as well as a first number of functions each of which is different from the first function; and allowing the main web browser app to perform the first function as well as a second number of functions each of which is different from the first function, wherein the second number is not less than the first number.

In a 3^{rd} example of the 10^{th} exemplary objective, the method includes one of the steps of [1] performing the erasing and then the switching, [2] performing the erasing concurrently with the switching; or [3] performing the switching and then the erasing.

In a 4^{th} example of the 10^{th} exemplary objective, the certain portion is one of an entire portion of the first result; and only a portion of but not an entire portion of the first result.

In a 5^{th} example of the 10^{th} exemplary objective, the method may include the steps of: including in the lock system a lock memory unit; and saving at least a portion of the first result in the lock memory unit, where the lock memory unit is one of a data buffer, a cache, a clipboard, a recycle bin, a non-volatile memory element; and a volatile memory element.

In a 6^{th} example of the 10^{th} exemplary objective, the erasing comprises one of the steps of [1] erasing the certain portion of the first result, where the certain portion may or may not stored in the lock memory unit.

In a 7^{th} example of the 10^{th} exemplary objective, the method may also include at least one of the steps of: allowing the user to access the lock memory unit in the lock mode; and allowing the user to access the lock memory unit in the unlock mode.

In an 8^{th} example of the 10^{th} exemplary objective, the switching may include the steps of: authenticating the user using the second user input; and performing the switching when the user passes the authenticating. The authenticating may also include the step of performing the authenticating based on a fingerprint of the user, an iris of the user, a retina the user, a voice of the user; or a face the user.

In a 9^{th} example of the 10^{th} exemplary objective, the method may include one of the steps of: remaining in the lock mode when the user fails the authenticating; and turning off the display unit when the user fails the authenticating.

In a 10^{th} example of the 10^{th} exemplary objective, the allowing the user to access the external source may include one of the steps of: allowing the user to visit a website of the external source; allowing the user to visit a cloud in which the external source resides; and
allowing the user to connect to a link of the external source.

In an 11^{th} example of the 10^{th} exemplary objective, the allowing the user to download the first result includes the step of downloading data, a file; a folder, or a content from the external source.

In a 12^{th} example of the 10^{th} exemplary objective, the method includes at least one of the steps of: removing the lock web browser app from the lock system when the lock web browser app may be infected by the virus; removing the lock web browser app from the lock system when the lock system is infected by the virus; and allowing the user to remove the lock web browser app from the lock system.

In a 13^{th} example of the 10^{th} exemplary objective, the preventing includes one of the steps of: preventing the infected content from accessing the main web browser app; preventing the infected content from accessing the main system; preventing the first result from accessing the main web browser app; preventing the first result from accessing the main system; preventing the lock system from accessing the main web browser app; and preventing the lock system from accessing the main system.

In a 14^{th} example of the 10^{th} exemplary objective, the preventing includes one of the steps of: preventing the user from accessing the main web browser app in the lock mode; preventing the user from storing the infected content in the main system; and preventing the user from storing the first result in the main system.

In an 11^{th} exemplary objective of this disclosure, a method is also provided for operating a data processing terminal which includes a display unit, a lock system, and a main system, while protecting the main system from the lock system, where the terminal operates the main system in an unlock mode, but operates the lock system in a lock mode. The method includes the steps of: including in the lock system a first number of lock elements one of which is a lock web browser app which is capable of performing a first function of accessing an external source including multiple contents, where the contents include at least one infected content which is infected by a malicious virus and at least one non-infected-content which is not infected by the virus; including in the main system a second number of main elements one of which is a main web browser app which is capable of performing the first function, where the second number is not less than the first number; upon receiving a first user input from a user in an off-state in which the display unit is turned off but the terminal is powered on, turning on the display unit, displaying the lock screen on the display unit in the lock mode, and also displaying a first graphical user interface of the lock web browser app on the lock screen; upon receiving a second user input which is provided to the first graphical user interface by the user, allowing the user to access the external source with the lock web browser app, and also allowing the user to download from the external source a first result which includes at least one of said contents, while preventing the lock system from accessing the main system in the lock mode; and upon receiving from the user a third user input in the lock mode after generating the first result, erasing a certain portion of the first result from the lock system, switching from the lock mode to the unlock mode, and displaying a home screen on the display unit in said unlock mode, whereby preventing the lock system from infecting the main system in the lock mode, even when the first result includes the infected content.

In a 1^{st} example of the 11^{th} exemplary objective, the method includes the steps of: displaying at least two graphical user interfaces on the lock screen in the lock mode, where a first of said graphical user interfaces is that of the lock web browser app, and where a second of said graphical user interfaces is that of a second lock element which is different from the lock web browser app.

In a 2^{nd} example of the 11^{th} exemplary objective, the method also includes the steps of: allowing the lock web browser app to perform the first function as well as a first number of functions each of which is different from the first function; and allowing the main web browser app to perform the first function as well as a second number of functions each of which is different from the first function, where the second number is not less than the first number.

In a 12^{th} exemplary objective of this disclosure, a method is also provided for operating a data processing terminal which includes a display unit, a lock system, and a main system, while protecting the second system from the first system, where the terminal operates the first system in a first mode, and where the terminal operates the second system in a second mode. The method may increase the steps of: including in the first system a first web browser app capable of performing a first function of accessing an external source which includes multiple contents, where the contents include at least one infected content which is infected by a malicious virus and at least one non-infected content which is not infected by the virus; including in the second system a second web browser app capable of performing the first function and further including in the second system at least one additional app which is not the second web browser app and which is not included in the first system; allowing the user to access the external source with the first web browser app, and allowing the user to download from the external source a first result which includes at least one of the contents, while preventing the first result from accessing the second system in the first mode; and upon receiving from a user a user input in the first mode after generating the first result, erasing a certain portion of the first result from the first system, and switching from the first mode to the second mode, whereby the terminal can prevent the first result from infecting the second system in the first mode, even when the first result includes the infected content.

In a 1^{st} example of the 12^{th} exemplary objective, the first mode is a lock mode, while the second mode is an unlock mode.

In a 2^{nd} example of the 12^{th} exemplary objective, the method may also include the step of,
upon receiving an earlier user input from the user in an off-state in which the display unit is turned off but the terminal is powered on, turning on the display unit, and displaying a first screen on the display unit as well as a first graphical user interface of the first web browser app on the first screen.

In a 3^{rd} example of the 12^{th} exemplary objective, the method may further include the steps of: including in the first system the first web browser app and a second app which is different from the first web browser app; and displaying a first screen on the display unit, along with a first graphical user interface of the first web browser app and a second graphical user interface of the second app.

In a 4^{th} example of the 12^{th} exemplary objective, the method may further include the steps of: allowing the first web browser app to perform the first function as well as a first number of functions each of which is different from the first function; and allowing the second web browser app to perform the first function as well as a second number of functions each of which is different from the first function, where the second number is not less than the first number.

In a 5^{th} example of the 12^{th} exemplary objective, the method may include [1] performing the erasing and then the switching, [2] performing the erasing concurrently with the switching, or [3] performing the switching and then the erasing.

In a 6^{th} example of the 12^{th} exemplary objective, the certain portion is one of an entire portion of the first result, and only a portion of but not an entire portion of the first result.

In a 7^{th} example of the 12^{th} exemplary objective, the method may further include the steps of: including in the first system a first memory unit; and saving at least a portion of the first result in the first memory unit, where the first memory unit is a data buffer, a cache, a clipboard, a recycle bin, a non-volatile memory element, or a volatile memory element.

In an 8^{th} example of the 12^{th} exemplary objective, the erasing includes one of the steps of: erasing the certain portion of the first result, where the certain portion is not stored in the first memory unit; and erasing the portion of the first result, where the certain portion is stored in the first memory unit.

In a 9^{th} example of the 12^{th} exemplary objective, the method may further include at least one of the steps of allowing the user to access the first memory unit in the first mode; and allowing the user to access the first memory unit in the second mode.

In a 10^{th} example of the 12^{th} exemplary objective, the switching includes the steps of: authenticating the user using the user input; and then performing the switching when the user passes the authenticating, where such authenticating includes the step of performing the authenticating based on a fingerprint of the user, an iris of the user, a retina of the user, a voice of the user, or a face of the user.

In an 11^{th} example of the 12^{th} exemplary objective, the method may include one of the steps of: remaining in the first mode when the user fails the authenticating; and turning off the display unit when the user fails the authenticating.

In a 12^{th} example of the 12^{th} exemplary objective, the allowing the user to access the external source may include one of the steps of: allowing the user to visit a website of the external source; allowing the user to visit a cloud in which the external source resides; and allowing the user to connect to a link of the external source. Alternatively, the allowing the user to download the first result includes the step of downloading data, a file, a folder, or a content from the external source.

In a 13^{th} example of the 12^{th} exemplary objective, the method may also include one of the steps of: removing the first web browser app from the first system when the first web browser app is found to be infected by the virus; and allowing the user to remove the first web browser app from the first system.

In a 14^{th} example of the 12^{th} exemplary objective, the preventing may include one of the steps of: preventing the infected content from accessing the second web browser app or the second system; preventing the first result from accessing the second web browser app or the second system; and preventing said first system from accessing the second web browser application or the second system. In the alternative, the preventing may include one of the steps of: preventing the user from accessing the second web browser app in the first mode; preventing the user from storing the infected content in the second system; and preventing the user from storing the first result in the second system.

In a 13^{th} exemplary objective of this disclosure, a method is provided for operating a data processing terminal which includes a display unit, a lock system, and a main system, while protecting the main system from the lock system, where the terminal operates the lock system in a lock mode, but operates the main system in an unlock mode. The method may include the steps of: including in the lock system a lock web browser app which can perform a first function of accessing an external source including at least one content infected by a malicious virus; including in the main system a main web browser app which can perform the first function and further including in the main system at least one additional app which is not the main web browser app and which is not included in the lock system; allowing the user to access the external source with the lock web browser app, and allowing the user to download from the external source a first result including the infected content, while preventing the infected content from accessing the main system in the lock mode; and upon receiving from a user a user input in the lock mode after generating the first result, erasing a certain portion of the first result from the lock system, and switching from the lock mode to the unlock mode, whereby preventing the infected content from infecting the main system in the lock mode, even when the lock system is infected by the malicious virus in the lock mode.

In a 14^{th} exemplary objective of this disclosure, a data processing terminal operates in a lock mode and in an unlock mode. The terminal includes a top body, a bottom body, a rotatable joint, a first display unit, a second display unit, a lock system, and a main system. Such a top body defines a top outer surface and a top inner surface, while the bottom body defines a bottom outer surface and a bottom inner surface. The rotatable joint rotatably couples the top body with the bottom body, defines a folding axis about which the top body or the bottom body rotates toward or away from the other thereof between a folded state and an unfolded state within a preset range of folding angles in such a way that the top inner surface and the bottom inner surface are not exposed to a user in the folded state but that the top inner surface and the bottom inner surface are exposed to the user in the unfolded state.

The first display unit is disposed on the top outer surface of the top body, and which is exposed to the user in the folded state, while the second display unit is disposed on at least one of the top inner surface of the top body and the bottom inner surface of the bottom body, and is exposed to the user in the unfolded state but not exposed to the user in the folded state. The lock system operates in the lock mode, and includes a first number of lock apps one of which is a first lock app capable of allowing the user to access an external source in the lock mode. The main system operates in the unlock mode, and includes a second number of main apps one of which is a first main app capable of allowing the user to access the external source in the unlock mode, where the second number is not less than the first number.

In the folded state, the user executes the first lock app on the first display unit in the lock mode, and generates results as a result of executing the first lock app, When the user provides the terminal with a first user input for unfolding in the folded state by rotating the top body away from the bottom body, the terminal switches from the folded state to the unfolded state, and exposes the second display unit to the user. The terminal runs an erase operation or a semi-erase operation, and erases at least a portion of the results in one of a plurality of erasure timings. As a result, the terminal prevents malicious viruses included in such results or the lock system from migrating into the main system in the unlock mode.

In a 1^{st} example of the 14^{th} exemplary objective, the rotatable joint may be a hinge, a rotary joint, or the like. The rotatable joint couples the top and bottom bodies along one of long and short vertices of the top and bottom bodies. The preset range of the folding angles may be about 450, 600, 900, 1200, 1500, 1500, 1800, 2100, 2400, or 2700.

In a 2^{nd} example of the 14^{th} exemplary objective, the results include data, files, folder, texts, images, contents, or computer codes. The main system may include [1] a second app which the lock system does not include, [2] a second app which runs a second operation which none of the lock apps run, or [3] a second app which performs a second function which none of the lock apps perform. The external source may include an add-on device, a portable device, a website, or a cloud. The first lock app may be a web browser app, an email app, a messenger app, an internet-of-things app, or an ad viewer app.

In a 3^{rd} example of the 14^{th} exemplary objective, the lock system is physically or operationally isolated from the main system. Thus, the terminal may [1] prevent the lock system from accessing the main system in the lock mode, [2] prevent the lock system from storing at least a portion of the results in the main system in the lock mode, [3] prevent the results from accessing the main system in the lock mode, [4] prevent the results from being accessed by the main system in the lock mode, [5] prevent the main system from accessing the results in the unlock mode, or the like. As a result, the terminal prevents the malicious viruses included in one of the results and the lock system from migrating into the main system in the lock mode.

In a 4^{th} example of the 14^{th} exemplary objective, the second display unit is disposed on the top inner surface as well as the bottom inner surface. The second display unit provides a top inner display surface and a bottom inner display surface, respectively, on the top inner surface and bottom inner surface, and the terminal operates the main system on both of the top inner and bottom inner display surfaces of the second display unit in the unlock mode. The terminal may also include a third display unit, where the second display unit is disposed on the top inner surface or where the third display unit is disposed on the bottom inner surface.

In a 5^{th} example of the 14^{th} exemplary objective, the erasure timing may be one of [1] a first timing which is when a terminal detects the viruses in the results, [2] a second timing which is when a terminal detects the viruses in the first lock app, [3] a third timing which is when a terminal detects the viruses in at least two of the lock apps, where one of the lock apps is the first lock app, [4] a fourth timing which is when a terminal detects the viruses in the lock system, [5] a fifth timing which is when a certain period has elapsed after running at least one of a previous semi-erase operation and a previous erase operation; [6] a sixth timing which is when the user runs a certain number of the lock operations, where the number may exceed a preset number, or [7] a seventh timing which is when a size of the result reaches a certain size which exceeds a preset size.

Alternatively, the erasure timing may be one of [1] an eighth timing which is when the terminal receives the first user input, [2] a ninth timing which is after the terminal receives the first user input but before receives an additional user input; [10] a tenth timing which is after the terminal receives the first user input but before beginning the unfolding, [11] an eleventh timing which is when the top body rotates away from the bottom body by a preset unfolding angle, [12] a twelfth timing which is during the unfolding, or [13] a thirteenth timing which is after the unfolding.

In a 6^{th} example of the 14^{th} exemplary objective, upon or after detecting the malicious viruses in at least a portion of the lock system, the terminal may remove [1] the first lock app from the lock system, [2] at least two lock apps one of which is the first lock app from the lock system, [3] all of the lock apps from the lock system, or [4] the lock system. After removing the first lock app, the terminal may reload (or load) a new first app into the lock system, and the terminal may use the reloaded (or reload) first app as a new first lock app with which the user accesses the external source in the lock mode.

In a 7^{th} example of the 14^{th} exemplary objective, the first main app can run up to a third number of different operations and capable of performing up to a fourth number of functions. The terminal may obtain the new first lock app in the lock system [1] by loading an entire portion of the first main app into the lock system, whereby the new first lock app is capable of running up to the third number of different operations and also capable of performing up to the fourth number of functions, [2] loading only a portion but not an entire portion of the first main app into the lock system, whereby the new first lock app is capable of running up to a fifth number of different operations and also capable of performing up to the sixth number of functions, where at least one of the fifth and sixth numbers is less than the third and fourth numbers, respectively, or [3] loading an entire portion of a reference first app into the lock system, where the new first lock app allows the user to access the external source in the lock mode, and where the reference first app may be stored in the terminal but not in the main system, or [4] loading at least a portion but not an entire portion of the reference first app.

In an 8^{th} example of the 14^{th} exemplary objective, the lock system may include therein the first number of the lock apps even in the unlock mode, except when at least one of the first number of the lock apps may be contaminated by the viruses. Or the lock system may include the first lock app therein even in the unlock mode, except when the first lock app is contaminated by the viruses.

In a 9^{th} example of the 14^{th} exemplary objective, the terminal may switch to the unfolded state in response to the first user input, and allow the user to drive the main system on the second display unit in the unlock mode, without running any user authentication operation.

In a 10^{th} example of the 14^{th} exemplary objective, the terminal may run a user authentication operation in response to the first user input, switch to the unlock mode, and allow the user to drive the main system in the unlock mode on the secondary display unit when the user passes the user authentication. The terminal may run the authentication operation based upon a user sub-input which is included in the first user input.

In this context, the erasure timing may be [1] a fourteenth timing which is before running the authentication operation, [2] a fifteenth timing which is concurrent with running the user authentication operation, [3] a sixteenth timing which is one of before, upon or after determining whether or not the passes the user authentication operation, [4] a seventeenth timing which is after running an authentication operation, or the like.

In an 11^{th} example of the 14^{th} exemplary objective, the first display unit may be one of [1] remaining turned on, while operating the lock system, [2] remaining turned on, while not operating the lock system; or [3] turned off.

In a 12^{th} example of the 14^{th} exemplary objective, after switching to the unfolded state, the terminal allows the user to operate the main system on the second display unit in the unlock mode, while [1] not allowing a user to access the results in the unlock mode, or [2] allowing the user to access remaining portions of the results in the unlock mode, after the terminal runs the semi-erase operation.

In a 15^{th} exemplary objective of this disclosure, a data processing terminal operates in a lock mode and in an unlock mode. The terminal includes a top body, a bottom body, a rotatable joint, a first display unit, a second display unit, a lock system, and a main system. The top body may define a top outer surface and a top inner surface, while the bottom body may define a bottom outer surface and a bottom inner surface. The rotatable joint may rotatably couples the top body with the bottom body, define a folding axis about which the top body or the bottom body may rotate toward or away from the other thereof between a folded state and an unfolded state within a preset range of folding angles in such a way that the top inner surface and the bottom inner surface are not exposed to a user in the folded state but that the top inner surface and the bottom inner surface are exposed to the user in the unfolded state.

The first display unit may be disposed on the top outer surface, and exposed to the user in the folded state. The second display unit may be disposed on at least one of the top inner surface and the bottom inner surface, and may not be exposed to the user in the folded state but exposed to the user in the unfolded state. The lock system operates in the lock mode, and includes a first number of lock apps one of which is a lock web browser app capable of allowing the user to access a website in the lock mode. The main system operates in the unlock mode, and includes a second number of main apps one of which may be a main web browser app capable of allowing the user to access the website in the unlock mode, where the second number is not less than the first number.

In the folded state, the user may execute the lock web browser app in the lock mode on the first display unit, and generate results as a result of executing the lock web browser app. When the user provides the terminal with a first user input for unfolding in the folded state by rotating the top body away from the bottom body, the terminal switches from the folded state to the unfolded state, and exposes the second display unit to the user. The terminal runs an erase operation or a semi-erase operation for erasing at least a portion of the results in one of a plurality of erasure timings. As a result, the terminal may prevent the malicious viruses included in the results or the lock system from migrating into the main system in the unlock mode.

In a 1^{st} example of the 15^{th} exemplary objective, the rotatable joint may be a hinge or a rotary joint. The rotatable joint may couple the top and bottom bodies along one of long and short vertices of the top and bottom bodies. The preset range of the folding angles may be about 45°, 60°, 90°, 120°, 150°, 150°, 180°, 210°, 240°, 270°, or the like.

In a 2^{nd} example of the 15^{th} exemplary objective, the results include data, files, folder, texts, images, contents, or computer codes. The main system may include [1] a second main app which runs a second operation which none of the lock apps run, or [2] a second main app which performs a second function which none of the lock apps perform.

In a 3^{rd} example of the 15^{th} exemplary objective, the lock system may be physically or operationally isolated from the main system. Therefore, the terminal may prevent [1] the lock system from accessing the main system in the lock mode, [2] the lock system from storing at least a portion of the results in the main system in the lock mode, [3] the results from accessing the main system in the lock mode, [4] the results from being accessed by the main system in the lock mode, or [5] the main system from accessing the results in the unlock mode, As a result, the terminal may prevent the malicious viruses included in [1] the results, or [2] the lock system from migrating into the main system in the lock mode.

In a 4^{th} example of the 15^{th} exemplary objective, the second display unit is disposed on the top inner surface and the bottom inner surface, and the second display unit provides a top inner display surface and a bottom inner display surface, respectively, on the top inner surface and bottom inner surface. The terminal may operate the main system on both of the top inner and bottom inner display surfaces of the second display unit in the unlock mode. The terminal may include a third display unit, where the second display unit is disposed on the top inner surface, and the third display unit is disposed on the bottom inner surface.

In a 5^{th} example of the 15^{th} exemplary objective, the erasure timing may be one of [1] a first timing which is when a terminal detects the viruses in the results, [2] a second timing which is when a terminal detects the viruses in the first lock app, [3] a third timing which is when a terminal detects the viruses in at least two of the lock apps, one of the lock apps is the first lock app, [4] a fourth timing which is when a terminal detects the viruses in the lock system, [5] a fifth timing which is when a certain period has elapsed after the terminal ran a previous semi-erase operation and a previous erase operation, [6] a sixth timing which is when a user runs a certain number of the lock operations, where the number exceeds a preset number; or [7] a seventh timing which is when a size of the result reaches a certain size which exceeds a preset size.

Alternatively, the erasure timing may be one of [1] an eighth timing which is when the terminal receives the first user input, [2] a ninth timing which is after the terminal receives the first user input but before receives an additional user input, [3] a tenth timing which is after the terminal receives the first user input but before the terminal begins the unfolding, [4] an eleventh timing which is when the top (or bottom) body may rotate away from the bottom (or top) body by a preset unfolding angle, [5] a twelfth timing which is during the unfolding, or [6] a thirteenth timing which is after the unfolding.

In a 6^{th} example of the 15^{th} exemplary objective, before, upon or after detecting the malicious viruses in the lock system, the terminal removes [1] the lock web browser app from the lock system, [2] at least two lock apps one of which is the lock web browser app from the lock system, [3] all of the lock apps from the lock system, or [4] the lock system from the terminal.

In a 7^{th} example of the 15^{th} exemplary objective, after removing the lock web browser app, the terminal may reload (or load) a new web browser app into the lock system, and use the reloaded (or loaded) web browser app as a new lock web browser app with which the user may access the website in the lock mode. When the main web browser app is capable of running up to a third number of different operations and capable of performing up to a fourth number of functions, the terminal obtains the new lock web browser app in the lock system by one of [1] loading an entire portion of the main web browser app into the lock system, whereby the new lock web browser app is also capable of running up to the third number of different operations and also capable of performing up to the fourth number of functions, [2] loading only a portion but not an entire portion of the main web browser app into the lock system, whereby the new lock web browser app is capable of running up to a fifth number of different operations and also capable of performing up to the sixth number of functions, where at least one of the fifth and sixth numbers may be less than the third and fourth numbers, respectively, [3] loading an entire portion of a reference web browser app into the lock system, where such a reference web browser app also allows the user to access the external source in the lock mode, and where the reference web browser app is stored in the terminal but not in the main system, or [4] loading at least a portion but not an entire portion of the reference web browser app.

In an 8^{th} example of the 15^{th} exemplary objective, the lock system may include all of the first number of the lock apps therein even in the unlock mode, except when at least one of the first number of the lock apps may be contaminated by the malicious viruses. Or the lock system may include the lock web browser app therein even in the unlock mode, except when the lock web browser app is contaminated by the malicious viruses.

In a 9^{th} example of the 15^{th} exemplary objective, the terminal may switch to the unfolded state in response to the first user input, and allow the user to drive the main system on the second display unit in the unlock mode, without running any user authentication operation. The terminal may run a user authentication operation in response to the first user input, switches to the unlock mode, and allow the user to drive the main system in the unlock mode on the secondary display unit when the user passes the user authentication. The terminal may run the user authentication operation based on a user sub-input which is included in the first user input.

In a 10^{th} example of the 15^{th} exemplary objective, such erasure timings may include one of [1] a fourteenth timing which is before running the authentication operation, [2] a fifteenth timing which is concurrent with running the user authentication operation, [3] a sixteenth timing which is before, upon or after determining whether or not the passes the user authentication operation, [4] a seventeenth timing which is after running an authentication operation, or the like.

In an 11^{th} example of the 15^{th} exemplary objective, the first display unit is [1] turned off, [2] remaining turned on, while operating the lock system, or [3] remaining turned on, while not operating the lock system.

In a 12^{th} example of the 15^{th} exemplary objective, after switching to the unfolded state, such a terminal may allow the user to operate the main system on the second display unit in the unlock mode, while [1] not allowing the user to access the results in the unlock mode, or [2] allowing the user to access the remaining portions of the results in the unlock mode, after the terminal runs the semi-erase operation.

In a 16^{th} exemplary objective of this disclosure, a data processing terminal operates in a lock mode and in an unlock mode. The terminal includes a top body, a bottom body, a rotatable joint, a first display unit, a second display unit, a lock system, and a main system. The top body may define a top outer surface and a top inner surface, and the first display unit may be disposed on the top outer surface of the top body, The bottom body may define a bottom outer surface and a bottom inner surface, and the second display unit may be disposed on [1] the bottom inner surface of the bottom body, or [2] the top inner surface of the top body. The rotatable joint which rotatably couples the top body with the bottom body, which defines a folding axis about which the top and bottom bodies rotates toward or away from each other between a folded state and an unfolded state within a preset range of folding angles. The top inner surface and the bottom inner surface are not exposed to a user in the folded state, but such inner surfaces are exposed to the user in the unfolded state.

The lock system may operate in the lock mode, and include a first number of lock apps one of which is a first lock app. The main system may operate in the unlock mode, and include a second number of main apps one of which is a first main app, where the second number is not less than the first number. The first lock app as well as the first main app may run at least one same operation.

The preset range may range from a smallest folding angle to a greatest folding angle. The terminal may be in a folded state when the folding angle is at least substantially close to the smallest folding angle so that the top inner surface is disposed proximate to the bottom inner surface and that the top inner surface and the bottom inner surface are not exposed to the user. The terminal may be in the unfolded state when the folding angle is at least substantially close to the greatest folding angle so that the top inner surface and the bottom inner surface are exposed to the user.

The terminal in the folded state may allow a user to drive the lock system in the lock mode on the first display unit, and the lock system may run lock operations in the lock mode, thereby generate the results from running the lock operations. When the user provides to the terminal a first user input of rotating the top (or bottom) body away from the bottom (or top) body, and the terminal starts unfolding in response to the first user input, the terminal may switch to the unfolded state after such unfolding, run an erase operation or a semi-erase operation so as to erase at least a portion of the results in one of various erasure timings, and allow the user to drive the main system in the unlock mode on the target display unit.

Whereby the terminal may prevent malicious viruses included in at least one of the results and the lock system from migrating into the main system.

The terminal of this 16^{th} exemplary aspect may be fabricated or operated based on various examples of the above 14^{th} or 15^{th} exemplary aspect.

In a 17^{th} exemplary objective of this disclosure, a data processing terminal may operate in a lock mode and in an unlock mode, and include a lock system, a main system, a display unit, or the like. Such a lock system may operate in the lock mode, and include a first number of lock apps one of which may be a first lock app capable of allowing a user to access an external source in the lock mode. The main system may operate in the unlock mode, and include a second number of main apps one of which may be a first main app capable of allowing the user to access the external source in the unlock mode, where the second number may not be less than the first number. Each of such lock and unlock systems may display one of multiple screens on the display unit.

When the user executes the first lock app in the lock mode, the user generates results at least a portion of which is contaminated by malicious viruses which may migrate from the external source. The lock system may be physically or operationally isolated from the main system such that the terminal may prevent the lock system from accessing the main system in lock mode, thereby protecting the main system from the lock system in the lock mode. The terminal may run an erase operation or a semi-erase operation, thereby erasing at least a portion of the results in one of multiple erasure timings, before, during or after the terminal switches from the lock mode to the unlock mode, thereby erasing the malicious viruses from the lock system and protecting the main system from the malicious viruses in the lock mode.

The lock system may include the first lock app therein not only in the lock mode but also in the unlock mode, whereby the terminal may not require the user to load the first lock app whenever the user enters the lock mode, Before, upon or after detecting such malicious viruses in at least a portion of the lock system, the terminal may run a removal operation of removing the malicious viruses from the lock system. After removing such viruses from the lock system, the first lock app or the results, the terminal may reload (or load) a new first app into the lock system, and allow the user to use the reloaded (or loaded) first app as a new first lock app, thereby allowing the user to access the external source in the lock mode by executing the new first lock app.

In a 1^{st} example of the 17^{th} exemplary objective, the results may include data, files, folder, texts, images, contents, or computer codes.

In a 2^{nd} example of the 17^{th} exemplary objective, the main system may include [1] a second main app which the lock system does not include, [2] a second main app which runs a second operation which none of such lock apps run, or [3] a second main app which performs a second function which none of such lock apps perform.

In a 3^{rd} example of the 17^{th} exemplary objective, the external source may be an add-on device, a portable device, a website, or a cloud, while the first lock app may be a web browser app, an email app, a messenger app, an internet-of-things app, or an ad viewer app.

In a 4^{th} example of the 17^{th} exemplary objective, the lock system may be physically or operationally isolated from said main system. Thus, the terminal may prevent [1] the lock system from accessing the main system in the lock mode, [2] the lock system from storing at least a portion of such results in the main system in the lock mode, [3] such results from accessing the main system in the lock mode, [4] such results from being accessed by the main system in the lock mode; or [5] the main system from accessing such results in the unlock mode. As a result, the terminal may prevent the malicious viruses included in such results or the lock system from migrating into the main system in the lock mode or in the unlock mode.

In a 5^{th} example of the 17^{th} exemplary objective, such erasure timings may be [1] a first timing which is when the terminal detects the malicious viruses in the results, [2] a second timing which is when a terminal detects the viruses in said first lock app, [3] a third timing which is when a terminal detects the viruses in at least two of the lock apps, where one of such lock apps may be the first lock app, [4] a fourth timing which is when a terminal detects such viruses in the lock system, [5] a fifth timing which is when a certain period has elapsed after running a previous semi-erase operation or a previous erase operation, [6] a sixth timing which is when the user runs a certain number of such lock operations, where such a number exceeds a preset number, [7] a seventh timing which is when a size of such result reaches a certain size which exceeds a preset size.

In a 6^{th} example of the 17^{th} exemplary objective, when a terminal receives a user input for a mode switching operation or a user authentication operation, such erasure timings may be [1] an eighth timing which is when the terminal receives the user input, [2] a ninth timing which is after the terminal receives the user input but before the terminal receives an additional user input, [3] a tenth timing which is after receiving the user input but before beginning such mode switching or user authenticating, or the like.

In a 7^{th} example of the 17^{th} exemplary objective, upon or after detecting such malicious viruses in the lock system, the terminal may remove [1] the first lock app from the lock system, [2] at least two lock apps one of which is the first lock app from the lock system, [3] all of the lock apps from the lock system, or [4] the lock system from the terminal. After removing the first lock app, the terminal may reload (or load) a new first app into the lock system, and said terminal may use the reloaded (or loaded) first app as a new first lock app with which the user accesses the external source in the lock mode.

In an 8^{th} example of the 17^{th} exemplary objective, the first main app may run up to a third number of different operations and perform up to a fourth number of functions, and the terminal may obtain the new first lock app in the lock system by [1] loading an entire portion of the first main app onto the lock system and, accordingly, the new first lock app may run up to the third number of different operations or may perform up to the fourth number of functions, [2] loading only a portion but not an entire portion of the first main app onto the lock system and, thus, the new first lock app may run up to a fifth number of different operations or perform up to a sixth number of functions, where at least one of the fifth and sixth numbers may be less than the third and fourth numbers, respectively, [3] loading an entire portion of a reference first app into the lock system, where the new first lock app may allow the user to access the external source in the lock mode, while the reference first app may be stored in the terminal but not in the main system, or [4] loading at least a portion but not an entire portion of the reference first app onto the lock system.

In a 9^{th} example of the 17^{th} exemplary objective, the lock system may include therein the first number of the lock apps even in the unlock mode, except when at least one of the first number of the lock apps may be contaminated by the viruses. Alternatively, the lock system may include therein the first lock app even in the unlock mode, except when the first lock app may be contaminated by the viruses.

In an 18^{th} exemplary objective of this disclosure, a data processing terminal may operate in a lock mode and in an unlock mode, and include a lock system, a main system, a display unit, or the like. Such a lock system may operate in the lock mode, and include a first number of lock apps one of which is a lock web browser app for allowing a user to access a website in the lock mode. The main system may operate in the unlock mode, and include a second number of main apps one of which may be a main web browser app for allowing the user to access the website in the unlock mode, where the second number may not be less than the first number. Each of such lock and unlock systems may display one of multiple screens on the display unit.

When the user executes the lock web browser app in the lock mode, the user may generate results at least a portion of which may be contaminated by malicious viruses which may have been migrated from the website. The lock system may be physically or operationally isolated from the main system such that the terminal may prevent the lock system from accessing the main system in lock mode, thereby protecting the main system from the lock system, the lock web browser app or the results which may include (or may be contaminated) by such viruses in the lock mode. The terminal may run an erase operation or a semi-erase operation, and erase at least a portion of the results in one of various erasure timings, before, during or after the terminal switches from the lock mode to the unlock mode, thereby erasing the malicious viruses from the lock system and protecting the main system from the malicious viruses in the lock mode.

The lock system may include the lock web browser app therein not only in the lock mode but also in the unlock mode, thereby not requiring the user to reload (or load) the lock web browser app whenever the user enters the lock mode.

Upon or after detecting the malicious viruses in at least a portion of the lock system, the terminal may run a removal operation for removing the malicious viruses from [1] the lock system, [2] the lock web browser app, or [3] the results. Upon or after removing the malicious viruses from the lock system, the terminal may reload (or load) a new web browser app onto the lock system, and allow the user to use the reloaded (or loaded) lock web browser app as a new lock web browser app, thereby allowing the user to access such a website by executing the new lock web browser app in the lock mode.

The terminal of this 18^{th} exemplary aspect may be fabricated or operated based on various examples of the above 14^{th}, 15^{th}, 16^{th} or 17^{th} exemplary aspect.

In a 19^{th} exemplary objective of this disclosure, a method may be provided for running operations with a data processing terminal which includes a lock system and a main system while protecting the main system from being contaminated by malicious viruses. The lock system and the main system may respectively operate in a lock mode and in an unlock mode. The lock system and the main system may respectively include a first number of lock apps and a second number of main apps, where the second number is not less than the first number.

The method may include the steps of: physically or operationally isolating such a lock system from at least a portion of the main system; accessing in the lock mode an external source by executing a first lock app which is one of the first number of the lock apps; running lock operations related to the external source with the first lock app in the lock mode; generating results by such accessing, executing, or running; erasing at least a portion of the results at an erasure timing; and retaining the first lock app in the lock system after the terminal switches from the lock mode to the unlock mode, except when the first lock app is contaminated by the viruses due to one of the accessing, executing, and running, whereby the terminal prevents the malicious viruses from migrating into the main system from one of the results, first lock app, and lock system in the lock mode.

In a 1^{st} example of the 19^{th} exemplary objective, the first lock app may be a web browser app, a messenger app, an email app, an internet-of-things app, or an ad viewer app. Such including the second number of the main apps may include at least one of the steps of: including in the main system a second main app which the lock system does not include; including in the main system a second main app which runs at least one operation which none of the lock apps run; and including in the main system a second main app which performs at least one function which none of the lock apps perform.

In a 2^{nd} example of the 19^{th} exemplary objective, such isolating may also include at least one of the steps of: preventing such a first lock app, lock system, or results from accessing the main system in the lock or unlock mode; preventing the first lock app or the lock system from storing at least a portion of the results in the main system in the lock or unlock mode; preventing the main system from accessing at least a portion of such results in the lock or unlock mode; preventing the main system from operating the first lock app in the lock or unlock mode; and preventing the terminal from operating the lock system in the lock or unlock mode.

When the main system may include a main CPU unit and a main memory unit, such isolating may include at least one of the steps of: preventing the first lock app or lock system from accessing the main memory unit in the lock or unlock mode; preventing the first lock app or lock system from storing at least a portion of the results into the main memory unit in the lock or unlock mode; preventing the first lock app or lock system from driving the main CPU unit in the lock or unlock mode; and preventing the main CPU unit from at least one of executing the first lock app and driving the lock system in the lock or unlock mode.

In a 3^{rd} example of the 19^{th} exemplary objective, such accessing the external source may include the step of accessing an add-on device, a portable device, a website, or a cloud.

Such running the lock operations in the lock mode may include at least one of the steps of: running a searching operation for searching a certain information; running a download operation for downloading apps, computer codes, contents, data, files, texts, folders, images, or links; running an arranging operation for arranging such downloaded apps, files, folders, computer codes, contents, data, images, links, or texts; and running a storing operation for storing such downloaded apps, computer codes, data, contents, files, folders, images, links, and texts.

In a 4^{th} example of the 19^{th} exemplary objective, such generating may include at least one of the steps of: obtaining information by running a searching operation; downloading apps, data, contents, texts, links, files, computer codes, folders, or images, by running a download operation; and arranging such downloaded apps, computer codes, contents, data, files, folders, images, links, and texts by running an arranging operation.

In a 5^{th} example of the 19^{th} exemplary objective, such erasing the portion of the results includes one of the steps of: running an erasing operation for erasing an entire portion of the results from the lock system; and running a semi-erasing operation for erasing at least a portion but not an entire portion of the results from the lock system. The erasure timing may be one of: a first timing which is when a terminal detects the viruses in the results; a second timing which is when a terminal detects the viruses in the first lock app; a third timing which is when a terminal detects the viruses in at least two of the lock apps, wherein one of the lock apps is the first lock app; a fourth timing which is when a terminal detects the viruses in the lock system; a fifth timing which is when a certain period has elapsed after running a previous semi-erase operation or erase operation; a sixth timing which is when the user runs a certain number of the lock operations, wherein the number exceeds a preset number; and a seventh timing which is when a size of the result reaches a certain size which exceeds a preset size.

In a 6^{th} example of the 19^{th} exemplary objective, the method may further include the step of detecting at least one of [1] the viruses which reside in the first lock app, [2] the viruses which reside in the lock system, [3] the first lock app which includes the viruses, [4] the first lock app which is contaminated by the viruses, [5] the lock system which includes the viruses, or [6] the lock system which is contaminated by the viruses.

In a 7^{th} example of the 19^{th} exemplary objective, the method may further include the steps of: removing the first lock app from the lock system; reloading a new first app onto the lock system; and allowing the user to use the reloaded first app as a new first lock app.

When one of the second number of the main apps is a first main app which can access the external source, such reloading may include the steps of: loading an entire portion of the first main app onto the lock system; loading only a portion but not an entire portion of the first main app onto the lock system; loading onto the lock system at least a portion but not an entire portion of a reference first app which is capable of accessing the external source, wherein the reference first app is stored in the terminal and not in the main system; and loading an entire portion of the reference first app onto the lock system.

In an 8^{th} example of the 19^{th} exemplary objective, the method may further include the steps of: removing the lock system from the terminal; reloading a new system onto the terminal; and allowing the user to operate the reloaded system as a new lock system.

In a 9^{th} example of the 19^{th} exemplary objective, the method may further include the step of receiving a user input for one of switching the mode, and authenticating the user, where the erasure timing may be one of: an eighth timing which is when the terminal receives the user input; a ninth timing which is after the terminal receives the user input but before receives an additional user input; and a tenth timing which is after the terminal receives the user input but before beginning the unfolding.

In a 20^{th} exemplary objective of this disclosure, a method may be provided for running operations with a data processing terminal which includes a lock system and a main system while protecting the main system from being contaminated by malicious viruses. Such lock and main systems respectively operate in a lock mode and in an unlock mode. Such lock and main systems respectively include a first number of lock apps and a second number of main apps, where the second number is not less than the first number.

The method may also include the steps of: a physically or operationally isolating at least a portion of the lock system from at least a portion of the main system in the lock mode; accessing an external source by driving the lock system in the lock mode; running lock operations related to the external source with the lock system in the lock mode; generating results obtained by such accessing, driving, or driving; erasing at least a portion of the results at an erasure timing; and retaining at least a portion of the lock system in the terminal after the terminal switches from the lock mode to the unlock mode, except when at least a portion of the lock system may be contaminated by the viruses due to such accessing, driving, or running, whereby the terminal may prevent the malicious viruses from migrating into the main system from the first lock app, the lock system, or the results in the lock mode.

In a 1^{st} example of the 20^{th} exemplary objective, the lock system may include a web browser app, an email app, a messenger app, an internet-of-things app, or an ad viewer app, to access the external source in the lock mode. Such including the second number of the main apps in the main system may include at least one of the steps of: including in the main system a second main app which the lock system does not include; including in the main system a second main app which runs at least one operation which none of the lock apps run; and including in the main system a second main app which performs at least one function which none of the lock apps perform.

In a 2^{nd} example of the 20^{th} exemplary objective, such isolating may include at least one of the steps of: preventing the lock system or the results from accessing the main system in the lock mode or unlock mode; preventing the lock system from storing at least a portion of such results into the main system in the lock or unlock mode; preventing the main system from accessing at least a portion of such results in the unlock or lock modes; preventing the main system from operating at least a portion of the lock system in the unlock or unlock modes; and preventing the terminal from operating the lock system in the lock or unlock mode.

In a 3^{rd} example of the 20^{th} exemplary objective, when the main system may include a main CPU unit and a main memory unit, such isolating may include at least one of the steps of: preventing the lock system from accessing the main memory unit in the lock or unlock mode; preventing the lock system from storing at least a portion of the results into the main memory unit in the lock or unlock mode; preventing the lock system from driving the main CPU unit in the lock or unlock mode; and preventing the main CPU unit from driving the lock system in the lock or unlock mode.

In a 4^{th} example of the 20^{th} exemplary objective, such accessing the external source may include the step of accessing an add-on device, a portable device, a website, or a cloud.

In a 5^{th} example of the 20^{th} exemplary objective, such running the lock operations may include at least one of the steps of: running a searching operation for searching for information; running a download operation for downloading apps, computer codes, contents, data, files, folders, images, links, texts, or the like; running an arranging operation for arranging the downloaded apps, contents, data, files, folders, images, links, texts or computer codes; and running a storing operation for storing the downloaded apps, computer codes, contents, data, files, folders, images, links, and texts.

In a 6^{th} example of the 20^{th} exemplary objective, such generating the results may include at least one of the steps of: obtaining information or such results by running a searching operation; downloading apps, contents, data, files, computer codes, folders, images, links, or texts by running a download operation; and arranging such downloaded apps, computer codes, contents, data, files, folders, images, links, and texts by running an arranging operation.

In a 7^{th} example of the 20^{th} exemplary objective, such erasing may include the step of: running an erasing operation for erasing an entire portion of the results from the lock system; running a semi-erasing operation for erasing at least a portion but not an entire portion of the results from the lock system, or the like.

In an 8^{th} example of the 20^{th} exemplary objective, such erasure timing may be one of: a first timing which is when a terminal detects the viruses in the results; a second timing which is when a terminal detects the viruses in the lock system; a third timing which is when a terminal detects the viruses in at least two of the lock apps; a fourth timing which is when a certain period has elapsed after running at least one of a previous semi-erase operation and a previous erase operation; a fifth timing which is when the user runs a certain number of the lock operations, wherein the number exceeds a preset number; and a sixth timing which is when a size of the result reaches a certain size which exceeds a preset size.

In a 9^{th} example of the 20^{th} exemplary objective, the method may further include the steps of detecting [1] the viruses which may reside in at least one of the lock apps, [2] the viruses which may reside in the lock system, [3] at least one of the lock apps which is contaminated by the viruses, or [4] the lock system contaminated by the viruses.

In a 10^{th} example of the 20^{th} exemplary objective, the method may also include the steps of: removing a first lock app which is contaminated by the viruses from the lock system; reloading a new first app onto the lock system; and allowing the user to use the reloaded first app as a new first lock app.

When one of the main apps is a first main app which can access the external source, and when a first lock app is contaminated by the viruses, such reloading may include one of the steps of: loading an entire portion of the first main app onto the lock system; loading only a portion but not an entire portion of the first main app onto the lock system; loading onto the lock system at least a portion but not an entire portion of a reference first app which can access the external source, where the reference first app is stored in the terminal and not in the main system; and loading an entire portion of the reference first app onto the lock system.

In an 11^{th} example of the 20^{th} exemplary objective, the method may further include the steps of: removing the lock system from the terminal; reloading a new system onto the terminal; and allowing the user to operate the reloaded system as a new lock system.

In a 12^{th} example of the 20^{th} exemplary objective, the method may further include the steps of: receiving a user input for switching the mode or authenticating the user, the erasure timing may be [1]: a seventh timing which is when the terminal receives the user input, [2] an eighth timing which is after the terminal receives the user input but before receives an additional user input, or [3] a ninth timing which is after the terminal receives the user input but before beginning the unfolding; In a 21^{st} exemplary objective of this disclosure, a method may be provided for driving a data processing terminal which includes a lock system and a main system. The method may include the steps of: providing a lock system including a first number of lock apps one of which is a first lock app; operating the lock system in the lock mode or executing the first lock app for accessing an external source in the lock mode; providing a main system including a second number of main apps one of which is a first main app, where such a second number is not less than the first number; executing the first main app for accessing the external source in the unlock mode; installing a display unit on which the lock and unlock systems display screens; generating results by executing the first lock app in the lock mode, where at least a portion of the results may include (or may be contaminated by) malicious viruses migrating from the external source; physically or operationally isolating the lock (or main) system from at least a portion of the main (or lock) system, thereby preventing the lock (or main) system from accessing the main (or lock) system in the lock or unlock mode; erasing at least a portion of the results in one of multiple erasure timings, thereby erasing the viruses from the lock system and protecting the main system from the viruses in the lock or unlock mode; keeping the first lock app in the lock system both in the lock and unlock modes, thereby not requiring the user to load the first lock app whenever the user switches to the lock mode from a powered-off state, an off state, or the unlock mode; removing the contaminated first lock app or malicious viruses from the lock system upon or after detecting the malicious viruses in at least a portion of the lock system; after such removing, reloading (or loading) a new first app into the lock system; and allowing the user to use the reloaded (or loaded) first app as a new first lock app, thereby allowing the use to access the external source in the lock mode by executing the new first lock app.

In a 1^{st} example of the 21^{st} exemplary objective, the external source may be a website, a cloud, an add-on device, or a portable device. In addition, the first lock app may be a web browser app, a messenger app, an email app, an internet-of-things app, or an ad viewer app.

In a 2^{nd} example of the 21^{st} exemplary objective, generating such results may include the step of obtaining a content, computer codes, data, a file, folder, an image or a text.

In a 3^{rd} example of the 21^{st} exemplary objective, such providing the main system may include at least one of the steps of: incorporating in the main system a second main app which the lock system does not include; incorporating in the main system a second main app which runs a second operation which none of such lock apps run; and incorporating in the main system a second main app which performs a second function which none of the lock apps perform.

In a 4^{th} example of the 21^{st} exemplary objective, such isolating may include at least one of: preventing the lock system from accessing the main system in the lock mode; preventing the lock system from storing at least a portion of the results in the main system in the lock mode; preventing the results from accessing the main system in the lock mode; preventing the results from being accessed by the main system in the lock mode; and preventing the main system from accessing the results in the unlock mode, whereby the terminal prevents the malicious viruses included in one of the results and the lock system from migrating into the main system in the lock mode.

In a 5^{th} example of the 21^{st} exemplary objective, the erasure timing may be [1] a first timing which is when a terminal detects the viruses in the results, [2] a second timing which is when a terminal detects the viruses in the first lock app, [3] a third timing which is when a terminal detects the viruses in at least two of such lock apps, where one of the lock apps is the first lock app, [4] a fourth timing which is when a terminal detects the viruses in the lock system, [5] a fifth timing which is when a certain period has elapsed after running at least one of a previous semi-erase operation and a previous erase operation, [6] a sixth timing which is when the user runs a certain number of the lock operations, where the number may exceed a preset number, or [7] a seventh timing which is when a size of the result reaches a certain size which exceeds a preset size.

In a 6^{th} example of the 21^{st} exemplary objective, the method may further include the step of receiving a user input for mode switching or authenticating the user, where such erasure timings may be [1] an eighth timing which is when the terminal receives the user input or [2] a ninth timing which is after the terminal receives the user input but before receiving an additional user input.

In a 7^{th} example of the 21^{st} exemplary objective, upon or after detecting such malicious viruses in the lock system, the method may also include the step of removing [1] the first lock app from the lock system, [2] at least two lock apps one of which is the first lock app the lock system, [3] all of the lock apps from the lock system, or [4] the lock system. After removing the first lock app, the method may further include the steps of:
reloading (or loading) a new first app into the lock system; and using the reloaded (or loaded) first app as a new first lock app with which the user can access the external source in the lock mode.

When the main app can run up to a third number of different operations or perform up to a fourth number of different functions, the method may also include the step of obtaining the new first lock app in the lock system by one of: loading an entire portion of the first main app into the lock system, whereby the new first lock app can run up to the third number of different operations or can perform up to the fourth number of functions; loading only a portion but not an entire portion of the first main app into the lock system, whereby the new first lock app can run up to a fifth number of different operations or can perform up to the sixth number of functions, where at least one of such fifth and sixth numbers is less than the third and fourth numbers, respectively; loading an entire portion of a reference first app into the lock system, where the new first lock app also allows the user to access the external source in the lock mode, and the reference first app is stored in the terminal but not in the main system; and loading at least a portion but not an entire portion of the reference first app onto the lock system.

In an 8^{th} example of the 21^{st} exemplary objective, the method may include the step of maintaining or keeping the first number of the lock apps in the lock system even in the unlock mode, except when at least one of the first number of the lock apps is contaminated by the viruses. Or the method may include the step of keeping or maintaining the first lock app in the lock system even in the unlock mode, except when the first lock app is contaminated by the viruses.

In various exemplary objectives hereinabove and in various exemplary aspects hereinafter, a lock system of a data processing terminal may include at least one lock (hardware or software) element or lock app (i.e., application), where a total number of such lock elements (including lock apps) may be typically smaller than a number of the main hardware (or software) elements and main apps in the main system. However and as exemplified in Section 10-16, the main system [1] may include a smaller number of such elements (including apps) than the lock system, [2] may be given a less access authority than that given to the lock system, or the like.

Other details of “3. Additional Objectives” are identical to the following portions of the '861 application such as, e.g., the text from [0463] on page 43 to [0534] on page 50, where these portions are incorporated herein in their entirety by reference.

Unless otherwise defined in this specification, all technical and scientific terms used herein have the same meaning as commonly understood by one of ordinary skill in the art to which such data processing terminals, methods of manufacturing and using such terminals, and sequences used in such terminals and methods belong. Although various other structures, methods, and sequences equivalent or similar to those described throughout this disclosure may be used in practicing and/or testing such terminals, methods, and sequences, suitable structures, methods, and sequences are to be described below. All publications, patent applications, patents or other references mentioned herein are incorporated by reference in their entirety. In case of any conflict, this disclosure, including definitions as provided above, will control. In addition, the structures, methods, and sequences are only illustrative and not intended to be limiting.

### BRIEF DESCRIPTION OF THE DRAWINGS

FIG. 1A is a block diagram of a main system of an exemplary data processing terminal including a lock viewer according to the first exemplary aspect of this disclosure;

FIG. 1B is a simplified block diagram of the main system of FIG. 5A;

FIG. 1C is a block diagram of a lock system of the exemplary data processing terminal of FIGS. 5A and 5B;

FIGS. 2A and 2B are block diagrams of an exemplary data processing terminal including at least one lock CPU unit according to the second exemplary aspect of this disclosure;

FIG. 3 is a block diagram of an exemplary data processing terminal fabricated in an embedded configuration according to the third exemplary aspect of this disclosure;

FIG. 4 is a block diagram of another exemplary data processing terminal fabricated in a hybrid configuration according to the fourth exemplary aspect of this disclosure;

FIG. 5 shows front views of foldable terminals, where Panels (A) and (B) show those in the folded state, while Panels (C) and (D) show those in the unfolded state;

FIG. 6 shows front views of foldable terminals, where Panels (A), (B), and (E) show those in the folded state, while Panels (C) and (D) show those in the unfolded state;

FIG. 7 shows front views and a side view of a rollable terminal, where Panels (A) and (B) are a front and side view of the terminal in its rolled state, while Panel (C) is a front view of the terminal in its unrolled state;

FIG. 8 shows top views of a rollable terminal, where Panel (A) shows that in its rolled state, while Panel (B) shows that in its unrolled state;

FIG. 9 is a schematic view of an exemplary three-component VR system;

FIG. 10 is a schematic view of an exemplary two-component VR system;

FIG. 11 show top views of exemplary terminals in various states or modes which display various GUIs of lock apps or main apps on their display units;

FIG. 12 show top views of exemplary terminals which remove a lock app contaminated by malicious viruses, and reload a corresponding app in such a way that a reloaded lock app runs the same or similar operations as a removed lock app or perform the same or similar functions as the removed lock app; and

FIGS. 13A to 13D are top views of exemplary terminals which illustrate sequences of exemplary seamless waking-up operations.

### DETAILED DESCRIPTION

This disclosure relates to various data processing terminals which enable a user to access any website of his or her choice, to download any contents therefrom, and to process any downloaded contents, while not having to worry about any malicious viruses which may have been impregnated into such contents and which may migrate into the user's terminals.

Most importantly, various data processing terminals of this disclosure provide their users with the enhanced security, the improved integrity, and the better data protection, while maintaining or improving a convenience of seamless operations by employing at least “four features” which may be “independent” of each other or may be “interdependent” on each other, based upon configurational or operational characteristics of a terminal or upon such characteristics of various hardware or software elements of various systems of a terminal.

The first of such features is to provide a user with “at least two different modes” of operation each of which is granted with different access authority to drive a hardware or software element of a lock, intermediate or main system. As a result, a user may operate a terminal in one mode such as, e.g., an unlock mode when a user processes reliable data, but may operate a terminal in another mode such as, e.g., a lock or intermediate mode when a user processes unreliable data.

The second of such features is the “physical isolation” or “operational isolation” of a main (or intermediate) system from a lock (or intermediate) system of a terminal.

The third of such features is the “erase (or semi-erase) operation” with which a terminal can erase all (or some) results obtained by running various lock operations with a lock system in a lock mode before such results may affect any hardware or software element of a main system of a terminal. To this end, a terminal may run an erase (or semi-erase) operation in one of various erasure timings defined hereinabove and hereinafter. Finally, the fourth of such features is the inclusion of a “mode-switching input unit” with which a user may conveniently switch from one mode to another mode, simply by providing a terminal with a user input which includes at least one mode-switching (user) sub-input, and without having to turn off a display unit of a terminal and then to turn it on again.

Beginning with the “first” of such features, a data processing terminal of this disclosure operates in a hierarchy which may define “multiple modes of operation” therein. In addition, a terminal may operate in each of such multiple modes examples of which may include (1) at least one lock mode in which a terminal operates a lock system, (2) at least one unlock mode in which a terminal operates an unlock (or main) system, and (3) at least one optional intermediate mode in which such a terminal operates an optional intermediate system.

A lock mode is a mode (1) in which a lock system runs various lock operations, and (2) to which a terminal grants such access authority enough to drive the least number of various hardware or software elements of a terminal. Accordingly, a lock mode corresponds to a mode which is granted with the least access authority. In contrary, an unlock mode is a mode (1) in which an unlock (or main) system runs various unlock operations and (2) to which a terminal grants such access authority enough to drive the greatest number of such hardware or software elements of a terminal. Thus, an unlock mode corresponds to a mode which is with the greatest access authority.

A terminal may set up another hierarchy in which various modes are arranged in a parallel or series manner, but in which at least two modes are granted with completely non-overlapping access authorities. Therefore, a terminal may drive entirely different hardware or software elements in each of the modes. In the alternative, at least two modes may be granted with the access authorities which partly overlapping access authorities. Accordingly, a terminal (1) may drive a 1^{st} of such elements in both modes, but (2) may drive a 2^{nd} of such elements in one of such modes but not in the other of such modes.

A terminal may rather operate in a hierarchy which may define multiple lock (or unlock) modes. In this case, a terminal may include multiple lock (or unlock) systems, and may grant multiple lock (or unlock) modes with the same, similar, or different access authorities in such a way that [1] a single user may use each of such modes for different purposes, or [2] multiple users can operate a single terminal one at a time, e.g., by ensuring each user to run operations only in his or her own modes but not in other users' modes. Accordingly, a terminal may enhance its security, improve its integrity, and ensure privacy of each user's data stored therein.

A data processing terminal of this disclosure may operate in a hierarchy which additionally defines at least one intermediate mode therein. In this case, a terminal may also include at least one intermediate system which operates in the intermediate mode. A terminal may grant an intermediate mode with access authority which is less than that of an unlock mode but greater than that of a lock mode.

A terminal may set up at least one hierarchy in which at least one lock mode, at least one intermediate mode, and at least one unlock mode are arranged in a parallel or series manner so that a user may switch from one mode to another in an order as provided in the hierarchy. Therefore, when a user provides a user input which includes a mode-switching (user) sub-input, a user may switch modes along the hierarchy in a forward direction (i.e., from one mode with less access authority to another mode with greater access authority) or in a backward direction (i.e., from one mode with greater access authority to another mode with less access authority).

It is noted that this disclosure provides various exemplary aspects and their exemplary embodiments in which a data processing terminal operates in a hierarchy defining at least one unlock mode and at least one lock mode. However, such aspects and embodiments are readily applicable to other terminals which may operate in another hierarchy which defines at least one intermediate mode along with such lock and unlock modes.

As to the “second feature,” a data processing terminal of this disclosure can achieve the enhanced security, the improved integrity, and the better data protection, while maintaining a convenience of seamless operations by including at least one main system and at least one lock system therein and by “isolating” at least a portion of a main (or lock) system from at least a portion of a lock (or main) system either “completely” or “partly.” Therefore, whatever websites a user may access with a lock system in a lock mode or whichever contents a user may download or process with a lock system in a lock mode, a terminal may prevent malicious viruses impregnated in such contents from adversely affecting the main system due to such isolation.

That is, even when such malicious viruses successfully land into a lock system while a user runs various lock operations with a lock system in a lock mode, such viruses cannot migrate into a main system and cannot adversely affect any hardware or software element of the main system due to such isolation. As a result, a terminal can enhance the security of its main system, improve the integrity of its main system, and heighten the protection of precious data stored in the main system.

As to the “third feature,” to achieve the enhanced security, improved integrity, and tightened data protection while maintaining a convenience of seamless operations, a data processing terminal of this disclosure may “run an erase (or semi-erase) operation” and erase such malicious viruses or codes which may have migrated into a lock system in a lock mode, preferably before a main system of a terminal may contact such viruses or codes. Thus, such viruses or malicious codes cannot adversely affect any hardware or software element of the main system.

To this end, a lock system may run an erase (or semi-erase) operation in a lock mode and erase such malicious viruses or codes which may be included in such results which are in turn obtained by running lock operations with a lock system in a lock mode. In this case, various erasure timings correspond to those which are before a terminal switches from the lock mode to another mode.

Alternatively, a main system may run an erase (or semi-erase) operation in an unlock mode and erase such malicious viruses or codes included in such results. Accordingly, whatever websites a user may access or whichever contents a user may download or process with a lock system in a lock mode, a terminal may prevent any virus impregnated in such contents from adversely affecting the main system due to such erase (or semi-erase) operation.

Because a data processing terminal of this disclosure operates in each of multiple modes, a user may have to frequently switch from one mode to another. Accordingly, in the “fourth feature,” a data processing terminal of this disclosure may incorporate at least one “mode-switching input unit” to maintain a convenience of seamless operations, while also achieving the enhanced security, the improved integrity, and the better data protection.

A mode-switching input unit is an input unit which is specifically designated to receive a user input which in turn includes a mode-switching (user) sub-input (i.e., UI_{SWI}) therein. Upon receiving a user input, such an input unit may acquire the mode-switching (user) sub-input using its sensor, may generate a control signal, and then may send the control signal to a main CPU or a main O/S. Based thereon, a terminal may switch from a current mode to a new mode which matches the sub-input.

A mode-switching input unit may be provided as a prior art hard button (e.g., a button or a switch), a prior art soft-key, or a prior art soft button (e.g., a GUI displayed on a display unit). Alternatively, a mode-switching input unit may be incorporated into a main input unit, thereby forming a unitary article.

Disclosed hereinafter include various exemplary aspects, exemplary embodiments, and detailed examples of data processing terminals of this disclosure, where such terminals may operate in multiple modes of operation to provide their users with the enhanced security, improved integrity, and heightened privacy of personal data stored therein. More particularly, this disclosure relates to various configurational and operational features of such terminals and to various methods of constructing or using such terminals in various hierarchies of multiple modes of operation. This disclosure also relates to methods of driving various hardware or software elements of a main system of such a terminal.

It is appreciated that this disclosure is provided with reference to accompanying drawings and text, in which such exemplary aspects, embodiments or examples only represent different forms. However, such terminals and various methods related thereto may also be embodied in many other different configurations, structures, methods, processes, or sequences in such a way that they should not be limited to various exemplary aspects and embodiments as set forth hereinabove and hereinafter. Rather, such exemplary aspects and embodiments described herein are provided so that this disclosure will be thorough and complete, and fully convey the scope of such terminals, methods, processes or sequences to one of ordinary skill in the relevant art.

It is appreciated that, unless otherwise specified, various systems, units, elements, portions, or parts of various data processing terminals are not typically drawn to proportions or scales in the accompanying figures for ease of illustration. It is also appreciated that such systems, units, elements, portions, or parts of such terminals and their operations, steps, and sequences which are designated by the same numerals in accompanying figures mean the same, similar or functionally equivalent systems, units, elements, portions, parts, operations, steps, and sequences, respectively.

Reference is made to accompanying drawings which show, by way of illustration, various exemplary aspects or embodiments in which various data processing terminals may be constructed and various methods related to such terminals may be practiced. It is appreciated that numerals appearing between parentheses “(“and”)” such as, e.g., (10) or (60), in this disclosure represent those systems, units, elements, portions, or parts which appear in the drawings.

It is appreciated that various exemplary aspects and embodiments of such data processing terminals of this disclosure, although different, are not necessarily mutually exclusive. That is, a particular feature, structure, operation, function, method, sequence or characteristic of such a terminal described herein in connection with one exemplary aspect or embodiment may also be implemented into another aspect or embodiment of this disclosure, within the extent of not contradicting each other, and without departing from a spirit and a scope of such terminals throughout this disclosure. Of course, such implementation may be subject to a modification, addition or omission each of which becomes apparent based on detailed contexts.

It is also appreciated that an arrangement or a position of each system, unit, element, portion, or part of various exemplary aspects or embodiments of this disclosure may also be modified to certain extents without departing from the spirits and scopes of other exemplary terminals of this disclosure. Accordingly, the following detailed description is not to be taken to limit the scope of various terminals for providing multiple different modes of operation while ensuring the enhanced security, improved integrity, and better data protection, not to mention seamless capabilities provided by such terminals. The scope of such terminals and methods are defined only by appended claims which should be interpreted in a full range of equivalents to which such claims are entitled. In the drawings, like reference numerals identify like or similar elements or functions through the several views.

Hereinafter, exemplary aspects and embodiments of various data processing terminals of this disclosure will be explained in detail in both hardware and software perspectives and with reference to the accompanying drawings so that those skilled in the art can easily understand and use such terminals, can manufacture such terminals, and can perform such sequences or steps of various operations for such terminals.

### 4. 1^{st} Configuration—Lock System with A Lock Viewer

In the first exemplary aspect of this disclosure which corresponds to the 1^{st} Configuration of this disclosure, a data processing terminal includes at least one main system and at least one lock system. A main system may include at least one main CPU unit, main input unit, main output unit, main memory unit, or other optional main units, where the main output unit may include at least one display unit for displaying static or dynamic images thereon, or at least one speaker to generate sounds. In contrary, a lock system may include at least one lock viewer and an optional lock memory unit, where this lock system may be viewed to have one of the simplest configurations. It is appreciated that each of the above units of a main (or lock) system may include or may be associated with at least one hardware or software element of a main (or lock) element to run certain operations, thereby performing specific functions assigned to each of such units.

### 4-1. 1^{st} Configuration—Main System

In one exemplary embodiment of the first exemplary aspect of this disclosure, a terminal includes at least one main system which in turn includes various main units each of which may include at least one (main) hardware element or at least one (main) software element. Such a software element may be embedded into the hardware element or may be provided as separate computer codes or computer programs.

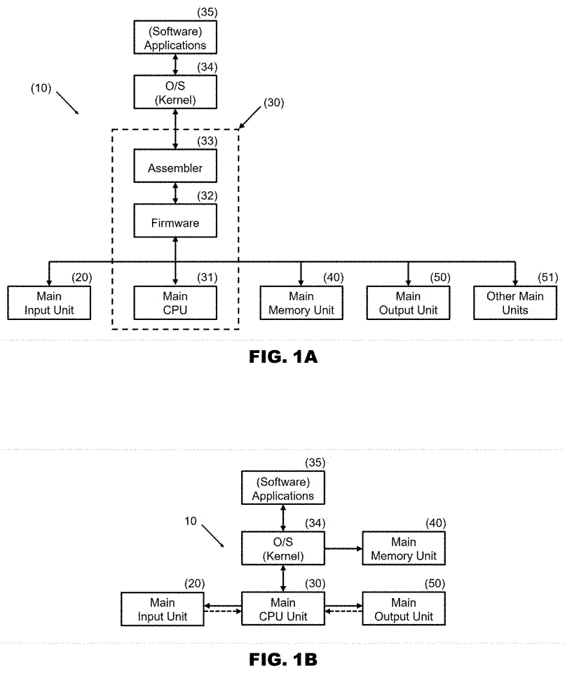

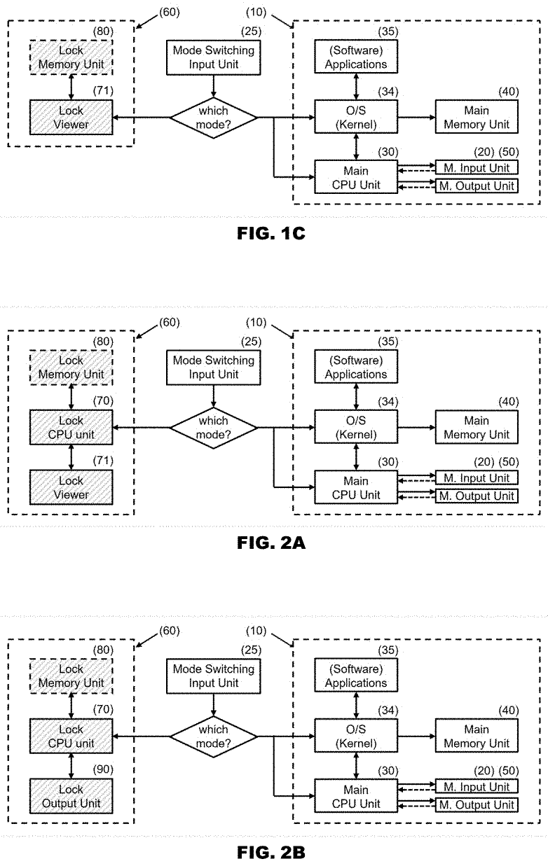

FIG. 1A is a block diagram of a main system of an exemplary data processing terminal of this first exemplary aspect of this disclosure. In particular, FIG. 1A describes a main system in a context of multiple abstract layers, where an exemplary main system (10) includes therein at least one main CPU (31), at least one main firmware (32) (optional), at least one main assembler (33) (optional), at least one main input unit (20), at least one main memory unit (40), at least one main output unit (50), at least one main (software) application (35), at least one main operating system (i.e., or an O/S) (34) which may include at least one main kernel (optional), and other optional units (51).

Various lines which connect such units of FIG. 1A describe “paths” of physical or operational coupling between various units such as, e.g., a command signal, data transfer, manipulation, or the like. It is noted that the paths of FIG. 1A are only exemplary and that many other units may be connected by additional paths. For example, the main CPU (31) and the main O/S (34) may drive other units of FIG. 1A. Not all paths are included in this figure, however, for simplicity of illustration, and other paths among such units of the figure will to be explained in greater detail below.

A main CPU (i.e., a main central processing unit) (31) generally refers to an electronic circuitry which carries out instructions of a computer program by performing basic arithmetic, logical, control, and/or I/O operations as specified by such instructions. The main CPU (31) may be fabricated as a microprocessor, may instead be incorporated into a microcontroller, or may be formed as a system-on-a-chip (SoC) which may also include therein a memory part, a peripheral interface, or the like.

A main firmware (32) may be a prior art software or (software) application for providing control, data monitoring, or data manipulation to many engineered parts (or portions) of various hardware elements of a main system (10) of the terminal. The main firmware (32) may be incorporated into various prior art parts of a terminal such as, e.g., an input unit, a touchscreen, a camera, or a display unit. A main assembler (33) is another software or (software) application creating an object code, e.g., by translating combinations of various mnemonics and syntax for operations and addressing modes into their numerical equivalents. The main assembler (33) may calculate a constant expression and resolve a symbolic name for memory locations, and may store tedious calculations and manual address updates after program modifications.

A main O/S (34) refers to a “system software” which can manage various hardware or software elements and other elements of a main system (10). The main O/S (34) provides common services to computer programs. That is, every computer program (including applications or apps and other computer codes), except the main firmware (32), may require the O/S (34) to run operations and to perform their intended functions. In addition, a main O/S (434) with time-sharing features may schedule tasks for efficient use of the main system (10), and may include an accounting software for cost allocation of processor time, mass storage, printing, or other resources. A main O/S (34) may serve as an intermediary between various software and hardware elements for performing various functions such as, e.g., memory allocation, or I/O (input-output) hardware functions.

In relation to the main O/S (34), a main kernel is a computer program which may have a complete control over (almost) everything which is processed or executed in the main system (10). In this context, the main kernel may be deemed as a central core of the main O/S (34). Therefore, the main kernel is the first program loaded on a startup of a terminal, and then manages the remainder of the startup such as, e.g., I/O requests by various software elements, translating them into data processing instructions for the main CPU (31), or the like. The main kernel is responsible for managing a main memory unit (40) and for managing and communicating with various prior art computing peripheries such as, e.g., a printer, an external speaker, and an external monitor. The main kernel may also manage and communicate with other external electrical devices to which a terminal may be operatively coupled either by wire or wirelessly, where examples of such devices may include, but not limited to, an electrical device included in an IoT network, another terminal, another computer, a vehicle or an automobile, a motorcycle, a robot, a drone, a weapon with at least minimum electrical circuits, or the like.

A main kernel may connect with various software elements of a main system (10) (including software apps, i.e., software applications). Critical codes of such a kernel are usually loaded into a protected sector of memory, thereby preventing such codes from being overwritten by other, less frequently used parts of the main O/S (34) or various applications residing therein. The main kernel typically performs its tasks (e.g., executing programs and handling interrupts) in a “kernel space,” whereas everything a user normally performs (e.g., writing text in a text editor or executing programs in a GUI) is done in a “user space,” thereby preventing interference between user data and kernel data, and resulting diminished performance, instability, or the like. When a process makes request of the main kernel, the request is called a “system call.” Various kernel designs differ in how they may manage the system calls and resources.

FIG. 1B is a simplified block diagram of the main system of FIG. 1A. As shown in the figure and for illustration purposes, a main “CPU unit” (30) may collectively refer to the main CPU (31), the main firmware (32), and the main assembler (33), as encircled by a dotted line in FIG. 1A. It is appreciated that such hardware and software elements of the main CPU unit (30) are identical or similar to those commonly found in prior art data processing devices such as, e.g., mobile phones or smart-phones, and other features of such elements are omitted herein.

As a result and as shown in FIG. 1B, the main system (10) may include at least one main CPU unit (30), at least one main O/S (34), at least one main (software) application (35), at least one main input unit (20), at least one main output unit (50), and at least one main memory unit (40). Although not included in the figure, the main system (10) may further include other optional units which are omitted herein for simplicity of illustration.

Still referring to FIG. 1B, the main memory unit (40) may include at least one conventional non-volatile memory element or at least one volatile memory element. When desirable, a terminal may be configured to releasably couple with an external memory unit or card (e.g., an add-on device) in such a way that the main CPU (31) or the main O/S (34) may drive the main memory unit (40) as well as the add-on, external memory unit, and may store various data into one or both of such units.

In addition, other units may be similarly configured such that they can releasably couple with an external unit. For example, when a terminal runs a DNA authentication operation, an additional input unit may be added to a terminal to perform a DNA analysis. Other units of the main system (10) such as, e.g., the main input unit (20) and the main output unit (50), may be similar or identical to those commonly found in conventional mobile phones or smart-phones and, accordingly, detailed configurations or operational characteristics of such units (20), (50) are omitted herein for simplicity of illustration.

Unless otherwise specified, a terminal is deemed to be able (1) to operate a lock system (60) in a lock mode, (2) to operate a main system (10) in an unlock mode, and (3) to optionally operate an intermediate system in an intermediate mode. By default, a lock system (60) is deemed to be able to drive all lock units and to be also able to drive all (lock) hardware and software elements of a lock system. In addition, a main system (10) is similarly deemed to be able to drive all main units and to be also able to drive all (main) hardware elements and all (main) software elements of a main system.

In addition, it is appreciated that a default isolation between a main system (10) and a lock system (60) is a complete isolation in this embodiment. Therefore, a main system (10) cannot drive any lock unit or any (lock) elements in an unlock mode. Similarly, a lock system (60) cannot drive any main unit or any (main) elements in a lock mode. When a main system (10) and a lock system (60) are only partly isolated, however, a main system (10) may be able to drive at least one (lock) unit or all (lock) units of a lock system (60). However, unless otherwise specified, a lock system (60) is deemed to not be able to drive any unit or element of a main system (10).

### 4-2. 1^{st} Configuration—Lock System

As described above, the exemplary data processing terminal of FIGS. 1A and 1B includes at least one main system (10) which also includes various units therein. In another exemplary embodiment of the first exemplary aspect, such a data processing terminal also includes at least one lock system (60).

FIG. 1C is a block diagram of an exemplary lock system of the exemplary data processing terminal of FIGS. 1A and 1B, where those units enclosed by a box on the right side of FIG. 1C correspond to the main system (10) of the terminal, and where a lock viewer (71) and an optional lock memory unit (80) enclosed by another box on the left side of FIG. 1C constitutes the lock system (60). In addition, the terminal also includes at least one mode-switching input unit (25) which may be viewed as a hardware element of the main system (10) or lock system (60).

It is appreciated that a lock system (60) of FIG. 1C with at least one lock viewer (71) and at least one optional lock memory unit (80) may be viewed as the one with the simplest configurations. Although not shown in FIG. 1C, a lock system (60) may include other optional lock units such as, e.g., at least one lock input unit, at least one lock output unit, or the like. It is also appreciated that, although many units of FIG. 1C are not connected to each other by any path with a single arrow or double arrows, such paths are omitted herein for simplicity of illustration. For example, a main CPU unit (30) may directly drive a main memory unit (40) or a lock viewer (71), a main O/S (34) may directly drive a lock viewer (71), a lock memory unit (80), or a main input or output unit (20), (50). Similarly, a main memory unit (40) and a lock memory unit (80) may operationally couple directly or indirectly with each other, and such units (40), (80) may exchange data. For the simplicity of illustration, however, additional paths representing such operational couplings are omitted herein.

A “lock viewer” (71) generally serves to run lock (or intermediate) operations in a lock (or intermediate) mode. More particularly, the lock viewer (71) may correspond to a software application capable of presenting data or files in a format friendly to a user. A lock viewer (71) may be a limited-functionality (software) application with which a user may not edit, create or modify any data or files. Therefore, a lock viewer (71) may include at least one format translator which may provide various views of data or files by handling, e.g., a different byte order, a code page, a new line style, or the like.

A lock viewer (71) may render HTML markup into a form which is human friendly, or provide graphic files such as a thumbnail preview, a thumbnail creation, or an image zooming. Therefore, a lock viewer (71) may correspond to various prior art viewers or browsers, examples of which may include, but not limited to, [1] a file viewer, [2] an image viewer, [3] a web browser, or [4] other prior art viewers. The terminal may drive the lock viewer (71) in various ways such as, e.g., [1] by including a driver capable of driving the lock viewer (71), [2] by using a main CPU unit (30) when a lock system (60) includes such, or [3] by using a main O/S (34). A lock system (60) may optionally include a lock CPU unit which may drive the lock viewer (71) as described in the following Sections 5 and 6.

When a main system (10) does not include any main (software) application which functions identical or similar to a lock viewer (71), there may not be any (or at most negligible) concern for any potential conflict or interference between the main and lock systems (10), (60), as far as a lock viewer (71) is concerned.

But when a main system (10) includes at least one (software) application which may be identical or similar to the lock viewer (71), the software application in a main system (10) may be referred to as a “main viewer” in contrast to the lock viewer (71) of a lock system (60). In this case, the lock viewer (71) may be regarded as a limited-functionality viewer which is only driven by a lock (or intermediate) system (60) in the lock (or intermediate) mode, whereas the main viewer may serve as a full-functionality viewer which is driven by the main system (10) in an unlock mode.

In one example, the lock viewer (71) may display data which reside in a lock system (60), but may not display any data residing outside a lock system (60). That is, the lock viewer (71) may neither access the main memory unit (40), nor retrieve any data from the main memory unit (40). A terminal may prevent the lock viewer (71) from storing results obtained by running lock (or intermediate) operations in the lock (or intermediate) mode into the main memory unit (40). In another example, the lock viewer (71) may access the main memory unit (40), retrieve an entire (or only a certain) portion of data therefrom, and may display such data in the lock (or intermediate) mode. It is appreciated that a terminal may determine the access authority of the lock viewer (71) based on a hierarchy in which it operates, based on the user needs, or the like.

With such configurations, a terminal may entirely (or at least partly) prevent a lock system (60) from altering or otherwise adversely affecting not only a main memory unit (40) but also a main system (10) as a whole. As a result, a terminal may improve and maintain the integrity or security of a main system (10), or preserve privacy of the user data stored in a main system (10). A terminal may run an erase (or semi-erase) operation in various erasure timings, thereby removing an entire (or selected) portion of results which are obtained by running lock (or intermediate) operations and which reside in the lock (or intermediate) system (60).

Even when a lock viewer (71) is a (software) app which does not reside in a main system (10), a terminal may still entirely (or at least partly) isolate the lock viewer (71) from the main system (10), [1] to improve integrity or security of the main system (10), [2] to preserve privacy of user data stored or residing in the main system (10), or [3] to run an erase or semi-erase operation in various erasure timings.

When desirable, a terminal may conditionally or adaptively allow a lock viewer (71) to access a main system (10), to retrieve all (or only certain) data from a main memory unit (40), to store all (or only selected) results which are obtained by running lock (or intermediate) operations by a lock (or intermediate) system (60) into a main memory unit (40), or the like. It is appreciated again that a terminal may determine the access authority of the lock viewer (71) based on a hierarchy in which it operates, based on the user needs, or the like.

When a main system (10) includes a main viewer, a terminal generally grants greater access authority to the main viewer than to the lock viewer (71) such that the lock viewer (71) can only display those data [1] stored or residing in the lock system (60) [2] obtained from an external source, but cannot display any data stored in the main system (10), or [3] obtained by running lock operations in a lock mode.

Alternatively, a terminal may grant greater access authority to a lock viewer (71) (than a main viewer), where such access authority may relate to [1] accessing a main memory unit (40) of a main system (10), [2] accessing another unit of a main system (10), [3] accessing an external source of other data via an internet or other networks, [4] connecting to an external link via an internet or other networks, [5] driving a certain hardware or software element of a main system (10), or the like. As a result, the lock viewer (71) of this arrangement may even be able to access all data stored in the main memory unit (40) or other units of the main system (10), while running operations in the lock (or intermediate) mode, although such an arrangement may generally be a rare case.

When a terminal runs such erasure (or semi-erasure) before, during or after switching from a lock mode to an unlock mode, whatever operations a user may run in a lock mode or whatever results a user may obtain by running lock operations in a lock mode can be erased before, during or after the mode switching and, therefore, such results cannot affect a main system (10). It is noted that granting the proper access authorities to different modes of operation is typically a matter of selection of a terminal manufacturer or a user. That is, the terminal or a user may pick and choose to assign appropriate access authorities to each mode depending upon his or her purpose, environment, or the like.

It is appreciated, however, that granting greater access authority to a lock system (60) than a main system (10) may pose a threat to the security or integrity of a terminal, for a user may accidently store results infected with malicious virus into a main memory unit (40), or may unknowingly transfer data infected with such virus into a main system (10). To prevent such accidents, it is typically desirable to limit such authorities to access a main system (10) with a lock system (60) when a user operates a terminal in a lock mode.

Therefore, even when a terminal may grant a user to access all (or some) units of a main system (10) while a user operates the terminal in a lock mode, it is generally advisable to configure a terminal [1] to entirely (or at least partly) prevent a user or a lock system from storing such results obtained by the lock system (60) into the main memory unit (40) or to other units of the main system (10), or [2] to entirely (or at least partly) prevent a main system to access a lock system, without properly checking presence of malicious viruses in advance.

When a lock system (60) includes at least one lock memory unit (80), a terminal may allow a user to store all (or only some) results obtained by running lock operations in a lock mode into a lock memory unit (80). To this end, a terminal may allow a user to manually mark to-be-stored results, thereby not erasing such to-be-stored results during such erasure or semi-erasure. As a result, the to-be-saved results may remain in the lock system, even after a terminal may switch to a new mode granted with greater access authority than the previous lock mode.

Alternatively, a terminal may adaptively select to-be-stored results based upon certain criteria such as, e.g., a type or content of such results, a period of time in which a user processes such results, a period of time in which a user remains in a certain website, a user preference, use statistics, or the like.

The lock memory unit (80) may serve to temporarily (or permanently) store such results obtained by running lock operations in a lock mode. A terminal may also ensure that such lock operations run by a lock system (60), results obtained or downloaded in a lock mode, or results stored or residing in a lock system (60) may not adversely affect or contaminate a main memory unit (40) or other units of a main system (10). As a result, even when a terminal allows a user to operate a lock system (60) and to store such to-be-saved results into a lock memory unit (80) and to retrieve data therefrom, a terminal may still prevent a user from storing any results stored or residing in a lock system (60) into a main memory unit (40) or other units of a main system (10).

When a terminal includes a lock memory unit (80), the terminal may complement a main memory unit (40) with a lock memory unit (80). For example, a terminal may [1] retrieve data from one memory unit and store such data into another memory unit, [2] store the same data in both memory units, [3] divide data into two portions and then store each portion in each memory unit, or the like. However, because there always exist potential risks that bad viruses or computer codes included in the results stored or residing in a lock system (60) may contaminate a main memory unit (40) by overwriting good data with infected data, a terminal may completely (or at least partly) isolate a main memory unit (40) from a lock memory unit (80).

A terminal may even physically or operationally divide a main memory unit (40) into multiple isolated memory sectors (e.g., a main sector and a lock sector). Thereafter, a terminal may drive a main system (10) and run unlock operations only in the main sector, while driving a lock system (60) and running lock operations in the lock sector. A terminal may also physically or operationally isolate the main sector from the lock sector of the main memory unit (40), thereby preventing a potential mix-up between such sectors. In this configuration, a lock system (60) may not include any lock memory unit.

Various conventional memory devices may be recruited as the lock memory unit (80). For example, the lock memory unit (80) may be a prior art non-volatile memory device or a volatile memory device. In the latter case, a terminal may be configured to cut power supply to a lock system (60) when the terminal switches from a lock mode to another mode. In such a case, the latter arrangement offers the benefit of obviating a need to run a separate erase (or semi-erase) operation, for any results stored in a lock memory unit (80) of a volatile memory type are to be erased anyway. Of course, a terminal may run the erasure (or semi-erasure) on a lock memory unit (80) of the volatile memory type.

A lock viewer (71) may include a temporary memory sector, and a lock system (60) may utilize the temporary memory sector as a lock memory unit (80). Conversely, a main memory unit (40) may include a temporary memory sector, and a lock system (60) may utilize such a sector as a lock memory unit (80). In addition, a lock system (60) may use any other conventional memory devices as a lock memory unit (80), where such memory devices may be included inside the terminal, or may be provided as a portable, add-on device.

A lock memory unit (80) may be incorporated into a terminal in various arrangements. In one example, a lock memory unit (80) may be incorporated inside a terminal, or at least a portion of a lock memory unit (80) may be exposed to an exterior. A lock memory unit (80) may be provided as a separate unit which may be releasably coupled to and uncoupled from a terminal (e.g., an add-on device).

Regardless of its type, a lock memory unit (80) needs to provide a minimum memory space for processing or storing results obtained by running lock operations in a lock mode by a lock system, while temporarily or permanently storing such results. When a lock viewer (71) serves to only display various data (e.g., displaying images or playing sounds), a terminal may not need any lock memory unit, because such data do not have to be stored anywhere anyway.

A terminal may include at least one mode-switching input unit (25) which is designed to receive a user input, and to acquire a mode-switching (user) sub-input (UI_{SWI}) therefrom. As shown in the figure, the mode-switching input unit (25) may be provided to a terminal as a separate unit in addition to a main input unit (20), where the former (25) may be implemented next to the latter (20), or may be incorporated in a position different form that of the latter (20). Alternatively, a mode-switching input unit (25) and a main input unit (20) may be formed as a unitary article which includes a sensor for acquiring UI_{SWI} and another sensor for acquiring another (user) sub-input from at least one user input.

As far as a mode-switching input unit (25) receives a user input, acquires UI_{SWI} therefrom, generates a control signal, and to deliver such signal to a main CPU unit (30) or to a main O/S (34), detailed configuration of a mod-switching input unit (25) and an exact location of the input unit (25) are typically within the knowledge of one of ordinary skill in the relevant art. In this context, any prior art input unit (e.g., a prior art button, switch, or lever) may be readily employed as a mode-switching input unit (25), as far as a terminal may recognize a control signal generated by a mode-switching input unit (25) as UI_{SWI}.

A mode-switching input unit (25) may also be provided as a software element or as a user interface such as, e.g., a graphical user interface (GUI). When a terminal employs a GUI, a user may easily manipulate the GUI and provide a user input including UI_{SWI} thereto when a terminal is in its on-state before mode switching. When a terminal is in its off-state, however, it may not be easy for a user to locate the GUI on a display unit (which is turned off anyway).

In this case, a terminal may allow a user to provide UI_{SWI} through a separate hardware element. That is, a terminal may include a GUI and a hardware input unit, where a user [1]may be able to provide UI_{SWI} to either the GUI or the input unit either in the off-state or on-state, or [2] may provide UI_{SWI} to the GUI only in the on-state, but may provide UI_{SWI} to the hardware input unit only in the off-state. Similarly, a terminal may configure its main input unit to receive a user input with UI_{SWI}, along with other user inputs which include other (user) sub-inputs.

A user may operate a terminal while switching modes as he or she sees fit, using the above lock system (60) and main system (10). Followings are several exemplary operations of a terminal including at least one display unit which is in turn a hardware element of a main output unit (50) of a main system (10).

In general, a terminal may launch and operate a main system (10) in an unlock mode. Thereafter, a terminal may allow a main system (10) to drive various units and elements of a main system (10) in an unlock mode. Similarly, a terminal may launch and operate a lock (or intermediate) system (60) in a lock (or intermediate) mode, and then may allow the lock (or intermediate) system (60) to drive various units and elements of a lock (or intermediate) system in a lock (or intermediate) mode. Because a terminal may operate in a single mode, a main system (10) may not typically operate in a lock (or intermediate) mode, while a lock (or intermediate) system (60) may not typically operate in an unlock mode.

In this context, following embodiments or examples of this 1^{st} Configuration are illustrated in the arrangements in which a main system (10) preferentially drives various main units and various (main) hardware or software elements in an unlock mode, and in which a lock system (60) preferentially drives various lock units and various (lock) hardware or software elements in a lock mode. Although not included in the following arrangements, a terminal may include an intermediate system and operate such a system in an intermediate mode, where an intermediate system may preferentially drive various intermediate units and various intermediate hardware or software elements in an intermediate mode.

However, a terminal which operates in a lock mode may launch a main system (10) in addition to a lock system (60), and may allow either or both of the main and lock systems (10), (60) to drive various units and elements of either of the main or lock system (10), (60), or both of the main and lock systems (10), (60). A terminal may also operate a main system (10) in a lock mode, while allowing a main system (10) to drive all (or only selected) units and elements of a lock system (60), without any intervention from a lock system (60).

Thus, it is noted that various embodiments and examples of this 1^{st} Configuration may be readily modified such that a main system (10) alone or in conjunction with a lock (or intermediate) system (60) may drive a lock viewer (71) and an optional lock memory unit (80). It is further appreciated that such modifications apply to other exemplary aspects provided throughout this disclosure.

### 4-3. 1^{st} Configuration—Operation 1

In an Operation 1 that is another exemplary embodiment of the first exemplary aspect, a terminal (i.e., an input unit) receives a 1^{st} user input while its display unit is in its off-state. A terminal may then determine to which mode it is to switch in various ways. It is appreciated that this mode switching of a terminal from an off-state to one mode defined in a hierarchy corresponds to the 1^{st} type mode switching as defined above.

In one example, a terminal may switch to a lock mode upon (or in response to) receiving a 1^{st} user input and launch a lock system, regardless of whether or not the 1^{st} user input includes UI_{SWI}. Thereafter, while operating a lock system in a lock mode, a terminal may switch to an unlock mode when a user provides a 2^{nd} user input (e.g., the series switching). When a user provides another 3^{rd} user input thereafter, a terminal may remain in an unlock mode when a terminal may switch modes in a non-circulating hierarchy, for such a hierarchy does not allow a user to switch to a lock mode granted with less access authority from an unlock mode. Alternatively, upon receiving the 3^{rd} user input, a terminal may switch to the lock mode when the hierarchy is circulating.

In another example, a terminal may receive a 1^{st} user input, acquire UI_{SWI-1} therefrom, and may then switch to a lock (or unlock) mode based on UI_{SWI-1} (e.g., the selective switching). When a user provides a 2^{nd} user input, a terminal may [1] stay in the lock (or unlock) mode or switch to the unlock (or lock) mode based on UI_{SWI-2} included in the 2^{nd} user input when the terminal adopts the selective switching, [2] always switch to the unlock (or lock) mode when the terminal adopts the series switching and where the hierarchy is circulating, or the like.

### 4-3-1. Lock Viewer Revisited

Once a terminal starts to operate a lock system (60) in a lock mode, a lock system (60) may also start to drive a lock viewer (71). For example, a lock system (60) may drive a lock viewer (71) such as a prior art viewer or browser, and run various operations for viewing files (e.g., a file viewer), viewing images (e.g., an image viewer), or accessing websites (e.g., a web browser). Similarly, a lock viewer (71) may obtain such files or images from a lock memory unit (80), from a main memory unit (40), from add-on devices which may releasably couple with a terminal, or from external websites. Because a lock viewer (71) is a limited-functionality (software) application (or app), its user may not be able to edit, create or modify any of such files or images. A terminal may not allow a lock viewer (71) to store any of such files, images, or other results into a main memory unit (40), even when a lock viewer (71) may be equipped with a functionality to store such results into a lock memory unit (80) either temporarily or permanently.

As a software element of a lock system (60), a lock viewer (71) may be implemented into various locations of a terminal. For example, a lock viewer (71) may be stored in a user space of a lock system (60) (i.e., physically isolated from a main system), and a lock system (60) drives a lock viewer (71) in a lock mode (i.e., operationally isolated from an unlock mode). When a lock system may include a lock CPU unit or a lock O/S, a terminal may allow such a CPU unit or O/S to drive a lock viewer (71) in a lock mode. Alternatively, a terminal may allow a main CPU unit (30) or a main O/S (34) of a main system (10) to drive a lock viewer (71), either in a lock mode or an unlock mode, and may even allow a main system (10) to store data into a lock memory unit (80) in a lock or unlock mode, or to retrieve the stored data or results from a lock memory unit (80) in a lock or unlock mode.

To the contrary, a lock viewer (71) may be implemented into a main system (10) (i.e., not physical isolated), and a lock or main system (60), (10) may drive a lock viewer (71) in a lock or unlock mode. When a main system (10) includes a main viewer, a terminal may physically or operationally isolate a lock viewer (71) from a main viewer. However, when a terminal includes only a single viewer, the viewer may be driven as a lock viewer by a lock system (60) in a lock mode, but as a main viewer by a main system (10) in an unlock mode (i.e., neither physically nor operationally isolated from a main system). A terminal may allow a main viewer to retrieve data only from a main memory unit (40) or from both of the lock and main memory units (80), (40).

It is appreciated that such arrangements of the preceding paragraphs may apply to other (software) elements as well as other configurations. For example, when a lock system (60) includes a lock application (such as, e.g., a lock messenger app or other lock apps) and a main system includes a main application (such as, e.g., a main messenger app or other main apps), the lock and main apps may [1] be physically or operationally isolated from each other, or [2] drive an entire (or only selected) portion of a database such as, e.g. a main or lock memory unit (40), (80). In addition, both apps may access and process the same data, but the lock app may not allow a user to edit or otherwise modify such data.

A terminal may limit a temporal duration of [1] driving a lock viewer with a lock system, [2] driving a lock viewer by a certain user, or [3] operating a lock system in a lock mode, such as, e.g., [1] as a default setting, or [2] as far as a user desires (e.g., until a user switches to another mode, turns off a display unit, or the like). A terminal may also limit a temporal duration of driving a lock viewer based on [1] an absolute length of such driving, [2] a size of data which a user accesses, obtains, downloads or processes in a single session in a lock mode, [3] a size of such “results” obtained from running lock operations in a lock mode, [4] a length of viewing certain contents, [5] a number of websites visited by a user, or the like. Based on a system setting or a user preference, a terminal may also [1] continue to allow a user to drive a lock viewer or an entire lock system (60), [2] terminate a lock viewer, [3] terminate an entire lock system (60), or the like.

In addition, a terminal may set up a protocol to stop driving a lock viewer (71) (or a lock system) based upon various factors. For example, a terminal may stop driving a lock viewer or an entire lock system (60) when a user may [1] switch from a lock mode to another mode, [2] turn off a display unit, [3] fail to provide any user input (i.e., a non-action by a user) for more than a preset period, [4] fail user authenticating for a preset number of times, or [5] pass such authenticating. More particularly, after stopping to drive a lock viewer (71), a terminal may switch to an unlock mode in [1] or [5] of this paragraph, may stay in a lock mode while driving a lock system (60) in [2], [3], or [4] of this paragraph, or the like.

A terminal may stop driving a lock viewer (71) or a lock system (60) [1] when a user attempts to access and to drive a hardware or software element of a main system (10) which is not accessible in a lock mode, [2] when a user tries to connect to a forbidden website, [3] when a user attempts to download data from an unreliable website, [4] when a terminal finds potential risks or malicious viruses from such websites or downloaded data, or the like. After a terminal stops driving a lock viewer (71), it may [1] remain in a lock mode while driving a lock system (60), [2] turn off its display unit, [3] give off visual or audible alarms, or [4] power off itself.

### 4-3-2. Synchronizing Mode Switching with User Authenticating

A terminal may be configured to switch from its off-state to a lock mode whenever a user provides a user input, whether or not [1] a user input includes therein UI_{SWI}, or [2] a terminal runs any authentication operation. That is, a terminal may be configured to switch modes (i.e., from an off-state to a lock mode) by turning on its display unit whenever it receives a user input in this arrangement.

Conversely, a terminal may condition the mode switching upon an outcome from user authenticating. That is, a terminal may switch modes differently whether or not a user passes the authenticating. As a result, a terminal may (or not) [1] turn on its display unit in one of various “turning-on timings” in response to UI_{SWI}, or [2] launch a lock system (60) or a main system (10) in various “launch timings” which is defined as the timings to launch a lock (or main) system with respect to a mode switching, where examples of the “launch timings” may include launching such a system [1] concurrently with a mode switching (e.g., at least one step of a launch operation overlaps with at least one step of a mode-switching operation), [2](immediately) after the mode switching, [3] after such mode switching but before a user provides another user input, [4] upon receiving a user input which includes UI_{SWI}, [5] concurrently with running an authentication operation, [6] (immediately) after running an authentication operation, [7] (immediately) before, concurrently with, or (immediately after) turning on (or off) a display unit of a terminal, or the like.

Because a terminal includes a separate, lock system (60) to run lock operations and isolate potentially harmful results and malicious viruses included therein from a main system (10), a lock system (60) may be physically or operationally isolated from a main system (10). Because it is desirable to remove such potentially harmful results from a terminal, a terminal may run an erase (or semi-erase) operation on all (or some) results before, during, or after the mode switching, thereby preventing the results from adversely affecting a new system operating in a new mode. Accordingly, a terminal may not require a user to authenticate himself or herself to launch a lock system (60).

A terminal may run such erase (or semi-erase) operation onto a lock memory unit (80) or onto a lock memory sector, and may erase (or semi-ease) only those results stored or residing therein. However, a terminal may run the erasure or (semi-erasure) by reformatting a lock memory unit (80) or a lock memory sector in which a lock viewer (71) may be stored. This arrangement may be useful when a previous lock viewer is contaminated by malicious virus or when a previous lock memory unit does not function normally due to such contamination. In this case, a terminal may reformat a lock memory unit (80) or an entire lock system (60), and then may have to reload a new lock viewer (71) and (optionally) its driver into a lock system (70).

A terminal may also run an authentication operation and allow a user to switch to an on-state and to advance to one of various modes defined in a hierarchy. For example, when a terminal runs at least one authentication operation in its off-state and when a user fails the user authenticating, a terminal may [1] keep its display unit turned off (i.e., staying in its off-state), or [2] launch a lock system (60) in a lock mode. Even while launching a lock system (60), a terminal may maintain its display unit turned off. This arrangement may prove useful, for a terminal with a launched lock system (60) may respond to additional user authenticating more quickly than otherwise. In the alternative, a terminal may turn on its display unit in one of such turning-on timings, while or after launching a lock system (60). This arrangement may be also helpful, for a user may easily confirm that a terminal is now waking up.

However, it frequently happens that the user authenticating may take longer than turning on a display unit. In this case, a terminal may first turn on a display unit and display a lock (or default) screen thereon in response to (or upon) receiving a user input, until a terminal completes the user authenticating. Thereafter, when a user fails the authenticating, a terminal may [1] turn off its display unit or [2] keep displaying a lock screen on an already turned-on display unit.

When a user passes such authenticating, a terminal may switch from a lock mode to an unlock mode, while launching a main system (10). During or after such mode switching, a terminal may display an unlock (or home) screen on its display unit. To this end, a terminal may [1] stop displaying the previously displayed lock screen and start to display an unlock screen, with or without any temporal gap between displaying different screens, [2] overlay an unlock screen over a lock screen, [3] gradually removing a lock screen, while filling the remove portion of a screen with an unlock screen, or the like.

Once a terminal launches a lock system (60) or a main system (10) in a lock or unlock mode, respectively, a user may run various lock or unlock operations therewith. When a user wants to switch from a current mode to a new mode, a user may provide a user input with UI_{SWI}, e.g., simply by manipulating a mode-switching input unit. Based thereon, a terminal may switch modes or may stay in a current mode.

When a new mode (e.g., an unlock mode) which a user wants to switch to may be granted with greater access authority than a current mode (e.g., a lock mode), a terminal may optionally request a user to run at least one user authentication operation. In addition, a terminal may run optional erasure (or semi-erasure) in one of the erasure timings, while also running a real-time, intermediate, or ex-post erasure (or semi-erasure), depending upon the needs of a user.

Once launched, a lock system (60) may start to drive a lock viewer (71). As discussed above, a terminal may launch a lock system (60) [1] whenever a user provides a user input and a terminal turns on its display unit in response to the user input (i.e., without having to run an authentication operation), [2] when a user fails the user authenticating in response to a user input received by a terminal in its off-state, [3] when a user passes the user authenticating in response to a user input received by a terminal in its off-state, or [4] when a terminal switches from an unlock mode to a lock mode.

A lock viewer (71) may then start to run lock operations, e.g., presenting data or files in a format friendly to a user. To this end, a lock viewer (71) may retrieve such data or files from [1] a lock memory unit (80), [2] a main memory unit (40), [3] an external device releasably coupled to a terminal, or the like. A lock viewer (71) may also retrieve the data or files from an external source through an internet or other communication means. In the last case, a lock system (60) may utilize a hardware element of a main system (10) for communication purposes.

An entire portion of a lock system (60) may be installed inside a cover of a terminal, or at least a portion of the lock system (60) may be exposed to an exterior. Alternatively, an entire (or a selected) portion a lock system (60) may be fabricated as an “external device” such as, e.g., [1] an “add-on device,” [2] a “portable device,” or [3] a “wearable device.” It is appreciated that an external device may include therein a lock viewer, a lock CPU unit, a lock memory unit, a lock input unit, or a lock output unit, and that an external device may include therein at least one lock hardware or software element, while including (or not including) an optional driver capable of driving the lock software element.

An external device may be fabricated as an “add-on device” which may be releasably coupled to a terminal and uncoupled therefrom. Thus, an add-on device may be fabricated as [1] a protector of a terminal, [2] its holder, [3] its case, [4] its cover which may enclose at least a portion of a terminal, [5] a “USB-type memory” (with or without including a driver therein), [6] an “external memory chip (or card)” which may couple with a terminal and which may (or not) include a driver, [7] a “portable memory chip (or card)” such as, e.g., a USIM card or a SIM card, which may releasably couple or uncouple with a terminal, and which may (or not) include a driver, [8] any other prior art memory chip (or device) which may include a space for storing data therein and which may (or may not) include a driver, or the like.

An external device may also be fabricated as a “wearable device” which a user may wear on or over a user's body part. Therefore, a wearable device may be fabricated as [1] a watch, [2] a wrist-band, [3] an arm band, [4] a glove, [5] a ring, [6] a goggle, [7] an eye glass, [8] a helmet, [9] a hat, [10] a belt, [11] a necklace, [12] a bracelet, [13] an earring, [14] an artificial nail, [15] an artificial tooth, [16] a shoe, [17] a pendant, [18] a brooch, [19] other ornaments, or [20] any other devices which may be portably worn by a user.

Moreover, an external device may be fabricated as a “portable device” which a user may readily carry with him or her. Such a portable device may be fabricated as [1] a bag, [2] a backpack, [3] a handbag, [4] a briefcase, [5] a luggage, or the like.

It is appreciated that [1] the above external device may be the lock system (60) itself, or [2] that a lock system (60) may constitute only a portion of the above external device. Therefore, the above external device of [2] of this paragraph may include not only at least a portion of a lock system (60) but also [2-1] at least a portion of a main system or [2-2] electric parts which do not relate to a terminal. For example, the above external device may include an entire (or a selected) portion of a lock system (60) and other electric parts such that the external device may operate (1) not only as a lock system (60) of a terminal (2) but also as a remote controller of a vehicle, a robot, another data processing terminal, another computer, other electrical appliances, or the like. It is also noted that the above external device may operationally communicate (or couple) with a terminal by wire or wirelessly.

It is appreciated that various features and configurations of a lock system (60) which are exemplified in this Section apply not only to the terminals of this 1^{st} Configuration but also to other Configurations of this disclosure provided hereinabove and hereinafter.

### 4-3-3. Erasure or Semi-Erasure

To enhance the security of a terminal, to improve its integrity, and to better protect personal data stored therein, a terminal may also run an erase (or semi-erase) operation in one of various erasure timings defined herein. A terminal may also run a real-time, intermediate, or ex-post erasure (or semi-erasure), thereby enhancing the security of a terminal, improving its integrity, and preserving private data stored in its main system (10).

In general, when a new mode (e.g., a lock mode) which a user wants to switch to is granted with less access authority than a current mode (e.g., an unlock mode), a terminal may not ask a user to run user authentication operations. A terminal may run the erasure (or semi-erasure) in one of such erasure timings, while running the real-time, intermediate, or ex-post erasure (or semi-erasure).

Because a terminal switches from an unlock mode to a lock mode in this example, potential risks that various outcomes obtained by running unlock operations with a main system (10) in an unlock mode may adversely affect a lock system (60) may be marginal in most cases. However, these features may not alleviate concerns of a current user that a 3^{rd} party may operate the same terminal in the same unlock mode later, and find out a list of operations which a user ran in an unlock mode or a list of websites which a user visited in an unlock mode, a list of files which a user downloaded in an unlock modes, a list of messages or SNS communications which a user exchanged with a 4^{th} person in an unlock mode, or the like. Accordingly, a user may prefer that a terminal runs such erasure or semi-erasure whenever he or she switches modes, regardless of the access authorities granted to the current and new modes.

When a terminal includes at least one lock memory unit (80), a lock system (60) may store at least a portion of “results” which are obtained by running lock operations in a lock mode (i.e., “to-be-stored results” or “stored results”) into a lock memory unit (80). A terminal may store such to-be-stored results either actively or passively.

It is noted that such “to-be-stored results” are generally identical to the “stored results,” unless a terminal fails to store all or some of such to-be-stored results and, as a result, the stored results turn out to be only a portion of the to-be-stored results. Accordingly, the “to-be-stored results” and the “stored results” typically refer to the same portion of such “results,” where such “to-be-stored results” mean at least a portion of such “results” before a terminal actually performs or completes such storing, while such “stored results” represent the same portion of such “results” after a terminal completes such storing.

In one example, a lock system (60) may actively store to-be-stored results before a lock system (60) runs such erasure (or semi-erasure) and, therefore, erases all or some of the to-be-erased results (i.e., “erased results”). Because such to-be-stored results have already been stored into a lock memory unit (80), a lock system (60) may run such erasure by erasing all results remaining in a lock system (60).

In another example, a lock system (60) may not actively store such to-be-stored results, but a lock system (60) may run a semi-erase operation by selectively erasing such to-be-erased results, while leaving such to-be-stored results in a lock system (60). Thus, a lock system (60) may be deemed to passively store such to-be-stored results in a lock memory unit (80). It is noted that either a lock or main system may select which results to be erased (or stored), where such results will be stored, e.g., in a lock memory unit (80) or a main memory unit (40), or the like.

A terminal or a user may select the to-be-erased results or to-be-stored results in various ways. In one example of an ex-post semi-erasure, a user may select the results to be erased (or stored) upon stopping to drive a lock viewer (71) or a lock system (60) by, e.g., marking specific files or folders of such results in a lock mode such that a terminal may thereafter erase (or store) only those marked files or folders. That is, a terminal may erase only those marked results, while not erasing (or saving) the rest of such results (or vice versa).

When a lock system (60) includes a lock memory unit (80), a lock system (60) may store such to-be-stored results therein. A lock system (60) may instead store such results in a main memory unit (40) (when allowed by a terminal), in a temporary memory sector (e.g., a data buffer, a cache, a clipboard, or a recycle bin) of a main system (10) or a lock system (60), or the like.

A terminal may also assist a user by displaying a list of such results obtained by running lock operations to a user and by allowing a user to mark which files or folders of such results may be erased (or stored). Once a user provides such markings, a terminal may erase or semi-erase (or not erase or save) such marked results in one of various erasure timings. Alternatively, a terminal may erase (or store) such results, only when a user confirms such erasure or storing. Accordingly, a terminal may prevent accidental or unintentional erasure (or storage) of desirable (or undesirable) results.

A terminal may allow a user to select [1] which memory units to store such results, [2] how long such results are to be stored, [3] in which mode a user may retrieve such results, or the like. A terminal may also connect to an external server and request the server to erase (or store) such to-be-erased (or to-be stored) results in that server, while optionally displaying whether or not such to-be-erased (or to-be-stored) data have actually been erased (or stored) in the server. This arrangement is particularly helpful when a lock viewer (71) retrieves data or files from the external server and displays such data or files on a display unit in a lock mode. A terminal may also manage a list of all websites or uniform resource locators (URL) which a user has accessed in a lock mode and inform the user of their erasure, with or without a user confirmation.

### 4-3-4. Launching Different Systems

In general, a terminal is to first launch (or load) a main system (10), and then to operate a main system (10) in an unlock mode. Similarly, a terminal is to launch a lock system (60), and then to operate a lock system (60) in a lock mode. For example, when a user provides a user input to a terminal in its powered-off state, a terminal may launch a lock system (60), and run an authentication operation. When a user passes such authenticating, a terminal may launch a main system (10).

A terminal may instead launch a lock system (60) and a main system (10) upon powering on either concurrently, or may launch one of such systems (10), (60), and then launch the other of such systems (10), (60). Thereafter, a terminal may pause operation of one of such systems, while continuing to operate the other system. In this case, a terminal may end up operating both systems (10), (60) for a certain period of time, unless a user turns off a display unit or powers off a terminal before he operates the other system. A typical example of this case is a terminal which displays two independent screens and which operates a main system (10) in one screen, while operating a lock system (60) in another screen.

Alternatively, a terminal may launch a main system (10) in a lock mode, with or without launching a lock system (60). In this arrangement, a main system (10) may be deemed to assist a lock system (60) or to rather replace a lock system (60).

When a terminal operates a main system (10) and a lock (60) system simultaneously, there exists a danger that a terminal may accidently allow a lock system (60) to drive some hardware or elements of a main system (10), to retrieve some data stored in a main memory unit (40), or to store such results obtained by running lock operations in a lock mode thereto.

Because both systems are concurrently operating, a terminal may have to effectively isolate a main system (10) from at least one or entire portion of a lock system (10).

A terminal may launch a lock system (60) or a main system (10) in various ways. In one example, a terminal may launch only one system at a time, but not two at the same time.

Therefore, when a terminal of this example switches modes, a terminal first stops to operate a lock system operating in the current lock mode, and then launches a main system in an unlock mode. In another example, a terminal may drive at least two different systems at the same time or in an overlapping manner.

As a result, when a terminal is to switch from a lock mode to an unlock mode, a terminal may (1) re-operate a main system (10) while still continuing to operate a lock system (60), (2) run a mode-switching operation with a main system (10), and (3) stop to operate a lock system (60) during or after switching to an unlock mode. The same arrangement may apply to a terminal which is to switch from an unlock mode to a lock mode.

### 4-3-5. Miscellaneous

Upon stopping to operate a lock viewer (71) or a lock system (60), a terminal may run a single operation or a series of preset operations. That is, when a terminal switches from a lock mode to another mode (including an off-state or a powered-off state), a terminal may [1] only run a mode-switching operation and wait for another user input, or [2] run not only the mode-switching operation but also at least one another operation, where such another operation may be determined in various ways.

In one example, before such mode switching, a terminal may [1] ask a user to supply UI_{THEN} and then run an authentication operation after acquiring such UI_{THEN}, [2] run an operation for displaying one of multiple lock (or unlock) screens on a display unit, [3] run an operation for connecting to a communication network or a network of internet-of-things, [4] run an operation to drive at least one hardware element of a main system (10) (e.g., a display unit, a camera, a speaker, a microphone, a GPS, a wireless transmitter, a wireless receiver, a sensor for user authenticating, or the like), or [5] run an operation for driving one or more software elements of a main system (10). Thus, the nature of such operations is generally related to which mode of operation a terminal is to switch.

Upon receiving a user input in an off-state and while deciding to which mode it switches to, a terminal may run at least one additional operation as well. For example, a terminal may receive a 1^{st} user input which includes UI_{SWI} as well as at least one more (user) sub-input such as, e.g., UI_{THEN} or UI_{ACT}. When a 1^{st} user input includes UI_{THEN}, a terminal runs an authentication operation in response to the user input as described hereinabove. Therefore, details of such operations are omitted herein.

When a user input includes UI_{ACT} (along with U_{THEN} or without UI_{THEN}), a terminal may turn on a display unit in response to the user input in one of such turning-on timings as defined herein. More particularly, a terminal may turn on a main display unit using a main system (10) or a lock system (60), or may automatically turn on a display unit in response to the user input.

Once a display unit is turned on, a terminal may automatically display a lock (or default) screen on a display unit. When a terminal runs an authentication operation, however, a terminal may run one of many operations such as, e.g., [1] keeping its display unit turned off until a terminal completes user authenticating, [2] turning on a display unit and displaying a lock (or default) screen thereon before a terminal completes authenticating and obtaining an outcome therefrom, or the like. In [1] of this paragraph, a terminal may [1-1] keep a display unit turned off when a user fails such authenticating, [1-2] turn on a display unit and display a lock screen thereon in case of such failure, or [1-3] turn on a display unit and display an unlock screen when a user passes such authenticating. In [2] of this paragraph, a terminal may [2-1] turn off its display unit when a user fails such authenticating, [2-2] keep displaying a lock screen when a user fails such authenticating, [2-3] replace a lock screen with an unlock screen when a user passes the user authenticating, or the like.

It is noted that various operations of this Section also apply to a terminal including an intermediate system operating in an intermediate mode. For example, such operations related to switching from a lock mode to an unlock mode as described above may apply to operations related to switching [1] from a lock mode to an intermediate mode, [2] from an intermediate mode to an unlock mode, or [3] from a 1^{st} intermediate mode granted with less access authority to a 2^{nd} intermediate mode with greater access authority. Such operations related to switching from an unlock mode to a lock mode may also apply to operations related to switching [1] from an unlock mode to an intermediate mode, [2] from an intermediate mode to a lock mode, or [3] from the above 2^{nd} intermediate mode to the above 1^{st} intermediate mode.

Although not included in this first exemplary aspect, a terminal may also include a main system (10) and a lock system (60), but may operate in a hierarchy which defines more than two modes. In one case, a hierarchy may define [1] one lock mode, one intermediate mode, and one unlock mode, [2] multiple lock modes, one unlock mode, and optional intermediate modes, [3] one lock mode, multiple unlock modes, and optional intermediate modes, [4] multiple lock and unlock modes, and optional intermediate modes, [5] only multiple unlock (or lock) modes, or the like, where a terminal may grant each of such multiple lock (or unlock) modes with identical, similar, or different access authorities.

The above modes may also be arranged in a certain hierarchy in parallel or series manner. When desirable, a terminal may set up multiple hierarchies, and allow a user to first select a certain hierarchy in which various modes are arranged to meet various needs of a user. In any of the above cases, a terminal may switch modes according to one of various arrangements provided herein.

A terminal may operate in the series switching or in the selective switching as well, thereby allowing a user [1] to switch along various modes defined in a certain hierarchy one after another or successively whenever a user provides a user input, or [2] to jump from one mode to a new mode of his or her choice. Moreover, the hierarchy itself may be circulating and allow a user to switch from an unlock mode to a lock mode.

Conversely, the hierarchy may be non-circulating, where a user may not be able to switch to a lock mode anymore, once a user switches to an unlock mode. Accordingly, various methods of using a terminal of this 1^{st} Configuration and switching modes using such a terminal in response to a user input including UI_{SWI} may be similar to those of the panels (A) to (H) of FIG. 2 of the '861 application, where the panels (A) to (H) of FIG. 2 and relevant portions of the texts in the '861 application have been incorporated herein in their entirety by reference.

### 4-4. 1^{st} Configuration—Operation 2

In an Operation 2 which is another exemplary embodiment of the first exemplary aspect, a terminal (or an input unit) receives a 1^{st} user input while a terminal is in its on-state and while a terminal is operating in a lock mode. A terminal may then determine to which mode it is to switch in various ways. It is appreciated that this mode switching of a terminal from an on-state to another mode defined in a hierarchy corresponds to the 2^{nd} type mode switching as defined above.

In one example, upon receiving a 1^{st} user input which may or may not include any UI_{SWI}, a terminal may switch from a lock mode to an unlock mode in response to a 1^{st} user input when a terminal adopts the series switching. When a user provides an additional user input thereafter, a terminal may remain in an unlock mode when a hierarchy is non-circulating, or may switch back to a lock mode when a hierarchy is circulating.

In another example, upon receiving a 1^{st} user input and acquiring UI_{SWI-1,} a terminal may stay in a lock mode or may switch to an unlock mode based upon UI_{SWI-1}, as may be the case of the selective switching. When a user provides a 2^{nd} input, a terminal may [1] stay in an unlock mode or [2] switch back to a lock mode based on UI_{SWI-2} when a terminal adopts the selective switching.

In either example, a user may readily provide a user input with UI_{SWI}, e.g., simply by manipulating at least a portion of a mode-switching input unit whenever he or she wants to switch from a current mode to a new mode. In addition, in either example, a terminal may run such erasure (or semi-erasure) in one of the erasure timings as defined herein. A terminal may also run the real-time, intermediate, or ex-post erasure (or semi-erasure), thereby enhancing security of a terminal, improving its integrity, and preserving private data stored therein.

Similar to the above Operation 1, a terminal may condition the mode switching upon an outcome of the user authenticating. It is noted that a terminal of this Operation 2 is (or has been) in a lock mode when it receives a 1^{st} user input. It then follows that [1] a terminal may not have to run any authentication operation for launching and operating a lock system (60) and thereafter begin to operate a lock system in a lock mode, or [2] a terminal may have already run the authentication operation, but a terminal has to launch a lock system (60) in a lock mode, for a user fails such user authenticating.

Whichever case it may be, to switch from a lock mode to an unlock mode, a terminal may better run such user authenticating and determine whether a current user is authorized for such mode switching. To this end, a 1^{st} user input may include not only UI_{SWI} but also UI_{THEN} for user authenticating, depending on whether a terminal adopts the selective switching or the series switching. For example, in case a terminal should adopt the series switching, a terminal may automatically switch from a lock mode to an unlock mode whenever a user passes such authenticating. Therefore, UI_{THEN} of a 1^{st} user input may also serve as UI_{SWI} in this case.

When a user fails the authenticating, a terminal may [1] stay in a lock mode while optionally notifying a user of such a failure, [2] ask a user to retry user authenticating while staying in a lock mode, [3] turn off a display unit, or [4] power itself off. However, when a user passes such authenticating, a terminal may switch to an unlock mode and display an unlock screen on a display unit, while launching (or resuming operation of) a main system (10) in one of such launch timings. When a user provides an additional user input thereafter, a terminal may switch back to a lock mode [1] when a terminal adopts the series switching or when a hierarchy is circulating, [2] when UI_{SWI} represents a lock mode and a terminal adopts the selective switching, or the like.

A terminal may also run an erase (or semi-erase) operation in one of various erasure timings as defined herein and in one of the real-time, intermediate, or ex-post manner, particularly when a new (e.g. an unlock) mode is granted with greater access authority than a current mode such as a lock mode. However, a terminal may run erasure (or semi-erasure) when it switches to a new mode granted with less access authority as well, due to various reasons described hereinabove.

When a terminal runs such semi-erasure rather than erasure, a terminal may erase only selected portions of such results which are obtained by running lock operations in a lock mode, while leaving the remainder of such results intact. In addition, a terminal may actively or passively store such to-be-stored results in a lock memory unit (80) or elsewhere of a terminal in one of various storing timings described in the previous Section.

To switch to a new unlock mode, a terminal may launch (or resume operation of) a main system (10) in various ways. In one example, when a terminal allows a user to launch only one system at a time, but not two at the same time, a terminal may first stop operation of a lock system (60) operating in the current lock mode, and may then launch (or resume operation of) a main system (10) in an unlock mode. To the contrary, when a terminal allows a user to launch or to operate multiple systems at the same time, a terminal may keep driving a current (lock) system, while launching (or resuming operation of) a main system. Once a terminal completes launching the main system, a terminal may then stop operating the old lock system.

Although not included in this first exemplary aspect, a terminal may also operate in a hierarchy in which more than two modes are defined in a certain hierarchy in a parallel or series manner. When desirable, a terminal may set up multiple hierarchies, and allow a user to first select a certain hierarchy in which various modes are arranged to meet various needs of a user. Various methods of using a terminal and various mode switching using such a terminal in response to a user input may be similar to those of the panels (A) to (H) of FIG. 2 of the '861 application, where the panels (A) to (H) of FIG. 2 and relevant portions of the texts in the '861 application have been incorporated herein in their entirety by reference.

Other features of the Operation 2 of this Section are typically identical or similar to the corresponding features of the Operation 1 of the previous Section, subject to a certain modification, addition, and/or omission, each of which becomes apparent according to their detailed contexts. Thus, further descriptions of various features of this Operation 2 are omitted here.

### 4-5. 1^{st} Configuration—Operation 3

In an Operation 3 which is yet another exemplary embodiment of the first exemplary aspect, a terminal (or its input unit) receives a 1^{st} user input while (1) a terminal is in its on-state and (2) a terminal is operating in an unlock mode. A terminal may then determine to which mode it is to switch in response to a 1^{st} user input in various ways. It is appreciated that this mode switching of a terminal from an on-state to another mode defined in a hierarchy also corresponds to the 2^{nd} type mode switching as defined above.

In one example, upon receiving a 1^{st} user input which may or may not include UI_{SWI} therein, a terminal may switch from an unlock mode to a lock mode in response to a 1^{st} user input, particularly when a terminal adopts the series switching. When a user provides an additional user input thereafter, a terminal may either stay in a lock mode or switch back to an unlock mode.

In another example, upon receiving a 1^{st} user input, a terminal acquires UI_{SWI-1} therefrom, and may [1] remain in an unlock mode or [2] switch back to a lock mode depending upon UI_{SWI-1}, as may be the case of the selective switching. When a user provides an additional 2^{nd} input, the terminal may [1] stay in an unlock mode, [2] switch back to a lock mode, or the like, based on UI_{SWI-2} when a terminal adopts the selective switching.

In either example, a user may readily provide a user input which includes UI_{SWI} therein, e.g., simply by manipulating a mode-switching input unit whenever he or she wants to switch from a current mode to a new mode. In either example, a terminal may run such erasure (or semi-erasure) in one of various erasure timings. A terminal may also run the real-time, intermediate, or ex-post erasure (or semi-erasure), thereby enhancing security of the terminal, improving its integrity, and preserving private data stored therein.

Similar to Operations 1 and 2 of the previous Sections, a terminal may condition the mode switching upon an outcome of the user authenticating. It is appreciated, however, that a terminal of this Section is (or has been) in an unlock mode. Accordingly, it follows that a terminal has already run an authentication operation, e.g., to advance from a lock mode to an unlock mode, and that a user has passed the authenticating. Therefore, a terminal may not need to authenticate a user once more. However, a terminal may require an additional user authenticating when the user desires to run another operation which may require more important or private data such as, e.g., making a financial transaction.

A terminal may run an erase (or semi-erase) operation in one of various erasure timings as defined herein, even when switching to a new mode with less access authority, due to the reasons described hereinabove. A terminal may erase only selected portions of such “results” obtained by running lock operations in a lock mode, while storing the remainder of such results intact in a lock memory unit or elsewhere in a terminal in one of various timings described in the previous Section. In addition, a terminal may launch (or resume to operate) a main system (10) or a lock system (60) in various ways as described above.

Although not explained in greater detail in this 1^{st} Configuration, a terminal may also operate in a hierarchy in which more than two modes are defined in a series, parallel, or hybrid arrangement. When desirable, a terminal may set up multiple hierarchies, and allow a user to first select a certain hierarchy in which various modes are arranged to meet various needs of a user. Various methods of using such terminals and switching modes with such terminals in response to a user input may be similar to those of the panels (A) to (H) of FIG. 2 of the '861 application, where the panels (A) to (H) of FIG. 2 and relevant portions of the texts in the '861 application have been incorporated herein in their entirety by reference.

It is noted that a terminal runs the Operation 3 of this Section while it is in a powered-on stare and an on-state. Thus, a terminal may run various operations of this Section while its display unit is or has been turned on. As a result, various operations explained in this Section is not conditioned upon a turning-on operation. But such operations of this Section may condition a turning-off operation so that a terminal may turn off its display unit when [1] a user fails the user authenticating, or [2] a user provides an additional user input but a terminal may not switch modes anymore, for a hierarchy is not circulating or for a user provides a wrong user input, or for UI_{SWI} included in a user input does not match any mode listed in a matching list, or the like.

Other features of the Operations 3 of this Section are typically identical or similar to the corresponding features of the Operations 1 and 2 of the previous Sections, subject to a certain modification, addition, and/or omission, each of which becomes apparent according to detailed contexts thereof. Thus, further descriptions of additional features of this Operation 3 are omitted here.

### 4-6. 1^{st} Configuration—Operation 4

In an Operation 4 which is yet another exemplary embodiment of the first exemplary aspect, a terminal (or its input unit) receives a 1^{st} user input while a terminal is powered off. That is, a display unit has been turned off, and a terminal has not been communicable when a terminal receives a 1^{st} user input. Thus, such a terminal is deemed to (1) not be in any of a lock, intermediate or unlock mode, and (2) not have been driving any unit or any element of a lock, intermediate or main system.

In a 1^{st} example, a user may desire to just power on a terminal, regardless of any user's intention to advance to a certain mode. That is, a user may be satisfied with just powering on a terminal. Thus, in response to the 1^{st} user input, a terminal may [1] power itself on but keep its display unit turned off (i.e., switching to an off-state), or [2] power itself on, and also turn on a display unit (i.e., switching to an on-state). In the case of [2], the terminal may [2-1] launch a lock system (60) in one of various launch timings, while displaying a lock (or default) screen on the display unit, or [2-2] launch a main system (10) while displaying a home screen on the display unit.

A terminal may also run an authentication operation. In this case, a terminal may condition various operations (e.g., turning on a display unit, launching a lock or main system, or displaying a lock or main screen) upon an outcome of the user authenticating, where further details of such operations of this 1^{st} example of Operation 4 have been described hereinabove and, therefore, omitted herein.

In a 2^{nd} example, a user may not only desire to power on a terminal but also desire to advance to a lock mode such that a user can run various lock operations with a lock system (60) in a lock mode. A user will be satisfied when he or she can seamlessly advance to a lock mode in response to a single user input. Accordingly, in response to the 1^{st} user input, a terminal may power itself on and switch into a lock mode.

In case a user should not mind showing his or her own lock screen to whoever would look at a lock screen in a lock mode, a terminal may power itself on, turn on its display unit, and automatically display a default lock screen which may include various user (lock) interfaces displayed thereon. It is noted that a terminal may run all of such operations in response to a single user input.

However, when the user does mind such, a terminal may run an authentication operation and confirm whether or not a current user may be authorized to switch to a lock mode. Therefore, in response to a single user input, a terminal may power itself on, and then run an authentication operation. To this end, a user input may include therein not only UI_{ACT} to turn on a display unit but also UI_{THEN} to run such user authenticating.

Alternatively, a terminal may be configured to turn on a display unit and to display a lock screen in response to a 1^{st} user input which is received in its powered-off state. In this case, the 1^{st} user input includes UI_{THEN} but may not have to include any UI_{ACT}, for a terminal turns on its display unit without having to acquire UI_{ACT}.

When a user passes the authenticating, a terminal may show a lock screen and display various user interfaces thereon, while launching a lock system (60) in one of various launch timings such as, e.g., before, during or after turning on a display unit. Thereafter, a user may run various lock operations with a lock system (60) in a lock mode, while obtaining various “results” from such running.

When a user fails such authenticating, a terminal may run one of various operations. For example, a terminal may [1] keep itself powered-off, [2] keep its display unit turned off in a powered-on state, [3] turn on a display unit and display a lock screen thereon, while not displaying any user interfaces thereon, or [4] turn on a display unit and display a lock screen showing user interfaces, while not granting such user interfaces to drive any hardware or software elements of a lock or main system (60), (10), even if a user manipulates such interfaces.

In a 3^{rd} example, a user may not only desire to power on the terminal but also desire to advance to an unlock mode and to run unlock operations with a main system (10) in an unlock mode. The user will be satisfied when he or she can seamlessly advance to an unlock mode in response to a single user input.

In case a user should not mind showing the user's own unlock screen to whoever would look at the screen in an unlock mode, a terminal may power itself on, may on its display unit and, thereafter, automatically display a home screen which includes various user interfaces displayed thereon. Because a terminal runs all of such operations in response to a single user input, a user may enjoy a seamless operation. However, when a user does mind such, a terminal may run an authentication operation and confirm whether or not a current user is authorized to switch to an unlock mode.

Therefore, in response to a single user input, a terminal may power itself on, and run an authentication operation. When a user passes such authenticating, a terminal may display a home screen which includes various user interfaces thereon, while launching a main system (10) in one of such launch timings such as, e.g., before, during or after turning on a display unit.

When a user fails such authenticating, a terminal may [1] remain in a powered-off state, [2] keep its display unit turned off in a powered-on state, [3] turn on a display unit and display a lock screen, while not displaying any user interfaces thereon, or [4] turn on a display unit, display a lock screen with the user interfaces, while not granting the user interfaces to drive any hardware or software elements of a lock or main system (60), (10) even if a user provides a user input thereto.

As described above, a terminal may spend more time in completing user authenticating than just turning on a display unit. Even when a user passes authenticating, it may be only a certain period of time after a terminal turns on a display unit. In this case, a terminal may turn on a display unit in response to a user input, display a lock screen thereon, and [1] keep a lock screen when a terminal learns that a user fails user authenticating, or [2] replace the lock screen with a home screen after learning that a user passes user authenticating.

### 4-7. 1^{st} User Input and Mode-Switching (User) Sub-Input

In another exemplary embodiment of the first exemplary aspect, a terminal may receive multiple user inputs one of which includes UI_{SWI} for switching from one mode to another. It is appreciated that the user input which includes UI_{SWI} therein may not include any other (user) sub-inputs or may also include other (user) sub-inputs such as, e.g., UI_{THEN} or UI_{ACT} and that inclusion of other sub-inputs along with UI_{SWI} generally depends upon a circumstance when a user wants to switch modes. It is also appreciated that a user may provide a terminal with such multiple user inputs either concurrently or sequentially.

In a 1^{st} example when a terminal has been powered off and when a user only wants to power on a terminal by providing a 1^{st} user input thereto, the 1^{st} user input may not have to include any of UI_{ACT}, UI_{THEN}, or UI_{SWI}. For example, a 1^{st} user input may not have to include UI_{ACT}, for a terminal may be configured to turn on its display unit anyway after being powered on. In addition, when a user only wants to launch a lock system in a lock mode after a terminal is powered on, a terminal already knows which mode it is to switch to and, therefore, a 1^{st} user input may not have to include UI_{SWI} therein. Moreover, because a lock mode is the mode granted with the least access authority, a terminal may not have to run any authentication operation and, accordingly, a 1^{st} user input may not have to include UI_{THEN} therein.

However, when a user wants to limit access to his or her own lock mode, a 1^{st} user input may have to include UI_{THEN} therein such that a terminal acquires UI_{THEN} from a 1^{st} user input, runs an authentication operation, and determine whether a current user is authorized to switch to a lock mode based thereon. In addition, when a user wants to advance to a certain mode of a certain hierarchy directly from a powered-off state and when a hierarchy defines multiple different modes therein, a 1^{st} user input may have to include UI_{SWI} so that a terminal may acquire UI_{SWI} from a 1^{st} user input, and direct a user to a correct mode, once a terminal is powered on and its display unit is turned on.

In a 2^{nd} example when a terminal is powered on but its display unit has been turned off (i.e., an off-state), a user may provide a 1^{st} user input to a terminal with an intention to run some operations in one of various modes. Because this example applies to a case in which a user has already provided a user input previously to power a terminal on, the 1^{st} user input is a user input which is provided to a terminal after it has already received a 0^{th} user input (i.e., a display unit is or has been turned off but a terminal has been powered on and, therefore, communicable in response to a 0^{th} user input).

In one case of the 2^{nd} example, a user may provide a 1^{st} user input to check some routine data. In this case, a 1^{st} user input may not have to include any of UI_{THEN} or UI_{SWI}, for a terminal may only turn on a display unit in a lock mode and display routine, non-personal data on a lock screen. In addition, when a terminal is configured to display a lock screen whenever it receives a user input in an off-state, a 1^{st} user input may not even have to include UI_{ACT} at all.

However, a user may instead want to switch to a lock mode by providing a 1^{st} user input to a terminal. In this case, a 1^{st} user input may include UI_{ACT} and UI_{SWI} therein so that a terminal turns on its display unit in response to UI_{ACT} and switch to a lock mode in response to UI_{SWI}. In addition, a 1^{st} user input may have to include UI_{THEN} therein when a user wants to limit access to his or her own lock mode by others. However, when a terminal is configured to turn on its display unit and to automatically advance to a lock mode, a 1^{st} user input may have to include neither UI_{ACT} nor UI_{SWI}.

In a 3^{rd} example where a terminal is powered on, its display unit has been turned on (i.e., an on-state), and a user has been operating a terminal in a current mode (i.e., one of multiple modes defined in a hierarchy), a user may provide various user inputs to a terminal for various purposes such as, e.g., running operations in a current mode, or switching to a new mode. It is appreciated that followings relate to a case when a user desires to switch from a current mode to a new mode and that a 1^{st} user input is the one provided to a terminal operating in a current mode.

When a user provides a terminal with a 1^{st} user input with an intention to switch to a new mode, a 1^{st} user input may not have to include any UI_{ACT}, for a display unit has already been turned on. A 1^{st} user input may not have to include UI_{THEN} either, when a terminal grants a new mode with less access authority than a current mode. Moreover, a 1^{st} user input may not have to include UI_{SWI} when a terminal may switch its modes in the series switching, for a terminal may switch modes successively along a hierarchy, regardless of detailed nature of a 1^{st} user input.

However, a 1^{st} user input may have to include UI_{ACT} when a new mode may require turning on a 2^{nd} display unit in addition to a main display unit. A 1^{st} user input may also have to include UI_{THEN} when a terminal grants a new mode with greater access authority than a current mode or when a user desires the user authenticating whenever a terminal switches modes. Furthermore, when a terminal operates in a hierarchy defining numerous modes therein, a 1^{st} user input may have to include UI_{SWI} so that a terminal may lead a user to a correct new mode.

As shown in the above 1^{st}, 2^{nd} and 3^{rd} examples of this embodiment, a 1^{st} user input provided by a user to a terminal which is in its powered-off state (e.g., in the 1^{st} example), or which operates in its off-state (e.g., in the 2^{nd} example), or which operates in its on-state (e.g., in the 3^{rd} example), may not have to include therein any (user) sub-input at all. Alternatively, in any of such examples, a 1^{st} user input may have to include at least one or all (user) sub-inputs such as, e.g., UI_{ACT}, UI_{THEN}, and UI_{SWI}, only to switch modes.

Accordingly, it is appreciated that the nature of a 1^{st} user input and the nature of the (user) sub-inputs included therein typically depends upon circumstances and the user's intention. A terminal may [1] similarly incorporate a single main input unit in a main system (10) or [2] incorporate various input units in a main or lock system (10), (60) according to such circumstances or user's intentions in such a way that a terminal may enhance its security, improve its integrity or better protect privacy of data stored or residing in its main system, or that a user may be able to enjoy seamless features provided by the terminal.

It is also appreciated that a terminal may switch modes by receiving various user inputs which are received by various input units of a terminal. In one example, a user may provide a 1^{st} user input which includes UI_{SWI} to a mode-switching input unit (25) but not to a main input unit (20). In another example, a user may provide a 1^{st} user input to either of a mode-switching input unit (25) or a main input unit (20).

In another example, a user may provide a user input which not only includes one of UI_{ACT} and UI_{TNEN} but also UI_{SWI} to any suitable input unit which includes a sensor capable of acquiring UI_{SWI} therefrom. In another example, a user may not have to provide a separate user input including UI_{SWI}, but a terminal may receive another user input which may also serve as a user input with UI_{SWI}.

In addition, when a terminal receives a 1^{st} user input, a terminal may automatically run certain operations according to the circumstances or control settings. In other words, a terminal may recognize UI_{ACT} or UI_{THEN} as UI_{SWI} based on various circumstances as described hereinabove and hereinafter. As a result, a terminal may run a single operation or multiple operations in response to a 1^{st} user input, regardless of how many (user) sub-inputs are included therein. Put differently, a terminal of this disclosure may utilize such features to provide a user with improved seamless features.

When a terminal includes a mode-switching input unit (25) and when a user provides a 1^{st} user input including UI_{SWI} therein, a terminal may switch modes in various ways. For example, a terminal may switch modes [1] only upon receiving at least one proper user input which is actively provided by a user, [2] upon receiving at least one user input which is passively provided by a user (e.g., actively acquired by a terminal), or [3] only based on a setting of a terminal which may (or not) be altered by a user once it is set by a manufacturer, a distributor or a terminal.

A terminal may also switch modes, particularly from a current mode granted with greater access authority to a new mode granted with less access authority, without necessarily having to acquire UI_{SWI} from a 1^{st} user input. Accordingly, a terminal may switch modes, e.g., [1] upon elapsing a certain period of time after a terminal has been in a current mode but does not receive a subsequent user input thereafter [2] upon elapsing a certain period of time after a main system (10) runs the last operation in a current mode, [3] upon detecting a certain event of unauthorized entries (or attempts) to a main system (10) (e.g., a hacking, an authorized access or entry, tainting of a main memory unit or a main system, altering a certain unit of a main system, or the like), or [4] upon detecting an occurrence (or an attempt) of an incident which is specified by a terminal or a user.

A terminal may allow a user to manipulate (or provide a user input to) a mode-switching input unit (25) even when a display unit is turned off. For example, a user may select which system a terminal should launch either before, during or after [1] turning on a display unit, [2] powering on a terminal, or the like. A user may render a terminal start to launch a desired system in a certain mode in response to a 1^{st} user input. When a terminal defines several different modes in a hierarchy, this arrangement may prove beneficial, for a user may launch a desired system in a desired mode, instead of navigating through a hierarchy of different modes. In this case, a terminal may acquire UI_{SWI} directly from a 1^{st} user input so that a terminal may provide more seamless operations to the user.

This embodiment may, however, be subject to an outcome of running an authentication operation (vice versa). For example, a terminal may be configured to proceed to an unlock mode and to also launch a main system (10) in response to a 1^{st} user input. In this arrangement, a terminal may also continue to switch to a lock mode when a user fails such user authenticating. In addition, when a user provides a specific command to a terminal, a terminal may proceed to an unlock mode and launch a main system (10), whether or not a user passes such user authenticating. This embodiment may prove advantageous when a terminal includes a button-type mode-switching input unit (25).

### 4-8. Lock Memory Unit and Erasure (Semi-Erasure)

In another exemplary embodiment of the first exemplary aspect, a lock system (60) may include an optional lock memory unit (80). As described above, one objective of various terminals of this disclosure is to physically isolate or operationally isolate a lock system (60) from a main system (10), thereby enhancing the security of a main system (10), improving the integrity thereof, and protecting data stored therein. In addition, another objective of various terminals of this disclosure is to not leave behind any (or at least one) trace of “results” obtained by running lock operations in a lock mode. To this end, a terminal may run such erasure (or semi-erasure) onto a lock system (60), or a lock system (60) may run such erasure (or semi-erasure) onto its lock memory unit (80) or a remainder of a lock system (60).

In one example, a lock system (60) may not include any designated lock memory unit (80) therein. Because a lock viewer (71) may only display on a display unit [1] various texts, files, images or web pages which may be available to a lock system (60) or [2] such results which are obtained by running lock operations in a lock mode, a lock system (60) may not have to store any new data (such as the “results”) therein anyway. Accordingly, a terminal may not need to run any separate erase (or semi-erase) operation onto a lock system (60).

However, a terminal may still have to run the erasure (or semi-erasure) to erase all (or some) of such results which may be stored or may reside in a temporary memory sector of a lock or main system (60), (10). As described above, a terminal may also recruit a main CPU unit (30) or a main O/S (34) to drive a lock viewer (71) in a lock mode. In this case, some results obtained by running lock operations in a lock mode may be stored or residing in a main system (10), particularly in a temporary memory sector of a main system (10). In this case, a terminal may still run such erasure (or semi-erasure) onto such sectors of a main system (10) as well.

In another example, a lock system (60) may include therein at least one designated lock memory unit (80) into which a terminal may store such “results” obtained by running lock operations in a lock mode, e.g., in a remnant format. Accordingly, a terminal may erase or semi-erase such results with any prior art methods such as, e.g., overwriting, encrypting or other software or hardware methods. In the alternative, a lock system (60) may store selected (or all) portions of the “results” in a lock memory unit (80) permanently. As described above, a terminal may also run such erasure (or semi-erasure) on such a unit (80) of a lock system (60) in a real-time, interim, or ex post arrangement in one of various erasure timings as defined herein.

A terminal may instead erase or semi-erase at least a portion of such “results” adaptively, e.g., by running an “adaptive erasure” (or “semi-erasure”), when a terminal may monitor, e.g., a potentially dangerous file (possible presence of malicious viruses), a flagged content (e.g., an illegal or obscene text or image) in a lock memory unit (80) or elsewhere in a lock system (60), an unauthorized attempt to access at least one unit of a main system (10), or the like. A terminal may provide a user with a list of such files, contents, or sources in such “results,” and run such erasure (or semi-erasure) upon (or without) confirmation by the user.

During the semi-erasure, a terminal (or a user) may select which portions of “results” to be erased, and then store all other portions of “results” remaining in a lock memory unit (80) or in a temporary memory sector of a lock system (60) or main system (10). Alternatively, a user may manually select which portions of “results” to be stored (or erased), or a terminal may adaptively select which portions of “results” to be stored (or erased). A terminal may then erase all other portions of “results” which remain in a lock system (60) or in the temporary memory sector or elsewhere in a main system (10).

A terminal or a user may select which (portions of) results to be erased or to be stored in the real-time, interim or ex post arrangement, either manually or adaptively. When a terminal may monitor, e.g., a certain content or website in which a user stays for a period of time which is longer than a reference period, a certain content coinciding with a user preference, or the like, a terminal may also adaptively store such (portions of) results. A terminal may also run such erasure (or semi-erasure) while storing such to-be-stored data in one of various “timings” which are similar to such erasure timings but in which a terminal stores such results instead of erasing them.

As described above, a terminal may store those selected (portions of) results in a lock memory unit (80) or a temporary memory sector of a lock or main system (60), (10). However, a terminal may prevent such memory units or sectors from driving the remaining units of a main system (10), from storing such (portions of) results into a main memory unit (40), or the like. By the same token, a terminal may prevent a user who operates a lock system (60) in a lock mode from accessing data stored in a main memory unit (40), from transferring data stored in a memory unit of one system to another memory unit of another system, or the like.

### 4-9. Timings of Launching Various Systems

In another exemplary embodiment of the first exemplary aspect, a terminal may switch from an unlock mode (or an intermediate mode) to a lock mode by, e.g., launching a lock system (60) and beginning to operate such a system (60) in a lock mode in various timings. This arrangement may prove particularly useful for a user who wants to switch back to a lock mode from an unlock (or intermediate) mode, [1] without having to power off a terminal and then to power in on again, [2] without having to turn off its display unit and then to turn it on again, or the like.

Therefore, whenever a user is not confident whether a certain operation which he or she is about to run in an unlock (or intermediate) mode may adversely affect a main system (10) of a terminal, a user may readily launch (resume operation of) a lock system (60) and then switch back to a lock mode in various launch timings. By doing so, a user may run that unreliable operation in a lock mode, without having to be concerned that “results” obtained by running that operation may adversely affect the main system (10) of a terminal.

As described above, a “launch timing” may refer to an instance which may be [1] concurrently with receiving a user input which may include a sub-input for launching (or resuming operation of) a lock (or main) system, [2] (immediately) after receiving such a user input, [3] after receiving such a user input but before a user provides another user input, or the like.

However, such “launch timings” may be defined similar to the erasure timings and may relate to those timings for launching (resuming an operation of) a lock, intermediate or main system with respect to a mode switching, authenticating, turning on, or the like.

In the 1^{st} example, such “launch timings” defined with respect to the mode switching may include launching (or resuming an operation of) a lock, intermediate or main system, e.g., [1] concurrently with such mode switching, [2] (immediately) after the mode switching, or [3] after such mode switching but before a user provides another user input. It is noted in this example that when the mode switching is from a (current) lock or intermediate mode to a (new) unlock mode, then a main system is to be launched, and that a terminal may stop operation of a lock or intermediate system.

In the 2^{nd} example, such “launch timings” which is defined with respect to the turning on may include launching (or resuming an operation of) a lock, intermediate or main system, e.g., [1] concurrently with such turning on, [2] (immediately) after such turning on, or [3] after such turning on but before a user may provide another user input.

In the 3^{rd} example, such “launch timings” defined with respect to the authenticating may include launching (or resuming an operation of) a lock, intermediate or main system, e.g., [1] concurrently with authenticating a user, [2] (immediately) after such authenticating, [3] after such authenticating but before a user may provide another user input, [4] concurrently with confirming that the user passes such authenticating, or [5] (immediately) after such confirming.

It is appreciated that the launching (or resuming an operation of) of an intermediate or main system may be conditioned upon the result (e.g., a pass or a failure) of the authentication operation. Accordingly, when a user fails the user authenticating, a terminal may not launch a main system at all and, therefore, the above definition of launch timings may not apply.

### 4-10. User Benefits

Contrary to the main system (10) which includes at least one main CPU unit (30), main memory unit (40), main input unit (20), or main output unit (50), a terminal of this Configuration 1 includes a lock system (60) which in turn may include at least one lock viewer (71) and an optional lock memory unit (80), along with at least one optional lock input unit, lock output unit, or the like. Because the main function of a lock viewer (71) is to view or to browse data like a prior art viewer or browser, a lock viewer (71) is inherently incapable of storing any “results” obtained by running various lock operations into a lock memory unit (80) or a main memory unit (40). As a result, a terminal of this Configuration 1 may not have to run any erasure or semi-erasure.

In this context, this lock system (60) is useful in reviewing documents or advertisements which are pre-stored therein or which may be obtained from an external provider (or website) via an internet. This lock system (60) is also useful in browsing various websites which offer an educational or advertising material via an internet. More particularly, because a lock system (60) may run such erasure (or semi-erasure) in one of such erasure timings, a user may be relieved from any concern about [1] leaving any “results” including lists of operations run in a lock mode to a next user, or [2] accidently spoiling or contaminating a main system (10) by the “results.”

A lock system (60) may include an optional lock memory unit (80) from which a user may retrieve data or into which a user may store results obtained from running lock operations in a lock mode. In addition, a terminal may allow a user to connect to an external memory device such as, e.g., a USB memory device, an external memory disk or chip, another computer, or another data processing device. Accordingly, a terminal may allow a user to use external resources, without having to incorporate everything in a terminal and, therefore, without having to increase a weight, a volume, and manufacturing cost of the terminal.

### 4-11. 1^{st} Configuration—Variations or Modifications

Various data processing terminals of this 1^{st} Configuration as exemplified in FIGS. 1A to 1C may also operate in different configurations, arrangements, or sequences. Therefore, variations or modifications of the terminals (including their units and their hardware or software elements) of this 1^{st} Configuration, and their variations or modifications may further include the followings.

### 4-11-1. Erasure by Overwriting

Various data processing terminals of this 1^{st} Configuration may enhance their security, improve their integrity, and better protect data stored therein by, e.g., [1] providing different modes of operation in a hierarchy in which a terminal operates, [2] physically or operationally isolating their main systems from their lock (or intermediate) systems, or [3] running the erasure or semi-erasure as described above.

In another exemplary embodiment of the first exemplary aspect, a terminal may erase an entire portion (i.e., run an “erase” operation or run such “erasure”) of all portions of results which may be obtained by running lock operations in a lock mode and which may be stored or residing in a lock system (60). Alternatively, a terminal may erase only a selected portion (i.e., run a “semi-erase” operation or run such “semi-erasure”) of such results in one or more of such erasure timings. Thus, a terminal may entirely or at least partly prevent contamination or degradation of its main system (10) by such results.

In addition to erasing (or semi-erasing) such results, a user may preserve his or her privacy as well by, e.g., erasing [1] a list of operations which he or she has run in a lock mode, [2] a list of websites which a user has visited in a lock mode, or [3] a list of contents which he or she has downloaded while running lock operations in a lock mode. For simplicity of illustration, the erasure (or semi-erasure) is to respectively include erasing all of such lists of [1] to [3] or some but not all of such lists of this paragraph throughout this disclosure. A terminal may run an erase operation in different ways, e.g., by running various “software-based erase operations” or “hardware-based erase operations.”

In another exemplary embodiment of the first exemplary aspect, a terminal may run an erase (or semi-erase) operation [1] in different extents onto those results or [2] in different ranges. For example, a terminal may run such erase operation in different extents by running, e.g., [1] a single-pass overwriting operation, [2] a double-pass overwriting operation, or [3] a multiple-pass overwriting operation. Details of such overwriting are well known in the relevant art and, therefore, are omitted herein.

In another exemplary embodiment of the first exemplary aspect, a terminal may run an erase (or semi-erase) operation in different timings as well. For example, a terminal may run one of the above overwriting operations [1] in real time, i.e., running a “real-time” erase (or semi-erase) operation, [2] interim, i.e., running an “interim” erase (or semi-erase) operation, [3] ex post, i.e., running an “ex post” erase (or semi-erase) operation, or the like. Details of such erasure (or semi-erasure) are provided in Section 2-2 and, therefore, omitted herein.

Further details of “4-11-1. Erasure by Overwriting” are identical to the following portions of the '861 application such as, e.g., the text from [0726] and [0727] on page 67, from [0729] on page 67 through [0730] on page 68, from [0732] through [0736] on page 68, where these portions are incorporated herein in their entirety by reference.

### 4-11-2. Erasing All Results or Semi-erasing Some Results

A data processing terminal of this 1^{st} Configuration may protect the security or integrity of its main system by physically or operationally isolating its main system from its lock or intermediate system, either completely or partly. In addition, a terminal may completely or partly prevent those “results” stored or residing in a lock system from adversely affecting, contaminating, or damaging its main system (10), e.g., by running various erase (or semi-erase) operations in one of the erasure timings as defined herein. Various terminals of another exemplary embodiment of the first exemplary aspect exemplify such features.

For example, a terminal or a user may erase an entire (or only a selected) portion of such “results” obtained by running various lock operations with a lock system (60) in a lock mode. A user may then ensure that such “results” stored or residing in a lock memory unit (80) (or sector) of a lock system (60) may not adversely affect or degrade any units of a main system (10). A user may also conveniently erase a trace of operations which a user has run by operating a lock system (60) in a lock mode, and may conveniently erase results which a user downloads with a lock system (60).

In another example, users may readily use either a lock system (60) or a main system (10) depending on each user's different walk of life. Such users may also readily utilize different hierarchies and different modes defined therein for different purposes. For example, a user may pick and choose a 1^{st} hierarchy (defining a lock mode, an intermediate mode, and an unlock mode) or a 2^{nd} hierarchy (defining a lock mode, a 1^{st} unlock mode, and a 2^{nd} unlock mode) for different purposes. Whereby, a terminal may ensure that a lock or main system (60), (10) operating in one mode of one hierarchy may not adversely affect another system operating in another mode of the same or different hierarchy. More particularly, a terminal may (almost always) run such erasure (or semi-erasure) whenever a terminal may switch from a current mode granted with less access authority to a new mode granted with greater access authority, while a terminal may not need to run such erasure (or semi-erasure) when a terminal may switch modes in a reserve direction.

A terminal (or a user) may erase such results by many prior art methods such as, e.g., driving certain hardware or software elements of a lock (or main) system by, e.g., [1] overwriting the meaningless or irrelevant null data over the to-be-erased results, or [2] encrypting such to-be-erased results after being obtained or before storing, and then performing such overwriting. For simplicity of illustration, all of the above [1] and [2] are to be referred to as an “active erasure (or semi-erasure)” hereinafter.

Conversely, a terminal may include a volatile memory unit which loses all results stored therein once an electric power supply stops. In addition, a terminal may erase results in a lock system (60) when a user does not take any action for a period of time longer than a threshold period. Because such erasure does not usually involve an active action taken by a user, such erasure is to be referred to as a “passive erasure (or semi-erasure)” or “inactive erasure (or semi-erasure)” hereinafter.

A terminal may combine the features of such “erasure” and “semi-erasure” in various ways as well. In one example, a terminal may adaptively run such semi-erasure to automatically erase certain results based upon the above criteria, while optionally allowing a user to manually run such erasure when desirable.

In another example, a terminal may allow a user to select either “erasure” or “semi-erasure” for each portion of “results” residing or stored in a lock system (60), each portion of “results” obtained from running an lock operation in a lock mode, each data category (e.g., texts, images, files, alpha-numerical tables, voice recordings, or video clips), each website which a user has accessed in a restricted mode, or the like.

### 4-11-3. Saving Some or All Results

As described above, a terminal may run such “erasure” or “semi-erasure” upon (or in response to) switching from one mode to another. More particularly, while running such “semi-erasure,” a terminal may select certain results which are to be excluded from being erased. Therefore, in another exemplary embodiment of the first exemplary aspect, a terminal may store at least a portion of “results” which reside or are stored in a lock system (60) when such to-be-stored results may not be deemed to adversely affect a main system (10) either in a lock mode or in an unlock mode.

In the 1^{st} example, a lock system (60) may temporarily (or permanently) store such to-be-stored results in a lock memory unit (80) which is physically or operationally isolated from a main memory unit (40) or other units of a main system (10). As a result, a terminal may entirely or at least partially prevent a lock memory unit (80) and those “results” stored or residing therein from adversely affecting a main memory unit (40) or other units of a main system (10).

Similarly, a terminal may prevent a memory unit of a certain system or “results” stored or residing therein from adversely affecting a memory (or another) unit of another system. In other words, due to such physical or operational isolation, a user can fully use each system, while completely (or at least partly) preventing a 1^{st} system operating in a 1^{st} mode and “results” obtained by running operations with the 1^{st} system in a 1^{st} mode from [1] contaminating or adversely affecting any hardware or software element of a 2^{nd} system operating in a 2^{nd} mode, [2] adversely varying a physical configuration of a 2^{nd} system, [3] adversely modifying operations and their steps of a software element of a 2^{nd} system, or the like.

In the 2^{nd} example, a terminal may erase only selected (portions of) “results” which are obtained by running lock operations in a lock mode while storing the rest of such results (i.e., to-be-saved results) in a lock memory unit (80) or in another memory unit (or sector) of a terminal. The terminal may run such semi-erasure in one of such erasure timings.

In the 3^{rd} example, a terminal may store different results for different periods of time. For example, a terminal may store some results only temporarily (e.g., only for a preset period) so that those results will be eventually erased automatically (or manually).

In another example, a terminal may store some results permanently [1] in a non-volatile memory unit, or [2] in a volatile memory while maintaining an electrical power supply thereto.

In another example, a terminal may store some results [1] until the next mode switching from one mode granted with less access authority to another mode with greater access authority, [2] until a terminal receives a user input to run an erase (or to semi-erase) operation onto at least one portion of such results, or the like. A terminal may thereafter erase such results concurrently with or after switching to a different mode.

Alternatively, a terminal may store some results semi-permanently, e.g., in a combination of such temporary storing and permanent storing, and erase some results as described above.

A terminal may store some results conditionally based upon various criteria such as, e.g., a setting selected by a terminal or a user, UI_{SWI}, a non-action by a user for a certain period of time, or the like. A terminal may also store some results until (or after) the mode switching is completed, until (or after) a certain event occurs, or the like.

In the 4^{th} example, a terminal may store such to-be-stored results in various hardware elements such as, e.g., in a lock memory unit (80), in an external memory unit which may (or not) be provided as an add-on device, in a memory unit of an external device or another terminal, or the like. A terminal may store such to-be-stored results in a memory unit of a cloud storage system or in a designated portion of a main memory unit (40) of a main system (10). A terminal may also store such results in any temporary memory sectors provided in any of the above units or systems. When an add-on device is recruited as an external memory unit, the add-on device may be utilized as a lock memory unit, as a supplementary main memory unit, or the like.

One example of the temporary memory sectors is a prior art data buffer, where a data buffer refers to at least one sector or portion of a lock (or main) memory unit for temporarily storing results while they are moved from one place of a memory unit to another place. A data buffer may be [1] a fixed memory location in a memory unit (or another medium) or [2] a virtual location in the memory unit (or another medium). Another example of the temporary memory sector is a prior art cache which may act as a data buffer.

Another example of the temporary memory sectors is a prior art clipboard which is a type of a data buffer (e.g., a paste buffer) and which may be a sector (or a portion) of a memory unit (or another medium). A data buffer is a short-term data storage between documents or (software) applications via, e.g., a copy operation, a paste operation, or the like.

Another example is a prior art recycle bin which also occupies at least a sector (or portion) of a memory unit (or another medium) and which may be used to temporarily store data which have been deleted, e.g., by a file manager, but that has not yet been erased permanently from the file system.

Such temporary memory sectors (or units) may be provided in a main memory unit (40) or a lock memory unit (80) or in other parts of a terminal. Such temporary memory sectors (or units) may generally be implemented as an internal unit of a terminal or may instead be provided as an external (memory) unit of another terminal or computer, as an external memory device (e.g., a USB memory device), an add-on device (e.g., an external memory device), or the like.

In the 5^{th} example, a terminal may temporarily store some of “results” by, e.g., storing at least a (or an entire) portion of the “results” wherever they are generated, sending such (a portion of) results to a temporary memory sector (or portion) of a memory unit or other units of a main or lock system. Thereafter, a terminal may erase such (a portion of) “results” whenever it sees fit, e.g., by overwriting, encrypting first and then erasing, terminating a power supply, or the like.

A terminal may conditionally store at least a (or entire) portion of the results as well by, e.g., storing some results wherever they are generated, transmitting some results to a temporary memory sector (or portion), or the like. A terminal may then decide whether or not to store (or erase) those results for a certain period based on various criteria such as, e.g., a user input, a (user) sub-input accompanied thereby, a type or a nature of such results, a user preference or setting, a user action or non-action, attempts by an unauthorized user to access at least one accessible hardware or software elements of a main system, or the like.

In the 6^{th} example, a terminal may store at least a (or entire) portion of “results” in various storing timings. It is noted that the storing timings for storing such a portion of “results” generally coincide with the erasure timings. Therefore and as used herein, “storing timings” are those timings which are related to storing at least a portion of such results or the mode switching, where examples of such storing times may include storing such a portion of the results [1] concurrently with such mode switching (e.g., at least one step of the storing operation overlaps with at least one step of a mode-switching operation), [2] (immediately) after such mode switching, [3] after such mode switching but before a user provides another user input, [4] upon receiving a user input including therein a (user) sub-input for such storing, or the like.

Such storing times may include other timings which are related to such storing and user authenticating, where examples of such storing times may include storing such a portion of the results [1] concurrently with running an authentication operation (or upon finding whether a current user passes or fails), [2] (immediately) after running an authentication operation, [3](immediately) before, concurrently with, or (immediately) after turning on (or off) a display unit, [4] (immediately) before, concurrently with, or (immediately) after powering off (or on) a terminal, or [5] concurrently with or immediately after receiving a user input with a (user) sub-input for running such erasure (or semi-erasure).

In addition, a terminal may store such a portion of such results in a real-time, interim, or ex post arrangement. For example, a terminal may run a “real-time storing” such that the terminal runs such storing as a user runs one lock operation after another, that a terminal stores data after data, file after file, folder after folder, or the like. A terminal may rather run an “interim storing” at every interval which is preset or selected by a user, or at every instance when, e.g., the results obtained by running lock operations exceed a certain size.

A terminal may instead run an “ex post storing” such that a terminal runs such storing once a user finishes a session (or episode) of running lock operations in a lock mode, regardless of whether a user [1] may still operate a terminal in a lock mode or [2] may still operate a terminal in a current mode which is not the lock mode.

Before, concurrently with, or after one of such storing timings, a terminal may erase unselected (but probably not an entire portion of) the “results” obtained by running lock operations in a lock mode in one of such erasure timings. Thus, a terminal may attain various goals such as, e.g., enhancing the security of a main system by preventing [1] alternation, [2] modification or [3] hacking of a main system by an unauthorized user, improving the integrity of a main system, or preserving private user data stored or residing in a main memory unit. When dealing with multiple sets of “results,” a terminal may store (or erase) at least one set of results in various ways such as, e.g., concurrently (i.e., in parallel and with at least one temporal overlap therebetween), sequentially (i.e., one after another) with a temporal gap therebetween, or the like.

As described above, a terminal may run such storing or erasing not only in a 1^{st} hierarchy which includes a lock mode and an unlock mode, but also in a 2^{nd} hierarchy with multiple lock modes and an unlock mode, in a 3^{rd} hierarchy with a lock mode, multiple unlock modes, in another hierarchy with such lock modes, unlock mode, and at least one intermediate mode, or the like, where the above examples apply to at least two or all of such different modes.

### 4-11-4. Hierarchies and Modes

Although such data processing terminals of this 1^{st} Configuration operate in a hierarchy which defines a single lock mode and a single unlock mode, such terminals may also operate in different hierarchies which define different modes therein, which arrange such modes in different arrangements, or the like.

Accordingly and in another exemplary embodiment of the first exemplary aspect, a terminal may operate in various hierarchies, where each hierarchy defines a certain number of different or identical modes and where a terminal may grant each of such modes with identical, different, or comparable access authorities. Accordingly, once selecting a hierarchy, a terminal may operate in each of multiple modes defined in a hierarchy one at a time.

As described above, a terminal may also operate in multiple modes concurrently, particularly when the terminal may provide multiple screens, while operating each of such different systems concurrently in each different mode in each screen. It is noted that following examples of this Section applies to a terminal which operates one system in one mode at a time. But such examples may apply to multiple systems concurrently operated by a single terminal but in multiple screens in multiple modes.

Returning to the embodiment of this Section, a terminal may accomplish a certain level of security and integrity in each mode, while a user may enjoy a certain level of privacy in each mode as well. In addition, a terminal may switch its modes from one to another along a certain hierarchy so that a user may select a current mode, a new mode, and then a 2^{nd} next mode based upon such access authorities which he or she desires. It is appreciated that access authorities granted to such multiple modes are typically defined in a relative context such as, e.g., based upon a scope or an extent of authorities to access to drive certain hardware or software elements of a main system of a terminal along a certain hierarchy.

To this end, a terminal may establish various hierarchies each of which defines at least two modes therein. In addition, a terminal may grant identical, similar, comparable or different access authorities to each mode, and may grant a user to drive certain units, or certain hardware or software elements, depending upon which mode a user operates a terminal and, therefore, depending upon which of a lock, intermediate, or main system a user is operating.

Accordingly, a user may run different number or types of operations in each of such modes, and may use each mode for different purposes, while enhancing the security of a main system of the terminal, improving the integrity thereof, and better protecting user data stored in the terminal.

Similarly, a terminal may provide various hierarchies and may allow multiple users to operate the terminal in a certain hierarchy. Because a terminal may set up a hierarchy and may grant identical, similar, comparable or different access authorities to each mode defined in the hierarchy, assigning a user to operate a terminal in a certain hierarchy may correspond to granting a user to operate the terminal with certain access authority in each mode defined in the hierarchy.

As a result, each user may operate a terminal in his or her own hierarchy, may operate a terminal in his or her own modes, or the like. As a result, the security of a main system of a terminal can be enhanced, the integrity of the main system can be improved, and data stored therein can be kept personal and do not get exposed to other users who operate a terminal in a different hierarchy or mode.

As defined in 1-4, a “mode” refers to an operational state of a terminal, where a user can access a certain number of accessible [1] units, [2] hardware elements or [3[software elements of a main, intermediate or lock system. A “hierarchy” similarly means a set of at least two modes which a terminal actually defines along a line of the access authority or in a domain of the access authority. A terminal grants a preset access authority to access accessible units, hardware or software elements of the main, intermediate or lock system.

Because various terms are defined in previous Sections, definitions of terms such as a “forward or backward direction,” a “series, parallel, or hybrid hierarchy,” a “non-circulating or circulating” hierarchy, and a “series or selective switching” arrangement are omitted herein.

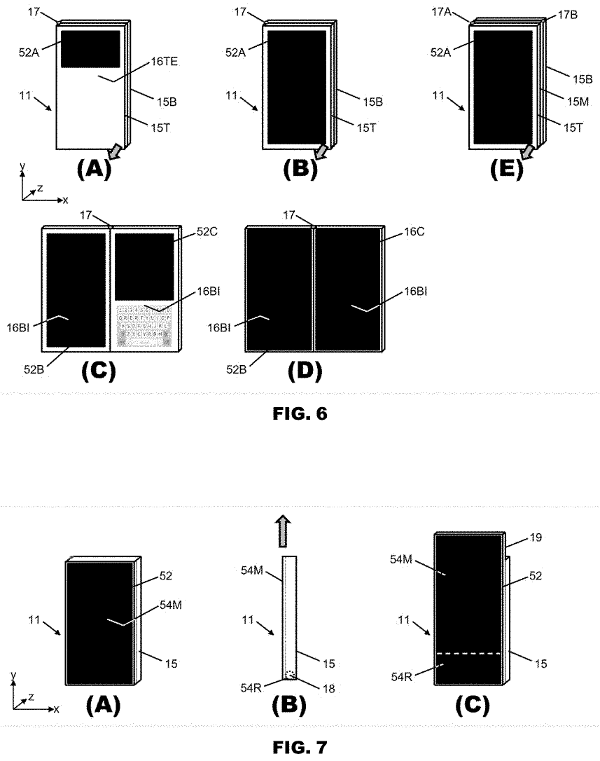

Further details of “4-11-4. Hierarchies and Modes” are identical to the following portions of the '861 application such as, e.g., FIGS. 6A and 6B, and the text from [0767] on page 71 through [0782] on page 73, where these portions are incorporated herein in their entirety by reference.

### 4-11-5. Mode Switching Made Easy

In another exemplary embodiment of this first exemplary aspect, various data processing terminals and their related methods of this disclosure may enable a user to conveniently switch from one mode to another mode. To this end, a terminal may include at least one input unit which includes a designated sensor for acquiring at least one “mode-switching (user) sub-input” or UI_{SWI} from a user input. As a result, a user may switch from a current mode to a new mode by providing a single user input to a terminal, without having to turn off a display unit and then turning it on again, like a user has to do with a prior art data processing device.

In the 1^{st} example of this exemplary embodiment, when a user provides a single user input (i.e., providing UI_{SWI} once), a mode-switching input unit of a terminal may acquire UI_{SWI} with its sensor. Upon acquiring UI_{SWI}, a sensor may generate and send a control signal to a terminal, more particularly, to a main CPU unit or a main O/S.

When desirable, a mode-switching input unit may verify whether or not [1] acquired UI_{SWI} is authentic, [2] acquired UI_{SWI} matches any mode listed in a matching list, or the like. Upon receiving or recognizing the control signal, a main CPU unit or a main O/S may switch modes from a current mode to a new mode which is adjacent to a current mode in the forward (or backward) direction in a hierarchy. A terminal adopting the series switching generally follows this suit.

When a terminal adopts the selective switching, it may consult a “matching list” upon receiving a control signal or UI_{SWI}. Because the matching list matches each of multiple UI_{SWI}'s with each of multiple modes defined in a hierarchy, a terminal may select a new mode as designated (or matched) by the control signal or UI_{SWI}, and may switch modes accordingly. As a result, the user can switch from a current mode (including an off-state or a powered-off state) to a new mode (including an off-state or a powered-off state) by providing UI_{SWI} once.

A terminal may receive a user input and then acquire UI_{SWI} therefrom with various input units.

In one case, a terminal may include a separate mode-switching input unit which is different from an activation input unit or an authentication input unit. A mode-switching input unit may [1] only receive a user input including UI_{SWI} but no other (user) sub-inputs therein, [2] receive a user input including UI_{SWI} along with at least one another (user) sub-inputs, [3] receive multiple user inputs at least one of which includes UI_{SWI}, whereas others may optionally include UI_{ACT}, UI_{THEN}, or UI_{AUX}, or [4] receive multiple user inputs at least two of which include multiple UI_{SWI}'s, along with other optional sub-inputs. A mode-switching input unit may be included as an element of a main or lock system. A mode-switching input unit may instead be included in a terminal, not as an element of a main or lock system.

Conversely and in another case, a single input unit may receive a single user input or multiple concurrent (or sequential) user inputs at least one of which includes therein UI_{SWI} and may optionally include at least one another (user) sub-input. To this end, a single input unit may serve as [1] a mode-switching input unit and an activation input unit by acquiring UI_{SWI} and UI_{ACT}, [2] a mode-switching input unit and an authentication input unit by acquiring UI_{SWI} and UI_{THEN}, or [3] an almighty input unit by acquiring UI_{SWI}, UI_{ACT}, UI_{THEN}, or the like. As a result, a single input unit may include [1] two sensors for acquiring UI_{SWI} and UI_{ACT}, [2] two sensors for acquiring UI_{SWI} and UI_{THEN}, or [3] two or more sensors for acquiring UI_{SWI}, UI_{ACT}, and UI_{THEN}.

Further details of the 1^{st} example of “4-11-5. Mode Switching Made Easy” are identical to the following portions of the '861 application such as, e.g., the text from [0789] on page 73 through [0797] on page 74, where these portions are incorporated herein in their entirety by reference.

In the 2^{nd} example of this exemplary embodiment and contrary to the above direction-insensitive UI_{SWI}, various data processing terminals and related methods of this disclosure may enable a user to switch modes based on a direction-sensitive UI_{SWI}, thereby allowing a user to switch modes in either a forward or backward direction in a certain hierarchy.

Accordingly, a terminal may switch from a current mode to a new mode in response to UI_{SWII} which carries information whether the mode switching is in a forward or backward direction and, therefore, which is direction-sensitive.

It is noted that a terminal may acquire information as to such a direction by various modes.

In a 1^{st} case, a user sub-input UI_{SWI} may carry the information regarding the direction. In a 2^{nd} case, UI_{SWI} may not carry such direction information, but a user input which includes such UI_{SWI} may include another user sub-input for such a direction. In a 3^{rd} case, UI_{SWI} may not carry such direction information, but a mode-switching input unit may include a sensor capable of generating multiple different control signals each representing a certain direction.

The following cases may refer to the 1^{st} case of this paragraph. However, detailed configuration or operations based on the 1^{st} case may apply to those based on the 2^{nd} and 3^{rd} cases of this paragraph.

In one case, a user may provide a user input by manipulating a mode-switching input unit (or other input units) while manipulating a direction of such user input. When the input unit receives a user input, its sensor acquires specific UI_{SWI} based not only on the nature of such manipulation but also on a direction of such manipulation. A terminal may then select one of multiple UI_{SWI}'s from the direction, and may switch modes accordingly. As a result, this configuration is helpful for a user who operates a terminal in the selective switching, for a user may seamlessly provide a desirable UI_{SWI} with a single effort.

In another case, the above configuration may be helpful for a user operating a terminal in the series switching as well. That is, a user may manipulate a direction of a user input and provide UI_{SWI} which may control the mode switching in a forward or backward direction. As a result, a user may switch from a current mode to a neighboring mode in either the forward or backward direction.

In the 3^{rd} example of this exemplary embodiment, various data processing terminals and related methods of this disclosure may enable a user to provide a single user while also providing [1] multiple (identical or different) UI_{SWI}'s, [2] multiple concurrent user inputs, or [3] multiple sequential user inputs. In general, a user may provide multiple UI_{SWI}'s to a terminal which may operate in the series switching. Upon acquiring such UI_{SWI}'s, a terminal may switch to a new mode which may be separated from the current mode by the same number of UI_{SWI}'s. For example, when a user provides a terminal operating in the series switching with three sequential UI_{SWI}'s, the terminal may switch to a new mode which is a 3^{rd} adjacent mode from a current mode in a forward direction, or to a new mode which is three modes away from a current mode in the same direction.

In the 4^{th} example of this exemplary embodiment, various data processing terminals and related methods of this disclosure may be configured to select a new mode by simply consulting a “matching list” which matches each of multiple UI_{SWI}'s with each of multiple modes defined in a certain hierarchy. For example, as a terminal receives UI_{SWI} and a terminal operates in the selective switching, a terminal may locate an entry (i.e., one of multiple pre-defined modes which is intended by a user) which corresponds to one of UI_{SWI}'s which the user provided to the terminal.

Accordingly, a terminal sets up a matching list for a certain hierarchy which may define such modes. In case when a terminal defines multiple hierarchies, a terminal may define multiple matching lists each of which is used by each hierarchy. Alternatively, a terminal may define a single matching list in which all modes defined in all hierarchies may be matched to each of multiple UI_{SWI}'s. It is appreciated, however, that when a terminal operates in the series switching, a terminal may not require the matching list.

It is appreciated that a matching list may [1] match (or assign) a single UI_{SWI} with (to) a single mode of operation (i.e., 1-to-1 matching), [2] match (or assign) multiple UI_{SWI}'s with (to) a single mode (i.e., m-to-1 matching), [3] assign (or match) a single UI_{SWI} to multiple modes (i.e., 1-to-n matching), [4] instead match (or assign) multiple UI_{SWI}'s to multiple modes (i.e., m-to-n matching), or the like.

In general, a terminal may adopt the arrangement [1] of the preceding paragraph, for this arrangement may be straightforward and free of confusion. However, the arrangement [2] of the preceding paragraph may also be useful when a user operates a terminal preferentially in one mode. For example, when a user switches to a preset mode most frequently, a terminal may be configured that manipulating a mode-switching input unit in three of four directions switches to the preset mode, while manipulating the input unit in the last direction may switch to another mode.

The 1-to-n matching arrangement may be useful when a terminal sets up multiple modes which are related to each other in some traits. For example, when a user performs multiple projects for work, the user may set up different modes in each of which the user may only drive a certain hardware or software element, may access only certain data stored therein, or the like.

When a user provides a user input and a terminal acquires a single UI_{SWI} therefrom, a terminal may display a list of multiple modes in such a way that a user may then select one mode from a list of such related modes, e.g., by displaying a list of different modes of operation to which the user may switch. Thereafter, a user may provide additional UI_{SWI} and may switch to the mode of his or her selection. This arrangement may be useful in relieving a burden from a user in memorizing a hierarchy and various modes defined therein.

Alternatively, a terminal may be configured such that, once a terminal displays a list of different modes, a user may be able to provide additional UI_{SWI} concurrently, and that a 1^{st} user input and a 2nd user input with additional UI_{SWI} can be a single, concurrent user input.

In the 5^{th} example of this exemplary embodiment, various data processing terminals may condition the mode switching with other operations run by a terminal. Examples of such operations may include, e.g., [1] running an authentication operation, [2] running a turning-on operation, [3] running an erase (or semi-erase) operation, [4] launching (or resuming an operation of) a lock, intermediate, or main system, or the like.

### 4-11-6. Mode Switching Embodied Easy

In another exemplary embodiment of this first exemplary aspect, a data processing terminal may be configured to embody such mode switching in a manner which is most convenient to a user, while maintaining seamless features related to such mode switching. As described below, embodying the mode switching operations and configurations therefor may be accomplished by incorporating necessary hardware or software elements into various terminals of this disclosure.

More particularly and as described above, a data processing terminal of this disclosure may include a mode-switching input unit which is designated to receive a user input with UI_{SWI}. As a result, a user may not have to manipulate [1] multiple prior art input units or [2] a single prior art input unit, more than once. A terminal may also combine a mode-switching input unit with another input unit and may acquire UI_{SWI} concurrently with UI_{ACT} or UI_{THEN}.

Therefore, a terminal may provide a user with benefits of seamless features, with which a user may run multiple operations while providing a single user input to a terminal.

In the 1^{st} example of this exemplary embodiment, a terminal may include at least one hard button-type mode-switching input unit (25) which can acquire UI_{SWI} therewith. Further details of this 1st example of “4-11-6. Mode Switching Embodied Easy” are identical to the following portions of the '861 application such as, e.g., FIGS. 7A to 7D and the text from [0812] on page 75 through [0825] on page 76, where these portions are incorporated herein in their entirety by reference.

In the 2^{nd} example of this exemplary embodiment, a terminal may receive a 1^{st} user input, and acquire UI_{ACT} or UI_{THEN} from a movement of a portion of a main (or lock) input unit, while also receiving a 2^{nd} user input and acquiring UI_{SWI} from [1] a direction of such a movement, [2] a static or dynamic feature of a force related to a 2nd user input, or the like. Alternatively, a terminal may receive a 1^{st} user input and acquire UI_{ACT} or UI_{THEN} from a contact between a user body part and a portion of a main (or lock) unit, while receiving a 2^{nd} user input and acquiring UI_{SWI} from [1] a direction of the contact, or [2] a static or dynamic feature of the 2^{nd} user input.

In these respects, an exact shape or configuration of the main (or lock) input unit and the mode-switching input unit may not be material, as far as such input units may be fabricated as separate articles and disposed (or coupled) adjacent to each other or at a preset distance.

Such input units may also be fabricated as a unitary article which may include multiple sensors for acquiring UI_{SWI} and at least one of UI_{ACT} and UI_{THEN}, or the like.

In the 3^{rd} example of this exemplary embodiment, a terminal may include a single input unit which may serve as a main (or lock) input unit and as a mode-switching input unit depending upon circumstances of receiving a user input, where this corresponds to a case in which the main (or lock) input unit and the mode-switching input unit are formed as a unitary input unit.

In one case, when this input unit receives a user input in its off-state, the input unit may acquire [1] UI_{ACT} when a terminal is to turn on its display unit upon receiving the user input, [2] UI_{THEN} when a terminal is to determine whether or not to turn on its display unit conditioned on an outcome of the user authenticating, [3] UI_{SWI} when a terminal may switch to a mode of a user's choice when a terminal turns on its display unit and launches one of a lock, intermediate, or unlock system based on UI_{SWI}, or the like.

In another case, when that input unit receives a user input in its on-state, the input unit may acquire [1] UI_{SWI} when a terminal is to switch modes based on UI_{SWI}, or [2] UI_{THEN} when a user desires to switch to a new mode granted with greater access authority than a current mode. Other configurational or operational features of the terminal of this 3^{rd} example may be similar or identical to those of the terminals of the 1^{st} example.

In the 4^{th} example of this exemplary embodiment, a terminal may include at least one soft button-type mode-switching input unit (25) which can acquire UI_{SWI} therewith. Further details of this 4^{th} example of “4-11-6. Mode Switching Embodied Easy” are identical to the following portions of the '861 application such as, e.g., FIGS. 7E and 7F and the text from [0829] on page 77 through [0840] on page 78, where these portions are incorporated herein in their entirety by reference.

In the 5^{th} example of this exemplary embodiment, a mode-switching input unit may employ various prior art capacitive sensing techniques which are based upon capacitive coupling and which can detect and measure anything which is conductive or which has a dielectric constant different from that of air. In general, capacitive sensors incorporated into a touchscreen of a prior art data processing device or a prior art data processing pad can detect a proximity, a position, a displacement or an acceleration. Therefore, various data processing terminals of this disclosure may adopt such prior art sensors to acquire UI_{SWI} from a user input.

Currently available capacitive sensing techniques include, e.g., surface capacitance technology, and projected capacitance technology. In the surface capacitance technology, a sensor includes an insulator, and only one side of the insulator may be coated with a conductive material. Upon applying a small electrical voltage to the material, uniform electrostatic field is developed. Due to sheet resistance of the surface, each corner may have different effective capacitances. Thereafter, when a conductor (e.g., a finger of a user or a conductive tip of a non-user object) touches an uncoated surface, a capacitor is dynamically formed on the surface. A controller of a sensor can then determine a location of a touch, indirectly from a change in the capacitance as measured from the four corners of the sensor, where the larger the change in capacitance becomes, the closer the touch is to that corner.

Further details of this 5^{th} example of such “4-11-6. Mode Switching Embodied Easy” are identical to the following portions of the '861 application such as, e.g., the text from [0843] on page 78 through [0848] on page 79, where these portions are incorporated herein in their entirety by reference.

In the 6^{th} example of this exemplary embodiment, a mode-switching input unit may use resistive technologies for acquiring UI_{SWI} (or multiple UI_{SWI}'s) from such contacts, movements of such contacts, multiple quick efforts, or the like. The resistive technologies may include analog (or digital) resistive technologies, or in-cell resistive technologies.

In addition, a mode-switching input unit may use optical touch technologies to acquire UI_{SWI} (or multiple UI_{SWI}'s) from such contacts, movements, or multiple quick efforts, where such optical touch technologies may function when a finger (or a non-user object) contacts a surface of the input unit and causes scattering of lights which may be monitored with a sensor or a camera which sends data to a software element which dictates a response to such contacts, movements of such contacts, or efforts, depending upon the type of reflection to be measured.

Such optical touch technologies may include, e.g., optical imaging technology, infrared (IR) technology, rear diffused illumination (DI) technology, IR grid technology, digital waveguide touch (DWT) technology, IR optical waveguide technology, diffused surface illumination (DSI) technology, laser light plane (LLP) technology, in-cell optical technology, or frustrated total internal reflection (FTIR) technology.

Other details of this 6^{th} example of “4-11-6. Mode Switching Embodied Easy” are identical to the following portions of the '861 application such as, e.g., the paragraphs of [0851] through [0855] on page 79, where these portions are incorporated herein in their entirety by reference.

In the 7^{th} example of this exemplary embodiment, a terminal may include various mode-switching input units which can allow a user to provide various UI_{SWI}'s more conveniently and readily. More particularly, a terminal may fabricate a mode-switching input unit by, e.g., employing suitable hardware or software elements thereto. Other details of this 7^{th} example of “4-11-6. Mode Switching Embodied Easy” are identical to the following portions of the '861 application such as, e.g., FIGS. 8A through 8E, the text from [0856] on page 79 through [0896] on page 83, where these portions are incorporated herein in their entirety by reference.

In the 8^{th} example of this exemplary embodiment, a data processing terminal may also grant various access authorities to each of multiple modes defined in a certain hierarchy. Such terminals may adopt various prior art access control (or authorization) algorithms, and grant a user with preset privileges to drive certain hardware or software elements of a main, lock or intermediate system of a terminal in each of the modes. When desirable, such terminals may adopt the above access control (or authorization) algorithms in conjunction with various user authentication algorithms.

Other details of this 8^{th} example of “4-11-6. Mode Switching Embodied Easy” are identical to the following portions of the '861 application such as, e.g., the text from [0898] on page 83 through [0903] on page 84, where these portions are incorporated herein in their entirety by reference.

In the 9^{th} example of this exemplary embodiment, a terminal may utilize various GUIs as the above access control means or authorization means, and may grant a user with access authority to drive certain resources of a terminal such as, e.g., certain hardware or software elements of a main (or lock) system of a terminal.

Other details of this 9^{th} example of “4-11-6. Mode Switching Embodied Easy” are identical to the following portions of the '861 application such as, e.g., the text from [0905] on page 84 through [0906] on page 85, where these portions are incorporated herein in their entirety by reference.

In the 10^{th} example of this exemplary embodiment, a data processing terminal may supervise access controls granted to each of multiple modes of operation defined in a certain hierarchy. Such terminals may adopt various prior art computer security engineering technologies [1] to grant a user with pre-determined privileges to drive the hardware or software elements of a main (or lock) system of a terminal in each mode or [2] to grant each mode with certain privileges to drive only certain hardware or software elements of a main (or lock) system, depending on users or regardless of an identity (e.g., an administrator or not) of a user.

Because various computer security engineering technologies and their algorithms are well known in the art, details to be omitted herein. However, some of such technologies and algorithms are available in a textbook which is entitled “Security engineering—a guide to building dependable distributed systems,” written by Ross Anderson, and published by John Wiley & Sons in January 2001 (ISBN-10: 0471389226). More particularly, refer to Chapter 4 “Access control” (pp. 62-64) and various references included therein.

### 4-11-7. Notifying Modes and Switching

From time to time, even a correct user happens to provide a wrong user input or may provide a correct user input which, however, carries unintended UI_{SWI} therein. As a result, a terminal may switch to an incorrect new mode or may not switch its mode at all. Such incorrect switching may not only cause an inconvenience to a user, but also require a user to take an extra remedial effort to switch from an incorrect mode to a correct new mode. In this respect, various data processing terminals of this disclosure may offer benefits to a user by providing the user with various notice signals and by informing him or her of various information regarding, e.g., [1] which mode of operation a user is currently in, [2] which UI_{SWI} a user has provided, [3] to which new mode a terminal will switch, [4] what types of access authority a user will be granted in a new mode, [5] which hardware or software elements a user may (or may not) drive once a user switches to a new mode, or the like.

Such terminals may provide further benefits to a user by allowing the user to confirm whether he has provided correct UI_{SWI}, i.e., whether the user has provided UI_{SWI} designated to a mode which the user has intended. In general, switching modes according to certain UI_{SWI} and informing a user of a new mode (or a user finds that he or she is in a wrong mode) may not be practically helpful, for the user may have to provide another user input with correct UI_{SWI} anyway when the user finds that he or she has moved to an unintended mode.

Accordingly and in another exemplary embodiment of the first exemplary aspect of this disclosure, a terminal may be configured to provide various information about such modes or access authorities before the terminal actually switches to a new mode. As far as a user can readily identify that he is providing unintended UI_{SWI} for the mode switching, the user can rectify his mistake before such mode switching.

Further details of this 9^{th} example of “4-11-7. Notifying Modes and Switching” are identical to the following portions of the '861 application such as, e.g., FIGS. 9A through 9D and the text from [0913] on page 85 through [0952] on page 89, where these portions are incorporated herein in their entirety by reference.

### 4-12. Interchangeability

Although the foregoing embodiments and examples of this 1^{st} Configuration have been explained with a focus on a data processing terminal which operates in a hierarchy which defines therein a single lock mode and a single unlock mode, all foregoing embodiments and examples equally apply to other data processing terminals operating in a hierarchy which defines any number of unlock, intermediate, or lock modes, where each of such modes is granted by a terminal (or a user) with identical, similar, comparable or different access authorities.

In this context, a terminal may operate in a hierarchy which defines at least one intermediate mode along with at least one lock mode and at least one unlock mode. It then follows that a terminal may advance from an off-state or a powered-off state directly to an intermediate mode, without having to advance to a lock mode. By the same token, a terminal may switch from an intermediate mode directly to an off-state or a powered-off state, without having to pass through a lock mode.

In addition, a terminal may switch from an intermediate mode to either an unlock mode or a lock mode. As a result, any operational features of this 1^{st} Configuration related to switching from an off-state or a powered-off state to a lock mode also apply to switching from an off-state or powered-off state to an intermediate mode. Similarly, any operational features of this 1^{st} Configuration which are related to switching from a lock mode to an off-state or a powered-off state also apply to switching from an intermediate mode to an off-state or a powered-off state.

It is noted that various features of a certain example of a certain embodiment of this 1^{st} Configuration may equally or similarly apply to a different example of [1] the same embodiment of the same 1^{st} Configuration, [2] a different embodiment of the same 1^{st} Configuration, or [3] a different embodiment of a different aspect of other aspects of this disclosure explained hereinabove or hereinafter, within the extent that such features do not contradict each other.

In addition, configurational or operational variations (or modifications) of various terminals described in various embodiments or examples of this first exemplary aspect (i.e., the 1^{st} Configuration) may be interchangeable with other various embodiments or examples of other exemplary aspects of this disclosure. Therefore, certain features of one embodiment or example of this first exemplary aspect may be applied to another embodiment or example of the same aspect or of different aspects.

Moreover, other configurational or operational features, their variations or modifications of the terminals of this first exemplary aspect [1] may apply to, [2] may be incorporated into, [3] may replace, [4] may be replaced by, or [5] may be combined with corresponding features of the same or different [1] aspect, [2] embodiment, or [3] example of this disclosure, as long as such application, incorporation, replacement, or combination does not contradict each other.

### 5. 2^{nd} Configuration—Lock System with Lock CPU Unit

In the second exemplary aspect of this disclosure which corresponds to the 2^{nd} Configuration of this disclosure, a terminal may include at least one main system and at least one lock (or intermediate) system. It is appreciated that a main (or lock) system includes therein at least one main (or lock) unit and that each main (or lock) unit includes at least one main (or lock) hardware or software element therein. As a result, each main (or lock) unit may run a certain operations, thereby performing a specific function.

Similar to that of Section 4, a main system of this 2^{nd} Configuration may operate in an unlock mode, and include at least one (1) main CPU unit, (2) main input unit, (3) main output unit, and (4) main memory unit, along with other optional main units. A lock system of this 2^{nd} Configuration may operate in a lock mode, and include (1) at least one lock CPU unit, (2) at least one lock memory unit, and (3) at least one optional lock viewer, along with other optional lock units such as a lock input unit.

By including a lock CPU unit therein, a lock system of this 2^{nd} Configuration may run at least one operation, completely (or partly) independent of a main system. In addition, by including the lock CPU unit, a lock system may not need to include any lock viewer, particularly when a lock CPU unit may run operations which can be run by the lock viewer.

Depending upon a capability of a lock CPU unit, a lock system may not need any configurational or operational assistance from a main system in running lock operations in a lock mode. That is, a lock system may run lock operations with its own lock CPU unit, without resorting to a main CPU unit or a main O/S of a main system. It then follows that physically or operationally isolating various units of a lock system from such units of a main system of a terminal of this 2^{nd} Configuration is generally more feasible than in the case of that of the previous 1^{st} Configuration.

Due to the presence of a lock CPU unit, a lock system of this 2^{nd} Configuration can drive more units, thereby capable of running more diverse lock operations, while performing more diverse functions. As a result, various terminals of this 2^{nd} Configuration can provide a user with the enhanced security, the improved integrity, and the heightened privacy. Details of such lock and main systems of various terminals of this 2^{nd} Configuration are provided below, while omitting those features identical to those of the 1^{st} Configuration.

FIG. 2A is a block diagram of an exemplary data processing terminal of the 2^{nd} Configuration of this disclosure. More particularly, FIG. 2A exemplifies a terminal including a single main system (10) and a single lock system (60), where such systems and their respective units are depicted in a context of multiple abstract layers, and where various units may physically or operationally couple with each other in various paths as represented by various lines with arrows.

Various lines which connect such units of FIG. 2A show “paths” of physical or operational coupling between various units such as, e.g., a command signal, data transfer, manipulation, or the like. It is noted that the paths of FIG. 2A are only exemplary and that many other units may be connected by additional paths.

For example, the main CPU unit (30) and main O/S (34) may drive other units of FIG. 2A. For simplicity of illustration, not all paths are included in this figure, and optional paths among other units of FIG. 2A will to be explained in detail in conjunction with other details of the main and lock systems of a terminal of this 2^{nd} Configuration. 5-1. 2^{nd} Configuration—Main System In the 1^{st} exemplary embodiment of the second exemplary aspect (i.e., a 2^{nd} Configuration) of this disclosure, a main system (10) of a terminal may include various units and various hardware or software elements as have been described in conjunction with the main system of the 1^{st} Configuration. It is appreciated that each unit of the main system (10) may include at least one of such hardware or software element.

For example and as shown in FIG. 2A, a main system (10) may include at least one main input unit (20), main CPU unit (30), main O/S (34), main (software) application (35), main memory unit (40), or main output unit (50), where each main unit of a terminal of this 2^{nd} Configuration is identical or similar to that of the terminal of the 1^{st} Configuration.

More particularly, a main CPU unit (30) may include a CPU, a firmware, and an assembler, similar to that of the 1^{st} Configuration. In addition, each unit of a main system (10) is similar or identical to the corresponding unit of the main system of the 1^{st} Configuration, and may be similar or identical to another corresponding unit of a terminal of other exemplary aspects of this disclosure. Thus, details of various units of the main system (10) are omitted herein.

However, by including a lock CPU unit (70) therein, a lock system (60) of the 2^{nd} Configuration may not need to recruit a main CPU unit (30) or a main O/S (34) to drive a lock viewer (71) or an optional lock memory unit (80). Accordingly, details of the main system (10) of a terminal of this 2^{nd} Configuration may differ from that of the 1^{st} Configuration to that extent as will be explained in greater below.

Except the above differences, other details of the main system (10) of this 2^{nd} Configuration may be similar or identical to those of the main system of the 1^{st} Configuration, or to those of other main systems of other terminals as described in other exemplary aspects of this disclosure, subject to certain modifications, additions or omissions each of which will become apparent based on detailed contexts.

### 5-2. 2^{nd} Configuration—Lock System

In the 2^{nd} exemplary embodiment of the second exemplary aspect, a terminal may also include at least one lock system (60), in addition to the main system (10). A lock system (60) may include a lock CPU unit (70), an optional lock viewer (71), and other optional lock units such as, e.g., [1] a lock memory unit (80), [2] a lock O/S (not included in the figure), [3] a lock output unit (not included in the figure), or the like.

A lock CPU unit (70) may include at least one [1] lock CPU, [2] lock firmware, or [3] lock assembler, and may perform various functions in a lock mode, where such functions may be similar or identical to those functions performed by a main CPU unit (30) operating in an unlock mode. Thus, depending upon which hardware or software elements are to be included in a lock CPU unit (70), a lock system (60) may serve [1] simply as a lock viewer as described in the above 1^{st} Configuration, [2] as a simplified version (i.e., having less functionality) of a main system (10) of the 1^{st} or 2^{nd} Configuration, or [3] as a system which is simpler than the main system (10) of the 1^{st} or 2^{nd} Configuration but which has more functionality than the lock system of the 1^{st} Configuration.

Alternatively, a lock (60) system may include a lock CPU unit (70) which is different from a lock viewer (71) of FIG. 2A. Although not shown in the figure, a lock system (60) may include a lock O/S which may work with a lock CPU unit (70) and help a user drive at least one hardware or software element of a lock system (60).

As described above, a lock CPU unit (70) generally includes a lock CPU which may carry out basic instructions of a computer program by performing basic arithmetic, logical, control, or I/O operations. A lock CPU unit (70) may optionally include a lock firmware and a lock assembler, where a lock firmware may provide control, data monitoring or data manipulation to various hardware elements of a lock system (60), while a lock assembler may create an object code, store tedious calculations and manual address updates after program modifications, or the like, just like a prior art CPU, firmware, assembler, or the like.

Alternatively, a lock CPU unit (70) may be configured to include a minimum functionality of a prior art CPU, firmware, or assembler. That is, a lock CPU unit (70) may carry out only some of such basic instructions, or provide only partial control, partial data monitoring, or partial data manipulation to various hardware elements of a lock system (60). In general, the more functionality a lock CPU unit (70) may be equipped with, such a unit (70) may run more operations, perform more functions, or the like. In this respect, the lock system (60) of a terminal of the 1^{st} Configuration which may only include a lock viewer may be deemed as a lock system with the minimum functionality.

A lock system (60) may optionally include a lock O/S which is equipped with at least minimum functionality of a main O/S (34) or that of another prior art O/S and which may manage various hardware or software elements of a lock system (60). As a result, a lock system (60) with a lock CPU unit (70) and a lock O/S may also provide services to software elements of a lock system (60) such as, e.g., driving such elements, allocating processor time or memories thereto, or driving I/O hardware elements of a lock system (60).

Therefore, it is appreciated that incorporating a lock CPU unit (70) differentiates a lock system (60) of this 2^{nd} Configuration from that of the 1^{st} Configuration. Therefore, a lock system (60) of this 2^{nd} Configuration may run an operation, without getting a main CPU unit (30) or a main O/S (34) involved. In addition, a lock system (60) of this 2^{nd} Configuration may be able run certain operations, without acquiring any prior authorization from a main CPU unit (30) or a main O/S (34).

By incorporating such a lock CPU unit (70) (or a lock O/S), a terminal manufacturer or an application developer may incorporate such lock systems (60) along with the lock CPU units (70) into a terminal, without having to obtain a pre-approval or pre-consent from an O/S provider. As a result, a terminal of this 2^{nd} Configuration may allow a user to select and launch a lock system (60), even before launching a main system (10), thereby partly or completely isolating a main system (10) from a lock system (60), either physically or operationally.

A lock system (60) may also include a lock viewer (71) which may be similar to that of the 1^{st} Configuration. A lock viewer (71) may be a limited-functionality (software) app which may not allow a user to edit, create or modify data (or files). For example, a lock viewer (71) may correspond to various conventional viewers or browsers such as, e.g., file viewers, image viewers, web browsers, or other prior art viewers. A lock CPU unit (70) may drive a lock viewer (71) by including therein, e.g., a driver capable of driving the lock viewer (71), or a lock O/S. Other configurational or operational features of the lock viewer (71) of this 2^{nd} Configuration may be similar or identical to those of the lock viewer of the 1^{st} Configuration.

It is noted that whether or not to include a lock viewer (71) in a lock system may depend upon functionality of a lock CPU unit (70). For example, when a lock CPU unit (70) cannot run all operations which a lock viewer (71) can run in a lock mode, a terminal may need to include a lock viewer (71), for a lock system (60) without a lock viewer (71) cannot run anyway all the operations which a lock viewer (71) could have run.

However, when a lock CPU unit (70) can run each and every operation which a lock viewer (71) can run in a lock mode, a terminal may not include a lock viewer (71), and obviate such redundancy. However, including a lock viewer (71) despite such redundancy may offer a few benefits to a user. First, by including a lock viewer (71) in addition to a lock CPU unit (70), a user may be able to drive a lock viewer (71) even when a lock CPU unit (70) may get contaminated or begin to malfunction. The reverse holds as well such that a user may drive a lock CPU unit (70) as a file viewer, an image viewer, or a web browser.

Secondly, a terminal may maximize isolation of a main system (10) from a lock CPU unit (70). For example, without a lock viewer (71), a terminal may have to operationally couple a lock CPU unit (70) with a main system (10), e.g., when it may be desirable to allow any unit of a main system (10) to drive any unit of a lock system (60). However, when a lock system (60) accidently introduces malicious viruses thereinto while running lock operations, such viruses may have the greater chance of migrating into a main system (10) when the more main units tend to drive a lock unit.

Accordingly, when a terminal assigns more viewing takes to a lock viewer (71) and less viewing tasks to a lock CPU unit (70), a terminal may minimize operational coupling between a main system (10) and a lock CPU unit (70), thereby decreasing a chance of contaminating a main system (10) by malicious viruses.

A lock system (60) may include an optional lock memory unit (80) which is similar to that of the 1^{st} Configuration. Accordingly, a lock memory unit (80) may store all or only some (portions of) “results” obtained by running lock operations in a lock mode. To this end, a user may manually mark to-be-stored results, thereby saving such (portions of) “results” from an erase (or semi-erase) operation. As a result, the to-be-stored results may remain in a lock system (60), even after a terminal switches to a new mode. A terminal (or user) may rather select the to-be-stored results based upon other criteria such as, e.g., a type or content of such (portions of) “results,” a period of time in which a user handles such (portions of) “results,”, a period of time in which a user remains in a certain website, a user preference, user statistics, use statistics, or the like.

A lock memory unit (80) may primarily serve to temporarily (or permanently) store various results obtained by running lock operations in a lock mode. A terminal may ensure that such lock operations run by a lock system (60), results obtained or downloaded in a lock mode, or results stored or residing in a lock system (60) may not adversely affect or contaminate a main memory unit (40) or other units of a main system (10). Thus, when a terminal allows a user to [1] drive a lock viewer (71), [2] store such (portions of) “results” in a lock memory unit (80), or [3] retrieve data therefrom, a terminal may [1] isolate a main system (10) from at least one unit of a lock system (60), [2] prevent a user from storing such (portions) of “results” which are stored or residing in a lock system (60) into a main memory unit (40) of a main system (10), [3] run an erase (or semi-erase) operation onto such results in one of various erasure timings, or the like.

A lock system (60) may include an optional lock input unit such as, e.g., at least one mode-switching input unit (25) which may be designated to receive a user input which in turn includes UI_{SWI} therein. To this end, a mode-switching input unit (25) may include a sensor for acquiring UI_{SWI} from the user input. A mode-switching input unit (25) may be fabricated as a hardware element which is different and separate from a main input unit (20), or may be combined with at least one of various input units such as, e.g., an activation input unit (for acquiring UI_{ACT}), an authentication input unit (for acquiring UI_{THEN}), or a main input unit (20) which may acquire at least two different (user) sub-inputs. A lock (or main) system (60), (10) may then drive a mode-switching input unit (25) in a lock (or unlock) mode.

Similar to that of the 1^{st} Configuration, a mode-switching input unit (25) may be [1] disposed away from a main input unit (20) (e.g., one input unit on a right edge of a terminal, while another input unit on its front surface), [2] disposed next to a main input unit (20), [3] provided as a unitary article with a main input unit (20), or the like. In addition, a mode-switching input unit (25) may be regarded as a hardware element of a main system (10), as that of [1] a lock system, [2] a main system, or [3] a terminal itself.

A lock system (60) may include an optional lock output unit (90) which may display static or dynamic images or may play sounds resulting from running various lock operations in a lock mode. It is appreciated that, instead of implementing an additional lock display unit or a lock speaker, a lock system (60) may recruit a main display unit or a main speaker of a main system (10) to display such images or to play sounds in a lock mode.

As described above, a terminal may use a lock system (60) of the 2^{nd} Configuration which may operate entirely or partly independent of a main system (10). Instead of being incorporated into a terminal, a lock system (60) may be fabricated as a separate article which a user may releasably couple with a terminal and which a user may operate as a lock system (60) of a terminal. To this end, a lock system (60) may be fabricated [1] as an external “USB-type device” which may include a lock CPU unit, a lock memory unit, or another lock unit, [2] as an “external memory chip (or card)” which may include at least one lock unit, [3] a “portable memory chip (or card)” which may include at least one lock unit, [4] any other prior art memory chip, card, or device which may include at least one lock unit, or the like. It is noted that each of the external lock systems (60) may include a lock O/S or a lock memory unit (80) with a space for storing data or at least a portion of such “results” therein.

A terminal may also use a lock system (60) of this 2^{nd} Configuration which may be incorporated into a wearable device worn by a user, where examples of such wearable devices have been provided above. It is appreciated that, when desirable, a lock system (60) incorporated into the add-on device or the wearable device may be operationally coupled to [1] a terminal or [2] a main system (10), through wire or wirelessly.

As will be explained below, a main system (10) may drive at least one hardware or software element of a lock system (60) in an unlock mode, e.g., before or after a terminal switches from an unlock mode to a lock mode. In contrary, a lock system (60) may drive at least one hardware or software element of a main system (10), e.g., before or after a terminal switches to an unlock mode. Such features may help a terminal switch mode more easily, more quickly, or more seamlessly.

When a lock system (60) includes a lock CPU unit (70) with limited functionality, a lock system (60) may have to recruit on a main CPU unit (30) or a main O/S (34) to drive a certain hardware or software element of a lock system (60) or a main system (10). Of course, such dependency may make it difficult for a lock system (60) to recruit or to drive some hardware and/or software elements of a lock system (60), not to mention those of a main system (10).

In this respect, a lock CPU unit (70) may offer the benefit of allowing a lock system (60) to drive a hardware or software element of a main system (10), rather independently of a main CPU unit (30), main O/S (34), or other units of a main system (10). It is noted that readiness of driving such elements or units of a main system (10) by a lock system (60) may depend on a scope or depth of the functionalities equipped to a lock CPU unit (70).

But a lock system (60) with a lock CPU unit (70), regardless of the extents of such functionality, may operate and function differently from a lock system without any lock CPU unit. When a lock system (60) includes a lock O/S with at least minimum functionality, a manufacturer of a terminal or its distributor may also install a main O/S (34) along with a lock O/S such that a user may select an order of launching a main O/S (34) and a lock O/S, either concurrently or sequentially. With this arrangement, a terminal may launch a lock system entirely independent [1] of a main CPU unit (30), [2] of a main O/S (34), or [3] entirely of a main system (10).

A terminal of this 2^{nd} Configuration may also offer the benefit of enabling a lock system (60) to store at least a portion of “results” therein, not necessarily into a main memory unit (40). A lock system (60) may store at least a selected portion of “results” in various temporary memory sectors such as a data buffer, cache, clipboard or recycle bin. A lock system (60) may also use not only a user space but also a kernel space of a lock CPU unit (70) to store important results obtained by running lock operations in a lock mode.

As mentioned hereinabove, a lock CPU unit (70) of this 2^{nd} Configuration may bring in vast flexibility in utilizing a lock system (60) as well as a terminal as a whole. Other details of this lock CPU unit (70) are provided below, while other configurational or operational features of the lock system (60) of this 2^{nd} Configuration are similar or identical to those of the lock system of the previous 1^{st} Configuration.

### 5-3. Operations

In the 3^{rd} exemplary embodiment of the second exemplary aspect, a terminal which includes the above main system (10) and lock system (60) may run various operations and perform various functions.

In the 1^{st} operation of this exemplary embodiment, when a display unit is turned off (i.e., an off-state), a terminal may receive a 1^{st} user input and determine to which mode it may switch based on UI_{SWI} included in a 1^{st} user input. Because of the presence of a lock CPU unit (70), a terminal may [1] allocate functionality to run various operations in a lock mode only to a lock CPU unit (70) or [2] distribute such functionality to both of a lock CPU unit (70) and a main CPU unit (30). A terminal may also allocate such functionality only to a lock O/S or to a main O/S (34).

Similarly, a terminal may allocate various data storage tasks in a lock mode to [1] only a lock memory unit (80) or [2] both of a lock memory unit (80) and a main memory unit (40). A terminal may assign a task of running an erase (or semi-erase operation) to [1] a lock CPU unit (70), [2] both of a lock CPU unit (70) and a main CPU unit (30), [3] a lock O/S, or [4] both of a lock O/S and a main O/S (34). Therefore, a terminal may erase all (or only selected) portions of “results” stored or residing in a lock system (60).

A lock system (60) with a lock CPU unit (70) and a lock memory unit (80) may be fabricated in various shapes, sizes, or configurations. For example, a terminal may incorporate all of such lock units therein, while isolating its main system (10) physically or operationally from such lock units. Alternatively, all or some of the lock units may be fabricated as an external or portable unit which may be added onto or releasably couple with a terminal as explained above. When multiple terminals are linked to each other, a lock system of one terminal may serve as a lock system of another terminal, with or without running a user authentication operation in at least one of such terminals.

In the 2^{nd} operation of this exemplary embodiment, when a display unit is turned on (i.e., in an on-state) and when a terminal operates in a lock mode, a terminal may receive a 1^{st} user input. A lock or main CPU unit (70), (30) may determine to which mode it switches based upon UI_{SWI} included in a 1^{st} user input. A lock or main memory unit (80), (40) may store an entire (or a selected) portion of such “results.”

Having been operating in a lock mode, a terminal has been operating a lock system (60) when it receives a 1^{st} user input. Thus, a lock system (60) drives various lock units to [1] receive a 1^{st} user input, [2] acquire UI_{SWI} therefrom, [3] switch modes, or [4] optionally run such erasure (or semi-erasure). A lock system (60) may also run user authenticating, as far as a terminal provides its lock CPU unit (80) or lock O/S with enough functionality. Otherwise, a terminal may recruit at least one main unit to help a lock system (60) run such operations.

In the 3^{rd} operation of this exemplary embodiment, a terminal may receive a 1^{st} user input while operating in an unlock mode. It then follows that a terminal has been in an on-state, while a display unit has been turned on. A lock system (60) may acquire UI_{SWI} from a 1^{st} user input, and a terminal may determine whether to remain in an unlock mode or to switch to a new mode which may be [1] a more unrestricted mode (e.g., another unlock mode) granted with more access authority, [2] a restricted mode (e.g., a lock mode) granted with less access authority, [3] a comparable mode granted with less access authority in one respect but more access authority in a different respect, or the like.

Because a terminal includes a lock CPU unit (70) and a main CPU unit (30), either or both CPU units (70), (30) may determine [1] whether a terminal may stay in a current mode or switch to a new mode, or [2] which results in a lock system (60) may be erased or stored. A terminal may recruit either or both memory units (80), (40) to store such results obtained by running lock operations in a lock mode.

Further details in operating the data processing terminal of this 2^{nd} Configuration may be similar or identical to those of operating the terminal of the 1^{st} Configuration, and may also be similar or identical to those of operating other terminals of other exemplary aspects of this disclosure, subject to certain modifications, additions or omissions each of which become apparent based on detailed context.

### 5-4. 1^{st} and 2^{nd} User Inputs

In the 4^{th} exemplary embodiment of the second exemplary aspect, a terminal may receive various user inputs, where the first of such user inputs includes UI_{SWI}, optionally UI_{THEN} or UI_{ACT} as described above. In response to receiving the first user input (or upon acquiring one of such sub-inputs), a terminal may [1] keep a display unit turned off (i.e., an off-state), [2] display a lock screen while (or after) launching a lock system (60) and switching to a lock mode, [3] display a home screen while (or after) launching a main system (10) and switching to an unlock mode, or [4] display a default screen while (or after) launching a default system and switching to a default mode, where the default mode may be one of a lock mode or one of various intermediate modes. A terminal may instead run different operations in response to the first user input as well.

Thus and in the 1^{st} example of this exemplary embodiment, a terminal may receive the first user input which includes UI_{ACT} (with or without UI_{THEN} or UI_{SWI}) in its off-state. In a 1^{st} case in which a terminal does not employ any user authentication, the first user input does not have to include UI_{THEN}. Thus, a terminal may turn on its display unit in response to UI_{ACT}, and launch a lock system (60) in a lock mode. Thereafter, a terminal may authenticate a user or switch modes upon (or in response to) receiving a second user input.

In a 2^{nd} case where the first user input includes UI_{ACT} and UI_{THEN}, a terminal may run user authenticating in response to the first user input, while keeping a display unit turned off. When a user fails the authenticating, a terminal may keep a display unit turned off, and remain in an off-state. However, when a user passes such user authenticating, a terminal may turn on its display unit, and switch to an unlock mode.

In a 3^{rd} case in which the first user input includes UI_{ACT} and UI_{THEN}, a terminal may turn on a display unit upon (or in response to) the first user input, and launch a lock system (60) in a lock mode. When a user fails the user authenticating, a terminal may stay in a lock mode. When a user passes such authenticating, a terminal may switch to an unlock mode. It is appreciated in the 1^{st} case that a terminal conditions such mode switching upon turning on a display unit. In the 2^{nd} and 3^{rd} cases, a terminal conditions such mode switching on an outcome of such user authenticating. It then follows that a terminal may switch modes without having to acquire UI_{SWI}. In the alternative, it is deemed that such UI_{ACT} or UI_{THEN} may serve as UI_{SWI} in such cases.

In the 2^{nd} example of this exemplary embodiment, a terminal may receive the first user input which includes UI_{ACT} and UI_{THEN} (with or without UI_{SWI}) in its off-state. In a 1^{st} case, a terminal may run user authenticating, and then [1] keep a display unit turned off when a user fails such authenticating, or [2] turn on its display unit when a user passes such authenticating.

In a 2^{nd} case, a terminal may turn on a display unit in response to UI_{ACT}, launch a lock system (60), and display a lock screen on a display unit. A terminal may run an authentication operation [1] before, [2] concurrently with, or [3] after such turning on. When a user fails the user authenticating, a terminal may [1] turn off its display unit, or [2] stay in a lock mode. When a user passes such authenticating, a terminal may switch to an unlock mode and display an unlock screen on a display unit.

It is appreciated in the 1^{st} and 2^{nd} cases of the 2^{nd} example that a terminal may condition such mode switching upon an outcome of the user authenticating. It then follows that, similar to the terminals of the 1^{st} example of this embodiment, a terminal may switch modes without having to acquire UI_{SWI}. Alternatively, it is deemed that such UI_{ACT} or UI_{THEN} may serve as UI_{SWI} in such cases.

In the 3^{rd} example of this exemplary embodiment, a terminal may receive the first user input which includes UI_{SWI}, UI_{ACT}, and UI_{THEN} in its off-state. In a 1^{st} case, a terminal may turn on a display unit, run an authentication operation concurrently therewith, and then advance to a certain mode of operation depending on an outcome of the user authentication. Therefore, a terminal may switch to, e.g., a lock mode or an unlock mode depending on whether a user fails or passes the authenticating. A terminal may switch modes concurrently with such turning-on operation or user authenticating. In general, this case corresponds to the series switching, although this case may also apply to the selective switching.

In a 2^{nd} case, a terminal may turn on a display unit, run an authentication operation concurrently therewith, and advance to a certain mode of operation depending not only upon an outcome of the user authenticating, but also upon UI_{SWI}. Accordingly, when a user passes the authenticating, a terminal may switch to one of different modes based on UI_{SWI}. In general, this case may correspond to the selective switching.

In a 3^{rd} case, a terminal may turn on a display unit, and then run such authenticating or mode switching, after a certain period of time. Accordingly, in this case, the turning-on operation is sequentially followed by the user authenticating or mode switching. In addition, when a mode which is intended by a user is a restricted mode or a more restricted mode, a terminal may forgo the user authenticating. It is noted, however, that a terminal may preferably run such turning-on operation, an authentication operation, and a mode-switching operation, for a terminal already acquires all three sub-inputs for running such operations.

In the 4^{th} example of this exemplary embodiment, a terminal may operate according to the above examples when a user provides the first user input in a powered-off state. A few differences of this example from such three examples are that (1) an input unit which receives the first user input may be a power-on input unit, (2) the power-on input unit may include at least one additional sensor for acquiring UI_{SWI} or UI_{THEN}, and (3) the first user input may not necessarily include UI_{ACT}, for a powering-on operation may generally lead to launching a lock system in a lock mode.

In the 5^{th} example of this exemplary embodiment, a terminal may receive the first user input including UI_{SWI}, UI_{ACT}, and UI_{THEN} in its on-state (i.e., a powered-on state as well). Upon receiving the first user input applied to a mode-switching input unit, a terminal acquires UI_{SWI} therefrom, and then switches from a current mode to a new mode designated by UI_{SWI} in one of such mode-switching timings. When a terminal switches from a current mode with less access authority to a new mode with more access authority, a terminal may run an additional authentication operation as described above.

Further details in operating the data processing terminal of this 2^{nd} Configuration using various user inputs are similar or identical to those of operating the terminal of the 1^{st} Configuration, and may also be similar or identical to those of operating other terminals of other exemplary aspects throughout this disclosure, subject to certain modifications, additions or omissions each of which become apparent based on detailed context.

### 5-5. Lock CPU Unit

In the 1^{st} exemplary embodiment of the second exemplary aspect, a lock system (60) may include at least one lock CPU unit (70) details of which have been described above. In general, a lock CPU unit (70) of a lock system (60) may be deemed as a unit [1] similar or identical to a main CPU unit (30) of a main system (10), [2] similar to a main CPU unit (30) but with limited functionality, or [3] as a unit which may run at least one operation which may not be run by a main CPU unit (30).

Further details of the 1^{st} embodiment of “5-5. Lock CPU Unit” are identical to the following portions of the '861 application such as, e.g., the text from [1020] through [1024] on page 95, where these portions are incorporated herein in their entirety by reference.

In the 2^{nd} exemplary embodiment of the second exemplary aspect, a terminal may dispose various lock units of a lock system (60) in many configurations. In the 1^{st} example of this exemplary embodiment, a terminal may include an entire lock system (60) and all lock units thereof such that an entire portion of a main system (10) as well as an entire portion of a lock system (60) coexist inside a terminal. In this example, a main system (10) may be physically or operationally isolated from a lock system (60) as described above or below.

In the 2^{nd} example of this exemplary embodiment, at least one unit of a lock system (60) may be implemented into a portable device or an add-on device which may releasably couple with a terminal. As a result, at least one of a lock CPU unit (70), an optional lock O/S, an optional lock memory unit (80), or a lock viewer (71) may reside in the portable or add-on device (to be abbreviated as an “add-on device” hereinafter).

In the 3^{rd} example of this exemplary embodiment, an entire lock system may be incorporated into an external add-on device in such a way that an add-on device itself may be viewed as a separate and self-sufficient lock system (60) which can run various lock operations in a lock mode, store desirable results therein, or run such erasure (or semi-erasure) by itself.

Further details of the 2^{nd} embodiment of “5-5. Lock CPU Unit” are identical to the following portions of the '861 application such as, e.g., the text from [1027] on page 95 through [1045] on page 97, where these portions are incorporated herein in their entirety by reference.

In all exemplary embodiments of this Section, a terminal may designate only one of a main CPU unit (30) and a lock CPU unit (70) to run such erasure (or semi-erasure) either by wire or wirelessly. In particular, running such erasure (or semi-erasure) may be recommended when a CPU unit disposed in a terminal is to run such operations onto a unit which is incorporated into such external devices. In addition, such devices may include a rechargeable battery or at least a capacitor which may supply electrical power to run such operation. Various features of this paragraph may be applicable whenever at least one unit of a lock system may be incorporated into such external devices.

In all exemplary embodiments of this Section, a terminal may run such erasure (or semi-erasure), while erasing not only such (portions of) results but also those software applications implemented into a lock system, whether such applications may be implemented into [1] a portion existing inside a terminal or [2] another portion of an external device such as an add-on device, a portable device, or a wearable device.

When a terminal erases such applications or even at least a portion of a lock O/S by, e.g., through a “formatting” or an “initialization” of at least a portion of a lock system (60), a terminal may have to reload such applications or a lock O/S before a user launches a lock system (60) to run lock operations. To this end, a terminal may incorporate a main CPU unit (30) or a main O/S with functionalities capable of formatting or initializing [1] at least a portion of a lock memory unit (80) or [2] at least one temporary memory sector of a lock system (60) or a main system (10). In addition, a terminal may allow a main CPU unit (30) or a main O/S (34) to reload [1] such software applications, [2] various drivers of such applications, or [3] a lock O/S, into a lock system.

Other configurational or operational features of the lock and main CPU units of this 2^{nd} Configuration are similar or identical to those of the lock and main CPU units of the 1^{st} Configuration. Other configurational or operational features of such lock and main CPU units of this 2^{nd} Configuration are also similar or identical to those of the lock and main CPU units of other aspects of this disclosure, subject to certain modifications, additions or omissions each of which may become apparent based on detailed context.

### 5-6. Lock Memory Unit

In another exemplary embodiment of the second exemplary aspect, a terminal may include at least one lock memory unit (80) which mainly serves to temporarily, conditionally or permanently store such “results” related to or resulting from running various lock operations in a lock mode. A lock memory unit (80) may be generally called by a lock CPU unit (70) and store such data or “results” thereinto, to send data or “results” to a lock CPU unit, or the like.

A lock memory unit (80) may be fabricated similar to other prior art memory devices and may be incorporated into a terminal like other prior art memory devices. As described above, however, a lock memory unit (80) may be provided as an add-on device which may be completely designated as a lock memory unit (80). Alternatively, an add-on device may include a lock memory unit (80), and also optionally include a lock CPU unit (70), a lock viewer (71), or the like. Alternatively, a portion of a lock memory unit (80) may reside in a terminal, while the remaining portions of a lock memory unit (80) may be included in the add-on device. A lock memory unit (80) may also be fabricated as a portable or wearable device, examples of which have been provided above.

As explained above, a main system (10) or its main CPU unit (30) may call a lock memory unit (80) for various purposes. For example, a main system (10) may call a lock memory unit (80) to store [1] 1^{st} results originating from a main system (10) or [2] 2^{nd} results originating from a lock system (60), where the 1^{st} results are obtained by running various unlock operations in an unlock mode, while the 2^{nd} results are obtained by running such lock operations in a lock mode.

As explained above, when a main system (10) physically or operationally couples with a lock memory unit (80), a main system (10) may take precautionary steps so that a lock system (60) may not transmit any results which are contaminated with malicious viruses or codes to a main memory unit (40) or other units of a main system (10). When a main system (10) requests a lock memory unit (80) to store certain results, a lock memory unit (80) may store such results permanently, for a preset period of time, or for another period pre-selected by a main system or a user.

Conversely, a lock system (60) may call a main memory unit (40) for various purposes as well. In one example, a lock memory unit (80) may directly or indirectly (e.g., via a main CPU unit or a main O/S) call a main memory unit (40) to [1] store results originating from a lock system (60) or obtained by running lock operations in a lock mode, or [2] execute some apps which reside in a main system (10) using data stored in or obtained by a lock system (60).

When a lock system (60) physically or operationally couples to a main memory unit (40) or another unit of a main system (10), a terminal may have to ensure that [1] a lock system (60) may not transmit “result” contaminated with viruses to a main memory unit (40) or other units of a main system (10), or [2] a lock system (60) may not modify a configuration or operation of a main system (10), may not delete existing data or app from a main system (10), may not add new data or application to a main system (10).

It is noted that various terminals of this disclosure may allow a user to run as many operations as he may want with a lock system (60) in a lock mode, without having to worry about security, integrity, and privacy of a main system. To this end, a terminal may run such erasure (or semi-erasure) in one of such erasure timings, thereby cleaning up any trail of malicious viruses or hazardous codes, thereby preventing such viruses or codes from migrating into such main units and from degrading or contaminating a main system (10) of a terminal.

However, some malicious codes or viruses may be more persistent than others, and may have successfully migrated into a main system (10), even after such erasure (or such semi-erasure). To remove such viruses or codes, a terminal may “format” or “initialize” an entire portion of a lock memory unit (80) or even a lock system (60) as a whole in various timings.

Therefore, a main (or lock) system (10), (60) may even initialize at least a portion of a lock CPU unit (70) or lock apps from time to time, e.g., [1] after running such erasure (or semi-erasure) for more than a certain number of times, [2] upon finding certain malicious viruses or codes, [3] upon detecting malfunctions of at least one lock unit, [4] upon detecting certain contamination of a lock memory unit or any unit of a main system, or the like.

Other configurational or operational features of such lock and main memory units of this 2^{nd} Configuration may be similar or identical to those of the lock and main memory units of the 1^{st} Configuration. In addition, further configurational or operational features of such lock and main memory units of this 2^{nd} Configuration may also be similar or identical to those of the lock and main memory units of other remaining aspects of this disclosure, subject to certain modifications, additions or omissions each of which may become apparent based on detailed context.

### 5-7. Lock Output Unit

In another exemplary embodiment of this second exemplary aspect of the disclosure, a terminal may optionally include a lock output unit capable of outputting results which may reside in a lock or main system (60), (10) or which may be obtained by running various lock operations in a lock mode. A lock output unit may output such results in various ways such as, e.g., [1] outputting visual signals (e.g., displaying images or playing video clips) on a main or lock display unit), [2] outputting audible signals (e.g., playing sounds or beeps with a main or lock speaker), [3] outputting tactile signals (e.g., generating vibrations with a main or lock vibrator), [4] causing or actuating movements of at least one portion of a terminal, or the like.

FIG. 2B shows a block diagram of another exemplary terminal of the 2^{nd} Configuration of this disclosure. More particularly, FIG. 2B exemplifies a terminal including a single main system (10) and a single lock system (60), where a main system (10) is identical to that of FIG. 2A, while a lock system (60) includes at least one lock CPU unit (70), at least one lock output unit (90), and other optional lock units such as a lock memory unit (80).

It is noted that a lock output unit (90) is typically an option, for incorporating an additional display unit, speaker, or vibrator (or actuator) into a terminal may increase not only a volume and a weight of a terminal but also its cost of manufacture. Thus, a terminal may rather recruit a main display unit, a main speaker, a main vibrator or a main actuator of a main system (10) as a lock output unit (90). That is, providing a redundant configuration such as incorporating an additional lock output unit (90) which is separate from a main output unit (50) may generally be a matter of choice of one of ordinary skill in the relevant art.

Alternatively, a user may include a lock output unit (90) into an add-on device in such a way that a user may [1] view images, [2] listen to sounds or music, or [3] feel vibration (or actuation) with an add-on device. When a lock output unit (90) is incorporated into a prior art wearable device, a terminal may also recruit any output unit of such a device as a lock output unit as well.

When desirable, a terminal may incorporate an additional output unit therein and recruit such as a lock output unit. For example, a terminal may include an additional display unit, speaker, vibrator or actuator and use such as a lock output unit. In this case, a terminal may determine whether or not a lock output unit may access a main system, e.g., its main memory unit, output unit, or the like. In this aspect, various notice units described above may be [1] viewed as or [2] recruited as a lock output unit as well.

Like a main output unit is typically driven by a main CPU unit (30), a lock output unit may be driven by a lock CPU unit (70). When a terminal does not include a separate lock output unit but may rather recruit at least a portion of a main output unit as a lock output portion, the lock output portion may be driven by a lock CPU unit (70) or a main CPU unit (30), by both of such CPU units (70), (30), or the like. In this case, a terminal may have to deliver data to be displayed from a lock system (60) to a lock output portion of a main system (10), while ensuring such data to not adversely affect, contaminate or spoil any unit of a main system (10).

Other configurational or operational features of such lock and main output units of this 2^{nd} Configuration are similar or identical to those of the lock and main output units of the 1^{st} Configuration. Other configurational or operational features of such lock and main output units of this 2^{nd} Configuration may also be similar or identical to those of the lock and main output units of other aspects of this disclosure, subject to certain modifications, additions or omissions each of which may become apparent based on detailed context.

### 5-8. Erasure or Semi-Erasure

In another exemplary embodiment of this second exemplary aspect of the disclosure, a terminal may run an erase (or semi-erase) operation in one of various erasure timings, for removing “results” obtained by running lock operations in a lock mode. A terminal may assign [1] a main CPU unit (30) to run such erasure (or semi-erasure), [2] a lock CPU unit (70) to run such, or [3] both of the lock and main CPU units (70), (30) to run such erasure (or semi-erasure), either concurrently or sequentially.

When a lock system (60) does not include a lock memory unit, a terminal may grant a lock system (60) with only limited functionality such as, e.g., displaying texts or images, playing video clips or audible sounds, or searching a web. Because this lock system (60) may not be able to store any results therein, a terminal may not have to run any separate erasure (or semi-erasure), although a terminal may still have to run such erasure or semi-erasure to remove any potential remnant data from a lock system (60).

When a lock system (60) includes a lock memory unit (80), a main system (10) or a lock system (60) needs to run such erasure (or semi-erasure), for some results may inevitably end up residing in [1] a lock memory unit (80), [2] another unit of a lock system (60), or [3] another memory sector of a lock system (60). Even after such results may be deleted, there still remain data remanence problems. Thus, a terminal may run the erasure (or semi-erasure) whenever there remain risks of such results from adversely affecting a main system (10) of a terminal. Other details of such erase (or semi-erase) operations may be similar or identical to those of the 1^{st} Configuration, or to those of such erasure (or semi-erasure) discussed in other aspects of this disclosure and, therefore, are omitted here.

By running a semi-erase operation, a main (or lock) system (10), (60) may erase such to-be-erased results, while storing the remaining to-be-saved results [1] only into a lock memory unit (80), [2] only in a main memory unit (40), or [3] in both of such memory units (80), (40). In this case, a user may manually select which results are to be stored either permanently, only temporarily or conditionally. As described, a terminal may adaptively determine which results are to be erased or saved.

When a terminal stores such results only in a lock memory unit (80), a terminal may prevent a user or a lock system (60) from storing the results into a main memory unit (40). However, a terminal may rather allow a main CPU unit (30) to retrieve data from a lock memory unit (80), or to store such retrieved data from a lock memory unit (80) into a main memory unit (40). When a lock system (60) is to store such results into a main memory unit (40), a lock system (60) may obtain an authorization from a terminal or by a user before such storing.

As described above, a terminal may run such erasure (or semi-erasure) and may remove potentially hazardous viruses from such results obtained by running lock operations in a lock mode. In addition, even if a lock system (60) may not detect any danger from such results, a user may still have another reason to run such erasure (or semi-erasure), particularly when a user does not want to disclose [1] which websites a user has visited, [2] which lock operations he has run in a lock mode, or [3] which results he has obtained by running such lock operations in a lock mode. Thus, a user may run such erasure or semi-erasure not only for enhancing security and improving integrity, but also for maintaining privacy in driving a terminal.

In another exemplary embodiment of this second exemplary aspect of the disclosure, a terminal may provide a user with a status of such erasure (or semi-erasure), and may receive instructions or a feedback from a user as well. To this end, a terminal may monitor various steps related to such erase (or semi-erase) operation, and communicate with a user about such monitored steps.

In one example of this exemplary embodiment, a terminal may inform a user about running such erasure (or semi-erasure) by, e.g., [1] informing a user when such erasure (or semi-erasure) starts, [2] informing a user when such erasure (or semi-erasure) finishes, [3] displaying outcome obtained by running an erase (or semi-erase) operation, or the like. With such information, a user can make sure that all (or some selected) data or results obtained by running various lock operations in a restricted mode has been erased. As described above, a terminal may allow a user to put a mark onto those to-be-erased results or onto those to-be-saved results.

In the 1^{st} example of this exemplary embodiment, a terminal may monitor presence of the malicious viruses or detect such viruses from such results. In a 1^{st} case, upon detecting any suspicious data or files, a terminal may automatically run such erasure (or semi-erasure), while sending an optional warning signal to a user. It is noted that this arrangement may be similar to a “real-rime erasure (or semi-erasure)” as defined above.

It is appreciated that a real-time erasure may disrupt continuity of operation and make it inconvenient for a user to run lock operations in a lock mode. However, a real-time erasure (or semi-erasure) may serve to inform a user that a certain lock operation has invited suspicious data or results into a lock system (60) and that such an operation (or a website which a user accesses) has to be stopped or otherwise rectified.

In a 2^{nd} case when a terminal detects any suspicious data or files, a terminal may wait for a user response. Upon receiving a consenting user input, a terminal may run such erasure (or semi-erasure). When a user does not consent to run such erasure (or semi-erasure), however, a terminal may resume to operate in a lock mode, and thereafter run such erasure or semi-erasure. It is noted that this arrangement may be similar to an “interim erasure (or semi-erasure)” or an “ex post erasure (or semi-erasure)” as defined above.

It is noted that an interim or ex post erasure may not disrupt continuity and make it comfortable for a user to continue to run lock operations in a lock mode. However, when suspicious data or files begin to deteriorate or contaminate a lock memory unit (80) or another lock unit, a main system (60) or a terminal may be put into danger. Accordingly, a terminal may run such interim or ex post erasure along with a real-time erasure, thereby mitigating risks involved with only running such interim or ex post erasure.

In the 2^{nd} example of this exemplary embodiment, a terminal may monitor such results, and reformat or initialize a lock memory unit (80) or even an entire lock system (60), upon detecting serious (or potential) breaches in security or integrity of a main system (10) or privacy of data stored in a main system (10). A terminal may then reformat or initialize a lock memory unit (80) or a lock system (60) in various arrangements.

In a 1^{st} case, upon detecting severe (or potential) breaches, a terminal may automatically start to reformat or initialize a lock memory unit (80) or an entire lock system (60), with or without necessarily sending a warning signal to a user. This arrangement may be referred to as a “real-rime initialization” which may be similar to a “real-rime erasure (or semi-erasure)” as defined above.

In a 2^{nd} case, upon detecting such breaches, a terminal may send a warning signal as well as another signal of recommending reformatting or initialization, and wait for a user response. Upon receiving a consenting user input, a terminal may reformat or initialize a lock memory unit (80) or other units of a lock system (60). When a user does not consent to such formatting or initialization, a terminal may resume to operate in a lock mode, and thereafter runs a reformatting or initialization operation. In this respect, this arrangement may be referred to as an “interim initialization” or “ex post initialization.”

Other operational features of the erasure (or semi-erasure) of this 2^{nd} Configuration are similar or identical to those of the erasure (or semi-erasure) of the 1^{st} Configuration. Other configurational or operational features of the erasure (or semi-erasure) of this 2^{nd} Configuration may also be similar or identical to those of the erasure (or semi-erasure) of other aspects of this disclosure, subject to certain modifications, additions or omissions each of which may become apparent based on detailed context.

### 5-9. 2^{nd} Configuration—Variations or Modifications

Various terminals of this 2^{nd} Configuration may be configured to operate according to other arrangements or sequences. Such variations or modifications of such terminals of this 2^{nd} Configuration are generally similar or identical to those of such terminals of the 1^{st} Configuration and, therefore, omitted.

Although the foregoing embodiments and examples of this 2^{nd} Configuration and this second exemplary aspect typically relate to various data processing terminals which may operate in a hierarchy defining a single lock mode and a single unlock mode, all foregoing embodiments and examples may equally apply to other terminals operating in another hierarchy defining any multiple modes each of which is granted by a terminal identical, similar, comparable or different access authority.

Thus, the foregoing embodiments and examples may equally apply to a terminal which may operate while switching between two modes, three modes, or more than three modes, where at least one 1^{st} mode is an unlock mode of the foregoing illustration, while at least one 2^{nd} mode is a lock mode of the foregoing illustration.

Configurational or operational variations (or modifications) of such terminals described in various embodiments or examples of this second exemplary aspect (i.e., the 2^{nd} Configuration) may be interchangeable with other various embodiments or examples of other exemplary aspects of this disclosure. Accordingly, certain features of one embodiment or example of this second exemplary aspect may be applied to another embodiment or example of the same aspect or of a different aspect.

Moreover, other configurational or operational features, their variations or modifications of the terminals of this second exemplary aspect [1] may apply to, [2] may be incorporated into, [3] may replace, [4] may be replaced by, or [5] may be combined with corresponding features of the same or different [1] aspect, [2] embodiment, or [3] example of this disclosure, as long as such application, incorporation, replacement, or combination does not contradict each other.

### 6. 3^{rd} Configuration—Embedded Lock System

In the third exemplary aspect of this disclosure which corresponds to the 3^{rd} Configuration of this disclosure, a terminal may include at least one main system (with at least one main unit) and at least one lock system (with at least one lock unit). Similar to that of Section 4 or Section 5, a main system of this 3^{rd} Configuration operates in an unlock mode, and may include at least one [1] main CPU unit, [2] main input unit, [3] main output unit, [4] main memory unit, or [5] other optional main units. A lock system of this 3^{rd} Configuration operates in a lock mode, and may include at least one [1] lock CPU unit, [2] lock memory unit, [3] other optional lock units such as, e.g., a lock viewer, a lock input unit, a lock output unit, or the like.

Contrary to the lock systems of Section 4 and Section 5, however, a lock system of this 3^{rd} Configuration may not be completely isolated from a main system. Rather, a lock system may be physically coupled or integrated into a main system in such a way that a certain unit of a main system may constitute an integrated unit with a corresponding unit of a lock system. As a result, a terminal of this 3^{rd} Configuration may also be regarded that an integrated unit (or a unitary article) of a terminal may include therein at least one main unit and an entire (or a selected) portion of a lock unit, where a main unit and a lock unit may be disposed adjacent to each other. As used herein, a main system and a lock system which has the above physical configuration are collectively referred to as an “embedded system” hereinafter. Because a terminal may typically provide a lock system with limited functionality, a lock system is to be regarded as being “embedded” into a main system.

Due to such physical coupling between a certain main unit and a corresponding lock unit, a terminal may be fabricated in a more compact shape or size. Although some units of a main system and a lock system may form an integrated unit, a terminal still employs various means to ensure such operational isolation between a main system and a lock system, thereby maintaining the enhanced security, improved integrity, and heightened privacy. In addition, a manufacturing process for such a terminal may be optimized, e.g., by dividing [1] a single microchip into two portions, while using a 1^{st} portion as a main CPU unit and a 2^{nd} portion as a lock CPU unit, [2] another chip into two portions, while using a 1^{st} portion as a main memory unit and a 2^{nd} portion as a lock memory unit, or the like.

Details of such lock and main systems of various terminals of this 3^{rd} Configuration are provided below, while omitting those features identical to those of the 1^{st} or 2^{nd} Configuration.

### 6-1. 3^{rd} Configuration—Main System

In the 1^{st} exemplary embodiment of a third exemplary aspect (i.e., the 3^{rd} Configuration) of this disclosure, a terminal includes at least one main system which in turn includes various main units each of which may include therein at least one (main) hardware or software element. Such a main software element may be [1] embedded into a main hardware element or [2] provided as separate codes of computer programs such as, e.g., a part of a main O/S or a (software) application.

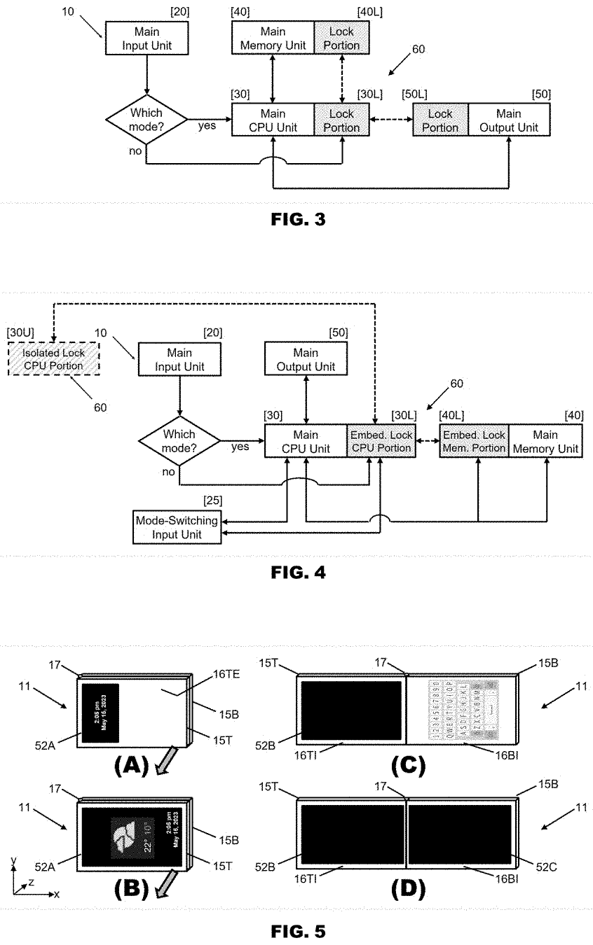

FIG. 3 is a block diagram of an exemplary data processing terminal of this third exemplary aspect which may be fabricated in an embedded configuration. More particularly, FIG. 3 describes a main system in a context of multiple abstract layers, where an exemplary main system (10) may include at least one [1] main CPU unit (30), [2] main input unit (20), [3] main memory unit (40), [4] main output unit (50), [5] main (software) application (35), [6] main operating system (i.e., or an O/S) (34) which may include at least one main kernel (optional), and other optional units (51), or the like.

A terminal also includes a main input unit (20) capable of receiving a user input which in turn includes various (user) sub-inputs. It is appreciated that a main input unit (20) is a single input unit of a terminal. It then follows that a main input unit (20) of a terminal of this 3^{rd} Configuration may also serve as a mode-switching input unit and acquire UI_{SWI} from a user input applied to a main input unit (20).

A terminal of this 3^{rd} Configuration includes a lock system (60) which may in turn include at least one [1] lock CPU unit (or portion) (30L), [2] lock memory unit (or portion) (40L), [3] lock output unit (50), or [4] other optional lock units (not included in the figure). Similar to that of the 2^{nd} Configuration, a lock system (60) may include a lock CPU unit (30L) and, accordingly, may not need to recruit a main CPU unit (30) or a main O/S (34) to run lock operations in a lock mode.

Other configurational or operational details of a main system (10) of a terminal of this 3^{rd} Configuration may be similar or identical to those of the main system of the 2^{nd} Configuration, or to those of other main systems of other terminals of other exemplary aspects of this disclosure, subject to certain modifications, additions or omissions each of which will become apparent based on detailed contexts.

### 6-2. 3^{rd} Configuration—Lock System

In the 2^{nd} exemplary embodiment of this third exemplary aspect of the disclosure and as depicted in FIG. 3, a terminal includes a lock system (60) which is embedded into a main system (10). More particularly, like units of a lock system (60) may be respectively embedded into like units of a main system (10) in such a way that a terminal may be viewed to include at least one of [1] an “integrated CPU unit” which is an assembly of a main CPU unit (30) and a lock CPU unit (30L), [2] an “integrated memory unit” which is another assembly of a main memory unit (40) and a lock memory unit (40L), [3] an “integrated output unit” which is an assembly of a main output unit (50) and a lock output unit (50L), or the like.

As manifest in the figure, a main input unit (20) is the single input unit of a terminal of this 3^{rd} Configuration and, therefore, a main input unit (20) may have to serve as a mode-switching input unit capable of acquiring UI_{SWI} from a user input. To this end, the main input unit (20) may also have to include at least one sensor for acquiring UI_{SWI}. In this context, the main input unit (20) may be viewed as an integrated input unit which is an assembly of a main input unit and a mode-switching input unit.

It is appreciated that various lock units of a lock system (60) of this 3^{rd} Configuration may be viewed as only a portion of the like integrated units and, therefore, that each unit of a lock system (60) may be referred to as a relevant portion of each integrated unit. Accordingly, such lock units of this 3^{rd} Configuration are to be referred to as a “lock CPU portion” (30L), a “lock memory portion” (40L), and a “lock output portion” (50L) hereinafter.

### 6-2-1. Total Embedding

In the 1^{st} exemplary configuration of this 2^{nd} exemplary embodiment of this third exemplary aspect, an entire portion of a lock system (60) is embedded (or integrated) into a main system (10), which may be referred to as a “total embedding.”

For example, a terminal in FIG. 3 is an embodiment of this configuration, where an integrated CPU unit includes at least one main CPU unit (30) and at least one lock CPU portion (30L). An integrated memory unit includes at least one main memory unit (40) and at least one lock memory portion (40L). Similarly, an integrated output unit includes at least one main output unit (50) and at least one lock output portion (50L). Therefore, even though each unit may be viewed as an integrated, assembled, or unitary unit, a 1^{st} portion of each integrated unit may run operations in an unlock mode, whereas a 2^{nd} portion may run operations in a lock mode. In this context, such lock portions of a lock system (60) may be embedded into a main system (10) in a distributed arrangement.

Further details of “6-2-1. Total Embedding” are identical to the following portions of the '861 application such as, e.g., the text from [1102] on page 101 through [1110] on page 102, where these portions are to be incorporated herein in their entirety by reference.

### 6-2-2. Partial Embedding

In the 2^{nd} exemplary configuration of this 2^{nd} exemplary embodiment of this third exemplary aspect, at least one but not all units of a lock system (60) may be embedded (or integrated) into a main system (10), which may be referred to as a “partial embedding.” For example, a lock system (60) may include two different lock CPU portions such as a lock CPU unit and a lock CPU portion. In addition, a lock CPU unit is not embedded into a main CPU unit and, therefore, physically isolated from a main CPU unit. However, a lock CPU portion is integrated into a main CPU unit and forms an integrated article with a main CPU unit.

In other words, a lock system (60) includes a lock CPU unit which is physically isolated from a main CPU unit and which may not be disposed inside, on, under, beside or proximate to a main CPU unit. As a result, a lock CPU unit may be physically isolated from a main CPU unit and, therefore, may not form an integrated article. However, a lock CPU portion forms an integrated article with a main CPU unit as described above.

Further details of “6-2-2. Partial Embedding” are identical to the following portions of the '861 application such as, e.g., the text from [1114] on page 102 through [1123] on page 103, where these portions are to be incorporated herein in their entirety by reference.

### 6-3. 3^{rd} Configuration—Lock Units vs. Main Units

In the 3^{rd} exemplary embodiment of this third exemplary aspect of this disclosure, the CPU units and memory units may be fabricated in various configurations in a total embedding configuration such as, e.g., an integrated configuration where [1] a lock CPU portion (30L) may form an integrated CPU unit with a main CPU unit, [2] a lock memory portion (40L) may form an integrated memory unit with a main memory unit (40), or the like. But in a terminal with a partial embedding configuration, a lock CPU (or memory) portion may be provided as an article which may be physically or operationally isolated from an integrated CPU (or memory) unit, where a lock CPU (or memory) portion is embedded into an integrated CPU (or memory) unit.

Further details of “6-3. 3^{rd} Configuration—Lock Units vs. Main Units” are identical to the following portions of the ′861 application such as, e.g., the text from [1126] on page 103 through [1140] on page 105, where these portions are to be incorporated herein in their entirety by reference.

### 6-4. 3^{rd} Configuration—Operations

In the 4^{th} exemplary embodiment of this third exemplary aspect of the disclosure, a terminal may operate in various ways while maintaining improved integrity and security as well as preserving privacy of a user. When a display unit is turned off and when a terminal remains in its off-state, a terminal may receive a 1^{st} user input and decide whether to advance to a lock mode or an unlock mode, based upon various criteria such as, e.g., UI_{SWI}, along with at least one of UI_{ACT} and UI_{THEN}. A terminal may [1] turn on its display unit in a lock mode in response thereto, [2] stay in an off-state when a user fails user authenticating, [3] stay in an off-state when a 1^{st} user input or its (user) sub-inputs do not match pre-stored values or information, or the like.

When a display unit is turned on and when a terminal operates in a lock mode upon receiving a 1^{st} user input, a terminal may decide whether to stay in a current lock mode or to switch to an un unlock mode depending on various criteria as described above. As a result, a terminal may [1] stay in a lock mode, [2] switch to a different lock mode, or [3] launch a main system while switching to an unlock mode. When any of UI_{SWI}, UI_{ACT}, or UI_{THEN} does not match a pre-stored value or information, a terminal may [1] stay in a current mode, [2] request a user to provide a new user input (along with other sub-inputs), or [3] turn its display unit off.

When a display unit is turned on and a terminal operates in an unlock mode upon receiving a 1^{st} user input, a terminal may [1] stay in the current unlock mode when UI_{SWI} matches the current mode, [2] stay in the current mode or switch to a new unlock mode when UI_{SWI} is different from that matched to the current mode, [3] switch to a lock mode when UI_{SWI} is designated to a lock mode, [4] switch to a lock mode when UI_{SWI} does not match a pre-stored value, [5] turn off its display unit and switch to an inactive state when the 1^{st} user input or its (user) sub-inputs do not match the pre-stored values or information, or the like.

As described above, a terminal may switch its modes in various mode-switching timings as well. For example, a terminal may switch to a new mode upon or after [1] receiving a 1^{st} or 2^{nd} user input, [2] acquiring UI_{SWI} which is actively provided by a user, [3] a terminal confirms that a user passes a user authentication operation, or [4] a terminal confirms that a user is granted with proper access authorities to switch to (or advance to) a new mode. Further examples of such timings are enumerated as the mode-switching timings in Section 1-21.

Other features of various operations of the terminal of this 3^{rd} Configuration may be identical or similar to those features of various operations of other terminals of [1] the 1^{st} or 2^{nd} Configuration, [2] other exemplary aspects disclosed herein, or the like, and further details are omitted herein.

### 6-5. 3^{rd} Configuration—Erasure, Semi-Erasure, and Storing

In the 5^{th} exemplary embodiment of this third exemplary aspect of the disclosure, a terminal may maintain the improved integrity and security of its main system while preserving heightened privacy of a user as well, by running such erasure (or semi-erasure) in one of various erasure timings. When a terminal runs such semi-erasure, a terminal (or a user) may select to-be-erased results and to-be-stored results, where such to-be-stored results may be stored temporarily, permanently or conditionally in a lock (or main) memory unit or in any other memory sector based on various criteria as described above.

A terminal may run such erasure with either or both of a main CPU unit and a lock CPU portion, where it is not material which CPU portion or unit a terminal selects to run such erasure, where one exception may be when a terminal recruits a main CPU unit (or a lock CPU portion) to run such erasure when a lock CPU portion (or a main CPU unit) may have been damaged. A terminal may run such erasure with either of a main CPU unit or a lock CPU portion on results which are stored or reside in a lock memory unit.

A terminal may also run such semi-erasure with either or both of a main CPU unit and a lock CPU portion. It is generally not material which CPU portion or unit a terminal recruits to run such semi-erasure. A terminal may run such semi-erasure with either of a main CPU unit or a lock CPU portion on results which are stored or reside in a lock memory unit.

In addition, a terminal may also run such semi-erasure while accommodating the circumstances. For example, a terminal may select such to-be-stored results based on [1] a duration in which a user has operated a terminal in a lock mode, [2] a number of websites which a user has accessed in a lock mode, [3] an amount (or a size) of results which a user has generated by running lock operations in a lock mode, [4] a number (or an amount) of contents which a user has generated and which also coincides with preset user preferences, or [5] a number (or an amount) of personal or financial data which a user has processed in a lock mode. Thereafter, the terminal may store such to-be-stored results into a preset memory unit or sector.

Other details of “6-5. 3^{rd} Configuration—Erasure, Semi-Erasure, and Storing” are identical to the following portions of the ′861 application such as, e.g., the text from [1152] on page 106 through [1160] on page 107, where these portions are to be incorporated herein in their entirety by reference.

It is appreciated that a terminal of this 3^{rd} Configuration includes a lock memory portion which is embedded into a main memory unit and that a lock memory portion may maintain a physical contact with a main memory unit. However, a terminal may still maintain operational isolation between a lock memory portion and a main memory unit for maintaining improved integrity, enhanced security, and better protection of private data stored in a main system of a terminal.

Other configurational or operational features of such erasure, semi-erasure, and storing results with a lock (or main) system of various terminals of this 3^{rd} Configuration may be identical or similar to those with [1] the lock (or main) systems of various terminals of the 1^{st} or 2^{nd} Configuration, or [2] different lock (or main) systems of other terminals described in other exemplary aspects of this disclosure.

### 6-6. 3^{rd} Configuration—Variations or Modifications

Various terminals of this 3^{rd} Configuration may be configured and operate according to other arrangements or sequences. Such variations or modifications of such terminals of this 3^{rd} Configuration may be generally similar or identical to those of such terminals of the 1^{st} or 2^{nd} Configuration, or to those of various terminals of other exemplary aspects of this disclosure.

Although the foregoing embodiments or examples of this third exemplary aspect typically relate to various data processing terminals operating between a single lock mode and a single unlock mode, such embodiments or examples may equally apply to other terminals which operates in any multiple modes each of which may be granted with identical, similar, comparable or different access authority. Therefore, the foregoing embodiments or examples may equally apply to a terminal operating between two modes or among more than two modes, where one mode may be viewed as a lock mode, whereas another mode is an unlock mode.

Configurational or operational variations or modifications of the terminals described in various embodiments or examples of this third exemplary aspect (i.e., the 3^{rd} Configuration) may also be interchangeable with other various embodiments or examples of other exemplary aspects of this disclosure. Accordingly, certain features of a certain embodiment or example of this third exemplary aspect may be applied to another embodiment or example of the same aspect or of a different aspect of this disclosure.

Moreover, other configurational or operational features, their variations or modifications of the terminals of this third exemplary aspect [1] may apply to, [2] may be incorporated into, [3] may replace, [4] may be replaced by, or [5] may be combined with corresponding features of the same or different [1] aspect, [2] embodiment, or [3] example of this disclosure, as long as such application, incorporation, replacement, or combination does not contradict each other.

### 7. 4^{th} Configuration—Hybrid Lock System

In the fourth exemplary aspect of this disclosure, various data processing terminals may include at least one main system and at least one lock system. Each main system of such terminals may be similar or identical to that of various terminals of the 1^{st}, 2^{nd} or 3^{rd} Configuration in such a way that, e.g., a terminal may operate or launch such a main system in an unlock mode, while operating or launching another system such as, e.g., a lock system, in a restricted mode (e.g., a lock mode).

A lock system of this 4^{th} Configuration similarly includes at least one lock CPU unit as well as at least one lock memory unit, while optionally including at least one lock output unit or at least one lock input unit. However, a lock system is configured such that at least one of its lock units may be physically or operationally embedded into a main system, whereas at least one of the remaining lock units may be provided as a unit which may be physically or operationally separate from a corresponding unit of a main system.

Accordingly, except such an isolated unit(s), the rest of a lock system may be viewed to couple with or to be integrated into a main system, thereby constituting a unitary or integrated unit with a main system. In addition, this lock system may be viewed as a hybrid unit which includes at least one lock unit which may in turn consist of an isolated portion as well as an embedded portion. Following examples represent exemplary configurations and operations of a terminal with a hybrid configuration.

### 7-1. 4^{th} Configuration—Main System and Lock System

In the 1^{st} exemplary embodiment of a fourth exemplary aspect which corresponds to a 4^{th} Configuration of this disclosure, a terminal incorporates therein at least one main system and at least one lock system, where each system includes therein various units and where each unit includes at least one hardware or software element as described above. In addition, at least a 1^{st} portion of at least one lock unit of a lock system may be physically embedded into a main system, while another 2^{nd} portion thereof is physically and operationally isolated from a main system. In this respect, various terminals of this 4^{th} Configuration may be similar to that of a partially embedded terminal which is described in Section 6-2-2.

FIG. 4 represents a block diagram of an exemplary data processing terminal which is provided in a hybrid configuration according to the fourth exemplary aspect (i.e., a 4^{th} Configuration) of this disclosure. A main system (10) of a terminal is typically similar to that of the 3^{rd} Configuration (e.g., FIG. 3), and may include therein at least one [1] main CPU unit (30), [2] main memory unit (40), [3] main input unit (20), or [4] main output unit (50).

Other configurational or operational details of a main system (10) of this 4^{th} Configuration are similar or identical to those of the main system of the 1^{st}, 2^{nd}, or 3^{rd} Configuration, or to those of other main systems of other terminals as described in other exemplary aspects of this disclosure and, therefore, further details are omitted herein.

A lock system (60) includes a lock CPU portion (30L) and a lock memory portion (40L), where the former (30L) is integrated into a main CPU unit (30) and form an integrated CPU unit therewith, whereas the latter (40L) is integrated into a main memory unit (40) and form an integrated memory unit therewith.

Unlike a terminal of the 3^{rd} Configuration, a lock system (60) may include a mode-switching input unit (25), and an isolated lock CPU portion (30U), where a mode-switching input unit (25) may be completely and physically isolated from a main input unit (20), and where an isolated lock CPU portion (30U) may be completely and physically isolated from a main CPU unit (30).

As a result, a terminal may be regarded to incorporate [1] a main CPU unit (30), [2] an embedded lock CPU portion (30L) which may be embedded into a main CPU unit (30) and form an integrated CPU unit therewith, [3] an isolated lock CPU unit which may be physically and operationally isolated from a main CPU unit (30), and which may (or may not) be physically or operationally isolated from an embedded lock CPU portion (30L), [4] a main memory unit (40), [5] an embedded memory portion (40L) which may be embedded into a main memory unit (40) and form an integrated memory unit therewith, and [6] other optional main units.

Because at least one lock unit includes a 1^{st} portion which is embedded into a like main unit and a 2^{nd} portion which is physically (and optionally operationally) isolated from a main system, the terminal may be referred to as having a “hybrid configuration.” It is noted that a hybrid configuration may be regarded as combining a “total embedding” with a completely “isolated configuration” and that a hybrid configuration may be identical to the above “partially embedding.” For simplicity of illustration, a lock CPU unit of this 4^{th} Configuration is deemed to include an insulated (and non-embedded) portion (30U) as well as an embedded portion (30L).

In the 2^{nd} exemplary embodiment of a fourth exemplary aspect of this disclosure, a terminal with a redundant configuration may use each of an embedded lock CPU portion (30L) and an isolated lock CPU portion (30U) for various purposes, while allowing each of the lock CPU portions (30L), (30U) to [1] drive the same or different unit of a lock or main system, [2] drive the same or different hardware or software elements of a lock or main system, [3] run the same or different operations with such elements or units, or [4] perform the same or different functions by running such operations.

That is, a terminal may configure such embedded and isolated lock CPU portions (30L), (30U) to [1] drive the same hardware or software element, [2] drive at least one common element, while allowing each lock CPU portion (30L), (30U) to drive different elements, [3]drive different elements, without any common element, or the like. As a result, such a terminal may allow the embedded and isolated lock CPU portions (30L), (30U) to run the identical or different operation.

As described above, an embedded lock CPU portion (30L) may be embedded into a main CPU unit (30). By being physically coupled to a main CPU unit (30), an embedded lock CPU portion (30L) may be disposed close to a main CPU unit (30). But an isolated lock CPU portion (30U) may be disposed in various locations inside or outside a terminal. For example, an isolated lock CPU portion (30U) may be disposed adjacent to a main CPU unit (30), when a terminal needs an operational isolation from a main CPU unit (30) but may not stringently require a physical isolation therefrom.

In addition, such lock CPU portions (30L), (30U) may physically or operatively couple in various ways. In one case, a terminal may physically isolate such lock CPU portions (30L), (30U) from each other, e.g., by disposing such portions (30L), (30U) in different locations. In another case, such lock CPU portions (30L), (30U) may be physically located adjacent to each other or may form a unitary article, with or without a main CPU unit (30). A terminal may operationally isolate such lock CPU portions (30L), (30U) from each other, although a terminal may allow such portions (30L), (30U) to communicate with each other through a main CPU unit (30) or other units of a main (or lock) system (10), (60).

By adopting the redundant configurations, a terminal may provide further benefits to a manufacturer or a user. First of all, a terminal may use either of such lock CPU portions (30L), (30U) to drive the same hardware or software elements. Accordingly, a manufacturer may enjoy flexibility in designing the hardware configuration or an O/S design. In other words, by allocating certain tasks to either of such lock CPU portions (30L), (30U), a manufacturer may simplify its design and manufacturing processes. In addition, a user may enjoy flexibility as well in running various operations with either of such lock CPU portions (30L), (30U).

Secondly, when an isolated lock CPU portion (30U) is contaminated or malfunctioning due to malicious viruses, a terminal may take various remedial actions which may be safer than other actions taken by a terminal without a redundant configuration. In one case, a terminal may recruit an embedded lock CPU portion (30L) and use such a portion (30L) as a lock CPU unit.

Thus, a terminal may obviate the need to use a main CPU unit (30) to run lock operations in a lock mode, thereby minimizing the risks of introducing malicious viruses into a main system (10) while running lock operations in a lock mode. Alternatively, a terminal may use an isolated lock CPU portion (30U) as an embedded lock CPU portion (30U), when the latter is contaminated or malfunctioning.

Thirdly, a terminal may drive such embedded and isolated portions (30L), (30U) of a lock CPU unit concurrently or sequentially. More particularly, when a terminal drives such portions (30L), (30U), a lock system (60) may run multiple operations seamlessly in a lock mode, thereby providing further benefits to a user. Accordingly, even when a terminal receives a user input which in turn includes multiple (user) sub-inputs, a terminal may concurrently drive the lock CPU portions (30L), (30U) and run various operations seamlessly, without recruiting a main CPU unit (30). A terminal may provide a user with additional benefits by driving the lock CPU portions (30L), (30U) sequentially by, e.g., driving the lock CPU portions (30L), (30U) as an individual processor or an individual core of a multi-core processor, while generating threads of execution sequentially or concurrently.

Moreover, a terminal may rather dispose an isolated lock CPU portion (30U) into an external device such as an add-on device, a portable device, or a wearable device. Accordingly, the external device may independently serve as an external lock system which can [1] drive a lock viewer disposed in the external device or inside a terminal, [2] store results into a lock memory unit disposed in the external device or inside a terminal or which can retrieve results therefrom or [3] drive other lock units disposed in the external device or inside a terminal.

At least one of such embedded and isolated lock CPU portions (30L), (30U) may run erasure (or semi-erasure) to a lock memory unit (80) in one of such erasure timings, thereby maintaining the improved security of a main system and preserving the privacy of various data stored therein. Similarly, at least one of such embedded and isolated lock CPU portions (30L), (30U) may run semi-erasure onto a lock memory unit (80), while storing the to-be-saved results in one of such storing timings as described above.

When desirable, a main system (10) may run such erasure (or semi-erasure) onto a lock memory unit (80) or, conversely, at least one of such lock CPU portions (30L), (30U) may run such erasure (or semi-erasure) onto a main memory unit (40).

Except the above differences, various features of such main or lock units of a terminal of this 4^{th} Configuration may be similar or identical to those of such units of the terminals of the 1^{st}2^{nd} and 3^{rd} Configurations, or to those of various units of the terminals of other exemplary aspects of this disclosure. Therefore, further details of various main units are omitted.

### 7-2. 4^{th} Configuration—Variations or Modifications

Various terminals of this 4^{th} Configuration may be configured and operate according to other arrangements or sequences. Such variations or modifications of such terminals of this 4^{th} Configuration may generally be similar or identical to those of such terminals of the 1^{st}, 2^{nd} or 3^{rd} Configuration or to those of other terminals of other exemplary aspects of this disclosure and, therefore, details are omitted here.

Configurational or operational variations (or modifications) of such terminals described in various embodiments or examples of this fourth exemplary aspect (i.e., the 4^{th} Configuration) may also be interchangeable with other various embodiments or examples of other exemplary aspects of this disclosure. Accordingly, certain features of a certain embodiment or example of this fourth exemplary aspect may be applied to another embodiment or example of the same aspect or of a different aspect.

Moreover, other configurational or operational features, their variations or modifications of the terminals of this fourth exemplary aspect [1] may apply to, [2] may be incorporated into, [3] may replace, [4] may be replaced by, or [5] may be combined with corresponding features of the same or different [1] aspect, [2] embodiment, or [3] example of this disclosure, as long as such application, incorporation, replacement, or combination does not contradict each other.

### 8. 5^{th} Configuration—Adjustable Terminal

In the fifth exemplary aspect of this disclosure, various data processing terminals may be provided in various adjustable configurations such as a foldable configuration or a rollable configuration, where each terminal may include at least one main system and at least one lock system, along with at least one optional intermediate system. Each main (or lock) system of such terminals may be similar or identical to each main (or lock) system of various terminals of the 1^{st}, 2^{nd} 3^{rd} or 4^{th} Configuration such that, e.g., a terminal may operate (or launch) a main system, an intermediate system or a lock system, respectively, in an unlock mode, an intermediate mode or a lock mode.

As defined hereinabove, an “adjustable configuration” includes a “foldable configuration” and a “rollable configuration.” A user who operates a terminal with a foldable configuration (i.e., a foldable terminal) may unfold (or fold) at least one foldable portion of a terminal or its display unit within a preset range of angles about an unfolding (or folding) axis in an unfolding (or folding) direction. To the contrary, a user who operates a terminal with a rollable configuration (i.e., a rollable terminal) may unroll (or roll) a rollable portion of a display surface of a display unit up to a preset length, width or distance, along an unrolling (or rolling) axis in an unrolling (or rolling) direction.

It is noted throughout this Section 8 (or 5^{th} Configuration) that a “1^{st} user input” represents a user input which a terminal (e.g., its input unit) receives in a folded (or rolled) state and which includes a (user) sub-input for switching a terminal from a folded (or rolled) state to an unfolded (or unrolled) state, and that a “2^{nd} user input” represents a user input which a terminal (e.g., its input unit) receives in an unfolded (or unrolled) state and which includes a (user) sub-input for switching a terminal from an unfolded (or unrolled) state to a folded (or rolled) state.

Such a 1^{st} type (or 2^{nd} type) user input in the adjustable configuration may include, but not be limited to, [1] unfolding (or folding) a foldable portion of a terminal (by an angle greater than a preset value), [2] unrolling (or rolling) a rollable portion (or a slider) (over a length greater than a preset value), [3] moving or touching a hard (or soft) button which may initiate such unfolding (or folding) or unrolling (or rolling), or [4] static or dynamic features of such unfolding (or folding) or unrolling (or rolling).

### 8-1. 5^{th} Configuration—Foldable Configuration

In the 1^{st} exemplary embodiment of this fifth exemplary aspect of this disclosure, a data processing terminal may be provided in a foldable configuration by including therein, e.g., at least one foldable portion which may be unfolded and folded by a user. As a terminal switches between an unfolded state (i.e., one of open states) and a folded state (i.e., one of closed states), the foldable portion may be respectively unfolded and folded by a user along an unfolding or folding axis within a preset range of angles.

In a 1^{st} example of the 1^{st} exemplary embodiment, a data processing terminal may be provided in a foldable configuration in such a way that its aspect ratio decreases after the terminal switches from a folded state to an unfolded state.

FIG. 5 shows front views of various foldable terminals, where Panels (A) and (B) show the terminals in their folded state, while Panels (C) and (D) show the terminals in their unfolded state, where an aspect ratio may be defined as a ratio of a width or length of a terminal (which is measured in the y direction) to a height of such a terminal (which is measured in the x direction).

More particularly, a terminal (11) fabricated in the foldable configuration may include a top body (15T) and a bottom body (15B) which may be movably or rotatably coupled to each other by a prior art rotatable joint (17) such as, e.g., a hinge or other rotary joints. Thus, when a user may push or rotate one of the top and bottom bodies (15T), (15B) away from or toward each other, a terminal (11) may respectively switch to an unfolded state or to a folded state.

It is appreciated in FIG. 5 that the top body and bottom body (15T), (15B) are rotatably coupled to each other along their short vertices. Therefore, an aspect ratio of the terminal (11) may decrease as it switches from its folded state to its unfolded state.

A top body (15T) may include a top inner surface (16TI) and a top outer surface (16TE), where the top inner surface (16TI) is not exposed but the top outer surface (16TE) is exposed in a folded state (see Panels (A) and (B)), but the top inner surface (16TI) is also exposed in an unfolded state (see Panels (C) and (D)).

A bottom body (15B) may also include a bottom inner surface (16BI) and a bottom outer surface (not shown in the figure), where the bottom outer surface is exposed but the bottom inner surface (16BI) is not exposed in a folded state (see Panels (A) and (B)), whereas the bottom inner surface (16BI) and the bottom outer surface (16BE) are exposed in an unfolded state (see Panels (C) and (D)).

A terminal (11) may include multiple display units. In a 1^{st} case of this 1^{st} example, a terminal may incorporate a 1^{st} display unit (52A) on a top outer surface (16TE), where the 1^{st} display unit (52A) in Panel (A) may occupy about one half of a top outer surface (16TE), while the 1st display unit (52A) in Panel (B) may encompass at least a substantial portion or an entire portion (e.g., bezel-less) of the top outer surface (16TE).

In a 2^{nd} case of this 1^{st} example, a terminal may include a 2^{nd} display unit (52B) on its top inner surface (16TI). As shown in Panel (C), a terminal (11) may include a 2^{nd} display unit (52A) on a top inner surface (16TI) of a top body (15T), while providing hard key buttons on a bottom inner surface (16BI) of a bottom body (15B).

In a 3^{rd} case of this 1^{st} example, a terminal may include a 2^{nd} display unit (52B) on a top inner surface (16TI) and, in addition, a 3^{rd} display unit (52C) on a bottom inner surface (16BI). For example and as shown in Panel (D), both of such 2^{nd} and 3^{rd} display units (52B), (52C) may respectively occupy substantial portions of the top and bottom inner surfaces (16TI), (16BI).

In a 1st exemplary structure, the 2^{nd} display unit (52B) and the 3^{rd} display unit (52B), (52C) are two separate display units, where display surfaces of such display units (52B), (52C) [1] may physically couple with each other or [2] may be disposed close to each other, while optionally having a clearance therebetween.

A user may operate the 2^{nd} display unit (52B) and the 3^{rd} display unit (52C) individually (e.g., by operating different windows or displaying different screens on different display units). As a result, the user may operate a lock system on one display unit (52B), while [1] displaying routine data on another display unit (52C) or [2] driving a main system on another display unit (52C), or the like.

In a 2^{nd} exemplary structure, the 2^{nd} display unit (52B) and the 3^{rd} display unit (52C) may represent different display surfaces of a single display unit, where such a display unit may be folded or unfolded along a folding axis. As a result, a user may drive a main system in an unlock mode while using two display surfaces of the single display unit (52B) and (52C) together. Therefore, the user may enjoy [1] an extended portrait view as the user holds the unfolded terminal (11) vertically along the x axis, [2] an extended landscape view when the user holds the unfolded terminal (11) horizontally along the x axis.

For illustration purposes, when the 2^{nd} display unit (52B) and the 3^{rd} display unit (52C) represent different display surfaces of a single display unit, the 2^{nd} and 3^{rd} display unit (52B), (52C) may be collectively referred to as the 2^{nd} display unit (52B) or as the 3^{rd} display units (52C).

In a 4^{th} case of this 1^{st} example, a terminal may include the same or different number of display units on the same or different top (or bottom) inner (or outer) surfaces of the top (or bottom) body. For example, at least one display unit may be provided on the bottom outer surface, or at least two display units may be provided on any of the top outer or inner surface, or bottom outer or inner surface. In the alternative, a display unit may be provided on each of [1] only two of such surfaces of the top or bottom body, [2] only three of such surfaces thereof, or the like.

In a 5^{th} case of this 1^{st} example, a terminal may include multiple display units. where at least two of such display units [1] may have the same, similar or different shapes or sizes, [2] may be provided on different surfaces of a terminal, or the like. Therefore, one display unit may occupy [1] only a portion of at least one of such surfaces (16TE), (16TI), (16BE), (16BI), [2] a substantial but not an entire portion of at least one of such surfaces, [3] an entire (or almost an entire) portion of at least one of such surfaces, or the like.

In a 2^{nd} example of the 1^{st} exemplary embodiment, a data processing terminal may be provided in a foldable configuration in such a way that its aspect ratio may increase after the terminal switches from a folded state to an unfolded state.

FIG. 6 shows front views of various foldable terminals, where Panels (A), (B), and (E) show those terminals in their folded state, while Panels (C) and (D) show those terminals in their unfolded state, where an aspect ratio is to be defined as a ratio of a width or a length of a terminal (which is measured along the x direction) to its height (which is measured along a y direction).

In particular, a terminal (11) fabricated in the foldable configuration in each of Panels (A) to (D) may include a top body (15T) and a bottom body (15B) which may movably or rotatably couple with each other by a prior art rotatable joint (17) such as, e.g., a hinge or any prior art rotary joint. Thus, when a user pushes or rotates one of the top and bottom bodies (15T), (15B) away from (or toward) each other, a terminal (11) switches to an unfolded state from a folded state (or vice versa).

It is appreciated in FIG. 6 that the top body and bottom body (15T), (15B) are rotatably coupled to each other along their long vertices. Therefore, when the terminal (11) switches from its folded state to its unfolded state, a display surface of the terminal (11) may increase (e.g., almost doubled), while an aspect ratio of a terminal (11) may increase.

Similar to that of the 1^{st} example of the 1^{st} exemplary embodiment and FIG. 5, a top body (15T) may include a top inner surface (16TI) and a top outer surface (16TE), while a bottom body (15B) may include a bottom inner surface (16BI) and a bottom outer surface (16BE). The terminal (11) may also include multiple display units in different arrangements which may be similar or identical to those exemplified as the 1^{st} to 5^{th} cases of the 1^{st} example of this embodiment and FIG. 5. Therefore, further details are omitted herein.

As shown in Panel (E), a terminal (11) may include at least three bodies such as a top body (15T), a middle body (15M), and a bottom body (15B), where adjoining pairs of such bodies (15T), (15M), (15B) may movably or rotatably couple with each other by two rotatable joints (17A), (17B) so that its aspect ratio may further increase as switching from its folded state, to its half-unfolded state, and to its completely unfolded state.

It is appreciated that at least one display unit of a foldable terminal may be regarded as a “target display unit” which can be folded and cannot be exposed to a user in a “folded state,” but which can be unfolded and can be exposed to the user in an “unfolded state.” Therefore, the target display unit may play the role of a main (or intermediate) display unit of a main (or intermediate) system of the terminal.

It is also noted that at least one display unit of a foldable terminal may be viewed as a “non-target display unit” which can be exposed to a user in a “folded state” and which can be optionally exposed in an “unfolded state.” Accordingly, the non-target display unit may play the role of a lock (or intermediate) display unit of the lock (or intermediate) system of the terminal.

Accordingly, unless otherwise specified, the terms a “target display unit” and a main display unit are to be used interchangeably in this 5^{th} Configuration, while the terms a “non-target display unit” and a lock display unit are to be used interchangeably in this 5^{th} Configuration. It is noted that an intermediate display unit may play the role of either a target display unit or a non-target display unit, depending on whether a terminal may not include any main system or may include a main system, or the like.

A terminal may designate the target display unit as the main display unit on which a user may operate a main system in an unlock mode. In this arrangement, the target display unit may define a display surface which may be the same as or larger than that of the non-target display unit. In addition, the terminal may designate the non-target display unit to display thereon routine data. Of course, a terminal may include a non-target display unit which may be larger or wider than a target display unit or may display routine data on the target display unit.

### 8-2. 5^{th} Configuration—Operating Foldable Terminals

A user may operate a foldable terminal of this 5^{th} Configuration in similar or identical ways of operating various terminals as exemplified through the above 1^{st} to 4^{th} Configurations. Due to the foldable configuration, however, a user may manipulate the foldable terminals in additional ways which are to be described below.

Because a foldable terminal may include multiple display units and because a user may provide an additional user input for unfolding or folding a foldable portion of the terminal (or its display unit), a foldable terminal may provide a user with more diverse options in [1] manipulating the terminal, [2] providing user inputs which may be exclusively suited for unfolding or folding a foldable portion of a foldable terminal (or its display unit), or [3] running a lock or unlock operation in a lock or unlock mode using manipulations or user inputs which may be different from those exemplified in the above 1^{st} to 4^{th} Configurations, or the like.

It is appreciated throughout this 5^{th} Configuration that “operating a main (or lock) system in an unlock (or lock mode) on a target display unit” means that a terminal operates a main (or lock) system in an unlock mode (or a lock mode) while displaying at least one GUI of at least one hardware element, software element, or app of the main (or lock) system on a target display unit. Accordingly, a terminal allows a user to drive such an element or an app by manipulating the GUI displayed on the target display unit.

Similarly, throughout this 5^{th} Configuration, “operating a main (or lock) system in an unlock (or lock mode) on a non-target display unit” means that a terminal operates a main (or lock) system in an unlock mode (or a lock mode) while displaying at least one GUI of at least one hardware element, software element, or app of the main (or lock) system on a non-target display unit. Therefore, a terminal allows a user to drive such an element or an app by manipulating the GUI displayed on the non-target display unit.

### 8-2-1. Unfolding and Folding Operations

In an unfolding or folding operation which corresponds to the 2^{nd} exemplary embodiment of this fifth exemplary aspect, a terminal (or its input unit) may receive in a folded state a 1^{st} user input (to switch from a folded state to an unfolded state, i.e., an unfolding operation), or may receive in an unfolded state a 2^{nd} user input (to switch from an unfolded state to a folded state, i.e., a folding operation).

For example, a 1^{st} user input may include a (user) sub-input for an unfolding operation such as, e.g., unfolding a foldable portion of a terminal (or a display unit) by, e.g., moving, rotating or pivoting a top body away from a bottom body (or vice versa) about an unfolding axis in an unfolding direction. After switching to an unfolded state, a terminal may expose a display unit which was not exposed to a user in a folded state.

Whereas, a 2^{nd} user input may include a (user) sub-input for a folding operation such as, e.g., folding a foldable portion of a terminal (or a display unit) by, e.g., moving, rotating or pivoting a top body closer to a bottom body about a folding axis in a folding direction. It is noted that the unfolding axis and the folding axis may coincide with each other and that the unfolding direction and the folding direction may be opposite to each other.

The unfolding or folding axis may be defined by a rotatable joint such as, e.g., a hinge or another prior art rotary joint, capable of allowing rotating or pivoting thereabout, where such an unfolding or folding axis may correspond to a longitudinal axis of such a joint. The rotatable joint may also define a preset range of rotatable angles so that the foldable portion may rotate about the unfolding or folding axis in either the unfolding or folding direction in the same preset range of angles, where examples of such preset ranges may include about 45°, 60°, 90°, 120°, 150°, 180°, 210°, 240°, 270°, or the like.

It is noted that each of such preset ranges of angles may include the lowest angle and the greatest angle. For example, when a certain range is 180°, the lowest angle of the range may be 0°, while the greatest angle of the range may be 180°. Accordingly, at the lowest angle of 0°, a top body [1] may contact a bottom body or [2] may not directly contact the bottom body but may be disposed very proximate to the bottom body. In this context, when a top body may contact a bottom body in a folded state, the lowest angle of such preset ranges is usually 0°.

Alternatively, when a certain range is 180°, the lowest angle of the range may be 15°, and the greatest angle of the range may be 195°. At the lowest angle of 15°, a top body [1] may contact a bottom body, [2] may not directly contact the bottom body but may be disposed very proximate to the bottom body, while forming a non-zero and positive angle between the top and bottom bodies.

In another alternative, when a certain range is 180°, the lowest angle may be a negative value such as, −5°, depending upon, e.g., a location of the rotatable joint, a pattern of coupling between the joint and the top (or bottom) body, or the like.

It is noted that the rotatable joint may hold the top body in certain folding angles with respect to the bottom body or vice versa. For example, when a certain range is 180° (between 0° and 180°), the rotatable joint may hold the top body in position in certain folding angles such as 30°, 60°, 90°, 120°, 150, or 180°.

When a user begins to unfold a foldable portion while a terminal is in a folded state, a terminal may be set up to recognize reception of a 1^{st} user input only when an angle between the top and bottom bodies may reach a preset unfolding angle. For example, a terminal may regard that it has received the 1^{st} user input when a foldable portion unfolds or rotates by a preset unfolding angle which may be identical to or more than about, e.g., [1] 1°, [2] 5°, [3] 10°, [4] 15°, [5] 30°, [6] 45°, [7] 60°, [8] 75°, [9] more than 75°, or the like where such a preset unfolding angle may be measured as a difference between an unfolded angle (between such bodies) and an angle between such bodies in their (completely or partially) folded state.

Thus, in the case of [2] of the preceding paragraph, a terminal may regard any unfolding less than 5° (from an angle between such bodies in a completely or partially folded state) as not receiving the 1^{st} user input. However, when an angle between such bodies due to unfolding or rotation may reach or exceed 5°, the terminal may recognize such unfolding as receiving the 1^{st} user input. Thereafter, a terminal may run different operations.

It is noted that a terminal may be configured that a top body may be folded or rotated from a bottom body up to a certain unfolding angle and then hold its position. For example, when a top body may be folded up to 210°, a terminal may include a holding mechanism so that the terminal may hold the top body from the bottom body at 45°, 60°, 90°, 120°, 150°, 180° or 210°. In this arrangement, unfolding or rotation of the top body away from the bottom body by a maximum range of angle (e.g., 210°) is to be referred to as “completely unfolding,” while any unfolding or rotation of the top body away from the bottom body by an angle which may be less than the above maximum angle (e.g., 210°) may be referred to as “partially unfolding.”

Similarly, when a user begins to fold a foldable portion while a terminal is in an unfolded state, a terminal may be set up to recognize reception of a 2^{nd} user input only when an angle between the top and bottom bodies may reach a preset folding angle. Therefore, a terminal may regard that it has received the 2^{nd} user input when a foldable portion folds or rotates by a preset folding angle which may be identical to or more than about, e.g., [1] 1°, [2] 5°, [3]10°, [4] 15°, [5] 30°, [6] 45°, [7] 60°, [8] 75°, or [9] more than 75°, where the preset folding angle is measured as a difference between a folded angle (between the top and bottom bodies) and an angle between the bodies in their (completely or partially) unfolded state.

Accordingly, in the case of [2] of the preceding paragraph, a terminal may regard any folding less than 5° (from an angle between such bodies in the completely or partially unfolded state) as not receiving the 2^{nd} user input. However, when an angle between such bodies due to folding or rotation reaches or exceeds 5°, the terminal may recognize such folding as receiving the 2^{nd} user input. Thereafter, a terminal may run different operations.

A terminal may be configured that a top body may be unfolded or rotated from a bottom body up to a certain folding angle and then hold its position. For example, when a top body may be folded up to 210°, a terminal may include a holding mechanism so that a terminal may mechanically hold the top body away from the bottom body at 0° (e.g., a minimum range of angle), 15°, 30°, 45°, 60°, 90°, 120°, 150°, 180° or 210° (e.g., a maximum angle). In this arrangement, a top body disposed away from a bottom body by an angle of 0° is to be referred to as “completely folding,” a top body which is disposed away from a bottom body by an angle which is greater than the above minimum angle and less than 210° may be referred to as “partially folding.”

In a 1^{st} example of the 2^{nd} exemplary embodiment, a terminal may receive a 1^{st} user input (e.g., a user input for unfolding) in an off state (i.e. a powered-on state). In this folded state, a target (or main) display unit has not been exposed to a user. Thus, in response to the 1^{st} user input, a non-target (or lock) display unit which is exposed to the user may [1] not display anything thereon as shown in Panels (A), (B), and (E) of FIG. 6, or [2] only display a routine data as shown in Panels (A) and (B) of FIG. 5. After a terminal switches to an unfolded state, the terminal may run various operations as follows.

In a 1^{st} case of this 1^{st} example, a terminal may turn on a non-target display unit, while keeping a target display unit turned off. A terminal may then allow a user to operate a lock system in a lock mode on the non-target display unit. A terminal may then allow a user to switch to an unlock mode on the non-target display unit upon receiving another user input including UI_{SWI}, where a terminal may or may not require a user authenticating. In addition, a terminal may require a user authenticating and then turn on the target display unit when the user passes such user authenticating.

In a 2^{nd} case of this 1^{st} example, a terminal may turn on a target display unit, while keeping a non-target display unit turned off. A terminal may launch a main system concurrently with or after turning on the target display unit, with or without requiring a user authenticating. Therefore, a user may operate a main system in an unlock mode on the target display unit.

In a 3^{rd} case of this 1^{st} example, a terminal may turn on both of a target display unit and a non-target display unit. A user may operate a lock system in a lock mode on a non-target display unit, while operating a main system in an unlock mode on a target display unit, with or without requiring user authenticating.

In a 2^{nd} example of the 2^{nd} exemplary embodiment, a terminal may receive the 1^{st} user input (e.g., a user input for unfolding) in an on state (i.e. a powered-on state) and in a lock mode. In this folded state, a target (or main) display unit may not be exposed to a user. However, a non-target (or lock) display unit (52A) has been turned on and a user has been running lock operations in a lock mode before receiving the 1^{st} user input. Accordingly, when a terminal recognizes a user's unfolding action as receiving the 1^{st} user input, a terminal switches to an unfolded state, and may run various operations as follows.

In a 1^{st} case of this 2^{nd} example, a terminal may turn on a target (or main) display unit, launch a main system on the target display unit, and display a home screen thereon, while turning off a non-target (or lock) display unit. As a result, a user may automatically switch from a lock mode (of the non-target display unit) to an unlock mode (of the target display unit) through such unfolding. A terminal may or may not require user authenticating to operate the main system on the target display unit. In addition, a terminal may run an erase (or semi-erase) operation in one of various erasure timings.

In a 2^{nd} case of this 2^{nd} example, a terminal may turn on a target (or main) display unit, while keeping a non-target (or lock) display unit turned on or turning off the non-target (or lock) display unit. Similar to the above 1^{st} case, a user may operate a main system in an unlock mode on the target display unit, with or without having to go through the user authenticating. In addition, a user may keep operating a lock system in a lock mode on the non-target display unit. A terminal may run an erase (or semi-erase) operation in one of various erasure timings of this disclosure.

In a 3^{rd} case of this 2^{nd} example, a terminal may turn on a target (or main) display unit, while keeping a non-target (or lock) display unit turned on. However, a terminal may display a lock screen on the target display unit, while asking a user to authenticate. When the user passes such user authenticating, a terminal may allow the user to operate the main system on the target display unit. When the user fails such authenticating, however, a terminal may [1] launch a lock system on the target display unit in a lock mode, [2] turn off the target display unit, or the like.

In a 3^{rd} example of the 2^{nd} exemplary embodiment, a terminal may receive the 1^{st} user input (e.g., a user input for unfolding) in an on state (i.e. a powered-on state) and in an unlock mode. In this folded state, a target (or main) display unit is not exposed to a user. However, a non-target (or lock) display unit has been turned on and a user has been running unlock operations in an unlock mode before receiving the 1^{st} user input. Therefore, when a terminal recognizes a user's unfolding action as receiving the 1^{st} user input, a terminal switches to an unfolded state, and may run various operations as follows.

In a 1^{st} case of this 3^{rd} example, a terminal may turn on a target (e.g., main) display unit while keeping a non-target (e.g., lock) display unit turned on, and launch a main system on the target display unit, with or without requiring a user authenticating. As a result, a user may run unlock operations not only on the target display unit but also on the non-target display unit.

A terminal may give the user [1] the same access authority to both main systems of the target and non-target display units or [2] different access authorities to such main systems on such display units. In this case, a terminal may allow a main system operating on the target display unit to retrieve information that may be obtained by running the unlock operations with the same (or different) main system operating on the non-target display unit (or vice versa).

In a 2^{nd} case of this 3^{rd} example, a terminal may turn on a target display unit, but switch a non-target display unit from an unlock mode to a lock mode. As a result, a user may run lock operations in a lock mode on the non-target display unit, while running unlock operations in an unlock mode on the target display unit. Such an arrangement may better ensure physical or operational isolation of the lock system from the main system.

In a 3^{rd} case of this 3^{rd} example, a terminal may turn on a target display unit, but turn off a non-target display unit. As a result, a user may run unlock operations only on the target display unit. This arrangement may better ensure physical or operational isolation of the lock system from the main system.

In the above cases of this 3^{rd} example, a terminal may require a user to run a user authentication operation to switch from a lock mode operating on a non-target display unit to an unlock mode operating on a target display unit, This arrangement may prove useful, particularly when a terminal may allow greater access authorities to a main system in the unlock mode operating on a target display unit than the one operating on a non-target display unit.

Further details of switching modes, turning on the target or non-target display unit or authenticating a user of the above 1^{st} to 3^{rd} examples of this 2^{nd} exemplary embodiment may be similar or identical to those of the 1^{st} to 4^{th} Configurations described above and, therefore, omitted herein.

In a 4^{th} example of the 2^{nd} exemplary embodiment, a terminal may instead receive a 2^{nd} user input (e.g., a user input for folding) in an off state (i.e. a powered-on state). In this unfolded state, a target (or main) display unit has been exposed to a user, while a non-target (or lock) display unit may or may not have been exposed to the user depending upon, e.g., an unfolding angle, or a location of the non-target display unit. For example, when a top body has been folded by more than, e.g., 350°, to switch from a folded state to an unfolded state, a non-target display unit may not be exposed to a user in an unfolded state. But when a top body has been folded by, e.g., 180°, to switch from a folded state to an unfolded state, a non-target display unit is exposed to a user in an unfolded state, although a user may have to flip a terminal to see the non-target display unit.

In a 1^{st} case of this 4^{th} example, a target display unit may have been turned off, for a user has not operated a terminal for a period longer than a preset value, and a terminal has turned off the target display unit. Therefore, upon or after a terminal receives a 2^{nd} user input for folding, the terminal may [1] keep the target display unit off as the terminal switches to the folded state, [2] turn on the target display unit and then shut down a main system, [3] turn on the target display unit and ask a user for permission for turning off the target display unit, or the like.

In a 2^{nd} case of this 4^{th} example, a non-target display unit may have been turned on when a terminal receives a 2^{nd} user input. Upon or after a terminal switches to a folded state, a terminal may [1] keep the non-target display unit turned on, or {2} turn off the non-target display unit. In this case, a terminal may also manipulate a target display unit according to the 1^{st} or 2^{nd} case of this 4^{th} example.

In a 3^{rd} case of this 4^{th} example, a non-target display unit may have been turned off when a terminal receives a 2^{nd} user input. Upon or after a terminal switches to a folded state, a terminal may [1] keep the non-target display unit turned off, or {2} turn on the non-target display unit. In this case, a terminal may also manipulate a target display unit according to the 1^{st} or 2^{nd} case of this 4^{th} example.

In a 5^{th} example of the 2^{nd} exemplary embodiment, a terminal may instead receive the 2^{nd} user input (e.g., a user input for folding) in on state (i.e., a powered-on state) and in a lock mode. In this unfolded state, a target (or main) display unit has been exposed to a user, while a non-target (or lock) display unit may or may not have been exposed to a user as explained in the 4^{th} example.

As a result, a user may have been running a lock system to run lock operating in a lock mode. Therefore, when a terminal receives the 2^{nd} user input for folding, the terminal may keep the target display off as the terminal switches to the folded state, while optionally running erasure or semi-erasure in one of various erasure timings.

After switching to the folded state, a terminal may [1] turn off a non-target display unit, with or without displaying routine data thereon, [2] keep the non-target display unit turned on, while displaying at least one GUI of a lock app thereon, [3] keep the non-target display unit turned off, while displaying routine data thereon, [4] keep the non-target display unit turned on, while asking a user to run user authenticating, or the like.

In a 6^{th} example of the 2^{nd} exemplary embodiment, a terminal may instead receive the 2^{nd} user input (e.g., a user input for folding) in an unlock mode (i.e., a powered-on state). In this unfolded state, a target (or main) display unit has been exposed to a user, while a non-target (or lock) display unit may or may not have been exposed to a user as described above.

In addition, a user may have been running unlock operations in an unlock mode when a terminal receives the 2^{nd} user input. Upon or after receiving the 2^{nd} user input, a terminal may run different operations as follows.

In a 1^{st} case of this 6^{th} example, a terminal may turn off a target display unit while keeping a non-target display unit turned on or off. Thus, a user may not run unlock operations with a main system anymore, but may (or may not) be able to run any lock operations in a lock mode on the non-target display unit.

A non-target display unit may have been turned off in an unfolded state. In this case, upon or after switching to a folded state, a terminal may [1] keep a non-target display unit turned off or [2] turn on a non-target display unit while displaying [2-1] routine data or [2-2] at least one GUI of a lock app thereon.

In a 2^{nd} case of this 6^{th} example, a terminal may switch a target (e.g., main) display unit from an unlock mode to a lock mode while displaying [1] routine or [2] at least one GUI of a lock app thereon. Therefore, a user may operate a lock system on a target display unit in a lock mode and run various lock operations. Of course, this case is applicable when the target display unit is disposed to a user in a folded state.

When a non-target display unit has been turned off in an unfolded state, a terminal may [1] keep the non-target display unit turned off or [2] turn on a non-target display unit, thereby allowing a user to run lock operations on the target display unit as well as on the non-target display unit.

When a non-target display unit has been turned on in an unfolded state, a terminal may [1] keep the non-target display unit turned on, thereby allowing a user to run lock operations on the non-target display unit as well as on the target display unit, or [2] turn off a non-target display unit.

When two display units are disposed close to each other, a terminal may utilize such display units individually. For example, a terminal may operate a lock system in a lock mode on a 1^{st} display unit, while operating a main system in an unlock mode on a 2^{nd} display unit. A terminal may instead use both display units as a single or unitary display unit so that a terminal drives a single system in a certain mode to operate both display units as a single or unitary display unit.

### 8-2-2. User Inputs and (User) Sub-Inputs for Unfolding and Folding Operations

Various user inputs exemplified in Section 1-10 can be used as the 1^{st} user input for unfolding or the 2^{nd} user input for folding.

For example, a user may pull or rotate a foldable portion of a terminal (or display unit) in a direction of an arrow depicted in Panels (A) and (B) of FIG. 5 or in Panels (A), (B), and (E) of FIG. 6. A terminal may then sense [1] a force applied to the foldable portion using a force transducer, [2] a radial displacement of a foldable portion using an angular sensor, [3] a linear displacement thereof using a displacement sensor, or the like, where all of the above [1] to [3] may be viewed as features of the mechanical user input or the 1^{st} type user input.

In the 3^{rd} exemplary embodiment of this fifth exemplary aspect, a terminal may sense such folding or unfolding by receiving different types of user inputs using different sensors.

In a 1^{st} example of the 3^{rd} exemplary embodiment, a user may provide a user input for unfolding (or folding) by rotating or flipping an entire portion of a terminal in a clockwise or counterclockwise direction so that [1] a top body may face the ground, while a bottom body may face the sky, or [1] a top or bottom body may face a side.

A terminal may sense a rotation or a flipping of an entire terminal with, e.g., [1] a gravity sensor for measuring a vertical or horizontal direction, [2] an accelerometer for measuring an inclination of a terminal, [3] a gyroscope for measuring a relative position of a terminal, its direction, its level or its angle, [4] an electronic compass for sensing a position, or the like.

For example, when a terminal is in an unfolded state and a top body is facing the sky, a terminal may then turn on a non-target display unit and allow a user to operate a lock system in a lock mode or a main system in an unlock on the non-target display unit. However, the terminal may allow a user to operate a main system on a target display unit when a bottom body faces the sky.

In a 2^{nd} example of the 3^{rd} exemplary embodiment, a terminal may include a hard button or a soft button which may cause folding or unfolding of a foldable portion of the terminal or its display unit. Accordingly, when a user may press, rotate or touch such a button, a terminal may switch from its folded state to its unfolded state or vice versa. In such an arrangement, a user's manipulation of such a button may be regarded as a user input for unfolding or folding the foldable portion of the terminal.

In a 3^{rd} example of the 3^{rd} exemplary embodiment, a user may provide a user input for unfolding or folding by looking at a target or non-target display unit so that a terminal may sense which direction or which display unit a user stares at, and then determine which display unit a user may want to operate based thereon. For example, when a terminal exposes at least two display units to a user and when a user wants to operate a target terminal, the terminal may track user's eyes, determine that a user stares at the target terminal, and then drive the target terminal, while operating or halting operation of a non-target display unit. To this end, a terminal may include a prior art eye tracking devices or algorithms.

### 8-3. 5^{th} Configuration—Rollable Configuration

In the 4^{th} exemplary embodiment of this fifth exemplary aspect of this disclosure, a data processing terminal may be provided in a rollable configuration by including, e.g., at least one rollable portion on a display surface of a display unit, where the rollable portion may be unrolled out of or rolled into a body of a terminal. That is, as a terminal switches between an unrolled state (i.e., one of the open states) and a rolled state (i.e., one of the closed states), a rollable portion may be respectively unrolled (e.g., disposed outside a body of a terminal and, therefore, exposed to a user) and rolled (i.e., disposed inside the body and, therefore, not exposed to the user) along an unrolling or rolling axis in an unrolling or rolling direction within a preset range of lengths.

In a 1^{st} example of the 4^{th} exemplary embodiment, a data processing terminal may be provided in a rollable configuration in such a way that its aspect ratio decreases as the terminal switches from a rolled state to an unrolled state.

FIG. 7 depicts front views and a side view of an exemplary rollable terminal, where Panels (A) and (B) are respectively a front view and a side view of a rollable terminal in its rolled state, while Panel (C) is a front view of the rollable terminal of Panels (A) and (B) in its unrolled state, where an aspect ratio is defined as a ratio of a width or length of a terminal (which is measured in the x direction) to a height of a terminal (which is measured in the y direction).

More particularly, a terminal (11) fabricated in the rollable configuration may include a body (15) and a display unit (52) provided on top of the body (15). A display unit (52) may define a display surface which in turn includes a main portion (of a display surface) (54M) and a rollable portion (of a display surface) (54R), where shapes or sizes of such portions (54M), (54R) may be identical to, similar to or different from each other.

In an unrolled state, a rollable portion (54R) of a display screen may be rolled out of a roller (18), pulled to an outside of a housing (18), or the like. Therefore, a rollable portion (54R) may be exposed to an exterior of the body (15), and a user may see a rollable portion (54R).

Thus, an aspect ratio of a display surface or that of a display unit (52) may in an unrolled state may be less than an aspect ratio in a rolled state.

In a rolled stare, however, a rollable portion (54R) of a display screen may roll into a body (15) of a terminal (11) and rolled around a roller (18) or kept inside a housing (18) both of which are installed inside a body (15). Thus, a rollable portion (54R) may not be exposed to an exterior, and a user may not see the rollable portion (54R) in the rolled state.

A body (15) may include at least one slider (19) which may slide upwardly with respect to a body (15) when a terminal switches from a rolled state to an unrolled state. In contrary, a slider (19) may slide downwardly with respect to the body (15) when a terminal switches from its unrolled state to a rolled state. In addition, the slider (19) may couple with the main portion (54M) of the display space of the display unit (52). Therefore, as the slider (19) moves upwardly, the slider (19) may also pull the rollable portion (54R) upwardly so that the rollable portion (54M) is unrolled from the roller (18) or pulled out of the housing (18). However, as the slider (19) moves downwardly, the slider (19) may push the rollable portion (54R) downwardly such that the rollable portion (54R) is rolled onto the roller (18) or pushed inside the housing (18). Alternatively, the roller or housing (18) may include a recoil element such as, e.g., a prior art spring, which may assist the rollable portion (54R) to recoil back onto the roller or into the housing (18).

A display unit (52) is placed on top of a slider (19). Thus, a terminal (11) may expose the main portion (54M) of the display surface of the display unit (52) to an exterior of the body (15) in a rolled state, while keeping the rollable portion (54R) of the display surface of the display unit (52) inside a body (15). When a terminal switches from a rolled state to an unrolled state, a slider (19) moves upwardly, while a display unit (52) moves upwardly along with a slider (19).

A terminal (11) of FIG. 7 may include at least one roller (or housing) (18) inside and along a bottom edge of its body (15). As a result, the roller (or housing) (18) does not move with respect to the body (15) as the rollable portion (54R) may unroll from the roller or out of the housing (18), or as the rollable portion (54R) may be rolled onto or into a roller or housing (18)

Alternatively, the roller or housing (18) may be installed on different locations of the terminal (11) such as, e.g., along a top edge of the body (15). In this case, the roller or housing (18) may move along with the main portion (54M) with respect to a body (15) when the rollable portion (54R) unrolls from the roller or out of the housing (18) or when the rollable portion (54R) rolls onto the roller or into the housing (18).

In a 2^{nd} example of the 4^{th} exemplary embodiment, a data processing terminal may be provided in a rollable configuration in such a way that its aspect ratio may increase after the terminal switches from its rolled state to its unrolled state.

FIG. 8 shows top views of an exemplary rollable terminal, where Panel (A) shows the terminal in its rolled state, while Panel (B) shows the terminal in its unrolled state, where an aspect ratio is defined as a ratio of a width or length of a terminal (which is measured along the x direction) to a height of a terminal (which is measured along the y direction).

In particular, a terminal (11) fabricated in the rollable configuration in each of Panels (A) and (B) may include a body (15) and a display unit (52) provided on top of the body (15). The display unit (52) may define a display surface which in turn includes a main portion (of a display surface) (54M) and a rollable portion (of a display surface) (54R).

In a rolled state, a rollable portion (54R) may be rolled around a roller (18) or kept inside a housing (18) so that a rollable portion (54R) is disposed inside the body (15), and not be exposed to an exterior of the body (15). As a result, a user may not see the rollable portion (54R) in the rolled state. In an unrolled state, however, the rollable portion (54R) may be rolled off from the roller (18) or pulled outside of the housing (18) such that the rollable portion (54R) is exposed to an exterior of the terminal (11) and that a user may see the rollable portion (54R), along with the main portion (54M).

A body (15) may include a slider (19) which may slide away from the body (15) when the terminal (11) switches from a rolled state to an unrolled state but which may slide closer or toward the body (15) when the terminal (11) switches from its unrolled state to a rolled state.

In addition, the slider (19) may couple with the main portion (54M) of the display space of the display unit (52). Therefore, as the slider (19) moves away from the body (15), the slider (19) may pull the rollable portion (54R) in the same direction so that the rollable portion (54M) is unrolled from the roller (18) or pulled out of the housing (18).

But as the slider (19) moves toward or closer to the body (15), the slider (19) may push a rollable portion (54R) in the same direction so that the rollable portion (54R) is rolled onto the roller (18) or pushed inside the housing (18). The terminal (11) may also include a recoil element such as a spring which may assist the rollable portion (54R) to recoil onto the roller or into the housing (18).

A display unit (52) may be installed on top of a slider (19) so that a terminal (11) may expose the main portion (54M) of the display surface of the display unit (52) to an exterior of the body (15) in a rolled state, but keeping the rollable portion (54R) of the display surface of the display unit (52) inside a body (15). Upon switching from a rolled state to an unrolled state, a slider (19) moves away from the body (15), while the rollable portion (54R) of the display surface of the display unit (52) also moves away from the body (15) along with the slider (19).

A terminal (11) of FIG. 8 includes a roller or a housing (18) inside and along a left edge of the body (15). As a result, the roller or housing (18) does not move with respect to the body (15) as the rollable portion (54R) may [1] unroll from the roller or out of the housing (18), or [2] be rolled onto the roller or into the housing (18)

Alternatively, the roller or housing (18) may be installed on different locations of the terminal (11) such as, e.g., along a right edge of the body (15). In this arrangement, the roller or housing (18) may move along with the main portion (54M) with respect to a body (15) when the rollable portion (54R) [1] unrolls from the roller or out of the housing (18) or [2] rolls onto or into the roller or housing (18).

### 8-4. 5^{th} Configuration—Operating Rollable Terminals

A user may operate a rollable terminal of this 5^{th} Configuration in similar or identical ways of operating various terminals as exemplified in the above 1^{st} to 4^{th} Configurations. Due to the rollable configuration, however, a user may manipulate the rollable terminals in additional ways which are to be described below.

That is, because a rollable terminal typically includes a display unit capable of varying at least one dimension (e.g., its height or its length or width) of its display surface and because a user may provide another user input for rolling or unrolling a rollable portion of a display surface of a display unit), a rollable terminal may provide a user with more diverse options in [1] manipulating a terminal, [2] providing a user input which is exclusively designed for a rollable terminal, [3] running a lock or unlock operation [3-1] using manipulations or [3-2] using user inputs which may be different from those exemplified in the 1^{st} to 4^{th} Configurations, or the like.

It is noted that a display surface of a display unit of a rollable terminal is deemed to include a main portion and a rollable portion. The main portion means the portion of a display screen of a display unit which may be always exposed to a user both in a rolled state and in an unrolled state, while the rollable portion is the portion which may generally be not exposed to a user in a rolled state (e.g., disposed inside a body of a terminal by being rolled around a roller or kept inside a housing) but which is unrolled in an unrolled state and, therefore, exposed to a user.

It is also appreciated in this 5^{th} Configuration that “operating a lock (or main) system in a lock (or unlock) mode on a main (or rollable) portion (of a display surface of a display unit)” means that a terminal may operate a lock (or main) system in a lock (or unlock) mode while displaying at least one GUI of a hardware element, a software element, or an app on the main (or rollable) portion (of a display surface of a display unit).

### 8-4-1. Unrolling and Rolling Operations

In an unrolling or rolling operation which corresponds to the 5^{th} exemplary embodiment of this fifth exemplary aspect, a terminal (e.g., its input unit) may receive from a user [1] a 1^{st} user input in a rolled state for unrolling a rollable portion out of a body of a terminal, [2] a 2^{nd} user input in an unrolled state for rolling a rollable portion inside a body of a terminal.

For example, the 1^{st} user input which is provided to a terminal in a rolled state may include a (user) sub-input for an unrolling operation such as, e.g., rolling (or pulling) out a rollable portion of a display surface of a display unit from a roller or out of a housing about an unrolling axis in an unrolling direction.

Because a rollable portion has been rolled on a roller or kept inside a housing and has not been exposed in a rolled state, a user may not see a rollable portion of a display surface in a rolled state. After a terminal receives the 1^{st} user input and switches to an unrolled state, a user may then see the rollable portion of a display surface along with a main portion thereof. Thus, a display unit can provide a screen on an extended display surface of a display unit.

To the contrary, the 2^{nd} user input which is provided to a terminal in an unrolled state may include a (user) sub-input for a rolling action such as, e.g., rolling an exposed rollable portion of a display surface back onto a roller or into a housing about a rolling axis in a rolling direction.

Because a rollable portion of a display surface has been exposed in an unrolled state, a user may see a rollable portion and a main portion of a display surface in an unrolled state. After a terminal receives the 2^{nd} user input and switches from an unrolled state to a rolled state, a user may not see the rollable portion of a display surface.

The unrolling (or rolling) axis may be defined by a roller or a housing capable of releasing or retracting a rollable portion of a display surface of a display unit. The roller may further define a preset dimension which a roller or a housing may release (or retract) about the unrolling (or rolling) axis.

Examples of the preset dimension may be about 10%, 20%, 30%, 40%, 50%, 60%, 70%, 80%, 90% or 100% of a characteristic dimension of a main portion of a display surface, where the characteristic dimension may be a length or a width of the main portion in the rolled state, when unrolling (or rolling) a rollable portion may respectively increase (or decrease) a length, a width or a height of a display surface.

When a user begins to unroll a rollable portion of a display surface of a display unit, a terminal may be set up to recognize a reception of the 1^{st} user input when unrolling reaches a certain dimension (e.g., a length, width or height). For example, a terminal may regard that it receives the 1^{st} user input when a rollable portion unrolls by a preset length which may [1] amount to or [2] be more than about, e.g., 5%, 10%, 20%, 30%, 40%, 50%, 60%, 70%, 80%, 90% or 100% of a characteristic dimension of a main portion of a display surface in the rolled state, where the characteristic dimension has been defined above.

Similarly, when a user begins to roll a rollable portion, a terminal may be set up to recognize a reception of the 2^{nd} user input when the rolling reaches a certain dimension (e.g., a length, width or height). For example, a terminal may regard that it receives the 2^{nd} user input when a rollable portion rolls into a roller or retracts into a housing by a preset length which may [1] amount to or [2] be more than about, e.g., 5%, 10%, 20%, 30%, 40%, 50%, 60%, 70%, 80%, 90% or 100% of a characteristic dimension of a main portion of a display surface in the rolled state, where the characteristic dimension has been defined above.

It is noted that a user's unrolling (or rolling) may be actuated by pulling (or pushing) a slider [1] away from (or closer to) a body, [2] out of (or onto) a roller, or [3] out of (or into) a housing. However, such unrolling (or rolling) may mechanically damage a display surface or a display unit or other mechanical or electromechanical units for sliding the rollable portion out of or into a body of a terminal.

In this case, a terminal may include a switch which may receive the above 1^{st} or 2^{nd} user input and respectively initiate such unrolling or rolling. In this case, any of the above 1^{st} type to 5^{th} type user input which is applied to a suitable input unit may be regarded as the 1^{st} user input for unrolling or the 2^{nd} user input for rolling.

When a rollable terminal may receive a user input which in turn includes UI_{SWI} (for switching to a lock or unlock mode), UI_{ACT}, or UI_{THEN}, the terminal may run various operations as exemplified in the 1^{st} to 4^{th} Configurations and, therefore, further details are omitted herein.

Accordingly, following examples exemplify when a rollable terminal receives a user input which includes one of the above 1^{st} user input for unrolling or 2^{nd} user input for rolling, where the 1^{st} or 2^{nd} user input includes [1] only one a (user) sub-input for unrolling or rolling or [2] one (user) sub-input for unrolling or rolling as well as at least one of UI_{SWI} (for switching to a lock or unlock mode), UI_{ACT}, or UI_{THEN}.

In a 1^{st} example of the 5^{th} exemplary embodiment, a rollable terminal in a rolled state is in an off state (i.e., a powered-on state). Upon receiving the 1^{st} user input for unrolling, a terminal keeps a main portion (of a display surface of a display unit) exposed and may begin to expose a rollable portion (of a display surface of a display unit) out of a body of the terminal.

In a 1^{st} case of this 1^{st} example, a terminal may keep a main portion as well as a rollable portion (of a display surface of a display unit) turned off (e.g., displaying nothing thereon or only displaying routine data on one or both portions (of the display surface of the display unit). A terminal may ask a user to run user authenticating and may [1] switch one or both portions to a lock mode when a user passes the authenticating, or [2] remain in off state when a user fails the authenticating. A terminal may run erasure or semi-erasure in [1] or [2] in one of various erasure timings.

In a 2^{nd} case of this 1^{st} example, a terminal may turn on a main portion as well as a rollable portion (of a display surface of a display unit). After such turning on, a terminal may [1] switch both portions to a lock mode and allow a user to run lock operations on both portions, [2] switch one portion to a lock mode and allow a user to run lock operations thereon, while asking a user to run an authentication operation on another portion, or the like. When a user passes the authenticating in [2], a terminal may switch that portion to an unlock mode, while optionally running erasure or semi-erasure in one of such erasure timings, When a user fails authenticating, that portion may remain in a lock mode or a terminal may turn off that portion.

In a 2^{nd} example of the 5^{th} exemplary embodiment, a rollable terminal in a rolled state may be in a lock mode (i.e., a powered-on state and an on state). Upon receiving the 1^{st} user input for unrolling, a terminal keeps a main portion (of a display surface of a display unit) exposed and may begin to expose a rollable portion (of a display surface of a display unit).

In a 1^{st} case of this 2^{nd} example, a terminal may turn on a rollable portion (of a display surface of a display unit) and operate the rollable portion in a lock mode. Therefore, a terminal may drive a single lock system which operates on both the main and rollable portions in a lock mode together, while providing an extended screen to a user.

In a 2^{nd} case of this 2^{nd} example, a terminal may turn on a rollable portion and operate the rollable portion in a lock mode. In addition, a terminal may operate the main and rollable portions independently, e.g., by providing different windows thereon such that a user may run different lock operations in each window (or portion).

In a 3^{rd} case of this 2^{nd} example, a terminal may turn on a rollable portion (or keep the rollable portion turned off) and ask a user to run authenticating. When a user passes such authenticating, a terminal may allow a user to use both the rollable and main portions as a single display unit, while switching to an unlock mode. A terminal may run erasure or semi-erasure on one of such erasure timings. When a user fails authenticating, a terminal may allow a user to [1] continue to drive a lock system on both the rollable and main portions, [2] continue to drive the same lock system in a main portion, while launching another lock system in a rollable portion, or [3] continue to drive the same lock system in a main portion, while keeping the rollable portion turned off.

In a 3^{rd} example of the 5^{th} exemplary embodiment, a rollable terminal in a rolled state operates in an unlock mode (i.e., a powered-on state and on state). Upon receiving the 1^{st} user input for unrolling, a terminal keeps a main portion (of a display surface of a display unit) exposed and may begin to expose a rollable portion (of a display surface of a display unit).

In a 1^{st} case of this 3^{rd} example, a terminal may turn on a rollable portion (of a display surface of a display unit) and operate the rollable portion in an unlock mode. Therefore, a terminal may drive a single main system which operates on both the main and rollable portions in an unlock mode together, thereby providing a user with an extended screen to a user.

In a 2^{nd} case of this 3^{rd} example, a terminal may turn on a rollable portion and operate such a rollable portion in an unlock mode. A terminal may then operate the main and rollable portions independently, e.g., by providing different windows thereon such that a user may run different unlock operations in each window (or portion) in an unlock mode, where the terminal may grant the same, similar or different access authorities in each unlock mode.

In a 4^{th} example of the 5^{th} exemplary embodiment, a rollable terminal in an unrolled state operates in an unlock mode (i.e., a powered-on state and on state). Upon receiving the 2^{nd} user input for rolling, the terminal keeps a main portion (of a display surface of a display unit) exposed and may begin to retract a rollable portion (of a display surface of a display unit) into a body of a terminal.

In a 1^{st} case of this 4^{th} example, a terminal may keep a main portion (of a display surface of a display unit) in an unlock mode after a rollable portion is rolled on a roller or retracted back into a housing. Therefore, when a terminal switches to a rolled state, the terminal operates the same main system on the main portion which has a smaller display surface. A terminal may run erasure or semi-erasure in various erasure timings.

In a 2^{nd} case of this 4^{th} example, a terminal may switch a main portion to a lock mode after a rollable portion is rolled on a roller or retracted back into a housing. Thus, when a terminal switches to a rolled state, a terminal may operate a lock system on the main portion which has a smaller display surface. A terminal may run erasure or semi-erasure in various erasure timings.

In a 5^{th} example of the 5^{th} exemplary embodiment, a rollable terminal in an unrolled state operates in a lock mode (i.e., a powered-on state and on state). Upon receiving the 2^{nd} user input for rolling, the terminal keeps a main portion (of a display surface of a display unit) exposed and may begin to retract a rollable portion (of a display surface of a display unit) into a body of a terminal.

In a 1^{st} case of this 5^{th} example, a terminal may keep a main portion (of a display surface of a display unit) in a lock mode after a rollable portion is rolled on a roller or retracted back into a housing. Therefore, when a terminal switches to a rolled state, the terminal operates the same lock system on the main portion which has a smaller display surface. A terminal may run erasure or semi-erasure in various erasure timings.

In a 2^{nd} case of this 5^{th} example, a terminal may turn off a main portion (of a display surface of a display unit) concurrently with, during or after a rollable portion is rolled on a roller or retracted back into a housing. Thus, when a terminal switches to an off state and rolled state. A terminal may run erasure or semi-erasure in various erasure timings.

### 8-4-2. User Inputs and (User) Sub-Inputs for Unrolling and Rolling Operations

Various user inputs exemplified in Section 1-10 can be used as user inputs which a terminal may recognize as the 1^{st} user input for unrolling or the 2^{nd} user input for rolling.

For example, a user may pull or push a slider or a rollable portion of a terminal (or display unit) in a direction of an arrow depicted in Panel (B) of FIG. 6 or in Panel (A) of FIG. 8. A terminal may then sense [1] a force applied to the slider or rollable portion using a force transducer, [2] a linear displacement of the slider or rollable portion using a displacement sensor, or the like, where the above [1] and [2] may be viewed as the mechanical user input or the 1^{st} type user input.

In the 6^{th} exemplary embodiment of this fifth exemplary aspect, a terminal may sense such rolling or unrolling by receiving different types of user inputs using different sensors.

In a 1^{st} example of the 6^{th} exemplary embodiment, a terminal may include a hard button or a soft button which may cause rolling or unrolling of a rollable portion of the terminal or its display unit. Accordingly, when a user may press, rotate or touch such a button, a terminal may switch from its rolled state to its unrolled state or vice versa. In such an arrangement, a user's manipulation of such a button may be regarded as a user input for unrolling or rolling the rollable portion of the terminal.

In a 2^{nd} example of the 6^{th} exemplary embodiment, a user may provide a user input for unrolling or rolling by looking at a target display unit or a non-target display unit such that a terminal may determine in which state a user may want to operate. For example, when a terminal is in a rolled state and when a user wants to switch to an unrolled state, the terminal may track user's eyes or their movement, determine where a user stares at, in which direction a user's eye moves, and then moves from one state to another. To this end, a terminal may incorporate prior art eye tracking devices or algorithms.

### 8-5. 5^{th} Configuration—Various Timings in Terminals

In the 7^{th} exemplary embodiment of this fifth exemplary aspect, various terminals with adjustable (i.e., foldable or rollable) configurations may run an erase (or semi-erase) operation, a mode-switching operation, a launch operation, or turning-on operation in various timings.

In a 1^{st} example of this 7^{th} exemplary embodiment, a terminal may run an erase (or semi-erase) operation in one of various erasure timings which have been described above.

In addition, a terminal may run an erase (or semi-erase) operation in one of additional erasure timings such as, e.g., [1] upon receiving the 1^{st} (or 2^{nd}) user input, [2] (immediately) after receiving the 1^{st} (or 2^{nd}) user input, [3] after receiving the 1^{st} (or 2^{nd}) user input but before receiving an additional user input which is neither the 1^{st} user input nor the 2^{nd} user input, [4] after receiving the 1^{st} (or 2^{nd}) user input but [4-1] before beginning such unfolding, folding, unrolling or rolling, [4-2] during (i.e., before completing) such unfolding, folding, unrolling or rolling, or [4-3] upon (or after) completing such unfolding, folding, unrolling or rolling.

In a 2^{nd} example of this 7^{th} exemplary embodiment, a terminal may launch (or run a launch operation of) a lock, intermediate or main system, respectively, in a lock, intermediate or unlock mode, in one of such launch timings which have been described above.

A terminal may also launch a certain system in one of additional launch timings such as, e.g., [1] upon receiving the 1^{st} (or 2^{nd}) user input, [2] (immediately) after receiving the 1^{st} (or 2^{nd}) user input, [3] after receiving the 1^{st} (or 2^{nd}) user input but before receiving an additional user input which may be neither the 1^{st} nor 2^{nd} user input, [4] after receiving the 1^{st} (or 2^{nd}) user input but [4-1] before beginning such unfolding, folding, unrolling or rolling, [4-2] during (i.e., before completing) such unfolding, folding, unrolling or rolling, [4-3] upon (or after) completing such unfolding, folding, unrolling or rolling, or the like.

In a 3^{rd} example of this 7^{th} exemplary embodiment, a terminal may run a (user) authentication in one of such authenticating timings which have been described above.

A terminal may run authentication operations in one of additional authenticating timings such as, e.g., [1] upon, (immediately) after or after receiving the 1^{st} (or 2^{nd}) user input, [2] after receiving the 1^{st} (or 2^{nd}) user input but before receiving an additional user input, [3] after receiving the 1^{st} user input but before, during or after starting (or completing) the unfolding or the unrolling, [4] after receiving the 2^{nd} user input but before, during or after completing the starting (or completing) the folding or rolling, or the like.

It is noted that “launching a certain (e.g., a lock, intermediate or main system)” may include situations [1] in which that certain system has not been launched before or [2] in which the certain system has been launched before but its operation has been halted and, thus, a terminal resumes operation of that certain system.

Moreover, other configurational or operational features, their variations or modifications of the terminals of this fifth exemplary aspect [1] may apply to, [2] may be incorporated into, [3] may replace, [4] may be replaced by, or [5] may be combined with corresponding features of the same or different [1] aspect, [2] embodiment, or [3] example throughout this disclosure, as long as such application, incorporation, replacement, or combination does not contradict each other.

### 9. 6^{th} Configuration—Applications in Virtual Reality (or World)

In the sixth exemplary aspect of this disclosure, various data processing terminals may be applied to or used with virtual reality (VR), augmented reality (AR), mixed reality (MR), extended reality (XR), substitutional reality (SR), or the like. It is appreciated that such VR, AR, MR, XR, and SR are to be collectively referred to as the “VR” hereinafter, unless otherwise specified.

It is also appreciated that an environment provided by such VR, AR, MR, XR, and SR are to be respectively referred to as a “virtual world (VW),” an “augmented world (AW),” a “mixed world (MW),” an “extended world (EW),” and a “substitutional world (SW),” all of which are to be collectively referred to as the “VW” hereinafter, unless otherwise specified.

Thus, following features exemplified for the VR (or VW) may be applied to the AR (or AW), MR (or MW), XR (or XW) or SR (or SW), unless otherwise specified. For example, when a VR may include a VR system which may embody an environment for a VW, [1] a VR may include a VR system which may embody an environment for a VW, [2] an AR may include an AR system which may embody an environment for an AW, [3] an MR may include an MR system which may embody an environment for an MW, [4] an XR may include an XR system which may embody an environment for an XW, or [5] a SR may include a SR system which may embody an environment for a SW.

In this disclosure, a VR may be provided to a user by a VR system which may generate realistic images, sounds, and optionally other sensations all of which may simulate a physical presence of a user in a VW. Thus, a user using a VR system may look around the VW, move around in the VW, and interact with virtual features or virtual items provided in the VW.

In order to generate realistic images, sounds or other sensations which may simulate the physical presence of a user in a VW, a VR system may use [1] a head-mounted display such as, e.g., a headset or a goggle, or [2] a multi-projected environment such as, e.g., a specially designed space with multiple large screens. A VR system may provide to a user or receive therefrom [1] auditory feedback signals, or [2] video feedback signals, but may allow other types of sensory or force feedback through haptic technology.

For simplicity of illustration, a head-mount display, multi-projected environment or other hardware elements for embodying the realistic images, sounds and other sensations which may simulate physical presence of a user in a VW (i.e., a virtual world) are to be collectively referred to as a “HMD” or a “head-mount display” hereinafter, unless otherwise specified.

It is noted that a VR system may include at least one additional sensor to obtain a signal from a movement of a body part (e.g., a finger, hand, wrist, arm, shoulder, neck, head, upper body, hip, lower limb, leg, or toe) of a user, a linear (or angular) direction of the movement, a linear (or angular) displacement of such movement, a linear (or angular) velocity of such movement, a linear or angular acceleration of such movement, or the like. It is also noted that a VR system may include at least one actuator to deliver at least one feedback signal which is generated by the VR system and which is delivered to at least one of such body parts of the user.

Such sensors or actuators may not be incorporated into the HMD and, thus, may not be worn by a user around his head of a user. Rather, such sensors or such actuators may be incorporated into other peripherals which [1] may be coupled to other body parts of the user or [2] may be worn by a user on or around such other body parts. For simplicity of illustration, however, such sensors or actuators which may not be coupled to or worn around a head of a user are to be collectively referred to as [1] a HMD or [2] a part of the HMD, unless otherwise specified.

### 9-1. 6^{th} Configuration—Three-Component (3C) VR System

### 9-1-1. Configuration of a Three-Component (3C) VR System

In the 1^{st} exemplary embodiment of this sixth exemplary aspect, a VR system may include at least one server, a head-mounted display (or “HMD”), and one of various terminals of this disclosure, where such a VR system may be referred to as a “three-component VR system” or as a “3C VR system” hereinafter.

FIG. 9 is a schematic view of an exemplary three-component VR system which may include at least one server (120), a head-mounted display (to be abbreviated as HMD hereinafter) (122), and one of various terminals (11) which have been described in this disclosure.

In general, a server (120) may be installed in a location [1] which is remote from a user or a HMD (122), [2] in which a HMD (122) is located, or the like. The server (120) may include computer codes which may simulate a virtual world (i.e., a VW) by rendering such computer codes, which may generate such images, sounds or other sensations for the VW, and may stream such images, sounds and other sensations to a HMD (122), or the like. The server (120) may be operated by a provider of [1] the computer codes, [2] the VR, or [3] the HMD (122). The server (120) may be a cloud server.

A HMD (122) is shaped and sized to be worn by a user around his head. The HMD (22) may include a display unit, a speaker, at least one sensor for monitoring a position, a movement, a velocity, or an acceleration of a user (110), at least one actuator for generating feedback signals, or the like. The HMD (122) may display such images on the display unit, play sounds on the speaker, or optionally generate other visual, auditory or tactile sensations, or the like, thereby simulating a user's physical presence in the VW.

A terminal (11) may operationally couple to a server (120), a HMD (122), or the like. For example, a terminal (11) may send or receive information to or from the server (12) or HMD (122), save at least a portion of such information therein, or erase at least a portion of such information therefrom.

It is appreciated that a terminal (11) may physically or operationally isolate its main system from a VR server (120) or a HMD (122) such that the server (120) or HMD (122) may not access the main system of the terminal (11) while a user is in the VW, [1] without a user's approval, [2] while the terminal (11) operates its lock system, [3] unless a user in the VW or in a real world passes a user authenticating, or the like. It is appreciated that the real world is the term used to be contrasted to the VW and that the real world is to be abbreviated as a “RW” hereinafter)

### 9-1-2. Operating a Three-Component (3C) VR System

As a user enters a virtual world (VW), he can run various operations, perform various functions, and generate various “outcomes.” For example, a user may play a game in the VR, where the game as well as the outcomes of the game do not affect a status of a user in the RW at all.

In contrary, a user who enters the VW may search for information of a company which may be not only listed in a VW stock market but also in a RW stock market. The user may want to store such information for future use. When a user has his own account in the VW, the user may store such information in his VW account. But when the user wants to use such information in the RW, he may decide to store such information in his terminal.

However, any information which a user obtains in the VW may include malicious viruses or codes, just like the information which the user may obtain from a suspicious website in the RW. Therefore and in the 2^{nd} exemplary embodiment of this sixth exemplary aspect, a user may use his own terminal, and may protect his VR account as well as a main system of the terminal, where the terminal may include at least one lock system, at least one main system, and optionally at least one intermediate system.

In a 1^{st} example of this 2^{nd} exemplary embodiment, a user may run operations in his VW account by executing the computer codes which may be stored in [1] a VW server, [2] his VW account, or [3] the HMD. After a user obtains information (or outcomes) in the VW, a user may send such information from his VW account to a lock system of his terminal which operates in a lock mode. The user may then access or refer to such information received from the VW by operating a lock system of his terminal in the RW. Because the user may run erasure (or semi-erasure) after such accessing or referring, he may not have to be concerned about allowing malicious viruses migrating [1] from the VW to his VW account, [2] from the VW into a main system of his terminal, or the like.

In a 2^{nd} example of this 2^{nd} exemplary embodiment, instead of running operations by executing the computer codes stored in the VW (e.g., a VW server, a VW account, or a HMD), a user may run some of such operations by executing such computer codes stored in a lock (or main) system of a terminal by operating a lock system of a terminal in a lock mode, and obtain “results” therefrom. That is, a user may not have to run such operations in his VW account, thereby obviating the risk of allowing malicious viruses migrating from a VW into his VW account. Rather, the user may run such operations using a lock system in a lock mode of his terminal, thereby isolating suspicious operations or such “results” not only from his VW account but also from a main system of his terminal.

In a 3^{rd} example of this 2^{nd} exemplary embodiment, instead of running operations by executing such computer codes exclusively in the VW (e.g., a VW server, a VW account, a HMD, or the like), a terminal may include at least a portion but not an entire portion of such computer codes therein. Accordingly, a terminal may execute such a portion of the computer codes, may generate some of such images, sounds or other sensations for the VW, and may stream such images, sounds or other sensations to a HMD.

In this arrangement, a terminal may run some operations in the VW using a lock system of his terminal in a lock mode, and obtain results therefrom. Due to the physical or operational isolation therebetween, a user may not have to take risk of allowing malicious viruses to migrate [1] into his VW account, [2] into a main system of his terminal, or the like.

In a 4^{th} example of this 2^{nd} exemplary embodiment, a user's VW account may include its own lock system and its own main system each of which may be identical or similar to that of a user's terminal. Accordingly, a user may run operations with a lock system in his VW account in a lock mode when the user is not confident whether or not malicious viruses may be included [1] in a VW website which a user is to visit, [2] in a VW document which a user is to download, or the like. By physically or operationally isolating his VW main system from his VW lock system, a user may protect his main system in his VW account from such malicious viruses.

In a 5^{th} example of this 2^{nd} exemplary embodiment, a terminal includes a lock system and a main system, and a user's VW account also includes its own lock system and its own main system each of which may be identical or similar to that of a user's terminal. A user may run operations with a lock system in his VW account (or his terminal) in a lock mode when the user is not confident whether or not malicious viruses may be included [1] in a VW website which a user is to visit, or [2] in a VW document which a user is to download. By physically or operationally isolating his main systems in the terminal and VW respectively from his lock system in the terminal and VW account, a user may protect his main systems in his VW account and in his terminal from the malicious viruses.

In this example, a user may determine which operation to run with his lock systems in his terminal and in his VW account. Alternatively, a terminal may determine which operation to run with its lock system or with a lock system stored in a user's VW account.

### 9-1-3. Various Timings in a Terminal of a 3C VR System

In the 3^{rd} exemplary embodiment of this sixth exemplary aspect, various terminals of the 3C VR systems may run erase (or semi-erase) operations, mode-switching operations, launch operations, or turning-on operations in various timings.

In a 1^{st} example of this 3^{rd} exemplary embodiment, a terminal (or a VR server or a HMD) may run an erase (or semi-erase) operation in one of various erasure timings which have been described above.

In addition, a terminal may run an erase (or semi-erase) operation in one of additional erasure timings such as, e.g., [1] after completing to run one operation in a VW and before starting to run another operation in the VW, [2] upon, during or after a user switches from a lock mode to an unlock mode in a VW, [3] upon or after a user leaves a VW (e.g., a user exits his VW account in the VW, turns off a VR system (or HMD), or takes off a HMD from his head), [4] upon or after a user leaves a RW (e.g., a user enters a VW, a user is allowed to enter his VW account, a user puts and turns on a HMD, or the like), [5] after processing information obtained in the VW, [6] upon or after a user terminates coupling between a VR server and a HMD, or the like.

In a 2^{nd} example of this 3^{rd} exemplary embodiment, a terminal (or a VR server or a HMD) may launch (or run a launch operation of) a lock, intermediate or main system, respectively, in a lock, intermediate or unlock mode, in one of such launch timings which have been described above.

A terminal may also launch a certain system in one of additional launch timings such as, e.g., upon or after a user [1] enters a VW, [2] a user is allowed to access his VW account, [3] enters a RW, [4] puts and turns on a HMD, [5] connects a HMD to a server or a terminal, [6] connects a terminal to a server or a HMD, [7] switches from one mode of a VW account to another mode of the account when a user is granted a lock system and a main system in his VW account, or the like.

In a 3^{rd} example of this 3^{d} exemplary embodiment, a terminal may run a (user) authentication in one of such authenticating timings which have been described above.

A terminal may run authentication operations in one of additional authenticating timings such as, e.g., upon or after a user [1] turns on a HMD, [2] connects a HMD to a server, [3] connects a terminal to a server or a HMD, [4] enters a VW, [5] is allowed to enter his VW account), [6] switches from a lock mode of a VW account into an unlock mode of the account when a user is granted a lock system and a main system in his VW account, [7] sends information which he obtains by running operations in a VW to a lock system of a terminal, [8] stores (or attempts to store) information (obtained by running operations in a VW) from the VW into a lock system of a terminal either temporarily or permanently, or the like.

Although above examples of the erasure timings, launch timings or authenticating timings have been provided in the perspective of the terminal, the same or similar erasure timings, launch timings or authenticating timings may be provided in the perspective of the server or the HMD.

### 9-2. 6^{th} Configuration—Two-Component (2C) VR System

### 9-2-1. Configuration of a Two-Component (2C) VR System

In the 4^{th} exemplary embodiment of this sixth exemplary aspect, a VR system may include a HMD and one of (1) a VR server and (2) one of various terminals of this disclosure. Such a VR system may be referred to as a “two-component VR system” or as a “2C VR system” hereinafter. It is noted that a main role of a VR server of the 3C VR system is to render computer codes which may simulate an environment of a VW. Therefore, in this 2C VR system, such computer codes may be [1] incorporated solely into a server, [2] incorporated solely into a terminal, [3] incorporated solely into a HMD, [4] distributed into a server and a terminal, [5] distributed into a server and a HMD, [6] distributed into a HMD and a terminal, or [7] distributed into a server, a terminal, and a HMD.

It is appreciated in such distributions of [4] to [7] of the preceding paragraph that [1] different portions of such computer codes are distributed into two of a server, a HMD, or a terminal, [2] some portions of such computer codes may be redundantly distributed into two of such, or [3] the same portions of such computer codes may be redundantly distributed into two of three.

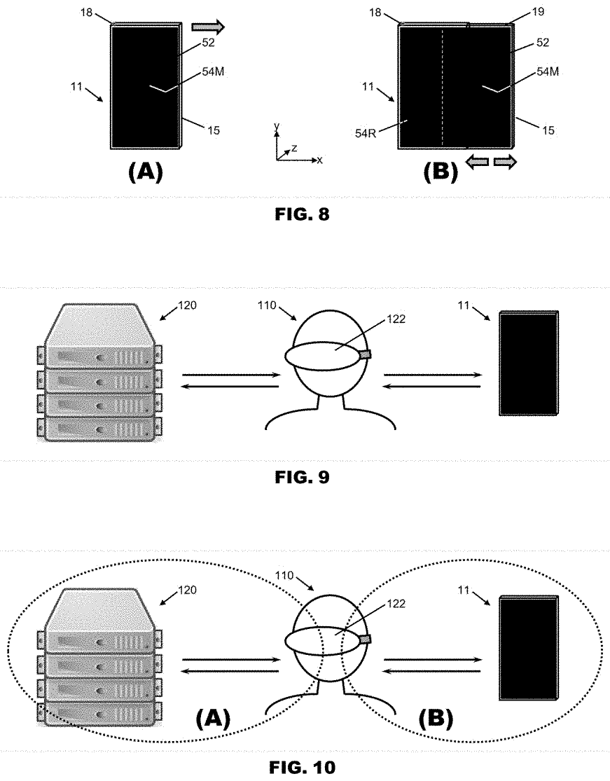

FIG. 10 is a schematic view of an exemplary two-component VR system of this 4^{th} exemplary embodiment, where the VR system may include a head-mounted display (HMD) and one of (1) at least one server (120) and one of various terminals which have been described in this disclosure.

In a 1^{st} example of this 4^{th} exemplary embodiment, a two-component VR system may include a HMD (122) and a VR server (120), as exemplified by a broken line designated as (A). In this example, the computer codes for simulating a VW may be included [1] solely in a server (120), [2] solely in a HMD (122), or [3] in a server (120) and a HMD (122) in one of the above distribution patterns.

In a 1^{st} case of the 1^{st} example, a server (120) may include a VW lock system as well as a VW main system in a user's VW account in order to protect the 2C VR system from malicious viruses which may infiltrate a VW. The lock and main systems in the user's VW account may be respectively similar or identical to the lock and main systems of such terminals exemplified in this disclosure.

In the alternative, a HMD (122) may include a HMD lock system and a HMD main system therein in order to protect the 2C VR system from malicious viruses which may infiltrate a VW. The HMD lock and main systems may be respectively similar or identical to the lock and main systems of various terminals exemplified in this disclosure. In the alternative, neither a server (120) nor a HMD (122) may not include a lock system and a main system therein. Rather, the server (120) or HMD (122) may manipulate the terminal (11) to run a lock system in order to protect the 2C VR system from malicious viruses which may infiltrate a VW.

In a 2^{nd} example of this 4^{th} exemplary embodiment, a two-component VR system may include a HMD (122) and a terminal (11), as exemplified by a broken line designated as (B). In this example, such computer codes for simulating a VW may be included [1] solely in a HMD (122), [2] solely in a terminal (11), or [3] in a terminal (11) and a HMD (122) in one of the above distribution patterns.

### 9-2-2. Operating a Two-Component (2C) VR System

As described above, any information which a user obtains in the VW may include malicious viruses or codes, just like the information which the user may obtain from a suspicious website. In the 5^{th} exemplary embodiment of this sixth exemplary aspect, a user may use his two-component VR system to protect his VR account and a main system of the terminal.

In a 1^{st} example of this 5^{th} exemplary embodiment, a VR system may connect to (or operationally couple with) a lock system of a terminal (11). For example, by physically or operationally isolating the lock system of the terminal (11) from a HMD (122) or server (120), a VR system can prevent malicious viruses included in those results obtained by running lock operations with the lock system of the terminal (11) from migrating into the server (120) or HMD (122) as well as the main system of the terminal (11).

In a 2^{nd} example of this 5^{th} exemplary embodiment, a HMD (120) may provide a user with a HMD lock system and a HMD main system in a user's VW account, where the VW lock and main system in the user's account may be respectively similar or identical to the lock and main systems of various terminals of this disclosure. By physically or operationally isolating such a lock system from a main system of the terminal (11), a HMD (122) or a server (120), a VR system can prevent malicious viruses included in those outcomes obtained by running lock operations with the lock system of the HMD (120) from migrating into [1] a main system of the HMD (122), [2] a main system of the terminal (11), [3] a user's VW account, or the like.

In a 3^{rd} example of this 5^{th} exemplary embodiment which may correspond to a combination of the above 1^{st} and 2^{nd} examples. For example, a user's VW account may include a lock system and a main system, and a terminal may also include a lock system and main system.

A user may then run lock operations either in his VW account or using his terminal depending upon various criteria such as, e.g., [1] types of operations, [2] functions to be performed by such operations, [3] probability that malicious viruses may be included, or the like.

### 9-2-3. Various Timings in a Terminal of a 2C VR System

In the 6^{th} exemplary embodiment of this sixth exemplary aspect, various terminals of the 2C VR systems may run erase (or semi-erase) operations, mode-switching operations, launch operations, or turning-on operations in various timings.

In a 1^{st} example of this 6^{th} exemplary embodiment, a server (providing a user with a VW lock system and a VW main system), a HMD (providing a user with a VW lock system and a VW main system) or a terminal may run an erase (or semi-erase) operation in one of various erasure timings which have been described above. A server, a HMD or a terminal may also run an erase (or semi-erase) operation in one of such additional erasure timings as described in the 1^{st} example of Section 9-1-3.

In a 2^{nd} example of this 6^{th} exemplary embodiment, a terminal (or a VR server or a HMD) may launch (or run a launch operation of) a lock, intermediate or main system, respectively, in a lock, intermediate or unlock mode, in one of such launch timings which have been described above. A server, a HMD or a terminal may also launch a certain system in one of such additional launch timings as described in the 2^{nd} example of Section 9-1-3.

In a 3^{rd} example of this 6^{th} exemplary embodiment, a terminal may run a (user) authentication in one of such authenticating timings which have been described above. In addition, a server, a HMD or a terminal may also run authentication operations in one of such additional authenticating timings as described in the 3^{rd} example of Section 9-1-3.

### 9-3. 6^{th} Configuration—Single-Component (1C) VR System

In the 7^{th} exemplary embodiment of this sixth exemplary aspect, a VR system may only include a HMD which may serve as the HMD, server, and terminal of the three-component or two-component VR system. In other words, the HMD may render computer codes which may simulate a VW, and display such an image on a display unit, play sounds on a speaker, or optionally generate other visual, auditory or tactile sensations, or the like, thereby simulating a user's physical presence in the VW.

In addition, the HMD may include a lock system and a main system (and optionally an intermediate system) so that the HMD may run lock operations, obtain results while physically or operationally isolating the main system from the lock system while the HMD operates the lock system in the lock mode, and run erasure (or semi-erasure) operations in one of various erasure timings. As a result, further details of this 1C VR system are omitted herein.

Other configurational or operational features, their variations or modifications of various terminals of this sixth exemplary aspect [1] may apply to, [2] may be incorporated into, [3] may replace, [4] may be replaced by, or [5] may be combined with corresponding features of the same or different [1] aspect, [2] embodiment, or [3] example throughout this disclosure, as long as such application, incorporation, replacement, or combination does not contradict each other.

### 10. Further Operations

In the seventh exemplary aspect of this disclosure, various data processing terminals of this disclosure [1] may run various operations or perform various functions, [2] may be fabricated or provided in various configurations or arrangements, or [3] may operate in various sequences, where such operations, functions, configurations, arrangements or sequences may be different from those operations, functions, configurations, arrangements or sequences as provided hereinabove.

For example, such terminals may not (or may) drive certain hardware or software elements of a main (or lock) system, may not (or may) incorporate any new hardware or software elements into a terminal, may not (or may) execute any additional steps, or the like.

Such terminals may [1] run certain operation in different orders or sequences, or [2] drive certain hardware or software elements under different options. Following embodiments and examples are other data processing terminals which [1] may be constructed according to the same or different configurations, [2] may run the same or different operations in the same or different orders or sequences, or [3] may perform the same or different functions. This, the following configurations or operations may readily be incorporated into various terminals, their main systems, their lock systems, or to their various units, each of which have been disclosed hereinabove.

### 10-1. Representative Data Processing Terminal with a Lock System and a Main System

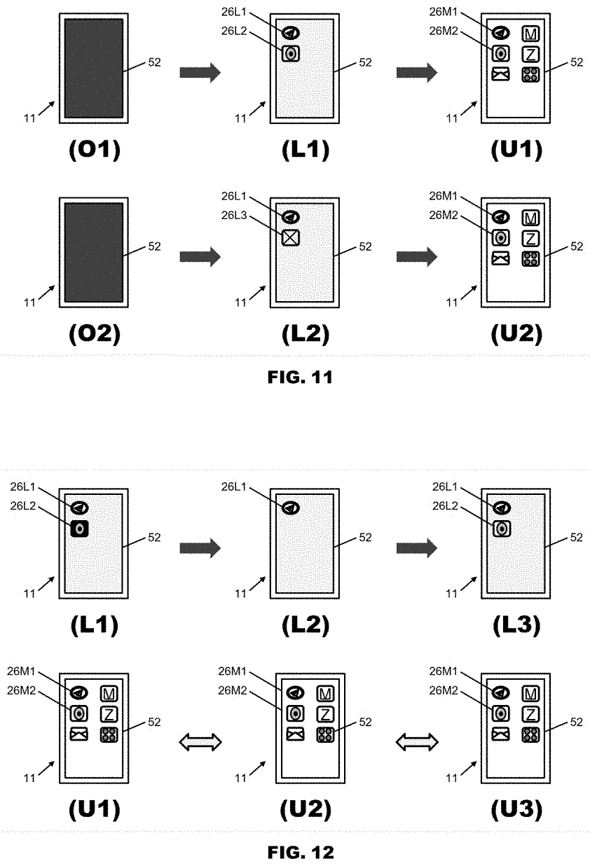

As described above, a data processing terminal of this disclosure may operate in numerous states or modes such as, e.g., [1] a powered-off state, [2] a powered-on state, [3] an off state, [4] an on state, [5] a lock mode, [6] an unlock mode, or [7] an optional intermediate mode. Following FIGS. 11 and 12 show various terminal operating in different states or modes.

FIG. 11 show top views of data processing terminals with their display units turned off (see Panels (O1) and (O2)), with their display units turned on and operating in lock modes (see Panels (L1) and (L2)), with their display units turned on and operating in unlock modes (see Panels (U1) and (U2)).

In Panel (O1), a terminal (11) may be [1] powered off (i.e., in a powered-off state), or [2] powered on (i.e., in a powered-on state) and in an off state in which the terminal (11) is communicable but a display unit (52) is turned off.

A terminal (11) may switch to a lock mode from [1] a powered-off state or [2] an off state. Once switching to a lock mode, a terminal (11) may display a lock screen on a display unit (52), along with at least one GUIs of lock hardware elements or lock software elements. In the case of Panel (L1), a terminal (11) may show GUIs of two lock apps (26L1), (26L2).

When a terminal (11) passes a user authentication or receives another user input, a terminal (11) may switch to an unlock mode from a lock mode. On or after switching to the unlock mode, a terminal (11) may display a home screen on a display unit (52), along with at least one GUI of main hardware elements or main software elements. In the case of Panel (U1), a terminal (11) may show GUIs of two main apps (26M1), (26M2) as well as four additional main apps, where two lock apps (26L1), (26L2) may correspond to these two apps (26M1), (26M2).

It is noted that a terminal (11) may directly switch from an off state to an unlock mode, when a user provides a user input to the terminal (11) in an off state, when the user input includes two (user) sub-inputs such as, e.g., UI_{SWI} and UI_{THEN}, and when the user passes the user authentication.

As described above, a terminal may generally give less access authority to a lock system operating in a lock mode than a main system operating in an unlock mode. This is also manifest in Panels (L1) and (U1), where a lock system operating in a lock mode displays a smaller number of GUIs of the lock apps on a display unit (52) in the lock mode, whereas a main system operating in an unlock mode displays greater number of GUIs of the main apps on the display unit (52).

It is appreciated that the lock apps (26L1), (26L2) which may be driven by a lock system in a lock mode are the same as or similar to two of the main apps (26M1), (26M2) which may be driven by a main system in the unlock mode.

As described hereinabove, the lock apps (26L1), (26L2) respectively “correspond” to the main apps (26M1), (26M2), where this correspondence may mean one of the followings three examples.

In the 1^{st} example of this correspondence, at least one lock app may [1] run the same operations as at least one main app (i.e., a corresponding (main) app) or [2] perform the same functions as at least one main app (i.e., a corresponding (main) app), or the like.

In the 2^{nd} example of this correspondence, at least one lock app may [1] run a smaller number of operations than at least one main app (i.e., a corresponding (main) app), or [2] perform a smaller number of functions than at least one main app (i.e., a corresponding (main) app).

In the 3^{rd} example of this correspondence, at least one lock app may run the same operations or perform the same functions, but may be given less options than at least one main app (i.e., a corresponding (main) app).

As exemplified in these three examples of this correspondence, that “at least one main app” may be referred to as the corresponding app of that “at least one lock app,” while that “at least lock one app” may be referred to as a corresponding app of that “at least one main app.”

Panel (O2) exemplifies a terminal (11) which is the same as that in Panel (O1). The terminal (11) may switch to a lock mode in response to the same user input or according to the same steps as exemplified in Panel (L1), except that a lock system may display two lock apps (26L1), (26L3), not those lock apps (26L1), (26L3) in Panel (L1).

Panel (U2) exemplifies a terminal (11) which switches to an unlock mode in response to the same user input or according to the same steps as exemplified in Panel (U1), except that a main system may not display a main app which corresponds to the lock app (26L3).

Similar to that in Panel (L1), a lock system in Panel (L2) operating in a lock mode displays a smaller number of GUIs of the lock apps on a display unit (52), but a main system in Panel (U2) operating in an unlock mode displays a greater number of GUIs of the main apps on a display unit (52).

It is appreciated, however, that at least one of the lock apps displayed on a display unit in a lock mode may not correspond to any of the unlock apps displayed on the display unit in an unlock mode. In other words, a first set of lock apps driven by a lock system in a lock mode does not have to be a subset of another set of main apps driven by a main system in an unlock mode.

For example, Panels (O1), (L1), and U1) exemplify a case in which each lock app (i.e., the GUI of each lock app) displayed on a display unit in a lock mode corresponds to at least one of such main apps (i.e., the GUI of each main app) displayed on the display unit in an unlock mode. It is noted throughout this disclosure that a phrase “an app displayed on a display unit” means “a GUI of that app displayed on a display unit,” unless otherwise specified.

To the contrary, Panels (O2), (L2), and U2) exemplify a different case in which at least one of the lock apps (i.e., the GUIs of such lock apps) displayed on a display unit in a lock mode may not correspond to any of such main apps (i.e., the GUIs of such main apps) which are displayed on the display unit in an unlock mode.

In another case which is not exemplified in the figures, none of the lock apps (i.e., the GUIs of the lock apps) displayed on a display unit in a lock mode may not correspond to any of the main apps (i.e., the GUIs of the main apps) displayed on the display unit in an unlock mode. Conversely, none of the main apps displayed on a display unit in a lock mode may not correspond to any of the main apps displayed on the display unit in an unlock mode.

In another case, a lock system may display a greater number of apps on a display unit than a main system may display in an unlock mode. In this case, a first portion of lock apps displayed on a display unit in a lock mode may correspond to those main apps displayed on the display unit in an unlock mode, while a second portion of lock apps displayed on the display unit in a lock mode may not correspond to any of those main apps displayed on the display unit in an unlock mode.

FIG. 12 show top views of a data processing terminal which operates in lock modes (Panels (L1), (L2), and (L3)), which operates in unlock modes (Panels (U1), (U2), and (U3)), which may remove a lock app which is (or suspected to be) contaminated by malicious viruses, and which may then reload a new app such that a reloaded new app may [1] run the same or similar operations as the removed lock app, [2] perform the same or similar functions as the removed lock app, or the like. In this context, this “new lock app” may be referred to as the “reloaded lock app” or “reloaded app” hereinafter.

Panel (L1) exemplifies a terminal (11) operating in a lock mode and displaying two lock apps (26L1), (26L2) on a display unit (26). When a terminal (11) or a user detects that a certain lock app (26L2) is contaminated by malicious viruses or the certain lock app (26L2) may be suspected of such contamination, the terminal (11) may remove the contaminated or suspicious lock app (26L2) as exemplified in Section 1-6 and elsewhere throughout this disclosure. A terminal (11) may run a removing operation [1] automatically (e.g., by itself upon detecting such an app) or [2] in response to a user input for starting the removing operation.

Panel (L2) exemplifies the terminal (11) of Panel (L1) in which the contaminated lock app (26L2) has been removed. Therefore, the terminal (11) may only display a single lock app (26L1) on a lock screen displayed on a display unit (26) in a lock mode, while the removed lock app (26L2) is not displayed thereon in the lock mode.

Panel (L3) exemplifies the terminal (11) of Panel (L2) which has been reloaded with a new lock app (26L2) which corresponds to the contaminated and removed lock app. Accordingly, a user may [1] run the same (or similar) operations which the contaminated and removed lock app used to run before such contamination, or [2] perform the same (or similar) functions which the contaminated lock app used to perform before such contamination. Details of the removing or reloading have been exemplified in Section 1-6 and elsewhere throughout this disclosure.

During such removing or reloading, a terminal (11) may display the lock screen as shown in Panels (L2) and (L3). Or a terminal (11) may show a default screen or another screen during such removing or reloading.

During such removing or such reloading, a terminal (11) may drive [1] a lock system, [2] a main system, or [3] another system which is neither the lock system nor the main system.

Although not shown in the figures but as described above, a terminal (11) may remove an entire lock system, regardless of how may lock apps may have been (or suspected) to be contaminated by the malicious viruses. In this case, a terminal (11) may run a removing operation or a reloading operation by driving a main system or another system which may be neither the lock system nor the main system. The terminal (11) may display a default screen or another screen during such removing or reloading.

Still referring to FIG. 12, Panels (U1), (U2), and (U3) exemplify the terminals (11) operating in unlock modes. For example, while a terminal (11) operates in a lock mode (see Panel (L1)), a main system of the terminal (11) still includes a main app (26M2) which corresponds to a lock app (26L2), Therefore, when a terminal (11) switches from the lock mode of Panel (L1) to an unlock mode (see Panel (U1)), the terminal (11) may display the GUIs of the main apps on a home screen, where one of the main apps (26U2) corresponds to the lock app (26L2) which was displayed on a lock screen in a lock mode (see Panel (U1)).

Similarly, before, during or after a terminal (11) may remove the contaminated lock app (26L2) from a lock system (see Panel (L2)), a main system of the terminal (11) still includes a main app (26M2) corresponding to the contaminated or removed lock app (26L2), Therefore, when a terminal (11) switches from a lock mode of Panel (L2) to an unlock mode before, during or after the removing (see Panel (U2)), the terminal (11) may display the GUIs of the main apps on a home screen, where one of the main apps (26U2) corresponds to the lock app (26L2) [1] which was contaminated but displayed on a lock screen in a lock mode, [2] which is being removed from a lock system during such removing, [3] which has been removed from the lock system after such removing, or the like.

Similarly, during or after a terminal (11) reloads a lock app which replaces the contaminated or removed lock app (see Panel (L3)), a main system of a terminal (11) still includes a main app (26M2) corresponding to the contaminated, removed or reloaded lock app (26L2), Accordingly, when a terminal (11) switches from a lock mode of Panel (L3) to an unlock mode (see Panel (U3)), the terminal (11) may display the GUIs of the main apps on a home screen, where one of the main apps (26U2) corresponds to a new, reloaded lock app (26L2) which may [1] run the same or similar operations as the removed lock app or [2] perform the same or similar functions as the removed lock app.

It is noted that the removed lock app had been loaded to a lock system and a user had run lock operations before the lock app was contaminated by the malicious viruses. When a terminal detects that the lock app or lock system is contaminated by such viruses or the results include such viruses, the terminal removes the contaminated lock app and load a new lock app into the lock system. In this context, that lock app is referred to be reloaded into the lock system throughout this disclosure.

### 10-2. Hardware/Software Configurations and Implementations

Different types of lock systems, their constituent units, and their hardware or software elements have been disclosed heretofore, particularly in conjunction with the 1^{st} to 6^{th} Configurations. It is appreciated, however, that such units of various lock systems do not necessarily have to be implemented into or inside various data processing terminals of this disclosure as have been exemplified above.

Accordingly and in the 1^{st} exemplary embodiment of a seventh exemplary aspect of this disclosure, various hardware elements of a lock system may be [1] provided as or [2] incorporated into an external device which may physically or operationally couple with a terminal (or its main system). To this end, various lock software elements or a lock O/S may be optionally loaded onto the external unit, where the external unit may include an add-on device, a portable device, or a wearable device.

Accordingly, a lock viewer as exemplified in the 1^{st} Configuration, a lock memory unit as exemplified in the 1^{st} or 2^{nd} Configuration, or an embedded or isolated lock CPU portion of the 3^{rd or} 4^{th} Configuration may easily be fabricated as (or incorporated into) an external device [1] which may be physically and releasably coupled to a port or a receptacle provided in a terminal, or [2] which may operationally couple with a terminal through wireless communication, without having to make any physical connection.

More particularly, an external device may serve as [1] a lock viewer capable of presenting data or files in a format friendly to a user in a lock mode, [2] a lock CPU unit capable of driving various hardware or software elements of a lock system or, when allowed by a terminal, capable of driving various hardware or software elements of a main system, or [3] a lock memory unit capable of providing an extra memory sector to a lock system or to a main system in a restricted mode). An external device may instead serve as a lock system which includes a lock memory unit or a lock CPU unit capable of providing an extra memory sector, providing only a selected (or an entire) functionality of an O/S of a main CPU unit, or a certain (software) application.

A terminal and external device may be releasably coupled to each other in various means to provide physical coupling, with or without an operational coupling. In one example, a terminal may include a receptacle or a port with which a terminal may releasably or fixedly receive an external device. In another example, a terminal may include a mechanical holder with which a terminal may releasably embrace, hold or otherwise couple to an external device. In another example, a terminal and external device may releasably couple with each other by a magnetic coupling, e.g., by disposing a magnet and a ferromagnetic material on or around a terminal and an external device, and by arranging magnetic poles for such coupling.

It is noted that such magnets or magnetic materials may be disposed in a position which may not interfere with hardware elements of a terminal, e.g., away from a main CPU unit, a main memory unit, an embedded lock CPU portion, or an embedded lock memory portion. As long as an external device may releasably couple with a terminal and communicate with a terminal by wire or wirelessly, detailed mechanisms of such coupling are a matter of choice of one of ordinary skills in the relevant art and, therefore, omitted herein.

It is appreciated that such external devices may be provided as (or incorporated into) a portable device or as a wearable device which may communicate with a terminal wirelessly and serve as a lock memory unit (or portion), a lock CPU unit (or portion), or a lock input (or output) unit. Accordingly, a user may use a terminal, while using a wearable device or add-on device as a lock system. Various lock units may be fabricated as or incorporated into any external devices examples of which have been provided in Section 4-3-2 and others.

Instead of using the external device as a lock unit (or its portion), an external device may instead be used as [1] an authenticating device capable of providing authentication (user) sub-inputs, [2] a mode-switching device capable of providing a mode-switching (user) sub-input, or the like. That is, an external device may provide a terminal with an authentication (user) sub-input or a mode-switching (user) sub-input based on various criteria such as, e.g., [1] when an external device approaches a terminal within a certain distance, [2] when an external device may move at a certain linear or angular speed, in a certain direction, or at a certain acceleration, [3] when an external device receives a certain user input which includes a certain (user) sub-input, [4] when an external device contacts a terminal, or [5] when an external device monitors a certain movement of a user (or a non-user object). Therefore, when a user provides a user input to switch to an unlock mode, a terminal may authenticate a user with his or her fingerprint as well as a presence of an external device (e.g., a watch) around a terminal, a distance from an external device to a terminal, or the like.

An external device may instead be used as, e.g., an anti-authentication device, such that, an external device may prevent a terminal from advancing to a mode with more access authority. For example, when an external device (e.g., a ring) is disposed within a certain distance, a terminal may prevent a user from [1] switching from a current mode to an unlock mode, [2] switching from a current mode to a new mode granted with more access authority than the current mode, or [3] switching from the current mode to any new mode, regardless of whether or not a user's authentication information or (user) sub-input (e.g., a fingerprint, an iris or voice) is correct. This arrangement may be beneficial to a user, particularly in a situation when a user may not want to access a certain mode of his or her terminal in a certain environment. In this case, a user may hold his or her terminal with his or her hand with a ring. Thereafter, a terminal will not allow the authenticated user from switching to that specific mode, to a specific new mode granted with greater access authority or to any mode, as long as the hand with a ring is not removed away from a terminal more than a preset distance.

In addition, an external device may communicate with a main system disposed inside a terminal through wire or via wireless communication. Accordingly, a terminal may use various wireless communication technologies such as, e.g., a Wi-Fi, a Bluetooth, a Wi-MAX (a world-wide interoperability for microwave access), a WLAN (wireless local area network), an NFC (near field communication), a ZigBee, or the like, where details of such technologies are well known to one of ordinary skill in the art and, therefore, are omitted herein. When desirable, a terminal may use other communication technologies such as, an IR (infra-red) communications or others as commonly used in prior art wireless communication devices.

This configuration may provide various advantages to a user, for a user may prepare multiple USBs (or external memory chips or devices which can couple with a terminal) each of which may be specifically configured to work as a lock viewer, a lock CPU unit, a lock memory unit, or a lock system for only a certain mode of operation, while each of such external devices may not work in a different mode other than the mode pre-selected by a user.

By the same token, a user may prepare multiple USBs each of which may be specifically configured to operate only in a certain mode such that a user may use each USP as an individual lock (or unlock) system which is, however, different from those of other USB's.

In addition, each of multiple users may prepare his or her own USB which is loaded with desired lock units such that each individual user may run different lock operations in his or her own restricted mode by coupling his or her own USB, without worrying about accidently disclosing his or her private information to other users.

In the above examples, each external device may require a user to provide an authentication (user) sub-input or other authentication information such that, e.g., an external device may include an authentication input unit. In the alternative, a terminal may synchronize the external device with a main system of a terminal in such a way that a main system runs an authentication operation in order to verify whether a user who is coupling the external device to a terminal has a proper access authority, or the like.

In addition, the above external devices may be configured that they may run such erasure (or semi-erasure) on its own (or by a terminal) onto an entire (or only a selected) portion of results stored therein when certain events happen. In one example, an external device may monitor whether or not a current user fails the user authenticating, and then run such erasure (or semi-erasure) when a user fails such authenticating once (or for a certain number of times).

In another example, a terminal may monitor whether or not a current user fails user authentication, and then may run such erasure (or semi-erasure) when a user fails such authenticating once (or for a certain number of times). Accordingly, an authorized user may ensure that any unauthorized user may not easily access any data or results stored in such an external device.

In another example, various computer codes may be loaded into an external device fabricated as a “plug-in” in such a way that a main O/S may drive such computer codes contained in a plug-in. As a result, a terminal may use such computer codes by driving them as software applications of a lock system (or a main system).

This configuration offers various benefits to a user, for the user may prepare an external device loaded with a certain plug-in which, when coupled to a lock (or main) system, may run additional operations, and perform specific functions which may not be available by an existing main (or lock) O/S or other (software) applications. A terminal may also use various themes, skins or widgets instead of or in conjunction with [1] such plug-ins or [2] other forms of the external devices. As a result, a user may be able to customize various software elements of a main (or lock) system of a terminal. Of course, it is desired that such plug-ins may be compatible with a main (or lock) O/S or (software) applications of a main (or lock) system.

In another example, a terminal may run such erasure (or semi-erasure) onto at least a portion of such results which may be stored or reside in a lock system or which are obtained from running lock operations in a lock mode in various ways and in various “timings” other than those described above, where such a lock system may be disposed inside a terminal or may be provided as (or incorporated into) an external device.

In one case, a terminal may run such erasure (or semi-erasure) onto a lock system as it similarly does onto any lock system in such timings as described above. In another case, a terminal may run such erasure (or semi-erasure) onto a lock system of an external device when a user may intentionally or accidently unplug or uncouple the external device from a terminal, regardless of whether or not a user is finished with operating a lock system or running lock operations in a lock mode. In the latter case, a terminal may not run such erasure (or semi-erasure) with an external device and, therefore, the external device may include a minimum power supply as well as a lock CPU unit equipped with a minimum functionality.

In another case, a terminal may run such erasure (or semi-erasure) onto a lock system while using an external device such as, e.g., [1] whenever a user provides a user input commanding a terminal to run such erasure (or semi-erasure), [2] when a user finishes a session after driving certain (software) applications, or [3] when a user finishes driving certain (software) applications. A terminal may run such erasure (or semi-erasure) when a user who operates a lock system which resides in an external device may then [1] start to operate a new system loaded into the same external device, [2] start to operate a new system loaded into a main system, or the like. A terminal may also run such erasure (or semi-erasure) when a user plugs an external device into a terminal or couples an external device to such a terminal.

That is, a terminal may run the erasure (or semi-erasure) for erasing (or semi-erasing) any unnecessary or unreliable results stored or residing in an external device and keeping such an external device clear of any malicious computer codes or viruses. Thus, a terminal may erase an entire (or only a selected) portion of such results residing or stored in an external device after running lock operations in a lock mode. Or a terminal may erase the portion of results which reside (or are stored) in a lock system, whenever a user finishes using an external device in a lock mode, or may erase such a portion before using an external device or during use.

As described above, an external device may include a lock viewer, a lock CPU unit, a lock memory unit, or a lock input (or output) unit of a lock system. It is appreciated that an external device may also be fabricated in different forms. As described in Section 4-3-2, an external device may be fabricated as an add-on device which may be fabricated as [1] a protector of a terminal, [2] its holder, [3] its case, or [4] its cover which may enclose at least a portion of a terminal, [5] a USB-type memory (with or without a driver), [6] an external memory chip (or card) (with or without a driver), [7] a portable memory chip or card (with or without a driver), [8] any other prior art memory chip (or device), or the like.

More particularly and as to the above [1] to [4], an external device may enclose at least a portion of a bottom surface of a terminal when a terminal disposes a display unit on its front surface, or may enclose a different surface of a terminal. An external device may mechanically and electrically couple with a terminal by a port or a connector, or may operationally couple therewith by wireless communication. When an external device may electrically couple with a terminal through electrical contacts, an external device may be powered by a terminal or may receive power wirelessly therefrom. Alternatively, an external device may include its own power supply as well, where the power supply may be a disposable battery, a rechargeable battery, a solar cell, or the like.

In addition, an external device may also be fabricated as a film which can be attached onto a front surface of a terminal such as, e.g., a film which can be releasably coated on such a surface. Because a film is provided as a thin layer, the film may include minimum functionality to operate as a lock CPU unit, a lock memory unit, or a lock input unit. The film may receive electrical power from a power supply of a terminal or wirelessly, may receive power from sun lights or from light rays emanating from a display unit, or may receive thermal energy from a display unit and then convert such into electrical energy. The film may also include its own battery.

In another example, an external device may be formed as an ornamental object of a terminal, where examples of such objects may include, but not limited to, a pendant, a handle, a strap, a tag, a holder, a protector, or anything which may be coupled to a terminal. Other configurational or operational features of such ornamental external device are similar or identical to other external devices such as various add-on devices, or the portable devices as described in this Section and Section 4-3-2 and, therefore, omitted herein.

### 10-3. Mode Switching in Inactivated and Unloaded Terminals

In the 2^{nd} exemplary embodiment of a seventh exemplary aspect of this disclosure, a terminal may switch a mode (of operation) in response a user input which may include a mode-switching user sub-input (UI_{SWI}). For example and in operations of each of the above Configurations, a user may provide a 1^{st} user input to a main input unit, where a 1^{st} user input generally includes an activation user sub-input (UI_{ACT}), while a terminal is in its powered-on state and in its off-state (i.e., when a terminal is in its inactive state). In response to the 1^{st} user input, a terminal runs an operation of turning on a display unit, and launches a lock system in a lock mode in various turning-on timings as defined above.

It is appreciated that timings of such “turning on” (i.e., turning timings) may include [1] an instance when a display unit is actually turned on, [2] an instance when a display unit starts to turn on, or [3] an instance when a terminal starts to prepare such turning on. When desirable (or required), a terminal may optionally run at least one additional operation in a lock mode, where examples of such additional operations may include, e.g., an operation of authenticating a user, or an operation of advancing to a certain mode of operation.

In addition to the turning on, a terminal also prepares to run various operations in one of multiple modes as defined in a hierarchy by launching a certain system which is to operate in such a mode. As defined in Section 4-3, a terminal may launch a lock (or main) system in one of various launch timings.

More particularly, when a terminal receives a 1^{st} user input in its off-state and when a terminal is to switch to a lock mode, a terminal may launch a lock system in various timings such as, e.g., [1] concurrently with such mode switching, [2] immediately after the mode switching, [3] after such mode switching but before a user provides another user input, [4] upon receiving a user input which includes UI_{SWI}, [5] immediately before such turning on, [6] concurrently with such turning on, [7] immediately after turning on, or the like. As described above, however, a 1^{st} user input does not have to necessarily include UI_{SWI} therein to switch to a certain mode from an off-state, particularly when such mode switching is conditioned upon other operations such as, e.g., an authentication operation.

Once a lock system is launched and begins to operate in a lock mode, a user may run lock operations. When a user is finished with running such lock operations and wants to switch from a current lock mode to a new unlock mode, a user may provide a 2^{nd} user input including a mode-switching (user) sub-input (UI_{SWI}) to a mode-switching input unit.

When a user is finished with running such lock operations and wants to switch from a current lock mode to a new unlock mode, a user may provide a 2^{nd} user input including a mode-switching (user) sub-input (UI_{SWI}) therein to a mode-switching input unit. It is appreciated that the mode-switching input unit may be the same main input unit or may be incorporated into a main input unit which receives the 1^{st} user input. Alternatively, a mode-switching input unit may be a separate input unit which may have a shape, a size, an orientation, a disposition, or an operating mechanism which may be similar to or different from those of a main input unit.

Upon receiving the 2^{nd} user input, a terminal selects whether to stay in a current mode or to switch to a new mode. When a terminal confirms UI_{SWI}, a terminal may switch to a new mode. However, a terminal may not be able to ascertain UI_{SWI} due to, e.g., an ambiguous user input, an incorrect user input, an undefined UI_{SWI} (e.g., the one which does not match any mode listed in a matching list), an incorrect timing of providing a user input or UI_{SWI}, or the like.

In this case, a terminal may [1] keep its display unit turned on and do nothing in a lock mode, [2] provide a warning message or a warning signal to a user by displaying such a message or signal on a display (or notice) unit, [3] turn on its display unit and then provide a warning message or signal thereon, [4] provide audible or tactile warning signals to a user while keeping a display unit turned off, or the like.

After a terminal confirms UI_{SWI}, a terminal may switch from a current mode to a new mode, while running an erase (or semi-erase) operation, particularly when a new mode is granted with more access authority than a current mode. A terminal may also run such erasure (or semi-erasure) in one of such erasure timings as well. When a terminal runs the semi-erasure, a terminal may [1] just leave to-be-saved results in a lock system, with or without storing such results in a lock memory unit (or sector) or [2] actively store to-be-stored results into a lock memory unit (or sector).

This exemplary embodiment may require an (almost) automatic turning on of a display unit in response to a user input and, therefore, apply to a terminal which does not condition such turning on a display unit upon an outcome from running an authentication operation. That is, this embodiment may not apply to a terminal which runs an authentication operation in an off-state, and then turns on a display unit when a user passes such authenticating, which but does not immediately turn on a display unit when a user fails the authenticating. This conditioning arrangement may still incorporate such erasure (or semi-erasure) as well, e.g., by running such erasure (or semi-erasure) whenever a user attempts to authenticate himself or herself, regardless of whether or not the user passes such authenticating.

In another exemplary embodiment of a fifth exemplary aspect of this disclosure which is similar to the above exemplary embodiment, a terminal may switch modes after authenticating a current user by running at least one authentication operation. Accordingly, a terminal may receive a 1^{st} user input with an input unit in its off-state. In response to the 1^{st} user input including UI_{THEN}, a terminal runs an authentication operation.

When the 1^{st} user input also includes UI_{ACT}, a terminal may turn on its display unit before, concurrently with or (immediately) after running (or starting to run) an authentication operation. When a terminal finishes turning on a display unit before finishing an authentication operation, it may launch a lock system and display a lock screen (or a different default screen) on a display unit in a lock mode.

When a terminal completes an authentication operation before finishing turning on a display unit, a terminal may still launch a lock system in a lock mode, while displaying a lock screen on a display unit in a lock mode. When a user passes the authenticating, a terminal may launch a main system in an unlock mode and display a home screen, e.g., by replacing an existing lock screen with a home screen or by overlaying a home screen over a lock screen. When the 1^{st} user input includes UI_{SWI}, a terminal may acquire UI_{SWI} therefrom and, based thereon, switch from a lock mode to a new mode as described above.

When a user fails an authentication operation, a terminal may [1] keep a display unit turned off, [2] turn on a display unit and then display a lock screen on a display unit in a lock mode, or [3] keep a display unit turned off, and then perform the above [2] upon detecting an occurrence of a certain event such as, e.g., [3-1] when a user keeps providing a single user input (e.g., not completely detaching or removing his or her finger from an input unit) for a period longer than a preset threshold, [3-2] when a user concurrently provides a new (user) sub-input such as a new UI_{THEN} and or another new (user) sub-input (e.g., moving a body part while maintaining a contact with such an input unit) which may qualify as UI_{THEN}, [3-3]when a user provides multiple sequential user inputs (e.g., repeating to provide the same or different user inputs), or the like. It is appreciated that, when a terminal requires such user authenticating, a terminal may receive a 2^{nd} user input which includes UI_{THEN} and then runs an authentication operation based thereon.

When a 1^{st} user input does not include UI_{ACT}, a terminal may not have to turn on its display unit until it finishes the user authenticating. While waiting for an outcome from such user authenticating, a terminal may [1] keep its display unit turned off, or [2] turn on a display unit in a lock mode, while displaying a lock screen on a display unit. When a user passes the authenticating, a terminal may launch a main system in an unlock mode, while overlaying a home screen over a lock screen or replace a lock screen with a home screen. When a user fails such authenticating, a terminal may [1] keep a display unit turned off, [2] turn on a display unit and display a lock (or default) screen on a display unit in a lock mode, or the like.

Even when a user fails an authentication operation, a terminal may turn on its display unit, based on various criteria. For example, a terminal may turn on a display unit as far as a preset condition is met such as, e.g., [1] when a user manipulates (e.g., presses, touches, or contacts) an input unit more than once, [2] when a user manipulates an input unit for a period longer than a threshold, [3] when a user may not supply a certain user input or any additional user input within a certain period of time, or the like. Alternatively, when a user input includes UI_{ACT}, a terminal may be configured to turn on a display unit anyway, even when a terminal may have to run an authentication operation.

### 10-4. Storing and Processing Results Obtained in Lock Mode

Prior to, concurrently with, or immediately after such mode switching, however, a terminal may run such semi-erasure by erasing to-be-erased results which is stored or which reside in a lock system, [1] while storing to-be-stored results, or [2] while not actively erasing such to-be-stored results. A user may want to keep such to-be-stored results for various reasons such as, e.g., [1] a user may want to review such to-be-stored results in the future, e.g., when a user operates a lock system in a lock mode in the next session, [2] a user may want to run more lock operations in the next session while using such to-be-stored results obtained in a current lock session, or [3] a user may want to process such to-be-stored results after he or she switches to a new mode.

Therefore and in the 3^{rd} exemplary embodiment of a seventh exemplary aspect of this disclosure, a terminal may store some of such results (i.e., to-be-stored results) into a lock (or main) memory unit in various ways. In a 1^{st} example of this 3^{rd} exemplary embodiment, a user may store to-be-stored results in a lock memory unit or in a temporary memory sector in a lock system. Once switching to an unlock mode, a user may drive a main unit in an unlock mode, and (1) access such to-be-stored results in a lock system, (2) retrieve such to-be-stored results by a main unit, and then (3) process such to-be-stored results with a main system in an unlock mode. In short, a user stores such to-be-stored results into a lock system using a lock system before such mode switching, and thereafter processes such to-be-stored results using a main system in an unlock mode after such mode switching.

In a 2^{nd} example of this 3^{rd} exemplary embodiment, a user may store such to-be-stored results not into a lock system but into a main system (e.g., a main memory unit) using a lock system while still operating in a lock mode. After switching to an unlock mode, a user may (1) access such to-be-stored results in a main system, (2) retrieve such to-be-stored results from a main system, and then (3) process such to-be-stored results with a main system in an unlock mode. In short, a user stores such to-be-stored results into a main system using a lock system in a lock mode, and thereafter processes such to-be-stored results using a main system in an unlock mode after such mode switching.

In a 3^{rd} example of this 3^{rd} exemplary embodiment, a user may still store such to-be-stored results in a main system, but not into a main memory unit but into a temporary memory sector in a main system while operating in a lock mode. After switching to an unlock mode, a user may then (1) access such to-be-stored results in a temporary memory sector, (2) retrieve such to-be-stored results therefrom, and (3) process such to-be-stored results with a main system in an unlock mode. In short, a user stores such to-be-stored results into temporary memory sector of a main system using a lock system in a lock mode, and thereafter processes such to-be-stored results using a main system in an unlock mode after such mode switching.

In all of such examples, not a user but a terminal may select which results are to be saved, particularly when a terminal may analyze user statistics or external circumstances and predict which results a user may desire to store. In addition, while a user may run various operations described in such examples of this section, a terminal may also run such erasure onto the to-be-erased results in one of such erasure timings.

### 10-5. Mode Switching in Inactivated but Loaded Terminals

A terminal is inactivated and in an off-state [1] when a user turns off a display unit after use or [2] when a terminal turns off its display unit due to a non-action by a user for a period longer than a certain period of time. A terminal may switch to the off-state from a lock mode as well as an unlock mode. Once inactivated, a terminal typically stops to drive a lock system or a main system. Therefore, when a user starts to operate a terminal again thereafter, a terminal has to launch again a main system in an unlock mode or launch a lock system in a lock mode.

To the contrary and in the 4^{th} exemplary embodiment of this seventh exemplary aspect of the disclosure, a terminal may continue to operate in an unlock (or lock) mode, even when a display unit is turned off in its powered-on state.

For example, before, while or (immediately) after a display unit is turned off, a terminal may store a certain step of a certain operation which a lock (or main) system has been operating in various ways such as, e.g., [1] by storing a pointer or a location of a pointer of the last step of the operation immediately before such turning off, [2] by storing certain data which may be associated with a lock (or main) system and which may provide information regarding the last step, [3] by storing data related to or resulting from launching such a system, or the like. Of course, a terminal may not completely unload a lock (or unlock) system even while its display unit is turned off.

Thereafter, when a terminal receives a 2^{nd} user input and acquires UI_{SWI} therefrom, a terminal may readily and immediately (1) resume operating a lock (or main) system, (2) locate the last step of the operation which the lock (or main) system had been running before its display unit had been turned off, and then (3) continue to run such an operation. That is, a terminal may allow a user (1) to conveniently resume to operate a system which he or she has been operating before turning off a display unit, without having to launch the same system again, and (2) to continue to run the operation which the user had been running before a display unit has been turned off.

A terminal may also resume to operate a lock (or main) system, by not necessarily acquiring UI_{SWI} but by acquiring UI_{ACT} or UI_{THEN}. A terminal may also be configured to resume to operate a lock (or main) system which a user has been operating, by providing a user input including UI_{ACT} or UI_{THEN} therein or, alternatively, to resume to operate a lock (or main) system as designated by UI_{SWI} as well. When a new mode designated by UI_{SWI} is different from the mode which the user had been operating, a terminal may have to launch a new system, while terminating the old system which the user had been operating before a display unit had been turned off.

When desirable, before launching one of such systems, a terminal may run the erasure or semi-erasure. This example may be useful, because results which had been stored or residing in a lock system may include contaminated data, viruses or fragments thereof, each of which may be detrimental to the integrity or security of a main system.

When desirable, a terminal may stay in an unlock mode when a display unit is turned off. When a user provides a user input while a display unit has been turned off, a terminal may launch a main system and allow a user to operate in an unlock mode. However, an easy entry into an unlock mode may be detrimental to the security or integrity of a main system. Therefore, it may be typically safer for a terminal to first launch (or resume to operate) a lock system instead of a main system.

### 10-6. Storing and Processing Data Obtained in Unlock Mode

While operating a main system in an unlock mode, a user may encounter situations where a user may [1] have to open unreliable folders, [2] have to access suspicious websites, [3] have to download questionable contents from an internet, or the like. In such situations, a user may desire to perform the above [1] to [3] with a lock system in a lock mode. Despite risks associated therewith, a user may desire to open such folders, access such websites, or download such contents. A user may [4] want to process data which are stored or residing in a main system in a lock mode with a lock system as well. Accordingly and in the 5^{th} exemplary embodiment of a seventh exemplary aspect of this disclosure, a terminal may allow a user to perform any of the above [1] to [4] with a lock system by readily switching to a lock mode.

To this end, a terminal may allow a user to transfer such unreliable folders, internet addresses of such websites, such contents, or such data to a lock system. For simplicity of illustration, such folders, addresses, contents, and data are to be collectively referred to as “main data” hereinafter.

In a 1^{st} example of this 5^{th} exemplary embodiment, a user may mark such main data using a main system in an unlock mode. Thereafter, a user may provide a terminal with a 1^{st} user input which includes UI_{SWI-1} which is designated to a lock mode. A terminal may transfer such main data to a lock memory unit with a main system in an unlock mode in various timings such as, e.g., [1] concurrently with acquiring UI_{SWI-1}, [2] (immediately) after acquiring UI_{SWI-1}, [3] (immediately) before switching to a lock mode, or [4] concurrently with switching to a lock mode. After a terminal switches to a lock mode, a user may retrieve such main data from a lock memory unit, and may begin to run various lock operations using a lock system in a lock mode and to process such main data. When a user is finished with processing such main data, a user may provide a terminal with a 2^{nd} user input which includes UI_{SWI}-2 designated to an unlock mode, thereby switching to an unlock mode.

In a 2^{nd} example of this 5^{th} exemplary embodiment, a user may mark the main data with a main system in an unlock mode, and then store such main data into a main memory unit using a main system in an unlock mode. A user may provide a terminal with a 1^{st} user input which includes UI_{SWI-1} designated to a lock mode. After a terminal switches to a lock mode, a user may retrieve such main data from a main memory unit using a lock system in a lock mode, and may begin to run various lock operations and to process the main data. When a user is done with processing such main data, a user may provide a terminal with a 2^{nd} user input with UI_{SWI-2} designated to an unlock mode, thereby switching to an unlock mode.

Instead of storing such main data concurrently with marking the main data, a terminal may instead store such main data to a main memory unit with a main system in an unlock mode in various timings such as, e.g., [1] within a certain period of time after a user marks such main data, [2] concurrently with acquiring UI_{SWI-1}, [3] (immediately) after acquiring UI_{SWI-1}, [4](immediately) before switching to a lock mode, or [5] concurrently with switching to a lock mode.

It is appreciated in the above 1^{st} and 2^{nd} examples that the 1^{st} and 2^{nd} user inputs may not necessarily include different UI_{SWI}'s therein, particularly when a hierarchy includes a single lock mode and a single unlock mode, and when a terminal may operate in a series switching. It is also appreciated that a user may mark such to-be-stored results using a lock system in a lock mode, and may then transfer such to-be-stored results as described in Section 8-3, where such to-be-stored results are obtained by running lock operations using a lock system in a lock mode, and where such to-be-stored results may (or may not) relate to such main data.

It is also noted that a terminal may employ variations or modifications of the above 1^{st} and 2^{nd} examples to process such main data using a lock system in a lock mode, as far as a lock system may access such main data in a lock (or unlock) mode, may retrieve such main data in a lock mode, and may process such main data in a lock mode.

In all of such examples, not a user but a terminal may select which main data are to be transferred to a lock system, particularly when a terminal may analyze user statistics or external circumstances and predict which main data a user may desire to process in a lock mode. In addition, while a user may run various operations described in such examples of this paragraph, a terminal may also run such erasure onto the to-be-erased results in one of such erasure timings.

### 10-7. Mode Switching in Activated and Loaded Terminals

In the 6^{th} exemplary embodiment of a seventh exemplary aspect of this disclosure, a terminal may switch a mode in various ways upon receiving a 2^{nd} user input and acquiring UI_{SWI} therefrom, while a user has been operating a lock (or main) system in a lock (or main) mode.

In the examples of Sections 8-2 and 8-3, a terminal received a 1^{st} user input in its off-state, and switched to a lock (or unlock) mode, while launching a lock (or main) system in a lock (or unlock) mode based on [1] UI_{SWI-1} or [2] an outcome of such user authenticating. A user then started to run various lock (or unlock) operations with the lock (or main) system in the lock (or unlock) mode. Thereafter, a user may provide a mode-switching input unit (or a main input unit) with a 2^{nd} user input, and acquire UI_{SWI-2} from the 2^{nd} user input. In response to thereto, a terminal may remain in the lock (or unlock) mode or may switch to the unlock (or lock) mode by employing various methods.

A terminal of this Section 10 may operationally couple a mode-switching operation with an authentication operation. For example, when a user fails such user authenticating, a terminal [1] may remain in a current mode, while not switching to a new mode, [2] may ask a user to provide a new user input, or [3] may turn off a display unit. A terminal may instead stop to operate a lock (or main) system to ensure that a terminal is no longer in a loaded state.

As a result, when a user turns on a display unit later, a terminal may not automatically resume to operate a lock system. In addition, regardless of an outcome from an authentication operation, a terminal may turn off a display unit when a preset condition is met (e.g., a user may not press, touch, slide, contact or otherwise manipulate an input unit more than once, for a period longer than a threshold, or the like).

When a user passes user authentication, a terminal may switch to a new mode designated by UI_{SWI}. A terminal may also run such erasure (or semi-erasure) in one of such erasure timings. It is appreciated that the terminals of this exemplary embodiment may keep their display units turned off in a lock mode. As a result, this embodiment may be useful in saving a battery power.

In the 7^{th} exemplary embodiment of a seventh exemplary aspect of this disclosure, a terminal may receive a 2^{nd} user input including UI_{SWI-2} when a terminal which has been in its off state may start to turn on its display unit in an unlock mode. A terminal may confirm UI_{SWI-2}, and switch from a current mode to a new mode, while running such erasure (or semi-erasure) in one of such erasure timings.

A terminal may condition a mode-switching operation upon an authentication operation so that a user who fails such authenticating may not switch from a current unlock mode to any other mode or that a terminal turns off a display unit. Upon such failure, a terminal may switch to a lock mode by launching a lock system or may instead unload an unlock system to ensure that a terminal is no longer in a loaded state.

In addition, regardless of an outcome obtained by running an authentication operation, a terminal may turn off a display unit when a preset condition is met (e.g., a user may not press, touch, slide, contact or otherwise manipulate an input unit more than once, for a period longer than a threshold, or the like).

When a user passes such user authenticating, a terminal may switch to a new mode designated by UI_{SWI}. A terminal may also run such erasure (or semi-erasure) in one of such erasure timings. However, it is appreciated that a terminal may not need to run any erasure (or semi-erasure), for a terminal switches from an unlock mode with the greatest access authority to another new mode with the less access authority. It is also appreciated that many terminals of this embodiment may keep their display units turned off in a lock mode, thereby saving a battery power.

### 10-8. Mode Switching while Waking Up

After use, a terminal usually puts itself into sleep, with its display unit turned off (i.e., an off-state). When a user tries to use a terminal in its off-state, the user has to switch from an off-state to an on-state, and then begins to operate a terminal by launching a lock or main system in a lock or unlock mode, respectively, and provides user inputs thereto. Accordingly, seamlessly coupling such a waking-up operation with a subsequent operation which a user desires to run in a lock or unlock mode may provide great benefit to a user.

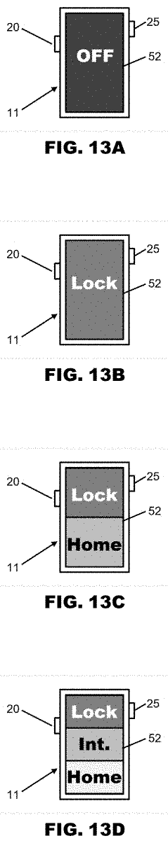

In the 8^{th} exemplary embodiment of this seventh exemplary aspect of the disclosure, a terminal may couple seamlessly such waking-up operation with subsequent operations in various ways, while maintaining the enhanced security of a terminal, the improved integrity thereof, and the preservation of personal data stored in a terminal. FIGS. 13A to 13D represent top views of exemplary terminals illustrating sequences of exemplary seamless waking-up operations according to this fifth exemplary aspect.

In a 1^{st} example of this exemplary embodiment, FIG. 13A shows an exemplary data processing terminal (11) which includes a main input unit (20), a mode-switching input unit (25), a (main) display unit (52), and other units which are not included in the figure. It is appreciated that a terminal (11) includes a main input unit (20) and a mode-switching input unit (25) along its left edge and right edge, respectively. Accordingly, a user may hold a terminal in his left or right hand, and manipulates such input units (20), (25) with different fingers. A terminal (11) of FIG. 13A is in its off-state, and its display unit (52) is turned off.

A terminal (11) may assign different tasks to a main input unit (20) and a mode-switching input unit (25). In a 1^{st} case, a main input unit (20) is to receive a user input with UI_{ACT} and to acquire UI_{ACT} therefrom, whereas a mode-switching input unit (25) is to receive a user input with UI_{SWI} and to acquire UI_{SWI} therefrom. In this case, a terminal (11) may not be able to acquire UI_{ACT} from a user input applied to a mode-switching input unit (25), and may not be able to acquire UI_{SWI} from a user input applied to a main input unit (20).

However, in a 2^{nd} case, a main input unit (20) is to receive a user input for powering on or off a terminal, while a mode-switching input unit (25) may receive a user input and acquire UI_{ACT}, UI_{SWI}, or UI_{THEN} therefrom. To this end, a mode-switching input (25) preferably includes multiple sensors capable of acquiring UI_{ACT}, UI_{SWI}, or UI_{THEN} from a user input.

It is appreciated that determining which input unit is to acquire which (user) sub-input is typically a matter of selection, and designing such input units is well within a knowledge of one of ordinary skill in the relevant art of fabricating input units. Therefore, details of other terminals based on the 1^{st} exemplary case of the preceding paragraph are omitted herein. It is also appreciated that following examples are based on the 2^{nd} exemplary case of the above paragraph.

When a user wants to operate a terminal (11), a user may provide the terminal (11) with a 1^{st} user input which includes UI_{SWI} therein, by manipulating the mode-switching input unit (25) by contacting, pressing, or otherwise manipulating as least a portion of the input unit (25). In response to receiving the 1^{st} user input and acquiring UI_{SWI} therefrom, a terminal (11) may switch from its off-state to an on-state and, more particularly, to an unlock (or home) mode or to a lock mode. The 1^{st} user input may also include UI_{THEN} when the terminal (11) runs an authentication operation to switch to an unlock mode or to even advance to a lock mode. The 1^{st} user input may also include UI_{ACT} when the terminal (11) requires such UI_{ACT} to turn on a display unit (52).

In a 2^{nd} example of this exemplary embodiment, FIG. 13B is an exemplary terminal (11) of FIG. 13A which switches to a lock mode from an off-state. In one case, a terminal (11) may always switch to a lock mode whenever it may receive a user input, whether a terminal (11) runs an authentication operation and even when a user passes the user authenticating. In this arrangement, a user may be able to run lock operations with a lock system in a lock mode whenever a user wakes up a terminal (11). Alternatively, a terminal (11) switches to a lock mode when a user fails the user authenticating. In this case, a user may run lock operations as well.

In a 3^{rd} example of this exemplary embodiment, FIG. 13C is the exemplary terminal (11) of FIG. 13A which wakes up and provides an option to a user which mode to switch to. In a 1^{st} case when a terminal (11) does not run an authentication operation, a terminal (11) may turn on its display unit (52) and display two GUIs thereon, where a 1st GUI is labeled as a “Lock Mode,” while a 2^{nd} GUI is labeled as a “Home Mode.” When a user provides a 2^{nd} user input to one of such GUIs, a terminal (11) switches to a lock mode or an unlock mode as designated by the 2^{nd} user input.

In this arrangement, a user may have to provide two sequential user inputs to turn on a display unit (52) and to switch to one of the lock and unlock modes, e.g., a 1^{st} user input for turning on a display unit (52), and a 2^{nd} user input for selecting a mode. However, a terminal (11) may be configured to receive the 1^{st} and 2^{nd} user inputs concurrently and, therefore, such 1^{st} and 2^{nd} user inputs may be deemed to be a single user input. This arrangement provides a user with the benefit of concurrently and seamlessly running the turning on and mode switching operations.

In a 1^{st} case, a user may contact or press a mode-switching user input (25) while a terminal (11) is in its off-state, thereby providing a 1^{st} user input thereto. A user continues to contact or press the mode-switching input unit (25) until a terminal (11) displays the above GUIs on a display unit (52). When a user wants to switch to a lock mode, a user may slide a finger or translate the input unit (25) upwardly, thereby providing a 2^{nd} but concurrent user input to a terminal (11).

Similarly, when a user desires to switch to an unlock mode, a user slides a finger or pushes the input unit (25) downwardly, thereby providing the 2^{nd} user input concurrently. As a result, a user may switch to either mode by applying a single user input, for a user has concurrently provided the 1^{st} and 2^{nd} user inputs, without detaching his or her finger from a mode-switching input unit (25).

In a 2^{nd} case, a user may repeat those sequences described in the above 1^{st} case, except that a user provides the 1^{st} and 2^{nd} user inputs differently from the 1^{st} case. That is, for a user who holds a terminal (11) with a left hand, a user manipulates (e.g., contacts or presses) a mode-switching input unit (25) with an index finger, and provide the 1^{st} user input thereto, similar to such manipulations of the above 1^{st} case.

While a user continues to manipulate a mode-switching input unit (25) with an index finger, a user [1] may manipulate his thumb to concurrently manipulate a main input unit (20), or [2] may concurrently touch one of such GUIs with his thumb, thereby concurrently providing the 2^{nd} user input, or the like.

In a 4^{th} example of this exemplary embodiment, FIG. 11D is the exemplary terminal (11) of FIG. 11A which wakes up and provides a different option to a user which mode to switch to. In a 1^{st} case when a terminal (11) does not run an authentication operation, a terminal (11) may turn on its display unit (52) and display three GUIs thereon, where a 1st GUI is labeled as a “Lock Mode,” a 2^{nd} GUI is labeled as an “Intermediate Mode,” and a 3^{rd} GUI is labeled as a “Home Mode.” When a user provides a 2^{nd} user input to one of such GUIs, a terminal (11) switches to a lock mode, an intermediate mode, or an unlock mode as designated by the 2^{nd} user input.

In this arrangement, a user may have to provide two sequential user inputs to turn on a display unit (52) and to switch to one of the lock and unlock modes. Accordingly, a terminal (11) may be configured to receive the 1^{st} and 2^{nd} user inputs concurrently as exemplified in the 1^{st} and 2^{nd} cases of the above 3^{rd} example.

A terminal (11) may use this arrangement regardless of how many modes are defined in a hierarchy in which a terminal (11) is to operate. In addition, a terminal (11) may employ different arrangements in such a way that multiple GUIs for multiple modes may be arranged vertically, in parallel, or in a combination thereof. In addition, a terminal may [1] highlight one of multiple GUIs as a user touches the GUI, [2] recommend a certain mode by highlighting a GUI corresponding to the mode, [3] include more information of such modes along with a GUIs, or the like. In this context, such GUIs may be similar to various notice units (or vice versa) as described above.

In a 5^{th} example of this exemplary embodiment, a terminal may run an authentication operation using UI_{THEN} provided by a user, when a user wants to switch from an off-state to an unlock mode directly. In this case, a user may have to provide a 3^{rd} user input including UI_{SWI} therein. However, this step may be combined into one of the steps described in the above 1^{st} and 2^{nd} cases, whereby a user can concurrently and seamlessly run the turning on, user authenticating, and mode switching.

In a 1^{st} case, a mode-switching input unit (25) may acquire UI_{THEN} from a 1^{st} user input. Once acquiring such, a terminal (11) may use UI_{THEN} and run an authentication operation at any time. In a 2^{nd} case, a main input unit (20) may acquire UI_{THEN} when a user powers a terminal (11) on. Thereafter, a terminal (11) may regard a user authenticated as far as the same user switches to an unlock mode within a certain period of time. In a 3^{rd} case, a mode-switching input unit (25) may acquire UI_{THEN} from a 2^{nd} user input which is concurrently provided along with a 1^{st} input.

Various configurational or operational features of various terminal of this Section may apply to other terminals illustrated in other Sections of this disclosure. Accordingly, such terminals of this Section may turn on their display units in one of various turning-on timings, may launch a lock (or main) system in one of various launch timings, may run such erasure (or semi-erasure) in one of various erasure timings, may switch modes in one of various mode-switching timings, or the like.

### 10-9. Erasure and Semi-Erasure vs. Access Authorities

In general, various terminals of this disclosure run an erase (or semi-erase operation) to achieve enhanced security, improved integrity, and better protection of data stored in a main system. Therefore, a terminal may run such erasure (or semi-erasure) as a terminal switches from a 1^{st} mode granted with less access authority (e.g., a lock mode or other restricted modes) to a 2^{nd} mode granted with greater access authority (e.g., an unlock mode or other unrestricted modes). In contrary, a terminal may not run any erasure (or semi-erasure) when a terminal switches from the above 2^{nd} mode to the above 1^{st} new mode.

A terminal according to the 9^{th} exemplary embodiment of a seventh exemplary aspect of this disclosure may nevertheless run such erasure (or semi-erasure) even when a terminal switches from one mode granted with greater access authority to a new mode granted with less access authority such as, e.g., while switching from an unlock mode to a lock mode, from an unlock mode to another restricted mode, or from a 1^{st} restricted mode to a lock mode. In addition, a terminal may run such erasure (or semi-erasure) when it switches from a 3^{rd} mode to a 4^{th} mode, where a terminal grants each of such 3^{rd} and 4^{th} modes with the access authorities which may be comparable in scopes, types, or depths in such a way that it may not be feasible to decide which mode may have more access authority than another.

When multiple users share the same terminal, a terminal may also run such erasure (or semi-erasure) when such users take turns, for it may be desirable to give each user his or her own access authority and to preserve each user's own privacy. A terminal may also completely (or partially) prevent each of such from accessing a lock (or main system) of other users. That is, a terminal (or its lock or main CPU unit) may run such erasure (or the semi-erasure) whenever it is desirable to remove an entire (or only a certain) portion of results which are stored or residing in a lock memory unit of a lock system of each user.

As described above, classifying various modes depending upon their access authorities are relative in nature in such a way that a 2^{nd} mode may have greater access authorities than a 1^{st} mode, but may have less access authority than a 3^{rd} mode. Even when such modes granted with distinct and different access authorities may be precisely lined up in an order of increasing access authorities, a terminal may run such erasure (or semi-erasure) [1] only when a new mode is granted with more access authorities than a current mode is, [2] when a new mode is granted with less access authorities than a current mode is, or [3] regardless of the differences between the access authorities of a current mode and a new mode.

Therefore, despite various configurations or arrangements which have been disclosed in relation to the erasure or semi-erasure, a terminal manufacturer or a user may implement a variety of such erase or semi-erase operations or may adjust timings of such erasure or semi-erasure as they see fit. In addition, as long as a user does not handle any crucial data in a lock system, frequently running such erasure or semi-erasure may provide a user with greater security, integrity or privacy than otherwise.

### 10-10. Mode Switching and Displaying Advertisements/Contents

As described above, various terminals of this disclosure may display various lock screens, default screens or home screens in various lock, intermediate, or unlock modes. Thus and in the 10^{th} exemplary embodiment of a seventh exemplary aspect of this disclosure, a terminal may “run a display operation” for various purposes such as, e.g., [1] to display at least one advertisement or at least one content on a display unit, [2] to allow a user to provide a user input for accessing a website which is included in the advertisement or the content, [3] to allow a user to edit the advertisement or content, [4] to allow a user to make a selection of options provided on the advertisement, content, or website, or [5] to allow a user to store results obtained by such displaying, accessing, editing, or making a selection.

As used herein, an “advertisement” refers to an announcement, a notice, and other information, where such advertisements are provided to promote a certain product, a certain service, or a certain event, and where a user viewing or otherwise interacting with the advertisements may be rewarded by an advertisement provider or by another who is related with such advertisements.

In one example, a terminal may display an advertisement on a lock screen, a default screen or even a home screen. In another example, a terminal may display an advertisement when a terminal switches to a certain mode or whenever a terminal switches modes, regardless of access authorities granted to each of such modes by a terminal (or a user). In another example, a terminal may display an advertisement when it may switch from a current mode with greater access authority to a new mode with less authority (or vice versa). In another example, a terminal may utilize an advertisement itself as a lock, intermediate, or home screen.

Alternatively, a terminal may display an advertisement as occupying a selected portion but not an entire portion of such a screen, where the advertisement [1] may be disposed in a certain fixed area of a screen, [2] may move around a screen while changing its location, [3] may change its shape or size while being displayed on such a screen, [4] may appear as a pop-up screen of various shapes or sizes, or the like. In another example, a terminal may display an advertisement [1] as long as the certain lock, intermediate, or home screen is displayed on a display unit, [2] for a certain period of time, [3] in a certain number of screens, or [4] for a certain number of modes.

It is appreciated that a terminal may drive a display unit to display a screen thereon in one of various “displaying timings” examples of which may include [1] concurrently with or (immediately) after a mode switching of a terminal from a powered-off state to a powered-on state (e.g., powering on a terminal), [2] concurrently with or (immediately) after a mode switching of a terminal from an off-state to an on-state (e.g., waking up a terminal or turning on), [3] concurrently with or (immediately) after a mode switching from an unlock mode to a lock (or intermediate) mode (or vice versa), [4] concurrently with or (immediately) after a mode switching from an intermediate mode to a lock mode (or vice versa), [5] concurrently with or (immediately) after launching a lock system in a lock mode, or the like.

As described above, a terminal may display an advertisement for a preset period of time, and then remove the advertisement from a screen. In the alternative, a terminal may display an advertisement on a display unit, and may keep the advertisement thereon [1] until a user provides an advertisement with a user input thereto or [2] until a user exercises an active or passive effort onto an advertisement, where a terminal removes an advertisement from a display unit. In either of the above [1] or [2], a terminal may then display a lock (or home) screen in a lock (or unlock) mode, and a user may begin to operate a terminal in such a mode.

In general, an advertisement may have a provider (or a sponsor) who may provide the advertisement in various arrangements and timings. In one example, a terminal may display an advertisement [1] which has been stored in a terminal, e.g., in a lock (or main) memory unit, [1-1] in the past, or [1-2] well before such displaying timings, [2] which has been received from a provider and then stored in a terminal [2-1] in the past, or [2-2] well before such displaying timings, or [3] which is received from a provider in real time when a terminal requests (directly or indirectly) to a provider. In addition, a terminal may generate an advertisement in real time or in one of such displaying timings.

A terminal may display an advertisement “as is” such that a displayed advertisement is the same advertisement as have been stored in a terminal, as have been obtained from a provider, or the like. A terminal may instead revise or edit an advertisement of the above [1] to [3] of the preceding paragraph, and then display the revised advertisement. In addition, a terminal may [1] display a single advertisement on a screen, [2] display multiple static advertisements on the screen, or [3] display a single or multiple advertisements and then change such advertisements over time.

An external provider may provide an advertisement in a one-way arrangement such that a user may view the advertisement but may not interact with the advertisement or with its provider. In contrary, an advertisement may generate results when the user provides a user input to the advertisement, where such results may include, e.g., [1] providing a user with a new screen, [2] providing a user with selections or options, [3] connecting a user to a new website, [4] downloading images, files, or documents, [5] giving a reward to a user, or the like.

An advertisement provider may count a number of user inputs which a user provides to an advertisement, a duration in which a user views an advertisement, or the like, and then change such results based thereon. As a result, the longer a user may view the advertisement or the more user inputs a user may provide to the advertisement, an advertisement provider may [1] give a bigger reward to a user, [2] connect a user to a more prestigious website, or the like.

When a user is done with viewing an advertisement or with interacting with an advertisement or its provider, a terminal may run such erasure (or semi-erasure), thereby erasing an entire (or only a selected) portion of such results which may be stored or reside in a lock system, where such results may be obtained [1] by viewing an advertisement, [2] manipulating an advertisement, [3] by accessing websites provided by an advertisement, [4] by connecting to external links offered by an advertisement, or the like. A terminal may run such erasure (or semi-erasure) in various erasure timings as described above.

When a user wants to store certain results obtained by manipulating or interacting with an advertisement, a user may manually select those to-be-stored results. A terminal may then store such to-be-stored results into a lock memory unit or a main memory unit (when authorized by a terminal), or into a temporary memory sector as described in conjunction with such semi-erasure.

Alternatively, a terminal may adaptively select such to-be-stored results based upon, e.g., a number of user inputs which a user provided to an advertisement or items included therein, a duration in which a user stays while viewing an advertisement, other user statistics, or the like. In addition, when a user desires to process such results with a main system in an unlock mode, a terminal may run various operations according to various methods described in Section 8-3.

Similar to obtaining and manipulating an advertisement, a terminal may run a display operation for displaying at least one content on a display unit, accessing a website which is provided by a content, editing or selecting on a content, storing results obtained from manipulating or interacting with such a content, or the like. As used herein, a “content” may mean a drawing, a picture, a character, a text, a video clip, a video game, a still image or a video clips of another object or person, or the like. A content may include illustration of facts, illustration of an opinion, an artistic expression, an aesthetic expression, or images as described above. A terminal may display and use such contents in ways similar or identical to those of an advertisement and, therefore, details thereof are omitted.

### 10-11. Displaying Advertisements/Contents on Lock Screens

Advertisement providers are those who would put such advertisements on whatever useful space they can find. Accordingly, it is no wonder that advertisement providers have been putting advertisements on various places available in data processing terminals. As such providers start to realize a potential value of a screen of such a terminal, many providers began to place various advertisements on a screen of a terminal whenever possible, particularly whenever a user browses an internet. On the part of a user, however, it is generally not a pleasant experience when a pop-up advertisement hovers around a screen and does not go away while a user delves into important reading or obtaining valuable information therefrom.

Therefore and in the 11^{th} exemplary embodiment of a seventh exemplary aspect of this disclosure, a terminal may display at least one advertisement on a lock screen in a lock mode. To this end, a terminal may include at least one “advertisement viewer” or an “ad viewer” which may be provided with only limited functionality and which may present data or files in a format which may be friendly to a user. Therefore, an ad viewer may be [1] a prior art file viewers, [2] a prior art image viewer, or [3] a prior art web browser, where a lock viewer of the 1^{st} Configuration is an example thereof.

More particularly, an ad viewer may display various advertisements which may be provided in different types or formats. Therefore, an ad viewer may include at least one format translator which may provide various views of data or files by handling, e.g., a different byte order, a code page, a newline style, or the like. An ad viewer may also render HTML markup into a form which is human friendly, or may provide graphic files such as a thumbnail preview, a thumbnail creation, or an image zooming. When desirable, an ad viewer may display not only images but also text on a display unit. In addition, an ad viewer may also play audible signals or generate tactile signals which may be related to such advertisements.

A terminal may drive this ad viewer as it does a lock viewer. Accordingly, a lock system may drive an ad viewer in a lock mode with its lock CPU unit or lock O/S. Alternatively, a main system may drive an ad viewer when a lock system does not include any lock CPU unit, a lock O/S or other applications which can drive an ad viewer. A lock or main system may also run such erasure (or semi-erasure) in one of various erasure timings.

Similar to the case of a lock viewer, a user may select and store a certain advertisement in a lock mode for a later review, e.g., by marking a certain advertisement or by storing a certain advertisement in a lock (or main) memory unit or other memory sectors available in a lock (or main) system. Similarly, a user operating a terminal in a lock mode may select certain results which are obtained by manipulating or editing such advertisements, obtained from a website directed by the advertisement, obtained by downloading files or data therefrom, or the like. A terminal may store such results in one of various storing timings as described above.

An ad viewer may be provided as a separate (software) application which may reside in a lock system and may be driven by a lock (or main) system or which may reside in a main system and may be driven by a main (or lock) system. Alternatively, an ad viewer may be provided as a plug-in application to a lock viewer or other (software) applications residing in a lock (or main) system.

An ad viewer may also be provided in an external device which may releasably and operatively couple with a terminal, where an ad viewer may run the erasure (or semi-erasure) in one of various erasure timings. In addition, an ad viewer may run such erasure (or semi-erasure) when a user unplugs or uncouples an external device from a terminal (or when a user plugs or couples an external device to a terminal) after, before or during use of an ad viewer as explained in Section 1.

In this respect, an ad viewer may be incorporated into various external devices such that a USB-type memory [1] may include only an ad viewer and its driver, [2] may include an ad viewer and a lock CPU unit which is equipped with a minimum functionality but which can drive the ad viewer, [3] may include an ad viewer, a lock CPU unit, and a lock memory unit, or the like. In the alternative, an external device may recruit at least a portion of a main CPU unit or a main memory unit to supplement those functionalities which lack in a lock system included in such an external device.

A terminal may use an ad viewer to provide various membership services to a user. In one example, an ad viewer may distribute discount coupons only to a certain member selected by certain criteria such as, e.g., [1] a member's status in a membership society, [2] sex, [3] age, [4] an occupation, [5] an income, [6] his or her preference or hobby, [7] a current location, [8] a destination of travel, [9] shopping history or shopping list, [10] a home or work address, [11] a distance or time taken to a certain store [11-1] from a home (or work) address or [11-2] from a current location, [13] a time of the day, [14] a day of the week (or month), [15] a marital status, [16] a size of family or relatives, [17] a temporal proximity to certain holidays, or the like.

In another example, an ad viewer may determine [1] when to start displaying a coupon, [2] how long to display such a coupon, [3] how many coupons to issue, or the like. In another example, an ad viewer may determine how much discount on what kind of merchandise or service to offer, based upon various criteria as described above or other criteria which are rather related not to a member but to a certain merchant or merchandise. In another example, an ad viewer may distribute coupons only on certain instances such as, e.g., [1] on a certain hour of the day, [2] on a certain day of the week (or a month), or [3] on (or before, after) a certain holiday.

To display various advertisements, a terminal may keep multiple advertisements in a central depository of a terminal, where a depository may reside [1] in a lock memory unit of a lock system (or embedded lock portion), [2] in other temporary memory sectors in a lock system (or portion), [3] in a main memory unit, or [4] in an external device. In addition, a terminal may acquire such advertisements in a depository by many ways such as, e.g., by receiving them from a manufacturer of a terminal or a user, by acquiring them a website, by receiving them from a provider of advertisements, or the like.

### 10-12. Common Display Unit

Each display unit of various terminals of this disclosure has been typically referred to as a main display unit. Alternatively, when a terminal includes a main system and a lock system, a main system may include a main display unit, while a lock system may include at least one lock display unit, where the main display unit and the lock display units may typically refer to separate hardware elements of the terminal.

t is appreciated that any lock system which does not include its own lock display unit has to display a screen on a main display unit. However, a lock system including its own lock display unit may display a screen [1] only on its own lock display unit, [2] only on a main display unit, or [3] on both of the lock and main display units.

Therefore and in the 12^{th} exemplary embodiment of this seventh exemplary aspect, a main display unit may be deemed to be a common hardware element to both a main system and a lock system so that a lock system may be able to drive a main display unit either directly or via a main CPU unit or a main O/S, particularly when a lock system does not include any lock display unit.

This may be inevitable because, even when a terminal does not allow a lock system to access any units of a main system, a terminal may have to allow a lock system to [1] directly access or drive a main display unit of the main system when a lock system does not include its own lock display unit, or [2] make a call to a main system which may access and drive a main display unit on behalf of a lock system. In this context, when a terminal is said to include not a “main display unit” but to include simply a “display unit” in this disclosure, such a display unit may be deemed as a hardware element of a main system which may also be driven by a lock system.

### 10-13. Display Unit and Mode Switching

In the 13^{th} exemplary embodiment of this seventh exemplary aspect, a terminal may include a single display unit which in turn includes multiple segments each of which may be driven only by a main (or lock) system or by both of a main system and a lock system, where all of such segments may have the same shape and the same size or where at least two segments may have different shapes or sizes. In either arrangement, a terminal may drive each segment of a display unit to display the same or different data or images on its own screen and utilize each of such segments for the same or different purposes.

In one example, a terminal may use each of such multiple segments like those sub-units of various notice units in such a way that a terminal may launch a lock (or main) system in a lock (or unlock) mode, while displaying such results obtained therefrom on one of such segments.

That is, a terminal may drive a 1^{st} segment of a display unit for displaying results obtained from operating a lock (or main) system in a lock (or unlock) mode, while driving a 2^{nd} segment of the same display unit for displaying results obtained from operating a main (or lock) system in an unlock (or lock) mode. Therefore, a user may monitor 1^{st} results which are obtained by running various lock operations and displayed on a 1^{st} segment, while concurrently monitoring 2^{nd} results which are obtained by driving various hardware or software elements of a main system.

In another example, when a user operates the same lock (or main) system in both segments of a display unit, a user may use such multiple segments by consolidating them into a single screen and display a single image on both segments of a display unit. Alternatively, a terminal may use one of such segments of a display unit to display routine data such as, e.g., a date, a time, a message informing an incoming emails or messages, or a status of a hardware or software element of a terminal, where such routine data may typically refer to those data obtainable without running an operation in response to a user input.

In the 14^{th} exemplary embodiment of this seventh exemplary aspect, a terminal may include multiple display units each of which may be driven only by a main system or by both of a main system and a lock system, where all of such display units may have the same shape and the same size or where at least two display units may define different shapes, sizes, or orientations. A terminal may also dispose multiple display units on the same surface of a terminal or on different surface thereof. In either arrangement, a terminal may drive each display unit for displaying the same or different data or images on its own screen, and may use each display unit for the same or different purposes.

In one example, a terminal may use each of such multiple display units like those sub-units of such notice units in such a way that a terminal may launch a lock (or main) system in a lock (or unlock) mode, while displaying such results obtained therefrom on one of such display units. In another example, when a user launches the same lock (or main) system for both display units, a user may also use multiple display units by consolidating them into a single display unit, e.g., by displaying one half of an image on a 1st display unit, while displaying another half on a 2^{nd} display unit, or the like. Other configurational or operational features of this embodiment may be similar or identical to those of the above embodiment in which a single display unit may include or define multiple segments therein.

### 10-14. Multiple Operating Systems or CPUs

As described above, a lock system may include a lock CPU unit which may drive a lock viewer, a lock memory unit, or other units of the lock system. Because a terminal includes a main CPU unit in addition to such a lock CPU unit, a lock CPU unit may not function properly, unless a main O/S of a main system is designed to take account of the presence of a lock CPU unit. Thus and in the 15^{th} exemplary embodiment of this seventh exemplary aspect, when a lock system includes a lock CPU unit, a terminal (or its main CPU unit) may make various arrangements to make the best use of a lock CPU unit.

In one example, a terminal may ask a user to select one of such CPU units while a terminal wakes up (e.g., switching from an off-state to an on-state) in response to a user input. When a user selects one CPU unit, a terminal may load a lock (or main) system in a lock (or unlock) mode, and may drive a lock (or main) CPU unit, a lock (or main) O/S, and other units of such a system.

In another example when a terminal receives a user input including UI_{SWI} in its on-state, a terminal may similarly ask a user which one of the lock and main CPU units (or the lock and main systems) a user desires to drive (or operate) after the mode switching. When a user selects a main (or lock) system after switching mode to an unlock (or lock) mode from a lock (or unlock) mode, a terminal may switch its mode, and launch a main (or lock) system while executing a main (or lock) CPU unit. When a user selects to drive the same main system (or lock system) after switching from an unlock (or lock) mode to a lock (or unlock) mode, a terminal may keep operating the same system and driving the same CPU unit, while stopping or suppressing execution of another CPU unit.

In another example, a terminal may configure a lock CPU unit and a main CPU unit to collaborate with each other, e.g., to run (or perform) a single identical operation (or function), to synchronize running the same or different multiple operations either concurrently or sequentially, or the like. A terminal may similarly synchronize a lock CPU unit with a main CPU unit (or vice versa) to run such erasure (or semi-erasure), e.g., [1] by running the erasure (or semi-erasure) with each of such CPU units (e.g., a double-pass overwriting or encryption), [2] by running such erasure (or semi-erasure) on different memory unit or different sets of data, or [3] by assigning each CPU unit to run only one of such erasure or semi-erasure.

### 10-15. More Operations with Terminals Having Adjustable Configurations

In the 16^{th} exemplary embodiment of this seventh exemplary aspect, various data processing terminals with adjustable configurations such as, e.g., a foldable configuration or a rollable configuration, may allow a user to [1] keep operating the same (lock, intermediate, or main) system on a newly exposed display unit (e.g., a target display unit) after an unfolding or unrolling operation, [2] operate a different system on a newly exposed display unit after an unfolding or unrolling operation, [3] keep operating the same (lock, intermediate or main) system on a different display unit after a folding or rolling operation, or [4] operate a different system on a different display unit after a folding or rolling operation.

In a 1^{st} example of this 16^{th} exemplary embodiment, a user may continue to operate a lock system in an unlock mode after such unfolding. For example, a user may operate a lock system on a non-target display unit in a lock mode. When a user unfolds a foldable portion of the terminal, the terminal may expose a target display unit, and may allow the user to continue to operate the lock system on the target display unit in a lock mode.

A terminal may do so as a default response to a user input which includes a (user) sub-input for an unfolding operation. In the alternative, before, during or after such unfolding, a terminal may ask a user whether a user desires to [1] continue operating the same system which the user used to operate on the non-target display unit on the target display unit or [2]stop operating the system which a user used to operate on the non-target display unit and to start to operate a different system on the target display unit after unfolding.

This configuration provides a user with several benefits. For example when a user operates a lock system on a non-target display unit in a lock mode and then finds that he needs a bigger display surface, he may unfold the foldable portion of the terminal, expose a target display unit with a bigger display surface, and continue to operate the lock system on the target display unit in the lock mode. Therefore, a user may enjoy seamless operational features provided by such a terminal.

In a 2^{nd} example of this 16^{th} exemplary embodiment, a user may continue to drive a main system in a lock mode after a folding operation. For example, a user may operate a main system on a target display unit in an unlock mode. When a user folds a foldable portion of the terminal, the terminal may hide a target display unit, and may allow the user to continue to operate the main system on the non-target display unit in an unlock mode.

A terminal may do so as a default response to a user input including a (user) sub-input for a folding operation. In the alternative, before, during or after such folding, a terminal may ask a user whether a user desires to [1] continue operating the same system which the user used to operate on the target display unit on the non-target display unit or [2] stop operating the system which the user used to operate on the target display unit and start to operate a different system on the non-target display unit after folding.

In a 3^{rd} example of this 16^{th} exemplary embodiment, a user may have been running various lock operations by driving a lock system on a non-target display unit in a lock mode, or obtaining such results by running lock operations on the non-target display unit. After such unfolding, a terminal may expose a target display unit, and may allow a user to drive a main system on a target display unit in an unlock mode, while allowing the user to access such results in the unlock mode. When desirable, the terminal may run anti-virus operations to ensure that the results to be accessed by the main system may not include any malicious viruses therein.

In a 4^{th} example of this 16^{th} exemplary embodiment, a user may have been running unlock operations by driving a main system in an unlock mode or obtaining outcomes by running unlock operations. After a folding operation, a terminal may hide a target display unit, but allow the user [1] to continue to run those operations which he used to run with a main system on a target display unit in an unlock mode, or [2] access the outcomes which he obtained after running the unlock operations with the main system in the unlock mode.

To this end, a terminal may allow a lock system to access a certain main hardware element, a certain main software element or a certain main app which has been used by a user in an unlock mode. The terminal may also allow the lock system to access those outcomes which are stored or residing in the main system either permanently, conditionally or temporarily.

In the alternative, a main system may transmit such outcomes to a lock system before, during or after a user starts to drive a lock system on a non-target display unit. When a lock system includes that main app or main software element which a user has been driving in an unlock mode, a main system may only have to transmit the outcomes. However, when a lock system does not include that main app or main software element which a user has been driving in an unlock mode, a terminal may download the main software element or main app to a lock system.

It is appreciated that the above examples of this 16^{th} exemplary embodiment which are related to a foldable terminal may be similarly or equally applied to a rollable terminal.

For example, similar to the 3^{rd} example of this 16^{th} embodiment, a user may have been running various lock operations by driving a lock system on a main portion of a display surface of a display unit in a rolled state or obtaining such results by running lock operations on the main portion thereof. After such unrolling, a terminal may expose a rollable portion of a display surface of a display unit, and may allow a user to drive a main system on an entire display surface of the display unit in an unlock mode in an unrolled state, while allowing the user to access such results in the unlock mode.

As exemplified in the 5^{th} Configuration (or Section 8), various data processing terminals according to those adjustable configurations may receive [1] the 1^{st} user input in a folded (or rolled) state for unfolding (or unrolling), [2] the 2^{nd} user input in an unfolded (or unrolled) state for folding (or rolling).

In the 17^{th} exemplary embodiment of this seventh exemplary aspect, a user may provide a terminal with [1] a similar (or same) 1^{st} user input, [2] a similar (or same) 2^{nd} user input or [3] another user input which may be different from the 1^{st} user input as well as the 2^{nd} user input, such that a terminal may determine [1] whether or not a user may continue to operate the same lock, intermediate or main system after such unfolding (or unrolling) or folding (or rolling), [2] whether or not a user in a new unfolded (or unrolled) state or folded (or rolled) state may access those results or outcomes which he has obtained in a previous state, or the like.

In a 1^{st} example of this 17^{th} exemplary embodiment, a user may provide a 3^{rd} user input along with one of the 1^{st} user input and a 2^{nd} user input, where the 1^{st} user or 2^{nd} user input may respectively include a (user) sub-input for unfolding (or unrolling) and for folding (or rolling), while the 3^{rd} user input may include another (user) sub-input which indicates whether or not a user may desire to [1] continue to run a certain system after the unfolding (or unrolling) or folding (or rolling).

A user may provide the 3^{rd} user input which may be at least one of any of the 1^{st} type to 4^{th} type user inputs exemplified in Section 1-10. In a 1^{st} example, a user may press a button-type input unit. In a 2^{nd} example, a user may press, touch or otherwise manipulate a certain portion of [1] a non-target display unit, [2] a main portion of a display surface of a display unit, [3] a top, or [4] a bottom body, once, twice, for a period which is longer than a certain period, or the like. In a 3^{rd} example, a user may swipe over [1] a non-target display unit, [2] a main portion of a display surface of a display unit, [3] a top body, or [4] a bottom body, in a certain direction or in any direction.

When a terminal receives the 3^{rd} user input as well as one of the 1^{st} and 2^{nd} user input user inputs, a terminal switches from a current state to a new state by running an operation for such unfolding, unrolling, folding, or rolling, and may determine whether or not a user may continue [1] to run the same or similar operations or [2] to perform the same or similar functions, after switching to the new state.

In a 2^{nd} example of this 17^{th} exemplary embodiment, a user may provide a 3^{rd} user input along with one of the 1^{st} user input and a 2^{nd} user input, where the 1^{st} user or 2^{nd} user input may respectively include a (user) sub-input for unfolding (or unrolling) and for folding (or rolling), while the 3^{rd} user input may be regarded as one effort of the multiple quick efforts exemplified in Section 1-12. Therefore, a terminal may recognize a combination of the 3^{rd} user input and one of the 1^{st} and 2^{nd} user inputs as multiple quick efforts, where it may not matter whether the terminal may regard such multiple efforts as [1] a single user input or [2] two different user inputs provided sequentially.

For example, a user may provide the 1^{st} user input for the unfolding, e.g., by rotating a foldable portion of a top body away from a bottom body. During rotation of the foldable portion, the user may manipulate a speed of such rotation, an acceleration of such rotation, or the like. The terminal may recognize one combination of such unfolding at a low speed (or acceleration) as a 4^{th} user input, while recognizing another combination of such unfolding at a high speed (or acceleration) as a 5^{th} user input.

Alternatively, during such rotation of the foldable portion, a user may [1] briefly pause or stop such rotation, [2] rotate the foldable portion backwardly and then forwardly (i.e., a back-and-forth) rotation, or [3] any other motion which may be different from such a simple rotation of the foldable portion. The terminal may then recognize one combination of such unfolding without any pause, any stop, any back-and-forth rotation or any different motion, as a 4^{th} user input, while another combination of such unfolding with one of a pause, a stop, a back-and-forth rotation or a different motion, as a 5^{th} user input.

In response to a 4^{th} user input, a terminal may allow a user [1] to continue to operate the same system which he has been operating in a folded state, even after switching to an unfolded state, [2] to run operations which are the same or similar to those operations which he has been running in a folded state, even after switching to an unfolded state, or the like.

In response to a 5^{th} user input, however, a terminal may allow the user [1] to only drive a new system after switching to an unfolded state, or [2] to not continue to run the same or similar operations which he has been running in a folded state after switching to an unfolded state.

In a 3^{rd} example of this 17^{th} exemplary embodiment, a user may provide the 1^{st} user input for the unrolling, e.g., by pushing a main portion of a display surface of a display unit upwardly. During the upward push, a user may manipulate a speed or acceleration of such an upward push, a direction of such an upward push, or the like. A terminal may recognize one combination of such unrolling at a low speed (or acceleration) or in a certain direction as a 4^{th} user input, while recognizing another combination of such unrolling at a high speed (or acceleration) or in another direction which is different from the certain direction as a 5^{th} user input.

In the alternative, during such an upward push of the main portion of the display surface of the display unit, a user may [1] briefly pause or stop the upward push, [2] push the main portion downwardly and upwardly (i.e., down-and-up push), [3] change a direction of a finger causing the upward push at a certain angle, or the like. The terminal may then recognize one combination of such unrolling without any pause, stop, down-and-up push, or any change in such a direction as a 4^{th} user input, while another combination of such unrolling with one of a pause, a stop, a down-and-up push, or a change in such a direction as a 5^{th} user input.

A terminal may react to the 4^{th} user input or the 5^{th} user input similar to the terminal of the above 2^{nd} example. That is, a terminal may (or not) allow a user [1] to continue to operate the same system which he has been operating in a folded state, even after switching to an unfolded state, [2] to run operations which are the same or similar to those operations which he has been running in a folded state, even after switching to an unfolded state, or the like.

### 10-16. More on Lock Modes

Throughout this disclosure, a “lock mode” has been generally defined as a mode to which a terminal grants the least access authority. Therefore, among various modes such as a lock mode, an intermediate mode, or an unlock mode, a terminal grants the least access authority to the lock mode, compared to the intermediate or unlock mode.

It then follows that a terminal gives the least access authority to a lock system which is operated in the lock mode than [1] an intermediate system which is operated in the intermediate mode, [2] a main system which is operated in the unlock mode, or the like. For example, the lock system may include the smallest number of (lock) software (or hardware) elements, the main system may include the greatest number of (main) software (or hardware) elements, or the intermediate system may include a preset number of (intermediate) software (or hardware) elements, where the preset number is generally less than the greatest number but greater than the smallest number.

In the 18^{th} exemplary embodiment of this seventh exemplary aspect, however, a data processing terminal of this disclosure or a user of the terminal may define a lock mode, a lock system, an unlock mode, and a main system (or an intermediate mode or an intermediate system) in ways which are different from those as have been exemplified above.

In a 1^{st} example of this 18^{th} exemplary embodiment, a terminal (or its user) may define a main system to be a system in which the user may [1] keep or store information to which he gives a priority (or an importance), [2] drive software (or hardware) elements, run operations, or execute an app, where the user gives a priority (or an importance to such elements, operations or apps [3] the software (or hardware) elements or apps of [2], [4] information about the user's finance or business may be kept, or the like.

Still referring to [4] of the preceding paragraph, a terminal (or its user) may keep or store important personal information such as, e.g., a number or a password of the user's account in [1] a bank, [2] a stock exchange market or institution, [3] a cryptocurrency market or institution, [4] a commodity market or institution, [5] a VW (i.e., a virtual world), or the like.

To this end, a user may store such important [1] information, [2] (main) software or hardware elements, or [3] apps, in a main system which may be operated in an unlock mode. As a result, the main system may include only a limited number of such (main) elements or (main) apps, where the limited number may be less than a number of the (lock) hardware elements, software elements, or apps included in the lock system. In addition, the terminal may grant the limited access authority to the main system or the unlock mode, where the limited access authority may be less than the access authority granted to the lock system or the lock mode by such a terminal.

In other words, a user may incorporate most of the software elements, hardware elements, or apps in a lock system, and may run various lock operations in order to perform the ordinary, day-to-day functions in the lock mode. In contrary, a user may incorporate a limited number of those important software elements, hardware elements, apps, or information only in the main system, and run the unlock operations to perform important functions in the unlock mode.

When a lock software element, lock hardware element, or lock app is contaminated by the malicious viruses, a terminal may remove those contaminated element or app, reload a corresponding element or app, use the reloaded element or app as a lock element or app, and run various lock operations in order to perform such ordinary, day-to-day functions in the lock mode.

In a 2^{st} example of this 18^{th} exemplary embodiment, a terminal (or its user) may define a lock system to be a system [1] in which a user stores information which may not be given a priority by the user, which may not be important to the user, but which the user may use most frequently, [2] in which the user may drive a software element, hardware element or app, and run operations which may not be given the priority by the user, which may not be important to the user, but which the user may run most frequently, or the like.

To this end, a user may store such frequently used but not important [1] information, [2](main) software or hardware elements, or [3] apps, in a lock system operated in a lock mode. As a result, the lock system may include a greater number of such (lock) hardware elements, software elements or apps, where the greater number may be greater than a number of the important (main) hardware elements, software elements, or apps which are included in the main system. In addition, the terminal may grant the greater access authority to the lock system or the lock mode, where the greater access authority may be greater than the access authority which is granted to the main system or the unlock mode by the terminal.

Accordingly, it is appreciated that the lock mode or a lock system is not necessarily the mode or the system to which a terminal grants the least access authority. It is also appreciated that the unlock mode or the main system is not necessarily the mode or the system to which the terminal grants the greatest access authority.

### 10-17. Variations or Modifications

Various data processing terminals of this seventh exemplary aspect may be configured and operate based on different configurations, arrangements or sequences. Such variations or modifications of such terminals of this fifth exemplary aspect may be similar or identical to those of such terminals exemplified in the 1^{st} to 7^{th} Configurations, or to those of other data processing terminals in other exemplary aspects of this disclosure and, thus, are omitted herein.

Configurational or operational variations (or modifications) of such terminals which are described in various embodiments or examples of this fifth exemplary aspect may be interchangeable with other embodiments or examples of other exemplary aspects of this disclosure. Thus, certain features of a certain embodiment or example of this fifth exemplary aspect may be applied to another embodiment or example of the same aspect or of a different aspect.

Moreover, other configurational or operational features, their variations or modifications of various terminals of this seventh exemplary aspect may [1] apply to, [2] be incorporated into, [3] replace, [4] be replaced by, or [5] be combined with corresponding features of other aspects, embodiments, or examples of this disclosure which have been described in this disclosure, as long as such application, incorporation, replacement, or combination does not contradict each other.

### 11. Interchangeability

Various data processing terminals and methods of constructing or using such terminals have been described above, particularly with reference to various exemplary aspects, their embodiments, examples, objectives, or the like, along with their details. Such description is intended only for better understanding the configurational or operational features or characteristics of such terminals and methods. Accordingly, it will be apparent to those skilled in the relevant art that various modifications and variations of such terminals may be made from the above disclosure.

While exemplary aspects, embodiments, examples, or objectives of the data processing terminals have been disclosed herein, it is understood that other modifications or variations are still possible. Accordingly, such modifications or variations are not to be regarded as a departure from the spirit and scope of such exemplary aspects, embodiments, examples, and objectives of this disclosure, and all such modifications or variations which would be obvious to one skilled in the art are intended to be included within the above disclosure as well as within the scope of the following claims.

Unless otherwise specified, various features of a certain aspect, embodiment, example or objective through this disclosure may apply interchangeably to those corresponding features of other aspects, embodiments, examples or objectives throughout this disclosure. However, such interchangeability may not apply when the application, incorporation, replacement, or combination may contradict each other.

For example, this disclosure centers around the data processing terminals, their lock (or main) systems, and their CPU units or O/S which may operate under a hierarchy defining a single lock mode and a single unlock mode. But configurational or operational features of such terminals may be expanded to other terminals which may operate in a hierarchy which may define at least one addition mode, other than a lock mode and a main mode. Therefore, such other terminals may switch mode from a lock mode to an intermediate mode, and then to an unlock mode. In addition, such other terminals may switch back to either a lock mode or an intermediate mode when the hierarchy is circulating.

Other features related to various terminals switching between a lock mode and an unlock mode may apply to other terminals which switches among at least three different modes. However, when the above disclosure specifies that a terminal includes only two systems such as a lock system and a main system, a terminal does not include an intermediate system and may not have to operate either system in the intermediate mode.

In another example, this disclosure demonstrates various configurational or operational features of such data processing terminals, their lock (or main) systems, their CPU units or O/S, and methods according to which a terminal may run various operations in response to those 1^{st} type mechanical user inputs. However, such features may be expanded to other terminals which run various operations in response to those user inputs of other types. Therefore, the definition of a single user input which holds for the mechanical user inputs may have to be modified to suit the different nature of other user inputs.

In the case of the 5^{th} type acoustic user input, a single user input may be defined as a user input resulting from a direct, indirect or other manipulation of at least a portion of a microphone by acoustic waves which may be generated by a vocal cord of a user or by other body parts of a user and which does not include therealong a temporal gap which a terminal may regard as a temporal gap.

Various data processing terminals, their systems incorporated into such terminals, and methods of using the terminals of this disclosure may further incorporate other electric or digital parts capable of running various operations for performing various functions similar to those described in this disclosure. As discussed above, however, such terminals may include any program, software, source code, binary code or other instructions as long as such terminals may run one or more operations when such terminals receive various user inputs when such terminals are (or have been) in their off-state and when such terminals may switch their display units from their off-states to their on-state in response to such user inputs or their (user) sub-inputs.

It is to be understood that, while various aspects, embodiments, and examples of this disclosure have been described in conjunction with detailed description provided hereinabove, the foregoing disclosure is intended to illustrate and not to limit the scope of various data processing terminals, which is defined by the scope of the appended claims. Other aspects, embodiments, examples, advantages, and modifications are within the scope of the following claims as well.

What is claimed is:

1. A data processing terminal operating in a lock mode and in an unlock mode comprising:
a top body which defines a top outer surface and a top inner surface;
a bottom body which defines a bottom outer surface and a bottom inner surface;
a rotatable joint which rotatably couples said top body with said bottom body, which defines a folding axis about which one of said top and bottom bodies rotates toward or away from the other thereof between a folded state and an unfolded state within a preset range of folding angles in such a way that said top inner surface and said bottom inner surface are not exposed to a user in said folded state but that said top inner surface and said bottom inner surface are exposed to said user in said unfolded state;
a first display unit which is disposed on said top outer surface of said top body, and which is exposed to said user in said folded state;
a second display unit which is disposed on at least one of said top inner surface of said top body and said bottom inner surface of said bottom body, and which is exposed to said user in said unfolded state but not exposed to said user in said folded state;
a lock system which operates in said lock mode, and includes a first number of lock apps one of which is a first lock app capable of allowing said user to access an external source in said lock mode; and
a main system which operates in said unlock mode, and includes a second number of main apps one of which is a first main app capable of allowing said user to access said external source in said unlock mode, wherein said second number is not less than said first number,
wherein, in said folded state, said user executes said first lock app on said first display unit in said lock mode, and generates results as a result of executing said first lock app,
wherein, when said user provides said terminal with a first user input for unfolding in said folded state by rotating said top body away from said bottom body, said terminal switches from said folded state to said unfolded state, and exposes said second display unit to said user, and
wherein said terminal runs one of an erase operation and a semi-erase operation, and erases at least a portion of said results in one of a plurality of erasure timings,
whereby said terminal prevents malicious viruses included in one of said results and said lock system from migrating into said main system in said unlock mode.

2. The terminal of claim 1, wherein said rotatable joint is one of a hinge and a rotary joint.

3. The terminal of claim 1, wherein said rotatable joint couples said top and bottom bodies along one of long and short vertices of said top and bottom bodies.

4. The terminal of claim 1, wherein said preset range of said folding angles is one of about 45°, 60°, 90°, 120°, 150°, 150°, 180°, 210°, 240°, and 270°.

5. The terminal of claim 1, wherein said results include at least one of data, files, folder, texts, images, contents, and computer codes.

6. The terminal of claim 1, wherein said main system includes at least one of:
a second app which said lock system does not include;
a second app which runs a second operation which none of said lock apps run; and
a second app which performs a second function which none of said lock apps perform.

7. The terminal of claim 1, wherein said external source includes one of an add-on device, a portable device, a website, and a cloud.

8. The terminal of claim 1, wherein said first lock app is one of a web browser app, an email app, a messenger app, an internet-of-things app, and an ad viewer app.

9. The terminal of claim 1, wherein said lock system is one of physically and operationally isolated from said main system.

10. The terminal of claim 9, wherein said terminal prevents at least one of:
said lock system from accessing said main system in said lock mode;
said lock system from storing at least a portion of said results in said main system in
said lock mode;
said results from accessing said main system in said lock mode;
said results from being accessed by said main system in said lock mode; and
said main system from accessing said results in said unlock mode,
whereby said terminal prevents said malicious viruses included in one of said results and said lock system from migrating into said main system in said lock mode.

11. The terminal of claim 1, wherein said second display unit is disposed on said top inner surface as well as said bottom inner surface, and wherein said second display unit provides a top inner display surface and a bottom inner display surface, respectively, on said top inner surface and bottom inner surface, and wherein said terminal operates said main system on both of said top inner and bottom inner display surfaces of said second display unit in said unlock mode.

12. The terminal of claim 1 further comprising a third display unit,
wherein said second display unit is disposed on said top inner surface, and
wherein said third display unit is disposed on said bottom inner surface.

13. The terminal of claim 1, wherein said plurality of erasure timings include:
a first timing which is when a terminal detects said viruses in said results;
a second timing which is when a terminal detects said viruses in said first lock app;
a third timing which is when a terminal detects said viruses in at least two of said lock apps, wherein one of said lock apps is said first lock app;
a fourth timing which is when a terminal detects said viruses in said lock system;
a fifth timing which is when a certain period has elapsed after running at least one of a previous semi-erase operation and a previous erase operation;
a sixth timing which is when said user runs a certain number of said lock operations, wherein said number exceeds a preset number; and
a seventh timing which is when a size of said result reaches a certain size which exceeds a preset size.

14. The terminal of claim 1, wherein said plurality of erasure timings include:
an eighth timing which is when said terminal receives said first user input;
a ninth timing which is after said terminal receives said first user input but before receives an additional user input;
a tenth timing which is after said terminal receives said first user input but before beginning said unfolding;
an eleventh timing which is when said top body rotates away from said bottom body by a preset unfolding angle;
a twelfth timing which is during said unfolding; and
a thirteenth timing which is after said unfolding.

15. The terminal of claim 1, wherein, when detecting said malicious viruses in said lock system, said terminal removes at least one of:
said first lock app from said lock system;
at least two lock apps one of which is said first lock app from said lock system;
all of said lock apps from said lock system; and
said lock system.

16. The terminal of claim 15, wherein, after removing said first lock app, said terminal reloads a new first app into said lock system, and wherein said terminal uses said reloaded first app as a new first lock app with which said user accesses said external source in said lock mode.

17. The terminal of claim 16, wherein said first main app is capable of running up to a third number of different operations and capable of performing up to a fourth number of functions, and wherein said terminal obtains said new first lock app in said lock system by one of:
loading an entire portion of said first main app into said lock system, whereby said new first lock app is also capable of running up to said third number of different operations and also capable of performing up to said fourth number of functions;
loading only a portion but not an entire portion of said first main app into said lock system, whereby said new first lock app is capable of running up to a fifth number of different operations and also capable of performing up to said sixth number of functions, wherein at least one of said fifth and sixth numbers is less than said third and fourth numbers, respectively;
loading an entire portion of a reference first app into said lock system, wherein said new first lock app also allows said user to access said external source in said lock mode, and wherein said reference first app is stored in said terminal but not in said main system; and
loading at least a portion but not an entire portion of said reference first app.

18. The terminal of claim 1, wherein said lock system includes said first number of said lock apps therein even in said unlock mode, except when at least one of said first number of said lock apps is contaminated by said viruses.

19. The terminal of claim 1, wherein said lock system includes said first lock app therein even in said unlock mode, except when said first lock app is contaminated by said viruses.

20. The terminal of claim 1, wherein said terminal switches to said unfolded state in response to said first user input, and allows said user to drive said main system on said second display unit in said unlock mode, without running any user authentication operation.

21. The terminal of claim 1, wherein said terminal runs a user authentication operation in response to said first user input, switches to said unlock mode, and allows said user to drive said main system in said unlock mode on said secondary display unit when said user passes said user authentication.

22. The terminal of claim 21, wherein said terminal runs said user authentication operation based upon a user sub-input which is included in said first user input.

23. The terminal of claim 21, wherein said plurality of erasure timings include:
a fourteenth timing which is before running said user authentication operation;
a fifteenth timing which is concurrent with running said user authentication operation;
a sixteenth timing which is one of before, upon or after determining whether or not said passes said user authentication operation; and
a seventeenth timing which is after running an authentication operation.

24. The terminal of claim 1, wherein said first display unit is one of:
remaining turned on, while operating said lock system;
remaining turned on, while not operating said lock system; and
turned off.

25. The terminal of claim 1, wherein, after switching to said unfolded state, said terminal allows said user to operate said main system on said second display unit in said unlock mode, while one of:
not allowing said user to access said results in said unlock mode; and
allowing said user to access remaining portions of said results in said unlock mode, after said terminal runs said semi-erase operation.

26. A data processing terminal operating in a lock mode and in an unlock mode comprising:
a top body which defines a top outer surface and a top inner surface;
a bottom body which defines a bottom outer surface and a bottom inner surface;
a rotatable joint which rotatably couples said top body with said bottom body, which defines a folding axis about which one of said top and bottom bodies rotates toward or away from the other thereof between a folded state and an unfolded state within a preset range of folding angles in such a way that said top inner surface and said bottom inner surface are not exposed to a user in said folded state but that said top inner surface and said bottom inner surface are exposed to said user in said unfolded state;
a first display unit which is disposed on said top outer surface of said top body, and which is exposed to said user in said folded state;
a second display unit which is disposed on at least one of said top inner surface of said top body and said bottom inner surface of said bottom body, and which is not exposed to said user in said folded state but exposed to said user in said unfolded state;
a lock system which operates in said lock mode, and which includes a first number of lock apps one of which is a lock web browser app capable of allowing said user to access a website in said lock mode; and
a main system which operates in said unlock mode, and includes a second number of main apps one of which is a main web browser app capable of allowing said user to access said website in said unlock mode, wherein said second number is not less than said first number,
wherein, in said folded state, said user executes said lock web browser app in said lock mode on said first display unit, and generates results as a result of executing said lock web browser app,
wherein, when said user provides said terminal with a first user input for unfolding in said folded state by rotating said top body away from said bottom body, said terminal switches from said folded state to said unfolded state, and exposes said second display unit to said user, and
wherein said terminal runs one of an erase operation and a semi-erase operation for erasing at least a portion of said results in one of a plurality of erasure timings,
whereby said terminal prevents malicious viruses included in one of said results and said lock system from migrating into said main system in said unlock mode.

27. The terminal of claim 26, wherein said rotatable joint is one of a hinge and a rotary joint.

28. The terminal of claim 26, wherein said rotatable joint couples said top and bottom bodies along one of long and short vertices of said top and bottom bodies.

29. The terminal of claim 26, wherein said preset range of said folding angles is one of about 45°, 60°, 90°, 120°, 150°, 150°, 180°, 210°, 2400, and 270°.

30. The terminal of claim 29, wherein said results include at least one of data, files, folder, texts, images, contents, and computer codes.

31. The terminal of claim 26, wherein said main system includes at least one of:
a second main app which runs a second operation which none of said lock apps run; and
a second main app which performs a second function which none of said lock apps perform.

32. The terminal of claim 26, wherein said lock system is one of physically and operationally isolated from said main system.

33. The terminal of claim 32, wherein said terminal prevents at least one of:
said lock system from accessing said main system in said lock mode;
said lock system from storing at least a portion of said results in said main system in
said lock mode;
said results from accessing said main system in said lock mode;
said results from being accessed by said main system in said lock mode; and
said main system from accessing said results in said unlock mode,
whereby said terminal prevents said malicious viruses included in one of said results and said lock system from migrating into said main system in said lock mode.

34. The terminal of claim 26, wherein said second display unit is disposed on said top inner surface as well as said bottom inner surface, and wherein said second display unit provides a top inner display surface and a bottom inner display surface, respectively, on said top inner surface and bottom inner surface, and wherein said terminal operates said main system on both of said top inner and bottom inner display surfaces of said second display unit in said unlock mode.

35. The terminal of claim 26 further comprising a third display unit,
wherein said second display unit is disposed on said top inner surface, and
wherein said third display unit is disposed on said bottom inner surface.

36. The terminal of claim 26, wherein said plurality of erasure timings include:
a first timing which is when a terminal detects said viruses in said results;
a second timing which is when a terminal detects said viruses in said first lock app;
a third timing which is when a terminal detects said viruses in at least two of said lock apps, wherein one of said lock apps is said first lock app;
a fourth timing which is when a terminal detects said viruses in said lock system;
a fifth timing which is when a certain period has elapsed after running at least one of a previous semi-erase operation and a previous erase operation;
a sixth timing which is when said user runs a certain number of said lock operations, wherein said number exceeds a preset number; and
a seventh timing which is when a size of said result reaches a certain size which exceeds a preset size.

37. The terminal of claim 26, wherein said plurality of erasure timings include:
an eighth timing which is when said terminal receives said first user input;
a ninth timing which is after said terminal receives said first user input but before receives an additional user input;
a tenth timing which is after said terminal receives said first user input but before beginning said unfolding;
an eleventh timing which is when said top body rotates away from said bottom body by a preset unfolding angle;
a twelfth timing which is during said unfolding; and
a thirteenth timing which is after said unfolding.

38. The terminal of claim 26, wherein, when detecting said malicious viruses in said lock system, said terminal removes at least one of:
said lock web browser app from said lock system;
at least two lock apps one of which is said lock web browser app from said lock system;
all of said lock apps from said lock system; and
said lock system.

39. The terminal of claim 38, wherein, after removing said lock web browser app, said terminal reloads a new web browser app into said lock system, and uses said reloaded web browser app as a new lock web browser app with which said user accesses said website in said lock mode.

40. The terminal of claim 39, wherein said main web browser app is capable of running up to a third number of different operations and capable of performing up to a fourth number of functions, and wherein said terminal obtains said new lock web browser app in said lock system by one of:
loading an entire portion of said main web browser app into said lock system, whereby said new lock web browser app is also capable of running up to said third number of different operations and also capable of performing up to said fourth number of functions;
loading only a portion but not an entire portion of said main web browser app into said lock system, whereby said new lock web browser app is capable of running up to a fifth number of different operations and also capable of performing up to said sixth number of functions, wherein at least one of said fifth and sixth numbers is less than said third and fourth numbers, respectively;
loading an entire portion of a reference web browser app into said lock system, wherein said reference web browser app also allows said user to access said external source in said lock mode, and wherein said reference web browser app is stored in said terminal but not in said main system; and
loading at least a portion but not an entire portion of said reference web browser app.

41. The terminal of claim 26, wherein said lock system includes said all of said first number of said lock apps therein even in said unlock mode, except when at least one of said first number of said lock apps is contaminated by said malicious viruses.

42. The terminal of claim 26, wherein said lock system includes said lock web browser app therein even in said unlock mode, except when said lock web browser app is contaminated by said malicious viruses.

43. The terminal of claim 26, wherein said terminal switches to said unfolded state in response to said first user input, and allows said user to drive said main system on said second display unit in said unlock mode, without running any user authentication operation.

44. The terminal of claim 26, wherein said terminal runs a user authentication operation in response to said first user input, switches to said unlock mode, and allows said user to drive said main system in said unlock mode on said secondary display unit when said user passes said user authentication.

45. The terminal of claim 44, wherein said terminal runs said user authentication operation based upon a user sub-input which is included in said first user input.

46. The terminal of claim 44, wherein said plurality of erasure timings include:
a fourteenth timing which is before running said user authentication operation;
a fifteenth timing which is concurrent with running said user authentication operation;
a sixteenth timing which is one of before, upon or after determining whether or not said passes said user authentication operation; and
a seventeenth timing which is after running an authentication operation.

47. The terminal of claim 26, wherein said first display unit is one of:
remaining turned on, while operating said lock system;
remaining turned on, while not operating said lock system; and
turned off.

48. The terminal of claim 26, wherein, after switching to said unfolded state, said terminal allows said user to operate said main system on said second display unit in said unlock mode, while one of:
not allowing said user to access said results in said unlock mode; and
allowing said user to access remaining portions of said results in said unlock mode, after said terminal runs said semi-erase operation.

49. A data processing terminal operating in a lock mode and in an unlock mode comprising:
a top body which defines a top outer surface and a top inner surface;
a first display unit which is disposed on said top outer surface of said top body;
a bottom body which defines a bottom outer surface and a bottom inner surface;
a second display unit which is disposed on one of said bottom inner surface of said bottom body and said top inner surface of said top body;
a rotatable joint which rotatably couples said top body with said bottom body, which defines a folding axis about which said top and bottom bodies rotates toward or away from each other between a folded state and an unfolded state within a preset range of folding angles;
wherein said top inner surface and said bottom inner surface are not exposed to a user in said folded state but that said top inner surface and said bottom inner surface are exposed to said user in said unfolded state;
a lock system which operates in said lock mode, and includes a first number of lock apps one of which is a first lock app; and
a main system which operates in said unlock mode, and includes a second number of main apps one of which is a first main app, wherein said second number is not less than said first number,
wherein said first lock app and said first main app run at least one same operation;
wherein said preset range ranges from a smallest folding angle to a greatest folding angle;
wherein said terminal is in said folded state when said folding angle is at least substantially close to said smallest folding angle so that said top inner surface is disposed proximate to said bottom inner surface and that said top inner surface and said bottom inner surface are not exposed to said user,
wherein said terminal is in said unfolded state when said folding angle is at least substantially close to said greatest folding angle so that said top inner surface and said bottom inner surface are exposed to said user,
wherein said terminal in said folded state allows said user to drive said lock system in said lock mode on said first display unit, and to run lock operations in said lock mode, thereby generate results from running said lock operations, and
wherein, when said user provides to said terminal a first user input of rotating said top body away from said bottom body and said terminal starts unfolding in response to said first user input, said terminal switches to said unfolded state after said unfolding, runs one of an erase operation and a semi-erase operation so as to erase at least a portion of said results in one of a plurality of erasure timings, and allows said user to drive said main system in said unlock mode on said target display unit,
whereby said terminal prevents malicious viruses included in at least one of said results and said lock system from migrating into said main system.
